(19) United States
(12) Patent Application Publication
(10) Pub. No.: US 2024/0216953 A1
(43) Pub. Date: Jul. 4, 2024

(54) APPARATUS

(71) Applicant: LG Display Co., Ltd., Seoul (KR)

(72) Inventors: Taehyung KIM, Paju-si (KR); GyungBo HA, Paju-si (KR); SeulKi NAM, Paju-si (KR); Minjung KIM, Paju-si (KR)

(73) Assignee: LG Display Co., Ltd., Seoul (KR)

(21) Appl. No.: 18/529,860

(22) Filed: Dec. 5, 2023

(30) Foreign Application Priority Data
Dec. 30, 2022 (KR) 10-2022-0190979

(51) Int. Cl. B06B 1/06

(52) U.S. Cl. CPC B06B 1/0629; B06B 1/064; B06B 3/02

(57) ABSTRACT

An apparatus includes a first vibration member, a second vibration member at a rear surface of the first vibration member, a vibration apparatus including a first vibration generating apparatus connected with the first vibration member and a second vibration generating apparatus connected with the second vibration member, and a space between the first vibration member and the second vibration member.

### CROSS-REFERENCE TO RELATED APPLICATION

This application claims the benefit and priority to Korean Patent Application No. 10-2022-0190979 filed in the Republic of Korea on Dec. 30, 2022, the entire contents of which is hereby expressly incorporated by reference into the present application.

### BACKGROUND

### Technical Field

The present disclosure relates to an apparatus, and more particularly, to an apparatus for outputting a sound.

### Description of the Related Art

Apparatuses include a separate speaker or sound apparatus for providing a sound. The apparatuses include a vibration meter which converts an input electrical signal into a physical vibration. Piezoelectric speakers including a piezoelectric device are lightweight and have low power consumption, and thus, are being used for various purposes.

In piezoelectric devices used in piezoelectric speakers, a lowest resonance frequency increases due to high stiffness, and due to this, a sound of a low-pitched sound band is easily insufficient. Therefore, piezoelectric speakers are not sufficient in sound pressure level of the low-pitched sound band, and due to this, apparatuses including a piezoelectric speaker have a problem where a sound pressure level of the low-pitched sound band is not sufficient.

### SUMMARY

Therefore, the inventors have recognized problems described above and have performed extensive research and experiments for enhancing a sound characteristic and/or a sound pressure level characteristic of an apparatus or a sound apparatus. Based on the extensive research and experiments, the inventors have invented an apparatus for enhancing a sound characteristic and/or a sound pressure level characteristic of a low-pitched sound band of an apparatus.

Accordingly, embodiments of the present disclosure are directed to an apparatus that substantially obviates one or more of the problems due to limitations and disadvantages of the related art.

An aspect of the present disclosure is to provide an apparatus for enhancing a sound characteristic and/or a sound pressure level characteristic of a low-pitched sound band.

Another aspect of the present disclosure is to provide an apparatus for enhancing a sound characteristic and/or a sound pressure level characteristic of a high-pitched sound band.

Another aspect of the present disclosure is to provide an apparatus for enhancing a sound characteristic and/or a sound pressure level characteristic of a wide pitched sound band.

Another aspect of the present disclosure is to provide an apparatus which may enhance a sound characteristic and/or a sound pressure level characteristic of a wide pitched sound band and may output a sound in both directions.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other aspects of the inventive concepts, as embodied and broadly described herein, a vibration apparatus may comprise a first vibration member, a second vibration member at a rear surface of the first vibration member, a vibration apparatus including a first vibration generating apparatus connected with the first vibration member and a second vibration generating apparatus connected with the second vibration member, and a space between the first vibration member and the second vibration member.

According to an embodiment of the present disclosure, an apparatus for enhancing a sound characteristic and/or a sound pressure level characteristic of a low-pitched sound band may be provided.

According to an embodiment of the present disclosure, an apparatus for enhancing a sound characteristic and/or a sound pressure level characteristic of a high-pitched sound band may be provided.

According to an embodiment of the present disclosure, an apparatus for enhancing a sound characteristic and/or a sound pressure level characteristic of a wide pitched sound band may be provided.

According to an embodiment of the present disclosure, an apparatus for enhancing a sound characteristic and/or a sound pressure level characteristic of a wide pitched sound band and improving the flatness of a sound pressure level may be provided.

An apparatus according to an embodiment of the present disclosure may enhance a sound characteristic and/or a sound pressure level characteristic of a wide pitched sound band and may output a sound in both directions.

According to an embodiment of the present disclosure, a piezoelectric device which is lightweight and has low power consumption may be used and a sound characteristic and/or a sound pressure level characteristic of the low-pitched sound band may be enhanced, and thus, an apparatus for realizing or implementing low power consumption and lightness may be provided.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description are exemplary and explanatory and are intended to provide further explanation of the inventive concepts as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain principles of the disclosure.

FIG. 1 illustrates an apparatus according to an embodiment of the present disclosure.

FIG. 2 is a cross-sectional view taken along line I-I′ illustrated in FIG. 1 according to an embodiment of the present disclosure.

FIGS. 3 to 9 are other cross-sectional views taken along line I-I′ illustrated in FIG. 1 according to another embodiment of the present disclosure.

FIG. 10 illustrates a vibration generating apparatus according to an embodiment of the present disclosure.

FIG. 11 is a cross-sectional view taken along line II-II′ illustrated in FIG. 10 according to an embodiment of the present disclosure.

FIG. 12 illustrates a vibration layer according to another embodiment of the present disclosure.

FIG. 13 illustrates an arrangement structure of a vibration generating apparatus illustrated in a region A of FIG. 9 according to another embodiment of the present disclosure.

FIGS. 14 to 45 illustrate an arrangement structure of the vibration generating apparatus illustrated in the region A of FIG. 9 according to another embodiment of the present disclosure.

FIG. 46 illustrates a vibration generating apparatus according to another embodiment of the present disclosure.

FIG. 47 is a cross-sectional view taken along line III-III′ illustrated in FIG. 46 according to another embodiment of the present disclosure.

FIGS. 48 to 71 illustrate an arrangement structure of the vibration generating apparatus illustrated in the region A of FIG. 9 according to another embodiment of the present disclosure. in FIG. 1 according to another embodiment of the present disclosure.

FIG. 73 illustrates a block diagram of a sound processing circuit according to an embodiment of the present disclosure.

FIG. 74 illustrates a block diagram of a sound processing circuit according to another embodiment of the present disclosure.

FIG. 75 illustrates a sound output characteristic of an apparatus according to an experiment example and an embodiment of the present disclosure.

FIG. 76 illustrates a sound output characteristic of an apparatus according to an experiment example and an embodiment of the present disclosure.

FIG. 77 illustrates a sound output characteristic of an apparatus according to an embodiment of the present disclosure.

FIG. 78 illustrates a sound output characteristic of an apparatus according to an experiment example and an embodiment of the present disclosure.

FIG. 79 illustrates a sound output characteristic of an apparatus according to an embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and/or convenience.

### DETAILED DESCRIPTION

Reference is now made in detail to embodiments of the present disclosure, examples of which may be illustrated in the accompanying drawings. In the following description, when a detailed description of well-known methods, functions, structure or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof will be clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements, one or more other elements may be added unless a term such as “only” or the like is used. The terms used in the present disclosure are merely used to describe particular embodiments, and are not intended to limit the scope of the present disclosure. The terms of a singular form may include plural forms unless the context clearly indicates otherwise.

The word “exemplary” is used to mean serving as an example or illustration, unless otherwise specified. Embodiments are example embodiments. Aspects are example aspects. “Embodiments,” “examples,” “aspects,” and the like should not be construed to be preferred or advantageous over other implementations.

An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

In describing a positional relationship, when the positional relationship between two elements (e.g., layers, films, regions, components, sections, or the like) is described, for example, using “on,” “upon,” “on top of,” “over,” “under,” “above,” “below.” “beneath,” “near,” “close to,” “adjacent to,” “beside,” “next to,” “at or on a side of,” or the like, one or more other elements may be located between two elements unless a more limiting term, such as “immediate(ly),” “direct(ly),” or “close(ly),” is used. For example, when an element is described as being positioned “on,” “upon,” “on top of,” “over,” “under,” “above,” “below,” “beneath,” “near,” “close to,” “adjacent to,” “beside,” “next to,” “on a side of,” or the like another element, this description should be construed as including a case in which the elements contact each other directly as well as a case in which one or more additional elements are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, can be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. In one or more aspects, the term “below” or the like, which is an example term, can include all directions, including directions of “above” and “below” and diagonal directions. Likewise, an exemplary term “above,” “on” or the like can include all directions, including directions of “above” and “below” and diagonal directions.

In describing a temporal relationship, when the temporal order is described as, for example, “after,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first”, “second,” or the like may be used herein to describe various elements (e.g., layers, films, regions, components, sections, or the like), these elements should not be limited by these terms, for example, to any particular order, sequence, precedence, or number of elements. These terms are used only to distinguish one element from another. For example, a first element could be a second element, and, similarly, a second element could be a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element (e.g., layer, film, region, component, section, or the like) is described as “connected,” “coupled,” “attached,” “adhered,” or the like to another element, the element may not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) “contacts,” “overlaps,” or the like with another element, the element may not only directly contact, overlap, or the like with another element, but also indirectly contact, overlap, or the like with another element with one or more intervening elements disposed or interposed between the elements, unless otherwise specified.

The phase that an element (e.g., layer, film, region, component, section, or the like) is “provided,” “disposed,” “connected,” “coupled,” or the like in, on, with or to another element may be understood, for example, as that at least a portion of the element is provided, disposed, connected, coupled, or the like in, on, with or to at least a portion of another element. The phrase “through” may be understood, for example, to be at least partially through or entirely through. The phase that an element (e.g., layer, film, region, component, section, or the like) “contacts,” “overlaps,” or the like with another element may be understood, for example, as that at least a portion of the element contacts, overlaps, or the like with a least a portion of another element.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure can operate functionally. For example, the terms “first direction,” “second direction,” and the like (or the terms such as a first direction X, a first horizontal direction, a first horizontal length direction, a second direction Y, a second horizontal direction, a second horizontal length direction, a vertical direction, a planar direction, a lengthwise direction, a widthwise direction, a vertical direction Z, and a height direction Z) should not be interpreted only based on a geometrical relationship in which the respective directions are parallel, perpendicular, diagonal, or slanted with respect to each other, and may be meant as directions having wider directivities within the range within which the components of the present disclosure can operate functionally.

The term “at least one” should be understood as including any and all combinations of one or more of the associated listed items. For example, each of the phrases of “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “some,” “some elements,” “a portion,” “portions,” “at least a portion,” “at least portions,” “a part.” “at least a part,” “parts,” “at least parts,” “one or more,” or the like of the plurality of elements can represent (i) one element of the plurality of elements, (ii) a part of the plurality of elements, (iii) parts of the plurality of elements, (iv) multiple elements of the plurality of elements, or (v) all of the plurality of elements. Moreover, at least a portion (or a part) of an element can represent (i) a portion (or a part) of the element, (ii) one or more portions (or parts) of the element, or (iii) the element, or the entirety of the element. A phrase that a plurality of first elements are connected to a plurality of second elements may describe, for example, that at least a part (or one or more first elements) of a plurality of first elements are connected to at least a part (or one or more second elements) of a plurality of second elements.

The expression of a first element, a second elements, “and/or” a third element should be understood to encompass one of the first, second, and third elements or any or all combinations of the first, second and third elements. By way of example, A, B and/or C may refer to only A: only B: only C: any of A, B, and C (e.g., A, B, or C): some combination of A, B, and C (e.g., A and B: A and C: or B and C); or all of A, B, and C. Furthermore, an expression “A/B” may be understood as A and/or B. For example, an expression “A/B” may refer to only A: only B: A or B: or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element (e.g., layer, film, region, component, section, or the like) is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise. In one or more aspects, unless stated otherwise, the term “nth” may refer to “nnd” (e.g., 2nd where n is 2) or “nrd” (e.g., 3rd where n is 3), and n may be a natural number.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

In the present disclosure, examples of an apparatus may include a narrow-sense display apparatus such as an organic light emitting display (OLED) module or a liquid crystal module (LCM) including a display panel and a driver for driving the display panel. Also, examples of the display apparatus may include a set device (or a set apparatus) or a set electronic apparatus such as a notebook computer, a TV, a computer monitor, an equipment apparatus including an automotive apparatus or another type apparatus for vehicles, or a mobile electronic device such as a smartphone or an electronic pad, which is a complete product (or a final product) including an LCM or an OLED module.

Therefore, in the present disclosure, examples of the display apparatus may include a narrow-sense display apparatus itself, such as an LCM or an OLED module, etc., and a set device which is a final consumer device or an application product including the LCM or the OLED module, etc.

Depending on the case, an LCM or an OLED module including a display panel and a driver may be referred to as a narrow-sense display apparatus, and an electronic device which is a final product including an LCM or an OLED module may be referred to as a set device. For example, the narrow-sense display apparatus may include a display panel, such as an LCD or an OLED, and a source printed circuit board (PCB) which is a controller for driving the display panel. The set device may further include a set PCB which is a set controller electrically connected to the source PCB to overall control the set device.

A display panel applied to an embodiment of the present disclosure may use all types of display panels such as a liquid crystal display panel, an organic light emitting diode (OLED) display panel, a quantum dot (QD) display panel, and an electroluminescent display panel. The display panel according to an embodiment of the present disclosure is not limited to a specific display panel capable of being bezel-bent in a lower back plate supporting structure and a flexible substrate for OLED display panels, without being limited thereto. As an example, the display panel may have a bezel not bent to the lower back plate and/or the flexible substrate, and/or may be a rigid or flexible display panel. Also, a shape or a size of a display panel applied to a display apparatus according to an embodiment of the present disclosure is not limited.

For example, when the display panel is the organic light emitting display panel, the display panel may include a plurality of gate lines, a plurality of data lines, and a plurality of pixels respectively provided in a plurality of pixel areas defined by intersections of the gate lines and the data lines. Also, the display panel may include an array substrate including a TFT which is an element for selectively applying a voltage to each of the pixels, an organic light emitting device layer on the array substrate, and an encapsulation substrate disposed on the array substrate to cover the organic light emitting device layer. The encapsulation substrate may protect the TFT and the organic light emitting device layer from an external impact and may prevent water (or moisture) or oxygen from penetrating into the organic light emitting device layer. Alternatively, a layer provided on the array substrate may include an inorganic light emitting layer (for example, a nano-sized material layer, a quantum dot, or the like) or an organic light emitting layer.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other, or may be implemented or carried out together in a co-dependent or related relationship. In one or more aspects, the components of each apparatus and device according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense, unless expressly defined otherwise herein.

The terms used herein have been selected as being general in the related technical field: however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

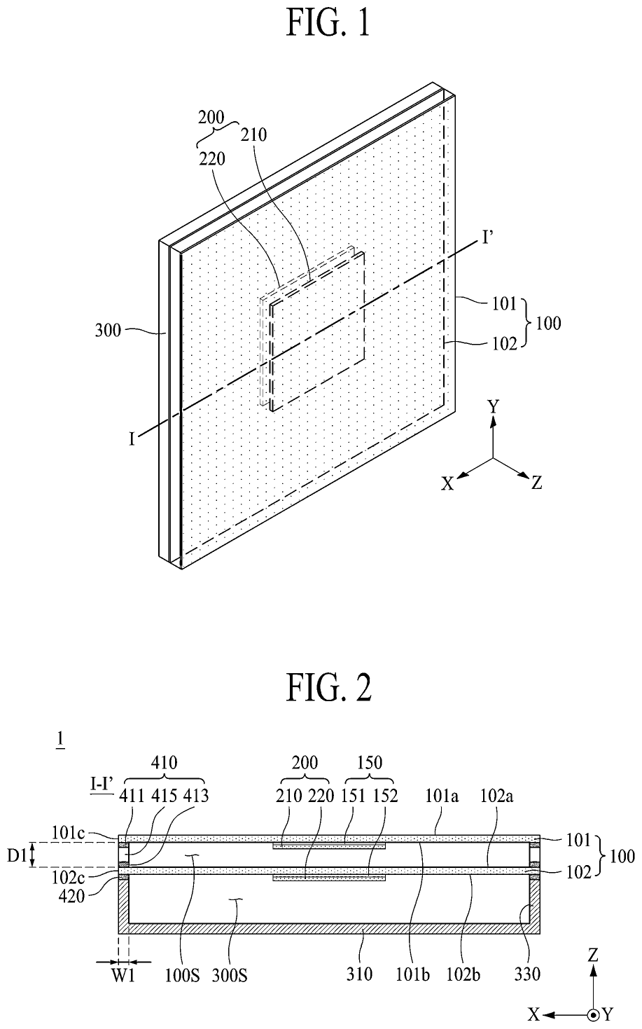

FIG. 1 illustrates an apparatus according to an embodiment of the present disclosure. FIG. 2 is a cross-sectional view taken along line I-I′ illustrated in FIG. 1 according to an embodiment of the present disclosure.

Referring to FIGS. 1 and 2, the apparatus 1 according to an embodiment of the present disclosure may implement a sound apparatus, a sound output apparatus, a vibration apparatus, a vibration generating apparatus, a sound bar, a sound system, a sound apparatus for electronic devices, a sound apparatus for display, a sound apparatus for transport apparatuses, or a sound bar for transport apparatuses. For example, a transport apparatus may include one or more seats and one or more glass windows. For example, the transport apparatus may include a vehicle, a train, a ship, or an aircraft, but embodiments of the present disclosure are not limited thereto. Also, the apparatus 1 according to an embodiment of the present disclosure may be implement or realize an analog signage or a digital signage such as an advertising signboard, a poster, or a signboard.

The apparatus 1 according to an embodiment of the present disclosure may be a display apparatus including a plurality of pixels, but embodiments of the present disclosure are not limited thereto.

The display apparatus may include a display panel, including a plurality of pixels configuring a black/white or color image, and a driver for driving the display panel. Each of the plurality of pixels may be a subpixel configuring one of a plurality of colors configuring a color image. The apparatus 1 according to an embodiment of the present disclosure may include a notebook computer, a television (TV), a computer monitor, an equipment apparatus including a specific form of a vehicle or a vehicular or automotive apparatus, and a set device (or a set apparatus) or a set electronic apparatus such as a smartphone or an electronic pad, which are complete products (or final products) including a display panel such as a liquid crystal display panel or an organic light emitting display panel.

The apparatus 1 according to an embodiment of the present disclosure may include a vibration member 100 and a vibration apparatus 200.

The vibration member 100 may generate or output a vibration (or a sound wave), based on a displacement (or driving or vibrating) of the vibration apparatus 200. The vibration member 100 may be a vibration object, a display member, a display panel, a signage panel, a passive vibration member, a passive vibration plate, a front member, a rear member, a vibration panel, a sound panel, a passive vibration panel, a sound output plate, a sound vibration plate, or an image screen, but embodiments of the present disclosure are not limited thereto.

The vibration member 100 may be a display panel which includes a display part (or a screen) including a plurality of pixels for implementing a black and white, or color image. Therefore, the vibration member 100 may generate one or more of a vibration and a sound, based on a displacement (or driving) of the vibration apparatus 200. For example, the vibration member 100 may vibrate based on a displacement (or driving) of the vibration apparatus 200 while displaying an image on the display part, and thus, may generate or output a sound synchronized with the image displayed on the display part, but embodiments of the present disclosure are not limited thereto.

The vibration member 100 may be configured to be transparent, semitransparent, or opaque. The vibration member 100 may include a metal material having a material property suitable for outputting sound in accordance with vibration or may include a non-metal material (or a composite non-metal material).

According to an embodiment of the present disclosure, the metal material of the vibration member 100 may include at least one of stainless steel, aluminum (Al), an aluminum (Al) alloy, magnesium (Mg), a magnesium (Mg) alloy, and a magnesium lithium (Mg—Li) alloy, but embodiments of the present disclosure are not limited thereto. For example, the vibration member 100 may include a metal material such as the aluminum (Al), or may include a plastic material such as plastic or styrene material, but embodiments of the present disclosure are not limited thereto. For example, the styrene material may be an ABS material. The ABS material may be acrylonitrile, butadiene, and styrene.

According to another embodiment of the present disclosure, the nonmetal material (or the composite nonmetal material) of the vibration member 100 may include one or more of plastic, fiber, leather, wood, cloth, rubber, carbon, glass, and paper, but embodiments of the present disclosure are not limited thereto. For example, the paper may be a cone paper for speakers. For example, the cone paper may be pulp or foam plastic, but embodiments of the present disclosure are not limited thereto.

The vibration member 100 may have a planar structure. For example, the vibration member 100 may include a flat plate structure having a polygonal shape including a rectangular shape or a square shape. For example, the vibration member 100 may include a flat plate structure having the same overall thickness or may include a non-planar structure, but embodiments of the present disclosure are not limited thereto.

The vibration member 100 may include a horizontal length parallel with a first direction X and a vertical length parallel with a second direction Y crossing the first direction X. For example, with respect to the same plane, the first direction X may be a first horizontal direction or a first horizontal length direction of the vibration member 100, the second direction Y may be a second horizontal direction intersecting with the first direction X or a second horizontal length direction of the vibration member 100. According to an embodiment of the present disclosure, the vibration member 100 may include a rectangular shape where the horizontal length is relatively longer than the vertical length, or may include a square shape where the horizontal length is equal to the vertical length, but embodiments of the present disclosure are not limited thereto.

A vibration member 100 according to an embodiment of the present disclosure may include a first vibration member 101 and a second vibration member 102. The first vibration member 101 and the second vibration member 102 may be spaced apart from each other in a third direction Z. For example, the third direction Z may be a vertical direction or a thickness direction of the vibration member 100. The first vibration member 101 and the second vibration member 102 may be disposed in parallel and spaced apart from each other in the third direction Z. The first vibration member 101 and the second vibration member 102 may be spaced apart from each other and may be configured to include a space 100S (or a first space) between the first vibration member 101 and the second vibration member 102. The first vibration member 101 and the second vibration member 102 may be provided to overlap each other. For example, at least a portion of the first vibration member 101 may overlap the second vibration member 102.

The first vibration member 101 according to an embodiment of the present disclosure may configure a front surface of the apparatus 1. The first vibration member 101 may include a first surface 101a, a second surface 101b, and a plurality of lateral surfaces 101c. For example, in the first vibration member 101, the first surface 101a may be a front surface, a forward surface, a top, or an upper surface. The second surface 101b may be a rear surface, a rearward surface, a back surface, a backside, a bottom, or a lower surface. Each of the plurality of lateral surfaces 101c may be a side, an outer side, a sidewall, or an outer wall. Each of the first surface 101a and the second surface 101b of the first vibration member 101 may include a flat structure. The first vibration member 101 may include a structure which has a wholly uniform thickness, but embodiments of the present disclosure are not limited thereto. For example, the first vibration member 101 may include a plate structure having a wholly uniform thickness, but embodiments of the present disclosure are not limited thereto. Each of the plurality of lateral surfaces 101c of the first vibration member 101 may include a vertical surface structure parallel to the third direction Z. The third direction Z may be a direction parallel to the thickness direction of the first vibration member 101.

According to an embodiment of the present disclosure, the first vibration member 101 may be configured to be transparent, semitransparent, or opaque. The first vibration member 101 may include a metal material having a material characteristic which is suitable for outputting a sound on the basis of a vibration, or may include a nonmetal material (or a complex nonmetal material). The metal material of the first vibration member 101 may include one or more materials of stainless steel, aluminum (Al), an Al alloy, magnesium (Mg), a Mg alloy, and a magnesium-lithium (Mg—Li) alloy, but embodiments of the present disclosure are not limited thereto. The nonmetal material (or the complex nonmetal material) of the first vibration member 101 may include one or more materials of plastic, fiber, leather, wood, cloth, rubber, carbon, glass, and paper, but embodiments of the present disclosure are not limited thereto. For example, the paper may be cone paper for speakers. For example, the cone paper may be pulp or foam plastic, but embodiments of the present disclosure are not limited thereto.

According to another embodiment of the present disclosure, the first vibration member 101 may implement or configure an analog signage or a digital signage such as an advertising signboard, a poster, or a guideboard. For example, in a case where the first vibration member 101 implements a signage panel, the analog signage may include signage content such as a sentence, a picture, and a sign. The signage content may be disposed in the first vibration member 101 so as to be visible. For example, the signage content may be attached on one or more of the first surface 101a and the second surface 101b of the first vibration member 101. For example, the signage content may be directly attached on one or more of the first surface 101a and the second surface 101b of the first vibration member 101. For example, the signage content may be printed on a medium such as paper, and a medium on which the signage content is printed may be directly attached on one or more of the first surface 101a and the second surface 101b of the first vibration member 101. For example, when the signage content is attached on the second surface 101b of the first vibration member 101, the first vibration member 101 may include a transparent material.

According to another embodiment of the present disclosure, the first vibration member 101 may include a display panel including a pixel displaying an image, or may include a non-display panel. For example, the first vibration member 101 may include one or more of a display panel including a pixel displaying an image, a screen panel on which an image is to be projected from a display apparatus, a lighting panel, a signage panel, an interior material of a vehicular means, an exterior material of a vehicular means or vehicular interior material, a glass window of a vehicular means or vehicular interior material, a seat interior material of a vehicular means or vehicular interior material, a ceiling material of a building, an interior material of a building, a glass window or a window of a building, an interior material of an aircraft, a glass window of an aircraft, and a mirror, but embodiments of the present disclosure are not limited thereto. For example, the non-display panel may include a light emitting diode lighting panel (or apparatus), an organic light emitting lighting panel (or apparatus), or an inorganic light emitting lighting panel (or apparatus), but embodiments of the present disclosure are not limited thereto.

The second vibration member 102 according to an embodiment of the present disclosure may be disposed on the second surface 101b (or a rear surface) of the first vibration member 101. The second vibration member 102 may be disposed to be spaced apart from the second surface 101b of the first vibration member 101. For example, the second vibration member 102 may be disposed to be spaced apart from the second surface 101b of the first vibration member 101 in the third direction Z. The second vibration member 102 may include a first surface 102a, a second surface 102b, and a plurality of lateral surfaces 102c. For example, in the second vibration member 102, the first surface 102a may be a front surface, a forward surface, a top, or an upper surface. The second surface 102b may be a rear surface, a rearward surface, a back surface, a backside, a bottom, or a lower surface. Each of the plurality of lateral surfaces 102c may be a side, an outer side, a sidewall, or an outer wall. Each of the first surface 102a and the second surface 102b of the second vibration member 102 may include a flat structure. The second vibration member 102 may include a structure which has a wholly uniform thickness, but embodiments of the present disclosure are not limited thereto. For example, the second vibration member 102 may include a plate structure having a totally uniform thickness, but embodiments of the present disclosure are not limited thereto. Each of the plurality of lateral surfaces 102c of the second vibration member 102 may include a vertical surface structure parallel to the third direction Z. The third direction Z may be a direction parallel to the thickness direction of the second vibration member 102.

According to an embodiment of the present disclosure, the second vibration member 102 may be configured to be transparent, semitransparent, or opaque. The second vibration member 102 may include a metal material having a material characteristic which is suitable for outputting a sound on the basis of a vibration, or may include a nonmetal material (or a complex nonmetal material). The metal material of the second vibration member 102 may include one or more materials of stainless steel, aluminum (Al), an Al alloy, magnesium (Mg), a Mg alloy, and a magnesium-lithium (Mg—Li) alloy, but embodiments of the present disclosure are not limited thereto. The nonmetal material (or the complex nonmetal material) of the second vibration member 102 may include one or more materials of plastic, fiber, leather, wood, cloth, rubber, carbon, glass, and paper, but embodiments of the present disclosure are not limited thereto. For example, the paper may be cone paper for speakers. For example, the cone paper may be pulp or foam plastic, but embodiments of the present disclosure are not limited thereto.

The first vibration member 101 and the second vibration member 102 according to an embodiment of the present disclosure may have the same size or different sizes. For example, the first vibration member 101 may have a size which differs from that of the second vibration member 102, or may have a size which is greater than or equal to that of the second vibration member 102. For example, the first vibration member 101 may have the same size as that of the second vibration member 102 and may overlap the second vibration member 102. For example, the first vibration member 101 may have a size which is greater than that of the second vibration member 102, and at least a portion of the first vibration member 101 may overlap the second vibration member 102.

The first vibration member 101 and the second vibration member 102 according to an embodiment of the present disclosure may have the same thickness or different thicknesses. For example, the first vibration member 101 may have a thickness which differs from that of the second vibration member 102, or may have a thickness which is greater than or equal to that of the second vibration member 102. Also, the first vibration member 101 and the second vibration member 102 may have the same material or different materials. For example, the first vibration member 101 and the second vibration member 102 may be configured to generate sounds of the same pitched sound band or different pitched sound bands. For example, the first vibration member 101 and the second vibration member 102 may be configured to generate sounds of different pitched sound bands. For example, the first vibration member 101 may be a vibration member of a middle-high-pitched sound band, and the second vibration member 102 may be a vibration member of a low-pitched sound band. For example, a peak portion of a sound generated based on a vibration of a vibration member may move to a low-pitched sound band area as a thickness of the vibration member is progressively thickened. Also, a pitched sound band of a sound generated based on a vibration of a vibration member may be adjusted based on a material characteristic of the vibration member. Therefore, the first vibration member 101 may be configured to have a thickness which is relatively greater than that of the second vibration member 102, or a characteristic of a material of the first vibration member 101 may include a material suitable for generating a sound of the middle-high-pitched sound band. Also, the second vibration member 102 may be configured to have a thickness which is relatively less than that of the first vibration member 101, or a characteristic of a material of the second vibration member 102 may include a material suitable for generating a sound of the low-pitched sound band. For example, a material of the first vibration member 101 may include a material which is harder than that of the second vibration member 102. For example, the first vibration member 101 may be a main vibration plate, but embodiments of the present disclosure are not limited thereto. For example, the second vibration member 102 may be a sub vibration plate, but embodiments of the present disclosure are not limited thereto. A connection member 410 (or a first connection member) may be further provided between the first vibration member 101 and the second vibration member 102 according to an embodiment of the present disclosure.

The first vibration member 101 may be connected with or coupled to the second vibration member 102 by the connection member 410 (or the first connection member). A first surface (or an upper surface) of the connection member 410 may be connected with or coupled to the second surface 101b (or the rear surface) of the first vibration member 101. Also, a second surface (or a lower surface) of the connection member 410 may be connected with or coupled to the first surface 102a (or the upper surface) of the second vibration member 102. The connection member 410 may include a base substrate 415, a first adhesive layer 411 disposed at a first surface (or an upper surface) of the base substrate 415, and a second adhesive layer 413 disposed at a second surface (or a lower surface) of the base substrate 415. For example, the first adhesive layer 411 of the connection member 410 may be connected with or coupled to an edge portion of the second surface 101b of the first vibration member 101. Also, the second adhesive layer 413 of the connection member 410 may be connected with or coupled to an edge portion of the first surface 102a of the second vibration member 102. Therefore, the first vibration member 101 may be connected with (or coupled to) or supported by the second vibration member 102 by the connection member 410. The connection member 410 may be provided to surround a space 100S between the first vibration member 101 and the second vibration member 102. For example, the space 100S between the first vibration member 101 and the second vibration member 102 may be formed by the first vibration member 101, the second vibration member 102, and the connection member 410. For example, the space 100S between the first vibration member 101 and the second vibration member 102 may be a first space, a gap space, an internal space, an air gap, an air damper, a vibration space, a sound space, or a closed space, but embodiments of the present disclosure are not limited thereto.

The connection member 410 according to an embodiment of the present disclosure may maintain a constant impedance component based on air acting on the first vibration member 101 or the second vibration member 102 when the first vibration member 101 or the second vibration member 102 is vibrating. For example, air of the space 100S between the first vibration member 101 and the second vibration member 102 may resist a vibration of the first vibration member 101 or the second vibration member 102 and may act as an impedance component having a reactance component and a resistance varying based on a frequency. Therefore, the connection member 410 may configure, as a sealed space, the space 100S between the first vibration member 101 and the second vibration member 102, and thus, may maintain a constant impedance component (or an air impedance or an elastic impedance) acting on the first vibration member 101 or the second vibration member 102 based on air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

The connection member 410 according to an embodiment of the present disclosure may be provided so that the first vibration member 101 is spaced apart from the second vibration member 102 by a first interval D1. For example, the first interval D1 between the first vibration member 101 and the second vibration member 102 may correspond to a thickness of the connection member 410. For example, the first interval D1 between the first vibration member 101 and the second vibration member 102 may be the same as a thickness of the connection member 410.

According to an embodiment of the present disclosure, the connection member 410 (or the first connection member) may intactly maintain the first interval D1 between the first vibration member 101 and the second vibration member 102, or may minimize or prevent a change in the first interval D1. For example, the connection member 410 may include a base substrate 415 having a certain thickness and adhesive layers 411 and 413 which are respectively disposed at a first surface (or an upper surface) and a second surface (or a lower surface) of the base substrate 415. For example, the adhesive layers 411 and 413 may include a first adhesive layer 411 disposed at the first surface (or the upper surface) of the base substrate 415 and a second adhesive layer 413 disposed at the second surface (or the lower surface) of the base substrate 415. The base substrate 415 of the connection member 410 may include a material which enables a constant thickness to be maintained. For example, the base substrate 415 of the connection member 410 may include a metal material, or may include a nonmetal material (or a complex nonmetal material). The metal material of the base substrate 415 of the connection member 410 may include one or more materials of stainless steel, Al, an Al alloy, Mg, a Mg alloy, and a Mg—Li alloy, but embodiments of the present disclosure are not limited thereto. The nonmetal material (or the complex nonmetal material) of the base substrate 415 of the connection member 410 may include one or more materials of plastic, fiber, leather, wood, cloth, rubber, carbon, glass, and paper, but embodiments of the present disclosure are not limited thereto. Each of the first and second adhesive layers 411 and 413 of the connection member 410 may include one or more of an adhesive, a double-sided tape, a double-sided foam tape, a double-sided foam pad, and a double-sided cushion tape, but embodiments of the present disclosure are not limited thereto.

According to an embodiment of the present disclosure, the connection member 410) (or the first connection member) may be configured so that a vibration of the first vibration member 101 is transferred to the second vibration member 102, or a transfer of vibration of the second vibration member 102 to the first vibration member 101 is minimized or prevented, while intactly maintaining the first interval D1 between the first vibration member 101 and the second vibration member 102. For example, the connection member 410 may include the base substrate 415 having a certain thickness and elasticity and the adhesive layers 411 and 413 which are respectively disposed at the first surface (or the upper surface) and the second surface (or the lower surface) of the base substrate 415. For example, the adhesive layers 411 and 413 may include the first adhesive layer 411 disposed at the first surface (or the upper surface) of the base substrate 415 and the second adhesive layer 413 disposed at the second surface (or the lower surface) of the base substrate 415. The base substrate 415 of the connection member 410 may include a material which has a certain thickness and has elasticity for vibration absorption (or impact absorption). For example, the base substrate 415 of the connection member 410 may include polyurethane or polyolefin. but embodiments of the present disclosure are not limited thereto. Each of the first and second adhesive layers 411 and 413 of the connection member 410 may include an adhesive, a double-sided adhesive, a double-sided tape, a double-sided adhesive tape, a double-sided foam tape, a double-sided foam pad, a double-sided adhesive foam pad, a double-sided cushion tape, a tacky sheet, a double-sided polyurethane tape, a double-sided polyurethane foam tape, or a double-sided sponge tape, but embodiments of the present disclosure are not limited thereto. The vibration apparatus 200 may be configured to vibrate the vibration member 100. The vibration apparatus 200 may be disposed or provided in the vibration member 100. The vibration apparatus 200 may vibrate (or displace or drive) based on a driving signal (or a vibration driving signal or a voice signal) applied thereto to vibrate (or displace or drive) the vibration member 100. For example, the vibration apparatus 200 may be a vibration structure, a vibration device, a vibrator, a vibration generating device, a vibration generating apparatus, a vibration generator, a sounder, a sound device, a sound generating device, a sound apparatus, a sound generating apparatus, or a sound generator, but embodiments of the present disclosure are not limited thereto.

The vibration apparatus 200 may include a piezoelectric material or an electroactive material having a piezoelectric characteristic. The vibration apparatus 200 may vibrate (or displace or drive) the vibration member 100 according to a vibration (or displacement or driving) of a piezoelectric material based on a driving signal (or a vibration driving signal or a voice signal) applied to the piezoelectric material. For example, the vibration apparatus 200 may alternately contract and/or expand based on a piezoelectric effect, and thus, may vibrate (or displace or drive). For example, the vibration apparatus 200 may alternately contract and/or expand based on an inverse piezoelectric effect, and thus, may vibrate (or displace or drive) in a vertical direction (or a thickness direction) Z.

The vibration apparatus 200 according to an embodiment of the present disclosure may include a tetragonal shape which has a first length parallel to a first direction X and a second length parallel to a second direction Y. For example, the vibration apparatus 200 may include a rectangular shape where one of the first length and the second length is relatively long, or may include a square shape where the first length is equal to the second length, but embodiments of the present disclosure are not limited thereto.

The vibration apparatus 200 according to an embodiment of the present disclosure may be connected with or coupled to a first surface (or an upper surface) or a second surface (or a lower surface) of the vibration member 100 by an adhesive member 150. For example, the adhesive member 150 may be disposed between the vibration member 100 and the vibration apparatus 200.

The adhesive member 150 according to an embodiment of the present disclosure may include an adhesive layer (or a tacky layer) which is good in adhesive force or attaching force. For example, the adhesive member 150 may include an adhesive, a double-sided adhesive, a double-sided adhesive tape, a double-sided adhesive foam tape, a double-sided foam pad, or a tacky sheet, but embodiments of the present disclosure are not limited thereto. For example, when the adhesive member 150 includes a tacky sheet (or a tacky layer), the adhesive member 150 may include only an adhesive layer or a tacky layer without a base member such as a plastic material.

The adhesive layer (or the tacky layer) of the adhesive member 150 according to an embodiment of the present disclosure may include epoxy, acryl, silicone, or urethane, but embodiments of the present disclosure are not limited thereto.

The adhesive layer (or the tacky layer) of the adhesive member 150 according to an embodiment of the present disclosure may include a pressure sensitive adhesive (PSA), an optically cleared adhesive (OCA), or an optically cleared resin (OCR), but embodiments of the present disclosure are not limited thereto.

The vibration apparatus 200 according to an embodiment of the present disclosure may include a first vibration generating apparatus 210 and a second vibration generating apparatus 220. The first vibration generating apparatus 210 may be connected with or provided at the first vibration member 101. The second vibration generating apparatus 220 may be connected with or provided at the second vibration member 102. The first vibration generating apparatus 210) and the second vibration generating apparatus 220 may have the same size, or may have different sizes. For example, the first vibration generating apparatus 210 and the second vibration generating apparatus 220 may have substantially the same size within an error range of a manufacturing process. The first vibration generating apparatus 210 and the second vibration generating apparatus 220 may be disposed spaced apart from each other in the third direction Z. At least a portion of the first vibration generating apparatus 210 may be provided to overlap the second vibration generating apparatus 220. For example, the first vibration generating apparatus 210 may overlap the second vibration generating apparatus 220. For example, the first vibration member 101 where the first vibration generating apparatus 210 is disposed and the second vibration member 102 where the second vibration generating apparatus 220 is disposed may be provided to overlap each other, and a center portion of the first vibration member 101 and a center portion of the second vibration member 102 may match therebetween. The first vibration generating apparatus 210 may be disposed at the center portion of the first vibration member 101, and the second vibration generating apparatus 220 may be disposed at the center portion of the second vibration member 102. Accordingly, the first vibration generating apparatus 210 may overlap the second vibration generating apparatus 220.

The first vibration generating apparatus 210 and the second vibration generating apparatus 220 according to an embodiment of the present disclosure may be configured to be displaced (or driven or vibrated) in the same direction. For example, the first vibration generating apparatus 210 may be connected with or provided at the second surface 101b of the first vibration member 101. The second vibration generating apparatus 220 may be connected with or provided at the second surface 102b of the second vibration member 102. Also, a vibration driving signal applied to the first vibration generating apparatus 210 and a vibration driving signal applied to the second vibration generating apparatus 220 may have the same phase.

The first vibration generating apparatus 210 according to an embodiment of the present disclosure may be configured to vibrate the first vibration member 101. The first vibration generating apparatus 210 may be disposed or provided in the first vibration member 101. The first vibration generating apparatus 210 may vibrate (or displace or drive) based on a driving signal (or a vibration driving signal or a voice signal) applied thereto to vibrate (or displace or drive) the first vibration member 101.

The first vibration generating apparatus 210 may include a tetragonal shape which has a first length parallel to a first direction X and a second length parallel to a second direction Y. For example, the first vibration generating apparatus 210 may include a rectangular shape where the second length is relatively longer than the first length, or may include a square shape where the second length is equal to the first length, but embodiments of the present disclosure are not limited thereto.

The first vibration generating apparatus 210 may be disposed at the second surface 101b of the first vibration member 101. For example, the first vibration generating apparatus 210 may be connected with or coupled to the second surface 101b of the first vibration member 101 by a first adhesive member 151. For example, the first adhesive member 151 may be disposed between the first vibration member 101 and the first vibration generating apparatus 210. The first adhesive member 151 may include an adhesive layer (or a tacky layer) which is good in adhesive force or attaching force. For example, the first adhesive member 151 may include an adhesive, a double-sided adhesive, a double-sided tape, a double-sided adhesive tape, a double-sided adhesive foam tape, a double-sided foam tape, a double-sided adhesive foam pad, a double-sided cushion tape, or a tacky sheet, but embodiments of the present disclosure are not limited thereto. According to another embodiment of the present disclosure, the first adhesive member 151 may be a chemical adhesive or a magnet, but embodiments of the present disclosure are not limited thereto.

The second vibration generating apparatus 220 according to an embodiment of the present disclosure may be configured to vibrate the second vibration member 102. The second vibration generating apparatus 220 may be disposed or provided in the second vibration member 102. The second vibration generating apparatus 220 may vibrate (or displace or drive) based on a driving signal (or a vibration driving signal or a voice signal) applied thereto to vibrate (or displace or drive) the second vibration member 102.

The second vibration generating apparatus 220 may include a tetragonal shape which has a first length parallel to a first direction X and a second length parallel to a second direction Y. For example, the second vibration generating apparatus 220 may include a rectangular shape where the second length is relatively longer than the first length, or may include a square shape where the second length is equal to the first length, but embodiments of the present disclosure are not limited thereto.

The second vibration generating apparatus 220 may be disposed at the second surface 102b of the second vibration member 102. For example, the second vibration generating apparatus 220 may be connected with or coupled to the second surface 102b of the second vibration member 102 by a second adhesive member 152. For example, the second adhesive member 152 may be disposed between the second vibration member 102 and the second vibration generating apparatus 220. The second adhesive member 152 may include an adhesive layer (or a tacky layer) which is good in adhesive force or attaching force. For example, the second adhesive member 152 may include an adhesive, a double-sided adhesive, a double-sided tape, a double-sided adhesive tape, a double-sided adhesive foam tape, a double-sided foam tape, a double-sided adhesive foam pad, a double-sided cushion tape, or a tacky sheet, but embodiments of the present disclosure are not limited thereto. According to another embodiment of the present disclosure, the second adhesive member 152 may be a chemical adhesive or a magnet, but embodiments of the present disclosure are not limited thereto.

The apparatus 1 according to an embodiment of the present disclosure may further include an enclosure 300 and a connection member 420 (or a second connection member).

The enclosure 300 may be disposed or provided at the second surface 102b (or the rear surface) of the second vibration member 102. The enclosure 300 may be configured to support an edge portion of the second surface 102b of the second vibration member 102. The enclosure 300 may be configured to cover the second surface 102b of the second vibration member 102.

The enclosure 300 according to an embodiment of the present disclosure may include a space 300S (or a second space) which surrounds the second surface 102b of the second vibration member 102. For example, the enclosure 300 may include a box shape where one side (or an upper side) of the space 300S is opened. For example, one opening of the enclosure 300 may be covered by the second vibration member 102, and an air gap may be formed in the space 300S between the enclosure 300 and the second vibration member 102. For example, the enclosure 300 may be a housing, a case, an outer case, a case member, a housing member, a cabinet, a sealing member, a sealing cap, a sealing box, or a sound box, but embodiments of the present disclosure are not limited thereto. For example, the space 300S of the enclosure 300 may be a gap space, an air gap, a vibration space, a sound space, a sounding box, or a sealing space, but embodiments of the present disclosure are not limited thereto.

The enclosure 300 according to an embodiment of the present disclosure may include one or more materials of a metal material and a nonmetal material (or a complex nonmetal material), but embodiments of the present disclosure are not limited thereto. For example, the enclosure 300 may include one or more materials of a metal material, plastic, and wood, but embodiments of the present disclosure are not limited thereto. For example, the enclosure 300 may include a metal material of an Al material or may include a plastic material of a plastic or styrene material, but embodiments of the present disclosure are not limited thereto. For example, the styrene material may be an ABS material. The ABS material may be acrylonitrile, butadiene, and styrene.

The enclosure 300 according to an embodiment of the present disclosure may intactly (or consistently) maintain an impedance component based on air acting on the second vibration member 102 when the second vibration member 102 is vibrating. For example, air around the second vibration member 102 may resist a vibration of the second vibration member 102 and may act as an impedance component having a reactance component and another resistance, based on a frequency. Accordingly, the enclosure 300 may configure a closed space surrounding the second vibration member 102, and thus, may intactly (or consistently) maintain an impedance component (or an air impedance or an elastic impedance) acting on the second vibration member 102 by air, thereby enhancing a sound characteristic and/or a sound pressure level characteristic of a low-pitched sound band generated based on a vibration of the second vibration member 102 and enhancing the quality of a sound of a high-pitched sound band.

The enclosure 300 according to an embodiment of the present disclosure may include a bottom part 310 and a lateral part 330.

The bottom part 310 may be disposed in parallel with the second vibration member 102. The bottom part 310 may be disposed to face the second surface 102b of the second vibration member 102. The bottom part 310 may be disposed to cover the second surface 102b of the second vibration member 102. The bottom part 310 may be spaced apart from the second surface 102b of the second vibration member 102. For example, the bottom part 310 may be spaced apart from the second surface 102b of the second vibration member 102 with a gap space 300S (or a second space) therebetween. For example, the bottom part 310 may be a plate, a bottom plate, a housing plate, or a housing bottom part, but embodiments of the present disclosure are not limited thereto.

The lateral part 330 may be connected with an edge portion (or a periphery portion) of the bottom part 310. For example, the lateral prat 330 may include a structure which is bent from an edge portion (or a periphery portion) of the bottom part 310. For example, the lateral part 330 may be parallel to a third direction

Z, or may be inclined with respect to the third direction Z. For example, the enclosure 300 may include two or more lateral parts 330. For example, the lateral part 330 may include first to fourth lateral parts. For example, the lateral part 330 may be a lateral surface, a sidewall, a supporting sidewall, a case lateral surface, a case sidewall, a housing lateral surface, or a housing sidewall, but embodiments of the present disclosure are not limited thereto.

The lateral part 330 may be provided as one body with the bottom part 310. For example, the bottom part 310 and the lateral part 330 may be integrated as one body. Therefore, a gap space 300S (or the second space) surrounded by the lateral part 330 may be provided on the bottom part 310. Accordingly, the bottom part 310 and the lateral part 330 may have a box shape where one side (or one portion) is opened.

The lateral part 330 may be connected or coupled to the second surface 102b of the second vibration member 102 by a connection member 420 (or a second connection member). For example, the lateral part 330 may be connected or coupled to an edge portion (or a periphery portion) of the second vibration member 102 by the connection member 420. For example, the lateral part 330 may be connected or coupled to an edge portion (or a periphery portion) of the second surface 102b of the second vibration member 102 by the connection member 420.

According to an embodiment of the present disclosure, the connection member 420 (or the second connection member) may be configured to minimize or prevent the transfer of a vibration of the second vibration member 102 to the enclosure 300. The connection member 420 may include a material characteristic suitable for blocking a vibration. For example, the connection member 420 may include a material having elasticity. For example, the connection member 420 may include a material having elasticity, for vibration absorption (or impact absorption). The connection member 420 according to an embodiment of the present disclosure may include polyurethane or polyolefin, but embodiments of the present disclosure are not limited thereto. For example, the connection member 420 may include one or more of an adhesive, a double-sided tape, a double-sided foam tape, a double-sided foam pad, and a double-sided cushion tape, but embodiments of the present disclosure are not limited thereto.

The apparatus 1 according to an embodiment of the present disclosure may include a first connection member 410 between the first vibration member 101 and the second vibration member 102 and a second connection member 420 between the second vibration member 102 and the enclosure 300. For example, the first connection member 410 may connect or couple an edge portion of the first vibration member 101 with or to an edge portion of the second vibration member 102. For example, the second connection member 420 may connect or couple an edge portion of the second vibration member 102 with or to a lateral portion of the enclosure 300.

The first connection member 410 and the second connection member 420 according to an embodiment of the present disclosure may have the same thickness or different thicknesses. For example, the first connection member 410 may have a thickness which is greater than that of the second connection member 420, so that space 100S between the first vibration member 101 and the second vibration member 102 has the first interval D1. The first connection member 410 may include a base substrate 415, a first adhesive layer 411 disposed at a first surface (or an upper surface) of the base substrate 415, and a second adhesive layer 413 disposed at a second surface (or a lower surface) of the base substrate 415. For example, the base substrate 415, the first adhesive layer 411, and the second adhesive layer 413 of the first connection member 410 may have a thickness same as the first interval D1.

The first connection member 410 and the second connection member 420 according to an embodiment of the present disclosure may at least partially overlap each other. For example, the first connection member 410 and the second connection member 420 may overlap each other with the second vibration member 102 therebetween. The first connection member 410 and the second connection member 420 may have the same width or different widths. For example, the first connection member 410 may have a width which differs from that of the second connection member 420, or the first connection member 410 may have a width which is less than or equal to that of the second connection member 420. For example, the base substrate 415, the first adhesive layer 411, and the second adhesive layer 413 of the first connection member 410 may have a width which differs from that of the second connection member 420, or may have a width which is less than or equal to that of the second connection member 420.

According to an embodiment of the present disclosure, the first connection member 410 and the second connection member 420 may be provided to overlap each other with the second vibration member 102 therebetween. The first connection member 410 and the second connection member 420 may be provided to have the same width. For example, the base substrate 415, the first adhesive layer 411, and the second adhesive layer 413 of the first connection member 410 may be configured to have the same width as that of the second connection member 420.

The first connection member 410 and the second connection member 420 may be provided to overlap a lateral portion 330 of the enclosure 300. For example, the lateral portion 330 of the enclosure 300 may have a first width W1, and the first connection member 410 and the second connection member 420 may have a width corresponding to the first width W1. For example, the base substrate 415, the first adhesive layer 411, and the second adhesive layer 413 of the first connection member 410 may have a width corresponding to the first width W1 of the lateral portion 330.

A first surface (or an upper surface) of the first connection member 410 may be connected with or coupled to the second surface 101b (or the rear surface) of the first vibration member 101, and a second surface (or a lower surface) of the first connection member 410 may be connected with or coupled to the furst surface 102a (or the upper surface) of the second vibration member 102. For example, the first surface of the base substrate 415 of the first connection member 410 may be connected with or coupled to the second surface 101b (or the rear surface) of the first vibration member 101 by the first adhesive layer 411, and the second surface of the base substrate 415 of the first connection member 410 may be connected with or coupled to the first surface 102a (or the upper surface) of the second vibration member 102 by the second adhesive layer 413. For example, the first surface (or the upper surface) of the first connection member 410 may be connected with or coupled to an edge portion of the second surface 101b of the first vibration member 101, and the second surface (or the lower surface) of the first connection member 410 may be connected with or coupled to an edge portion of the first surface 102a of the second vibration member 102. For example, the first surface of the base substrate 415 of the first connection member 410 may be connected with or coupled to an edge portion of the second surface 101b of the first vibration member 101 by the first adhesive layer 411, and the second surface of the base substrate 415 of the first connection member 410 may be connected with or coupled to an edge portion of the first surface 102a of the second vibration member 102 by the second adhesive layer 413. Accordingly, the first vibration member 101 may be connected with (or coupled to) or supported by the second vibration member 102 by the first connection member 410. Also, the first vibration member 101 may be supported by the lateral portion 330 of the enclosure 300 with the second vibration member 102 therebetween.

The second connection member 420 may overlap the first connection member 410 with the second vibration member 102 therebetween. The first surface (or the upper surface) of the second connection member 420 may be connected with or coupled to the second surface 102b (or the rear surface) of the second vibration member 102, and the second surface (or the lower surface) of the second connection member 420 may be connected with or coupled to the enclosure 300. For example, the first surface (or the upper surface) of the second connection member 420 may be connected with or coupled to an edge portion of the second surface 102b of the second vibration member 102, and the second surface (or the lower surface) of the second connection member 420 may be connected with or coupled to the lateral portion 330 of the enclosure 300. Accordingly, the second vibration member 102 may be connected with (or coupled to) or supported by the enclosure 300 by the second connection member 420. Also, the second vibration member 102 may support an edge portion of the first vibration member 101 by the first connection member 410 and may be connected with (or coupled to) or supported by the lateral portion 330 of the enclosure 300 by the second vibration member 102.

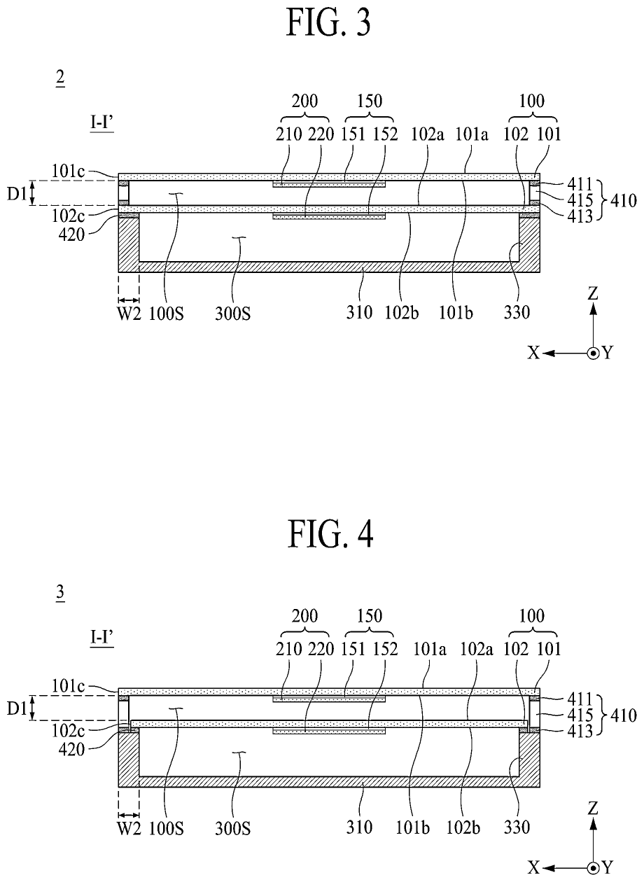

FIGS. 3 to 9 are other cross-sectional views taken along line I-I′ illustrated in FIG. 1 according to another embodiment of the present disclosure. FIGS. 3 to 9 illustrate an embodiment implemented by modifying configurations of a connection member and an enclosure in the apparatus described above with reference to FIGS. 1 and 2. Therefore, in the following description, like elements except a connection member, an enclosure, and relevant elements are referred to by like reference numerals, and repeated descriptions thereof are omitted or will be briefly given.

Referring to FIGS. 1 and 3, an apparatus 2 according to another embodiment of the present disclosure may include an enclosure 300, a first connection member 410, and a second connection member 420.

The enclosure 300 may be disposed or provided at a second surface 102b (or a rear surface) of a second vibration member 102. The enclosure 300 may be configured to support an edge portion of the second surface 102b of the second vibration member 102. The enclosure 300 may be configured to cover the second surface 102b of the second vibration member 102. The enclosure 300 may include a bottom portion 310 and a lateral portion 330.

The first connection member 410 and the second connection member 420 may at least partially overlap each other. For example, the first connection member 410 may overlap at least a portion of the second connection member 420 with the second vibration member 102 therebetween. For example, the first connection member 410 and the second connection member 420 may have different widths. For example, the first connection member 410 may be provided to have a width which is less than that of the second connection member 420. For example, a base substrate 415, a first adhesive layer 411, and a second adhesive layer 413 of the first connection member 410 may be configured to have a width which is less than that of the second connection member 420.

The first connection member 410 and the second connection member 420 may be provided to at least partially overlap the lateral portion 330 of the enclosure 300. For example, at least a portion of the first connection member 410 may overlap the lateral portion 330, and the second connection member 420 may overlap the lateral portion 330. For example, the lateral portion 330 of the enclosure 300 may have a second width W2. For example, the second width W2 may have a width which is relatively greater than the first width W1 illustrated in FIG. 2.

The first connection member 410 may at least partially overlap the lateral portion 330 and may have a width which is less than or equal to the second width W2 of the lateral portion 330. For example, the first connection member 410 may have a width which is less than the second width W2 of the lateral portion 330. For example, the base substrate 415, the first adhesive layer 411, and the second adhesive layer 413 of the first connection member 410 may have a width which is less than the second width W2 of the lateral portion 330. According to an embodiment of the present disclosure, when a width of the first connection member 410 is less than that of the second connection member 420, a width of the second connection member 420 may be equal to the first width W1 of the enclosure 300 illustrated in FIG. 2. For example, the first width W1 of the enclosure 300 may be greater than a width of the first connection member 410.

A first surface (or an upper surface) of the first connection member 410 may be connected with or coupled to a second surface 101b (or a rear surface) of a first vibration member 101, and a second surface (or a lower surface) of the first connection member 410 may be connected with or coupled to a first surface 102a (or an upper surface) of the second vibration member 102. For example, a first surface of a base substrate 415 of the first connection member 410 may be connected with or coupled to the second surface 101b (or the rear surface) of the first vibration member 101 by the first adhesive layer 411, and a second surface of the base substrate 415 of the first connection member 410 may be connected with or coupled to the first surface 102a (or the upper surface) of the second vibration member 102 by the second adhesive layer 413. For example, the first surface (or the upper surface) of the first connection member 410 may be connected with or coupled to an edge portion of the second surface 101b of the first vibration member 101, and the second surface (or the lower surface) of the first connection member 410 may be connected with or coupled to an edge portion of the first surface 102a of the second vibration member 102. For example, the first surface of the base substrate 415 of the first connection member 410 may be connected with or coupled to an edge portion of the second surface 101b of the first vibration member 101 by the first adhesive layer 411, and the second surface of the base substrate 415 of the first connection member 410 may be connected with or coupled to an edge portion of the first surface 102a of the second vibration member 102 by the second adhesive layer 413. Accordingly, the first vibration member 101 may be connected with (or coupled to) or supported by the second vibration member 102 by the first connection member 410. Also, the first vibration member 101 may be supported by an edge portion of the lateral portion 330 of the enclosure 300 with the second vibration member 102 therebetween.

The second connection member 420 may overlap the lateral portion 330 and may have a width which is greater than or equal to that of the first connection member 410 and is less than or equal to the second width W2 of the lateral portion 330. For example, the second connection member 420 may have a width which is greater than a width of the first connection member 410 and corresponds to the second width W2 of the lateral portion 330. The second connection member 420 may overlap the first connection member 410 with the second vibration member 102 therebetween. The second connection member 420 may have a width which is greater than that of the first connection member 410. A first surface (or an upper surface) of the second connection member 420 may be connected with or coupled to a second surface 102b (or a rear surface) of the second vibration member 102, and a second surface (or a lower surface) of the second connection member 420 may be connected with or coupled to the enclosure 300. For example, the first surface (or the upper surface) of the second connection member 420 may be connected with or coupled to the second surface 102b of the second vibration member 102, and the second surface (or the lower surface) of the second connection member 420 may be connected with or coupled to the lateral portion 330 of the enclosure 300. Therefore, the second vibration member 102 may be connected with (or coupled to) or supported by the enclosure 300 by the second connection member 420. Also, the second vibration member 102 may support an edge portion of the first vibration member 101 by the first connection member 410 and may be connected with (or coupled to) or supported by the lateral portion 330 of the enclosure 300 by the second connection member 420.

The apparatus 2 according to another embodiment of the present disclosure may differently adjust (or set) a size (or an area) of an overlap region between the first vibration member 101 and the first connection member 410 and a size (or an area) of an overlap region between the second vibration member 102 and the second connection member 420, and thus, may adjust a resonance frequency of each of the first vibration member 101 and the second vibration member 102. Accordingly, offset interference between a vibration of the first vibration member 101 and a vibration of the second vibration member 102 may be minimized or prevented, and thus, a dip phenomenon where a sound pressure level in a specific frequency occurring in a low-pitched sound band is reduced may be reduced, and the flatness of a sound characteristic in the low-pitched sound band may be improved.

Referring to FIGS. 1 and 4, an apparatus 3 according to another embodiment of the present disclosure may further include an enclosure 300, a first connection member 410, and a second connection member 420.

The enclosure 300 may be disposed or provided at a second surface 102b of a second vibration member 102. The enclosure 300 may be configured to support an edge portion of a second surface 101b of a first vibration member 101 and may be configured to support an edge portion of the second surface 102b of the second vibration member 102. The enclosure 300 may be configured to cover the second surface 102b of the second vibration member 102. The enclosure 300 may include a bottom portion 310 and a lateral portion 330. The lateral portion 330 of the enclosure 300 may have a second width W2. For example, the second width W2 may have a width which is relatively greater than the first width W1 illustrated in FIG. 2.

The first connection member 410 may not overlap the second vibration member 102. The first connection member 410 may not overlap the second connection member 420. For example, a base substrate 415, a first adhesive layer 411, and a second adhesive layer 413 of the first connection member 410 may not overlap the second connection member 420. For example, the first connection member 410 and the second connection member 420 may have the same width or different widths. For example, the first connection member 410 may be provided to have the same width as that of the second connection member 420. For example, the base substrate 415, the first adhesive layer 411, and the second adhesive layer 413 of the first connection member 410 may be configured to have the same width as that of the second connection member 420.

The first connection member 410 and the second connection member 420 may at least partially overlap the lateral portion 330 of the enclosure 300. For example, the first connection member 410 and the second connection member 420 may respectively overlap different portions of the lateral portion 330.

The first connection member 410 may be disposed or coupled between an edge portion of the first vibration member 101 and an outer edge portion of the enclosure 300 to surround the second connection member 420. A first surface (or an upper surface) of the first connection member 410 may be connected with or coupled to a second surface 101b (or a rear surface) of the first vibration member 101, and a second surface (or a lower surface) of the first connection member 410 may be connected with or coupled to an outer edge portion of the lateral portion 330 of the enclosure 300. For example, a first surface of a base substrate 415 of the first connection member 410 may be connected with or coupled to the second surface 101b (or the rear surface) of the first vibration member 101 by the first adhesive layer 411, and a second surface of the base substrate 415 of the first connection member 410 may be connected with or coupled to the outer edge portion of the lateral portion 330 of the enclosure 300 by the second adhesive layer 413. For example, the first surface (or the upper surface) of the first connection member 410 may be connected with or coupled to an edge portion of the second surface 101b of the first vibration member 101, and the second surface (or the lower surface) of the first connection member 410 may be connected with or coupled to the outer edge portion of the lateral portion 330 of the enclosure 300 to surround the second vibration member 102 and the second connection member 420. For example, the first surface of the base substrate 415 of the first connection member 410 may be connected with or coupled to an edge portion of the second surface 101b of the first vibration member 101 by the first adhesive layer 411, and the second surface of the base substrate 415 of the first connection member 410 may be connected with or coupled to the outer edge portion of the lateral portion 330 of the enclosure 300 to surround the second vibration member 102 and the second connection member 420 by the second adhesive layer 413. Accordingly, the first vibration member 101 may be connected with (or coupled to) or supported by the outer edge portion of the lateral portion 330 of the enclosure 300 by the first connection member 410.

The second connection member 420 may be surrounded by the first connection member 410. For example, the second connection member 420 may be disposed or coupled between an edge portion of the second vibration member 102 and an inner edge portion of the enclosure 300. For example, the second vibration member 102 may have a size which is less than that of the first vibration member 101. The first surface (or the upper surface) of the second connection member 420 may be connected with or coupled to the second surface 102b (or the rear surface) of the second vibration member 102, and the second surface (or the lower surface) of the second connection member 420 may be connected with or coupled to the inner edge portion of the enclosure 300. For example, the first surface (or the upper surface) of the second connection member 420 may be connected with or coupled to an edge portion of the second surface 102b (or the rear surface) of the second vibration member 102, and the second surface (or the lower surface) of the second connection member 420 may be connected with or coupled to the inner edge portion of the enclosure 300. Accordingly, the second vibration member 102 may be surrounded by the first connection member 410 and may be connected with (or coupled to) or supported by an inner edge portion of the lateral portion 330 of the enclosure 300 by the second connection member 420.

In the apparatus 3 according to another embodiment of the present disclosure, a size of the first vibration member 101 and a size of the second vibration member 102 may be differently set, and thus, a resonance frequency of each of the first vibration member 101 and the second vibration member 102 may be adjusted. Accordingly, offset interference between a vibration of the first vibration member 101 and a vibration of the second vibration member 102 may be minimized or prevented, and thus, a dip phenomenon where a sound pressure level in a specific frequency occurring in a low-pitched sound band is reduced may be reduced, and the flatness of a sound characteristic in the low-pitched sound band may be improved.

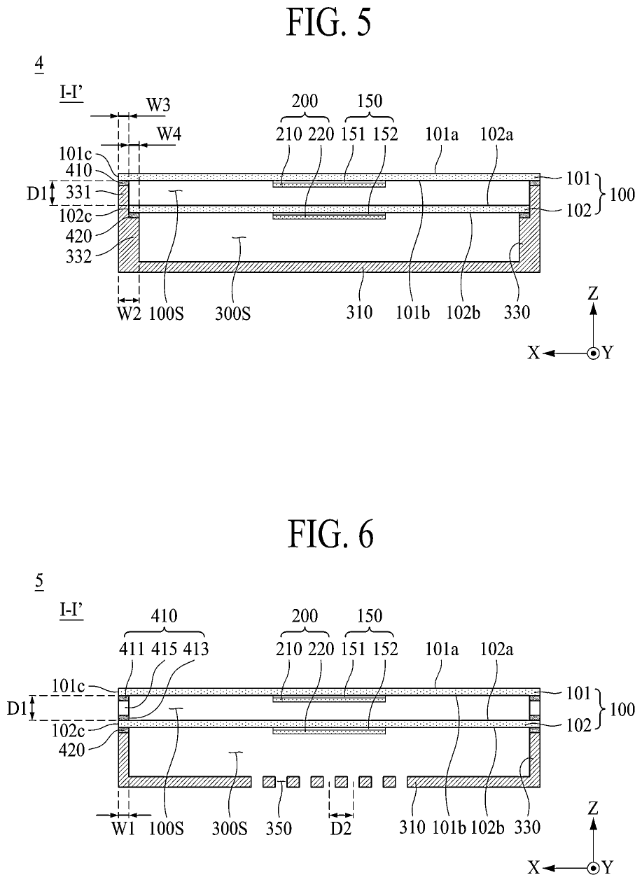

Referring to FIGS. 1 and 5, an apparatus 4 according to another embodiment of the present disclosure may further include an enclosure 300, a first connection member 410, and a second connection member 420.

The enclosure 300 may be disposed or provided at a second surface 102b (or a rear surface) of a second vibration member 102. The enclosure 300 may be provided to support an edge portion of a second surface 101b of a first vibration member 101 and may be provided to support an edge portion of a second surface 102b of a second vibration member 102. The enclosure 300 may be configured to cover the second surface 102b of the second vibration member 102. The enclosure 300 may include a bottom portion 310 and a lateral portion 330. The lateral portion 330 of the enclosure 300 may include a first lateral portion 331 and a second lateral portion 332. The second lateral portion 332 may be disposed at the inner side of the first lateral portion 331. A total width of the lateral portion 330 of the enclosure 300 may have a second width W2. The first lateral portion 331 may have a third width W3, and the second lateral portion 332 may have a fourth width W4. For example, the third width W3 and the fourth width W4 may be less than the second width W2 and may each be equal to or different from each other.

The first lateral portion 331 of the enclosure 300 may protrude more upward than the second lateral portion 332 in a third direction Z. For example, the first lateral portion 331 may be configured to surround the second lateral portion 332 at an outer portion of the second lateral portion 332. The second lateral portion 332 of the enclosure 300 may be inward from the first lateral portion 331 and may be provided to be surrounded by the first lateral portion 331. For example, the first lateral portion 331 may be provided to have a height or a thickness corresponding to a first interval D1, so that a space 100S between the first vibration member 101 and the second vibration member 102 has the first interval D1. For example, the space 100S between the first vibration member 101 and the second vibration member 102 may be provided by the first vibration member 101, the second vibration member 102, the first lateral portion 331, and the first connection member 410. Also, a space 300S between the second vibration member 102 and the enclosure 300 may be provided by the second vibration member 102, the second lateral portion 332, and the second connection member 420.

The first connection member 410 may be configured to overlap the first lateral portion 331 of the enclosure 300, and the second connection member 420 may be configured to overlap the second lateral portion 332 of the enclosure 300. The first connection member 410 and the second connection member 420 may have the same width or different widths. For example, the first connection member 410 may be configured to have the same width as that of the second connection member 420. The first connection member 410 and the second connection member 420 may have the same thickness or different thicknesses. For example, the first connection member 410 may be configured to have the same thickness as that of the second connection member 420. Also, the first connection member 410 and the second connection member 420 may include the same material or different materials. For example, the first connection member 410 may include the same material as that of the second connection member 420.

The first connection member 410 may be disposed or coupled between an edge portion of the first vibration member 101 and the first lateral portion 331 of the enclosure 300. A first surface (or an upper surface) of the first connection member 410 may be connected with or coupled to a second surface 101b (or a rear surface) of the first vibration member 101, and a second surface (or a lower surface) of the first connection member 410 may be connected with or coupled to the first lateral portion 331 of the enclosure 300. For example, the first surface (or the upper surface) of the first connection member 410 may be connected with or coupled to an edge portion of the second surface 101b of the first vibration member 101, and the second surface (or the lower surface) of the first connection member 410 may be connected with or coupled to the first lateral portion 331 of the enclosure 300 which is provided to surround the second vibration member 102 and the second connection member 420. Accordingly, the first vibration member 101 may be connected with (or coupled to) or supported by the first lateral portion 331 of the enclosure 300 by the first connection member 410.

The second connection member 420 may be surrounded by the first lateral portion 331 of the enclosure 300 and may be disposed or coupled between an edge portion of the second vibration member 102 and the second lateral portion 332 of the enclosure 300. For example, the second vibration member 102 may have a size which is less than that of the first vibration member 101. A first surface (or an upper surface) of the second connection member 420 may be connected with or coupled to a second surface 102b (or a rear surface) of the second vibration member 102, and a second surface (or a lower surface) of the second connection member 420 may be connected with or coupled to the second lateral portion 332 of the enclosure 300. For example, the first surface (or the upper surface) of the second connection member 420 may be connected with or coupled to an edge portion of the second surface 102b of the second vibration member 102, and the second surface (or the lower surface) of the second connection member 420 may be connected with or coupled to the second lateral portion 332 which is configured to be surrounded by the first lateral portion 331 of the enclosure 300. Accordingly, the second vibration member 102 may be surrounded by the first lateral portion 331 and may be connected with (or coupled to) or supported by the second lateral portion 332 of the enclosure 300 by the second connection member 420.

The apparatus 4 according to another embodiment of the present disclosure may have substantially the same effect as that of the apparatus 3 described above with reference to FIG. 4. In the apparatus 4 according to another embodiment of the present disclosure, the enclosure 300 may provide the space 100S between the first vibration member 101 and the second vibration member 102 and may be connected with (or coupled to) and supported by the first vibration member 101 and the second vibration member 102, and thus, an interval D1 between the first vibration member 101 and the second vibration member 102 may be maintained to be more constant and the apparatus 4 may be stable in structure.

Referring to FIGS. 1 and 6, in an apparatus 5 according to another embodiment of the present disclosure, an enclosure 300 may further include at least one hole 350, compared to the apparatus 1 described above with reference to FIGS. 1 and 2.

The at least one hole 350 may be configured to decrease an air pressure of a space 300S (or a second space) of the enclosure 300 or a space 300S provided between a second vibration member 102 and the enclosure 300. The at least one hole 350 may connect the space 300S provided between the second vibration member 102 and the enclosure 300 with the outside. For example, the at least one hole 350 may be provided to have an interval D2. For example, the interval D2 may be set to be constant, or may be differently set. The at least one hole 350 may be formed based on a size of a vibration apparatus 200. For example, the at least one hole 350 may be formed based on a size of a second vibration generating apparatus 220 disposed on the second vibration member 102. The at least one hole 350 may overlap the vibration apparatus 200. For example, at least a portion of the at least one hole 350 may overlap the second vibration generating apparatus 220 disposed in the second vibration member 102. The at least one hole 350 may be less in size than the vibration apparatus 200. For example, the at least one hole 350 may be less in size than the second vibration generating apparatus 220 disposed on the second vibration member 102.

In the enclosure 300, the at least one hole 350 may be differently disposed toward a region where the second vibration generating apparatus 220 is not disposed, instead of a region where the second vibration generating apparatus 220 is disposed. For example, the at least one hole 350 of the enclosure 300 may be disposed to be different toward an edge of the second vibration generating apparatus 210 from a center of the second vibration generating apparatus 220. The at least one hole 350 may be disposed to have the same interval D2, but embodiments of the present disclosure are not limited thereto. For example, the at least one hole 350 may be formed to have different intervals toward the edge of the second vibration generating apparatus 220 from the center of the second vibration generating apparatus 220. For example, the at least one hole 350 may be formed to have a narrower interval or a wider interval toward the edge of the second vibration generating apparatus 220 from the center of the second vibration generating apparatus 220. For example, the at least one hole 350 may be a groove, a hole or a slit, but embodiments of the present disclosure are not limited thereto.

According to an embodiment of the present disclosure, the at least one hole 350 of the enclosure 300 may extend a band of a low-pitched sound band by decreasing an air pressure of the space 300S (or a second space or a gap space), and thus, may improve a sound characteristic of the low-pitched sound band. For example, as a pressure (or an air pressure) of the space 300S is reduced by the at least one hole 350, the amount of displacement (or a bending force) of the second vibration generating apparatus 220 disposed between the second vibration member 102 and the enclosure 300 may increase, and thus, a band of the low-pitched sound band may extend and a sound characteristic and/or a sound pressure level characteristic of the low-pitched sound band may be enhanced. When the at least one hole 350 is not disposed in the enclosure 300, an air pressure of the space 300S may increase due to a sound or a sound wave generated by a vibration of the second vibration generating apparatus 220, causing a reduction in sound characteristic of the low-pitched sound band.

The apparatus 5 according to another embodiment of the present disclosure may have substantially the same effect as that of the apparatus 1 described above with reference to FIG. 2. In the apparatus 5 according to another embodiment of the present disclosure, because the at least one hole 350 is provided in the enclosure 300, even when a sound wave or a sound is generated by a vibration of the second vibration generating apparatus 220, air may be discharged through the at least one hole 350, and thus, an air pressure of the space 300S may be lowered. Accordingly, a band of the low-pitched sound band may extend, and thus, a sound characteristic of the low-pitched sound band may be improved.

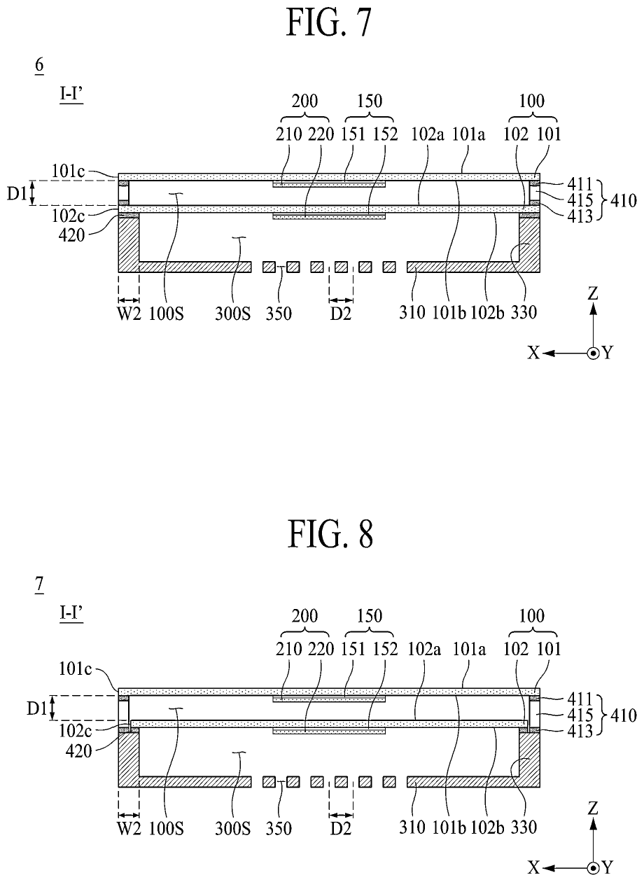

Referring to FIGS. 1 and 7, in an apparatus 6 according to another embodiment of the present disclosure, an enclosure 300 may further include at least one hole 350, compared to the apparatus 2 described above with reference to FIGS. 1 and 3.

A first connection member 410 and a second connection member 420 of the apparatus 6 according to another embodiment of the present disclosure may be configured to at least partially overlap a lateral portion 330 of the enclosure 300. For example, the first connection member 410 may be configured to at least partially overlap the lateral portion 330, and the second connection member 420 may be configured to overlap the lateral portion 330. For example, the lateral portion 330 of the enclosure 300 may have a second width W2. For example, the second width W2 may have a width which is relatively greater than the first width W1 illustrated in FIG. 2.

The first connection member 410 may at least partially overlap the lateral portion 330 and may have a width which is less than or equal to the second width W2 of the lateral portion 330. For example, the first connection member 410 may have a width which is less than the second width W2 of the lateral portion 330. For example, a base substrate 415, a first adhesive layer 411, and a second adhesive layer 413 of the first connection member 410 may have a width which is less than the second width W2 of the lateral portion 330.

The second connection member 420 may overlap the lateral portion 330 and may have a width which is greater than or equal to a width of the first connection member 410 and is less than or equal to the second width W2 of the lateral portion 330. For example, the second connection member 420 may have a width which is greater than a width of the first connection member 410 and corresponds to the second width W2 of the lateral portion 330.

The enclosure 300 of the apparatus 6 according to another embodiment of the present disclosure may further include the at least one hole 350. For example, the at least one hole 350 may be configured for decreasing an air pressure of a space 300S (or a second space) of the enclosure 300 or a space 300S provided between the second vibration member 102 and the enclosure 300.

The apparatus 6 according to another embodiment of the present disclosure may have substantially the same effect as that of the apparatus 2 described above with reference to FIG. 3. In the apparatus 6 according to another embodiment of the present disclosure, because the at least one hole 350 is provided in the enclosure 300, even when a sound wave or a sound is generated by a vibration of the second vibration generating apparatus 220, air may be discharged through the at least one hole 350, and thus, an air pressure of the space 300S may be lowered. Accordingly, a band of the low-pitched sound band may extend, and thus, a sound characteristic of the low-pitched sound band may be improved.

Referring to FIGS. 1 and 8, in an apparatus 7 according to another embodiment of the present disclosure, an enclosure 300 may further include at least one hole 350, compared to the apparatus 3 described above with reference to FIGS. 1 and 4.

The enclosure 300 of the apparatus 7 according to another embodiment of the present disclosure may be configured to support an edge portion of a second surface 101b of a first vibration member 101 and may be configured to support an edge portion of a second surface 102b of a second vibration member 102. A first connection member 410 may not overlap the second vibration member 102. The first connection member 410 may not overlap the second connection member 420. For example, a base substrate 415, a first adhesive layer 411, and a second adhesive layer 413 of the first connection member 410 may not overlap the second connection member 420. Each of the first connection member 410 and the second connection member 420 may be configured to at least partially overlap a lateral portion 330 of the enclosure 300. For example, the first connection member 410 and the second connection member 420 may be configured to respectively overlap different portions of the lateral portion 330.

The first connection member 410 may be disposed or coupled between an edge portion of the first vibration member 101 and an outer edge portion of the enclosure 300 to surround the second connection member 420.

The second connection member 420 may be surrounded by the first connection member 420 and may be disposed or coupled between an edge portion of the second vibration member 102 and an inner edge portion of the enclosure 300.

The enclosure 300 of the apparatus 7 according to another embodiment of the present disclosure may further include the at least one hole 350. For example, the at least one hole 350 may be configured for decreasing an air pressure of a space 300S (or a second space) of the enclosure 300 or a space 300S provided between the second vibration member 102 and the enclosure 300.

The apparatus 7 according to another embodiment of the present disclosure may have substantially the same effect as that of the apparatus 3 described above with reference to FIG. 4. In the apparatus 7 according to another embodiment of the present disclosure, because the at least one hole 350 is provided in the enclosure 300, even when a sound wave or a sound is generated by a vibration of the second vibration generating apparatus 220, air may be discharged through the at least one hole 350, and thus, an air pressure of the space 300S may be lowered. Accordingly, a band of the low-pitched sound band may extend, and thus, a sound characteristic of the low-pitched sound band may be improved.

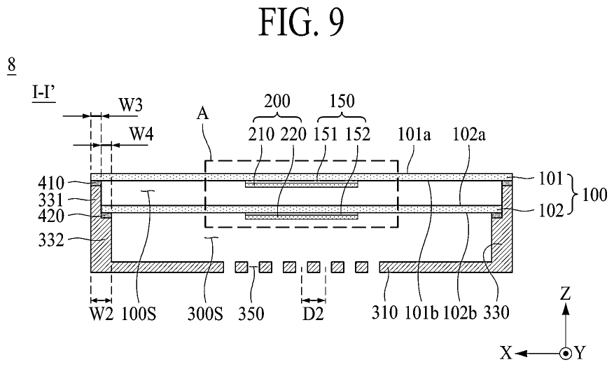

Referring to FIGS. 1 and 9, in an apparatus 8 according to another embodiment of the present disclosure, an enclosure 300 may further include at least one hole 350, compared to the apparatus 4 described above with reference to FIGS. 1 and 5.

The enclosure 300 of the apparatus 8 according to another embodiment of the present disclosure may be configured to support an edge portion of a second surface 101b of a first vibration member 101 and may be configured to support an edge portion of a second surface 102b of a second vibration member 102. A lateral portion 330 of the enclosure 300 may include a first lateral portion 331 and a second lateral portion 332. A total width of the lateral portion 330 of the enclosure 300 may have a second width W2. The first lateral portion 331 may have a third width W3, and the second lateral portion 332 may have a fourth width W4. For example, the third width W3 and the fourth width W4 may each be less than the second width W2 and may be equal to or different from each other.

A space 100S between the first vibration member 101 and the second vibration member 102 may be provided by the first vibration member 101, the second vibration member 102, the first lateral portion 331, and the first connection member 410. Also, a space 300S between the second vibration member 102 and the enclosure 300 may be provided by the second vibration member 102, the second lateral portion 332, and the second connection member 420.

The first connection member 410 may be configured to overlap the first lateral portion 331 of the enclosure 300, and the second connection member 420 may be configured to overlap the second lateral portion 332 of the enclosure 300.

The first connection member 410 may be disposed or coupled between an edge portion of the first vibration member 101 and the first lateral portion 331 of the enclosure 300.

The second connection member 420 may be surrounded by the first lateral portion 331 of the enclosure 300. For example, the second connection member 420 may be disposed or coupled between an edge portion of the second vibration member 102 and the second lateral portion 332 of the enclosure 300.

According to an embodiment of the present disclosure, the first vibration member 101 may be a display panel, and the second vibration member 102 may include a metal material or a plastic material. For example, the second vibration member 102 may include one or more materials of stainless steel, Al, an Al alloy, Mg, a Mg alloy, a Mg—Li alloy, and a plastic material, but embodiments of the present disclosure are not limited thereto. When the first vibration member 101 is the display panel, a cover glass may be further disposed on the first vibration member.

According to another embodiment of the present disclosure, the first vibration member 101 may be a vehicular interior material, and the second vibration member 102 may include a metal material or a plastic material. For example, the second vibration member 102 may include one or more materials of stainless steel, Al, an Al alloy, Mg, a Mg alloy, a Mg—Li alloy, and a plastic material, but embodiments of the present disclosure are not limited thereto.

The enclosure 300 of the apparatus 8 according to another embodiment of the present disclosure may further include the at least one hole 350. For example, the at least one hole 350 may be configured for decreasing an air pressure of a space 300S (or a second space) of the enclosure 300 or a space 300S provided between the second vibration member 102 and the enclosure 300.

The apparatus 8 according to another embodiment of the present disclosure may have substantially the same effect as that of the apparatus 4 described above with reference to FIG. 5. In the apparatus 8 according to another embodiment of the present disclosure, because the at least one hole 350 is provided in the enclosure 300, even when a sound wave or a sound is generated by a vibration of the second vibration generating apparatus 220, air may be discharged through the at least one hole 350, and thus, an air pressure of the space 300S may be lowered. Accordingly, a band of the low-pitched sound band may extend, and thus, a sound characteristic of the low-pitched sound band may be improved.

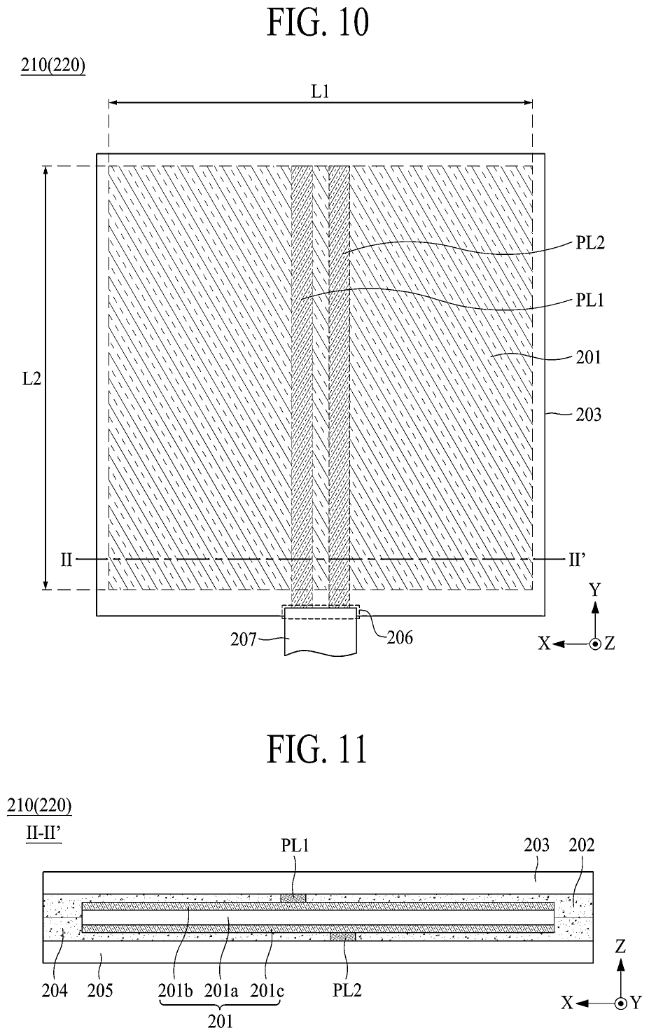

FIG. 10 illustrates a vibration generating apparatus according to an embodiment of the present disclosure. FIG. 11 is a cross-sectional view taken along line II-II′ illustrated in FIG. 10 according to an embodiment of the present disclosure. FIGS. 10 and 11 illustrate a first vibration generating apparatus or a second vibration generating apparatus of a vibration apparatus according to an embodiment of the present disclosure.

Referring to FIGS. 10 and 11, a vibration generating apparatus 210 and 220 (or a first vibration generating apparatus 210 or a second vibration generating apparatus 220) according to an embodiment of the present disclosure may be a vibration structure, a vibrator, a vibration generator, a flexible vibration apparatus, a flexible vibration structure, a flexible vibrator, a flexible vibration generating device, a flexible vibration generator, a flexible sounder, a flexible sound device, a flexible sound generating device, a flexible sound generator, a flexible actuator, a flexible speaker, a flexible piezoelectric speaker, a film actuator, a film type piezoelectric composite actuator, a film speaker, a film type piezoelectric speaker, or a film type piezoelectric composite speaker, but embodiments of the present disclosure are not limited thereto.

The vibration generating apparatus 210 and 220 (or a first vibration generating apparatus 210 or a second vibration generating apparatus 220) according to an embodiment of the present disclosure may include at least one vibration part 201. For example, the at least one vibration part 201 may be a piezoelectric vibration part or a piezoelectric-type vibration part.

The at least one vibration part 201 according to an embodiment of the present disclosure may include a tetragonal shape which has a first length L1 parallel to a first direction X and a second length L2 parallel to a second direction Y. For example, the at least one vibration part 201 may include a square shape where the first length L1 is equal to the second length L2, or may include a rectangular shape where one of the first length L1 and the second length L2 is relatively long, but embodiments of the present disclosure are not limited thereto.

The vibration part 201 according to another embodiment of the present disclosure may include a vibration layer 201a, a first electrode layer 201b, and a second electrode layer 201c.

The vibration layer 201a may include a piezoelectric material or an electroactive material having a piezoelectric effect. For example, the piezoelectric material may have a characteristic where pressure or twisting is applied to a crystalline structure by an external force, a potential difference occurs due to dielectric polarization (or poling) caused by a relative position change of a positive (+) ion and a negative (−) ion, and a vibration is generated by an electric field based on a voltage applied thereto. The vibration layer 201a may be referred to as the terms such as a piezoelectric layer, a piezoelectric material layer, an electroactive layer, a vibration portion, a piezoelectric material portion, an electroactive portion, a piezoelectric structure, a piezoelectric composite layer, a piezoelectric composite, a piezoelectric ceramic composite or the like, but embodiments of the present disclosure are not limited thereto. The vibration layer 201a may include a transparent conductive material, a semitransparent conductive material, or an opaque conductive material and the vibration layer 201a may be transparent, semitransparent, or opaque.

The vibration layer 201a may include an inorganic material portion. The inorganic material portion may include a piezoelectric material, a composite piezoelectric material, or an electroactive material, which has a piezoelectric effect

The vibration layer 201a according to an embodiment of the present disclosure may include a ceramic-based material for generating a relatively strong vibration, or may include a piezoelectric ceramic having a perovskite-based crystalline structure. The perovskite crystalline structure may have a piezoelectric effect and/or an inverse piezoelectric effect, and may be a plate-shaped structure having orientation. The perovskite crystalline structure may be represented by a chemical formula “ABO₃”. In the chemical formula, “A” may include a divalent metal element, and “B” may include a tetravalent metal element. For example, in the chemical formula “ABO₃”, “A” and “B” may be cations, and “O” may be anions. For example, the chemical formula “ABO₃” may include one or more of lead titanate (PbTiO₃), lead zirconate (PbZrO₃), lead zirconate titanate(PbZrTiO₃), barium titanate (BaTiO₃), and strontium titanate (SrTiO₃), but embodiments of the present disclosure are not limited thereto.

The piezoelectric ceramic may include single crystalline ceramic having a single crystalline structure, or may include polycrystalline ceramic or a ceramic material having a polycrystalline structure. A piezoelectric material of the single crystalline ceramic may include α-AlPO₄, α-SiO₂, LiNbO₃, Tb₂(MoO₄)₃, Li₂B₄O₇, or ZnO, but embodiments of the present disclosure are not limited thereto. The piezoelectric material of the polycrystalline ceramic may include a lead zirconate titanate (PZT)-based material including lead (Pb), zirconium (Zr), and titanium (Ti) or may include a lead zirconate nickel niobate (PZNN)-based material including lead (Pb), zirconium (Zr), nickel (Ni), and niobium (Nb), but embodiments of the present disclosure are not limited thereto.

For another example, the vibration layer 201a may include one or more of CaTiO₃, BaTiO₃, and SrTiO₃ without Pb, but embodiments of the present disclosure are not limited thereto.

The first electrode layer 201b may be disposed on a first surface (or an upper surface) of the vibration layer 201a. For example, the first electrode layer 201b may have a single electrode (or one electrode) shape disposed at the whole first surface of the vibration layer 201a. For example, the first electrode layer 201b may have substantially the same shape as that of the vibration layer 201a, but embodiments of the present disclosure are not limited thereto.

The first electrode layer 201b according to an embodiment of the present disclosure may include a transparent conductive material, a semitransparent conductive material, or an opaque conductive material. For example, the transparent conductive material or the semitransparent conductive material of the first electrode layer 201b may include indium tin oxide (ITO) or indium zinc oxide (IZO), but embodiments of the present disclosure are not limited thereto. The opaque conductive material of the first electrode layer 201b may include gold (Au), silver (Ag), platinum (Pt), palladium (Pd), molybdenum (Mo), magnesium (Mg), carbon, or glass frit-including Ag, or may include an alloy thereof, but embodiments of the present disclosure are not limited thereto. For example, the first electrode layer 201b may include Ag having low resistivity, so as to enhance an electrical characteristic and/or a vibration characteristic of the vibration layer 201a. For example, the carbon may be carbon material including carbon black, ketjen black, carbon nano tube, or graphite, but embodiments of the present disclosure are not limited thereto.

The second electrode layer 201c may be disposed on a second surface (or a rear surface), which is different from (or opposite to) the first surface, of the vibration layer 201a. For example, the second electrode layer 201c may have a single electrode (or one electrode) shape disposed at the entire second surface of the vibration layer 201a. For example, the second electrode layer 201c may have substantially the same shape as that of the vibration layer 201a, but embodiments of the present disclosure are not limited thereto. The second electrode layer 201c according to an embodiment of the present disclosure may include a transparent conductive material, a semitransparent conductive material, or an opaque conductive material. For example, the second electrode layer 201c may include the same material as that of the first electrode layer 201b, but embodiments of the present disclosure are not limited thereto. As another example of the present disclosure, the second electrode layer 201c may include a material different from that of the first electrode layer 201b.

The vibration layer 201a may be polarized (or poling) by a certain voltage applied to a first electrode layer 201b and a second electrode layer 201c in a certain temperature atmosphere or a temperature atmosphere which is changed from a high temperature to a room temperature, but embodiments of the present disclosure are not limited thereto. For example, the vibration layer 201a may alternately repeat contraction and/or expansion according to an inverse piezoelectric effect based on a vibration driving signal (or a voice signal) applied from the outside to the first electrode layer 201b and the second electrode layer 201c. For example, the vibration layer 201a may vibrate based on a vertical-direction vibration and a lateral-direction vibration by the first electrode layer 201b and the second electrode layer 201c. A displacement (or a vibration or driving) of a vibration member (or a vibration plate or a vibration object) may increase based on the contraction and/or expansion of the vibration layer 201a in a horizontal direction, and thus, a vibration characteristic of a vibration apparatus may be more enhanced.

The vibration generating apparatus 210 and 220 (or a first vibration generating apparatus 210 or a second vibration generating apparatus 220) according to an embodiment of the present disclosure may further include a first cover member 203 and a second cover member 205.

The first cover member 203 may be disposed on a first surface of the vibration generating apparatus 210 and 220. For example, the first cover member 203 may be configured to cover the first electrode layer 201b. Accordingly, the first cover member 203 may protect the first electrode layer 201b.

The second cover member 205 may be disposed on a second surface of the vibration generating apparatus 210 and 220. For example, the second cover member 205 may be configured to cover the second electrode layer 201c. Accordingly, the second cover member 205 may protect the second electrode layer 201c.

Each of the first cover member 203 and the second cover member 205 according to an embodiment of the present disclosure may include one or more materials of plastic, fiber, and wood, but embodiments of the present disclosure are not limited thereto. For example, the first cover member 203 and the second cover member 205 may include the same material or different materials. For example, the first cover member 203 and the second cover member 205 may be a polyimide film or a polyethylene terephthalate film, but embodiments of the present disclosure are not limited thereto.

The first cover member 203 according to an embodiment of the present disclosure may be connected or coupled to the first electrode layer 201b by a first adhesive layer 202. For example, the first cover member 203 may be connected or coupled to the first electrode layer 201b through a film laminating process using the first adhesive layer 202.

The second cover member 205 according to an embodiment of the present disclosure may be connected or coupled to the second electrode layer 201c by a second adhesive layer 204. For example, the second cover member 205 may be connected or coupled to the second electrode layer 201c through a film laminating process by the first adhesive layer 204.

The first adhesive layer 202 may be disposed between the first electrode layer 201b and the first cover member 203. The second adhesive layer 204 may be disposed between the second electrode layer 201c and the second cover member 205. For example, the first adhesive layer 202 and the second adhesive layer 204 may be provided between the first cover member 203 and the second cover member 205 to fully surround the vibration layer 201a, the first electrode layer 201b, and the second electrode layer 201c. For example, the vibration layer 201a, the first electrode layer 201b, and the second electrode layer 201c may be buried or embedded between the first adhesive layer 202 and the second adhesive layer 204.

Each of the first adhesive layer 202 and the second adhesive layer 204 according to an embodiment of the present disclosure may include an electrical insulation material which has adhesive properties and is capable of compression and/or decompression. For example, each of the first adhesive layer 202 and the second adhesive layer 204 may include epoxy resin, acrylic resin, silicone resin, and/or urethane resin, but embodiments of the present disclosure are not limited thereto.

Any one of the first cover member 203 and the second cover member 205 may be attached or coupled (or connected) to the vibration member (or a vibration plate or a vibration object) via an adhesive member.

According to one embodiment of the present disclosure, any one of the first cover member 203 and the second cover member 205 may be attached to or coupled to (or connected to) the vibration member (or the vibration plate or the vibration object) via an adhesive member. For example, any one of the first cover member 203 and the second cover member 205 may be attached to or coupled to (or connected to) the vibration member 100 via an adhesive member 150 as described with reference to FIGS. 1 and 2.

The vibration generating apparatus 210 and 220 (or a first vibration generating apparatus 210 or a second vibration generating apparatus 220) according to one embodiment of the present disclosure may further include a first power supply line PL1, a second power supply line PL2, and a pad part 206.

The first power supply line PL1 may be disposed on the first cover member 203. For example, the first power supply line PL1 may be disposed between the first electrode layer 201b and the first cover member 203, and may be electrically connected to the first electrode layer 201b. The first power supply line PL1 may be elongated along the first direction X or the second direction Y, and may be electrically connected to a central portion of the first electrode layer 201b. In one embodiment, the first power supply line PL1 may be electrically connected to the first electrode layer 201b via an anisotropic conductive film. In another embodiment of the present disclosure, the first power supply line PL1 may be electrically connected to the first electrode layer 201b through a conductive material (or particles) in a first adhesive layer 202.

The second power supply line PL2 may be disposed on the second cover member 205. For example, the second power supply line PL2 may be disposed between the second electrode layer 201c and the second cover member 205, and may be electrically connected to the second electrode layer 201c. The second power supply line PL2 may be elongated along the first direction X or the second direction Y, and may be electrically connected to a central portion of the second electrode layer 201c. In one embodiment, the second power supply line PL2 may be electrically connected to the second electrode layer 201c via an anisotropic conductive film. In another embodiment, the second power supply line PL2 may be electrically connected to the second electrode layer 201c through a conductive material (or particles) in a second adhesive layer 204.

According to an embodiment of the present disclosure, a first power supply line PL1 and a second power supply line PL2 may be disposed not to overlap each other. When the first power supply line PL1 is disposed not to overlap the second power supply line PL2, a problem of a short circuit defect between the first power supply line PL1 and the second power supply line PL2 may be solved.

The pad part 206 may be electrically connected to the first power supply line PL1 and the second power supply line PL2. For example, the pad part 206 may be provided at one edge portion (or one periphery portion) of one of the first cover member 203 and the second cover member 205 so as to be electrically connected to one side (or one end or one portion) of each of the first power supply line PL1 and the second power supply line PL2.

The pad part 206 according to an embodiment of the present disclosure may include a first pad electrode which is electrically connected to one end of the first power supply line PL1 and a second pad electrode which is electrically connected to one end of the second power supply line PL2.

The first pad electrode may be disposed at one edge portion (or one periphery portion) of one of the first cover member 203 and the second cover member 205 and may be connected to one end (or one portion) of the first power supply line PL1. For example, the first pad electrode may pass through one of the first cover member 203 and the second cover member 205 and may be electrically connected to one end (or one portion) of the first power supply line PL1.

The second pad electrode may be disposed in parallel with the first pad electrode and may be connected to one end (or one portion) of the second power supply line PL2. For example, the second pad electrode may pass through one of the first cover member 203 and the second cover member 205 and may be electrically connected to one end (or one portion) of the second power supply line PL2.

According to an embodiment of the present disclosure, each of the first power supply line PL1, the second power supply line PL2, and the pad part 206 may be configured to be transparent, semitransparent, or opaque.

A pad part 206 according to an embodiment of the present disclosure may be electrically connected with a signal cable 207.

The signal cable 207 may be electrically connected with the pad part 206 disposed in the vibration generating apparatus 210 and 220 and may transfer a vibration driving signal (or a sound signal or a voice signal), supplied from a sound processing circuit, to the vibration generating apparatus 210 and 220. The signal cable 207 according to an embodiment of the present disclosure may include a first terminal electrically connected with a first pad electrode of the pad part 206 and a second terminal electrically connected with a second pad electrode of the pad part 206. For example, the signal cable 207 may be a flexible printed circuit board (PCB), a flexible flat cable, a single-sided flexible printed circuit, a single-sided flexible PCB, a flexible multi-layer printed circuit, or a flexible multi-layer PCB, but embodiments of the present disclosure are not limited thereto.

The sound processing circuit may generate an alternating current (AC) vibration driving signal including a first vibration driving signal and a second vibration driving signal, based on sound data provided from an external sound data generating circuit. The first vibration driving signal may be one of a positive (+) vibration driving signal and a negative (−) vibration driving signal, and the second vibration driving signal may be one of the positive (+) vibration driving signal and the negative (−) vibration driving signal. For example, the first vibration driving signal may be supplied to the first electrode layer 201b through the first terminal of the signal cable 207, the first pad electrode of the pad part 206, and a first power supply line PL1. The second vibration driving signal may be supplied to the second electrode layer 201c through the second terminal of the signal cable 207, the second pad electrode of the pad part 206, and a second power supply line PL2.

According to an embodiment of the present disclosure, the signal cable 207 may be configured to be transparent, semitransparent, or opaque.

The vibration generating apparatus 210 and 220 (or a first vibration generating apparatus 210 or a second vibration generating apparatus 220) according to an embodiment of the present disclosure may be implemented as a thin film type as a first portion having a piezoelectric characteristic and a second portion having flexibility are alternately and repeatedly connected with each other. Accordingly, the vibration generating apparatus 210 and 220 may be bent in a shape corresponding to a shape of a vibration member or a vibration object. For example, when the vibration generating apparatus 210 and 220 is connected with or coupled to a vibration member including various curved portions by the adhesive member 150, the vibration generating apparatus 210) and 220 may be bent in a curved shape along a curved portion shape of the vibration member 100, and despite being bent in a curved shape, reliability against damage or breakdown may not be reduced.

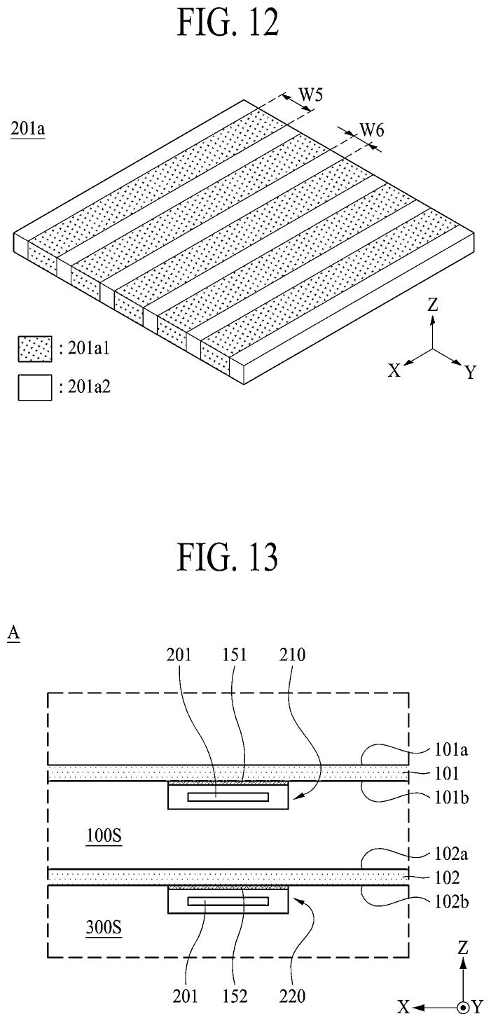

FIG. 12 illustrates a vibration layer 201a according to another embodiment of the present disclosure.

The vibration layer 201a according to another embodiment of the present disclosure may include a plurality of first portions 201a1 and a plurality of second portions 201a2. For example, the plurality of first portions 201a1 and the plurality of second portions 201a2 may be alternately and repeatedly disposed in a first direction X (or a second direction Y). For example, the first direction X may be a widthwise direction of the vibration layer 201a, and the second direction Y may be a lengthwise direction of the vibration layer 201a intersecting with the first direction X, but embodiments of the present disclosure are not limited thereto. For example, the first direction X may be the lengthwise direction of the vibration layer 201a, and the second direction Y may be the widthwise direction of the vibration layer 201a.

At least one vibration part 201 according to another embodiment of the present disclosure may be configured to have flexibility. For example, the at least one vibration part 201 may be provided to be bent in a nonplanar shape including a curved surface. Therefore, the at least one vibration part 201 according to an embodiment of the present disclosure may be a flexible vibration structure, a flexible vibrator, a flexible vibration generating device, a flexible vibration generator, a flexible sounder, a flexible sound device, a flexible sound generating device, a flexible sound generator, a flexible actuator, a flexible speaker, a flexible piezoelectric speaker, a film actuator, a film type piezoelectric composite actuator, a film speaker, a film type piezoelectric speaker, or a film type piezoelectric composite speaker, but embodiments of the present disclosure are not limited thereto.

Each of the plurality of first portions 201a1 may include an inorganic material portion. The inorganic material portion may include a piezoelectric material, a composite piezoelectric material, or an electroactive material, which has a piezoelectric effect.

Each of the plurality of first portions 201a1 may include a ceramic-based material for generating a relatively strong vibration, or may include a piezoelectric ceramic having a perovskite-based crystalline structure. The perovskite crystalline structure may have a piezoelectric effect and/or an inverse piezoelectric effect, and may be a plate-shaped structure having orientation. The perovskite crystalline structure may be represented by a chemical formula “ABO₃”. In the chemical formula, “A” may include a divalent metal element, and “B” may include a tetravalent metal element. For example, in the chemical formula “ABO₃”, “A” and “B” may be cations, and “O” may be anions. For example, the first portions 201a1 may include one or more of lead titanate (PbTiO₃), lead zirconate (PbZrO₃), lead zirconate titanate(PbZrTiO₃), barium titanate (BaTiO₃), and strontium titanate (SrTiO₃), but embodiments of the present disclosure are not limited thereto.

The piezoelectric ceramic may include single crystalline ceramic having a single crystalline structure, or may include polycrystalline ceramic or a ceramic material having a polycrystalline structure. A piezoelectric material of the single crystalline ceramic may include α-AlPO₄, α-SiO₂, LiNbO₃, Tb₂(MoO₄)₃, Li₂B₄O₇, or ZnO, but embodiments of the present disclosure are not limited thereto. The piezoelectric material of the single crystalline ceramic may include a lead zirconate titanate (PZT)-based material including lead (Pb), zirconium (Zr), and titanium (Ti) or may include a lead zirconate nickel niobate (PZNN)-based material including lead (Pb), zirconium (Zr), nickel (Ni), and niobium (Nb), but embodiments of the present disclosure are not limited thereto.

For another example, the vibration layer 201a may include one or more of CaTiO₃, BaTiO₃, and SrTiO₃ without Pb, but embodiments of the present disclosure are not limited thereto.

Each of the plurality of first portions 201a1 according to an embodiment of the present disclosure may be disposed between two adjacent second portions 201a2 of the plurality of second portions 201a2, and moreover, may have a fifth width W5 parallel to the first direction X (or the second direction Y) and may have a length parallel to the second direction Y (or the first direction X). Each of the plurality of second portions 201a2 may have a sixth width W6 parallel to the first direction X (or the second direction Y) and may have a length parallel to the second direction Y (or the first direction X). The fifth width W5 may be the same as or different from the sixth width W6. For example, the fifth width W5 may be greater than the sixth width W6. For example, the first portion 201a1 and the second portion 201a2 may include a line shape or a stripe shape having the same size or different sizes. Accordingly, the vibration layer 201a may have a 2-2 composite structure having a piezoelectric characteristic of a 2-2 vibration mode, and thus, may have a resonance frequency of 20 kHz or less, but embodiments of the present disclosure are not limited thereto. For example, the resonance frequency of the vibration layer 201a may vary based on one or more of a shape, a length, and a thickness.

In the vibration layer 201a, the plurality of first portions 201a1 and the plurality of second portions 201a2 may be disposed (or arranged) in parallel on the same plane (or the same layer). Each of the plurality of second portions 201a2 may be configured to fill a gap between two adjacent first portions 201a1, and thus, each of the plurality of second portions 201a2 may be connected to or attached on an adjacent first portion 201a1. Accordingly, the vibration layer 201a may extend by a desired size or length on the basis of lateral coupling (or connection) of the first portion 201a1 and the second portion 201a2.

In the vibration layer 201a, the width W6 of each of the plurality of second portions 201a2 may decrease progressively in a direction from a center portion of the vibration layer 201a to both edge portions (or both ends or both periphery portions) thereof.

According to an embodiment of the present disclosure, when the vibration layer 201a vibrates in a vertical direction Z (or a thickness direction), a second portion 201a2 having a largest width W6 among a plurality of second portions 201a2 may be disposed at a portion on which a largest stress concentrates. When the vibration layer 201a vibrates in the vertical direction Z, a second portion 201a2 having a smallest width W6 among the plurality of second portions 201a2 may be disposed at a portion on which a smallest stress concentrates. For example, the second portion 201a2 having the largest width W6 among the plurality of second portions 201a2 may be disposed at a center portion of the vibration layer 201a, and the second portion 201a2 having the smallest width W6 among the plurality of second portions 201a2 may be disposed at both edge portions (or both periphery portions) of the vibration layer 201a. Accordingly, when the vibration layer 201a vibrates in the vertical direction Z, an overlap of a resonance frequency or interference of a sound wave generated at a portion on which the largest stress concentrates may be minimized, and thus, the dip of a sound pressure level occurring in a low-pitched sound band may be improved and the flatness of a sound characteristic in the low-pitched sound band may be improved.

In the vibration layer 201a, the plurality of first portions 201a1 may have different sizes (or widths). For example, a size (or a width) of each of the plurality of first portions 201a1 may decrease or increase progressively in a direction from the center portion of the vibration layer 201a to both edge portions (or both ends or both periphery portions) thereof. Therefore, a sound pressure level characteristic of a sound of the vibration layer 201a may be enhanced by various unique vibration frequencies based on vibrations of the plurality of first portions 201a1 having different sizes, and a reproduction band of a sound may extend.

Each of the plurality of second portions 201a2 may be disposed between the plurality of first portions 201a1. Therefore, in the vibration layer 201a, vibration energy based on a link in a unit lattice of the first portion 201a1 may be increased by the second portion 201a2, and thus, a vibration characteristic may increase and a piezoelectric characteristic and flexibility may be secured. For example, the second portion 201a2 may include one of an epoxy-based polymer, an acrylic-based polymer, and a silicone-based polymer, but embodiments of the present disclosure are not limited thereto.

Each of the plurality of second portions 201a2 according to an embodiment of the present disclosure may include an organic material portion. For example, each of the organic material portions may be disposed between two adjacent inorganic material portions of the plurality of inorganic material portions, and thus, may absorb an impact applied to a corresponding inorganic material portion (or a first portion), a stress concentrating on the inorganic material portion may be released to enhance the durability of the vibration layer 201a, and flexibility may be provided to the vibration layer 201a. Accordingly, the vibration device 200 may be configured to have flexibility.

The second portion 201a2 according to an embodiment may have modulus (or Young's modulus) and viscoelasticity which are lower than those of the first portion 201a1, and thus, may enhance the reliability of the first portion 201a1 which is vulnerable to an impact due to a fragile characteristic thereof. For example, the second portion 201a2 may include a material which has a loss coefficient of 0.01 to 1 and a modulus of 0.1 Gpa to 10 Gpa (Gigapascal).

The organic material portion included in the second portion 201a2 may include an organic material, an organic polymer, an organic piezoelectric material, or an organic non-piezoelectric material having a flexible characteristic compared to the inorganic material portion which is the first portion 201a1. For example, the second portion 201a2 may be referred to as an adhesive portion, a flexible portion, a bending portion, a damping portion, or a ductile portion, or the like, but embodiments of the present disclosure are not limited thereto.

The plurality of first portions 201a1 and the plurality of second portions 201a2 may be disposed on (or connected to) the same plane, and thus, the vibration layer 201a according to an embodiment of the present embodiment may have a single thin film form. For example, the vibration layer 201a may have a structure where the plurality of first portions 201a1 are connected to one side thereof. For example, the vibration layer 201a may have a structure where the plurality of first portions 201a1 are connected in all of the vibration layer 201a. For example, the vibration layer 201a may be vibrated in a vertical direction by the first portion 201a1 having a vibration characteristic and may be bent in a curved shape by the second portion 201a2 having flexibility. Also, in the vibration layer 201 a according to an embodiment of the present disclosure, a size of the first portion 201a1 and a size of the second portion 201a2 may be adjusted based on a piezoelectric characteristic and flexibility needed for the vibration layer 201a. For example, in the vibration layer 201a requiring a piezoelectric characteristic rather than flexibility, a size of the first portion 201a1 may be adjusted to be greater than that of the second portion 201a2. In another embodiment of the present disclosure, in the vibration layer 201a requiring flexibility rather than a piezoelectric characteristic, a size of the second portion 201a2 may be adjusted to be greater than that of the first portion 201a1. Accordingly, a size of the vibration layer 201a may be adjusted based on a desired characteristic, and thus, the vibration layer 201 a may be easily designed.

The vibration layer 201a according to another embodiment of the present disclosure may include a plurality of first portions 201a1, which are spaced apart from one another in a first direction X and a second direction Y, and a second portion 201a2 disposed between the plurality of first portions 201a1.

The plurality of first portions 201a1 may be disposed to be spaced apart from one another in each of the first direction X and the second direction Y. For example, the plurality of first portions 201a1 may be disposed in a lattice form to have a hexahedral shape having the same size. Each of the plurality of first portions 201a1 may include substantially the same piezoelectric material as that of the first portion 201a1 described above with reference to FIG. 12, and thus, like reference numerals refer to like elements and repeated descriptions thereof may be omitted.

The second portion 201a2 may be disposed between the plurality of first portions 201a1 in each of the first direction X and the second direction Y. The second portion 201a2 may be configured to fill a gap between two adjacent first portions 201a1 or surround each of the plurality of first portions 201a1, and thus, may be connected or adhered to an adjacent first portion 201a1. According to an embodiment of the present disclosure, a width of the second portion 201a2 disposed between two first portions 201a1 adjacent to each other in the first direction X may be the same as or different from that of the first portion 201a1, and a width of the second portion 201a2 disposed between two first portions 201a1 adjacent to each other in the second direction Y may be the same as or different from that of the first portion 201a1. The second portion 201a2 may include substantially the same organic material as that of the second portion 201a2 described above with reference to FIG. 12, and thus, like reference numerals refer to like elements and repeated descriptions thereof may be omitted.

The vibration layer 201a according to another embodiment of the present disclosure may have a 1-3 composite structure having a piezoelectric characteristic of a 1-3 vibration mode, and thus, may have a resonance frequency of 30 MHz or less, but embodiments of the present disclosure are not limited thereto. For example, the resonance frequency of the vibration layer 201a may vary based on one or more of a shape, a length, and a thickness.

In the vibration layer 201a according to another embodiment of the present disclosure, each of the plurality of first portions 201a1 may have a circular flat structure. For example, each of the plurality of first portions 201a1 may have a circular plate shape, but embodiments of the present disclosure are not limited thereto. For example, each of the plurality of first portions 201a1 may have a dot shape including an oval shape, a polygonal shape, or a donut shape. The vibration layer 201a may include a plurality of first portions 201a1, which are spaced apart from one another in the first direction X and the second direction Y, and a second portion 201a2 between the plurality of first portions 201a1.

In the vibration layer 201a according to another embodiment of the present disclosure, each of the plurality of first portions 201a1 may have a triangular flat structure. For example, each of the plurality of first portions 201a1 may have a triangular plate shape.

According to another embodiment of the present disclosure, four adjacent first portions 201a1 of the plurality of first portions 201a1 may be disposed adjacent to one another to form a tetragonal shape (or a square shape). A vertex of each of four adjacent first portions 201a1 forming a tetragonal shape may be disposed adjacent to a center portion (or a middle portion) of a tetragonal shape.

According to another embodiment of the present disclosure, six adjacent first portions 201a1 of the plurality of first portions 201a1 may be disposed adjacent to one another to form a hexagonal (or a regular hexagonal) shape. A vertex of each of six adjacent first portions 201a1 forming a hexagonal shape may be disposed adjacent to a center portion (or a middle portion) of a hexagonal shape.

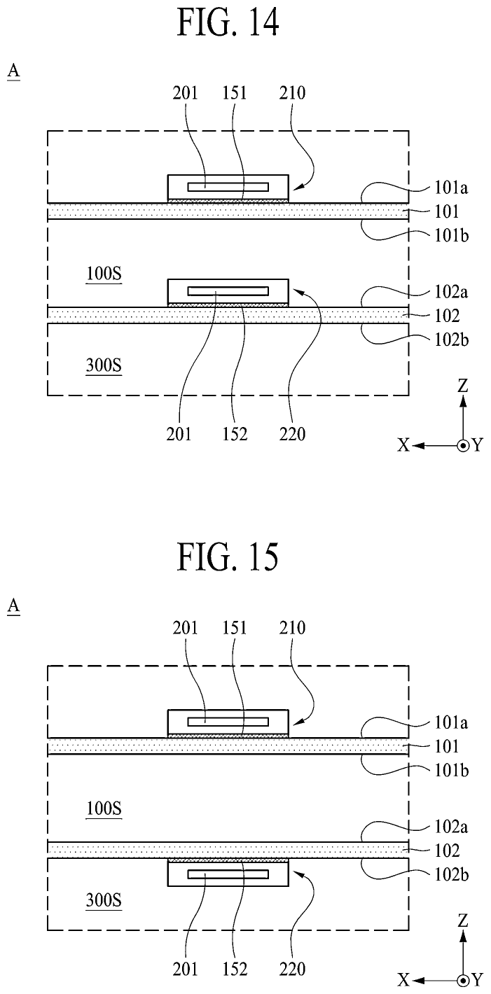

FIG. 13 illustrates an arrangement structure of a vibration generating apparatus illustrated in a region A of FIG. 9 according to another embodiment of the present disclosure. FIGS. 14 to 45 illustrate an arrangement structure of the vibration generating apparatus illustrated in the region A of FIG. 9 according to another embodiment of the present disclosure. FIG. 13 illustrates an arrangement structure of a vibration generating apparatus including the vibration part described above with reference to FIGS. 10 to 12, in the apparatus 8 described above with reference to FIG. 9, and FIGS. 14 to 45 illustrate various examples of an arrangement structure of a vibration generating apparatus including the vibration part described above with reference to FIGS. 10 to 12, in the apparatus 8 described above with reference to FIG. 9. FIGS. 13 and 14 to 45 illustrate an embodiment where the arrangement of a vibration generating apparatus is applied to the apparatus 8 and may be identically applied to the apparatuses 1 to 7 described above with reference to FIGS. 1 to 8. Therefore, in the following description, like elements except the arrangement of a vibration generating apparatus and relevant elements are referred to by like reference numerals, and repeated descriptions thereof are omitted or will be briefly given.

Referring to FIG. 13, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

Each of the first vibration generating apparatus 210 and the second vibration generating apparatus 220 may include at least one vibration part 201. For example, the at least one vibration part 201 may be a piezoelectric vibration part or a piezoelectric-type vibration part. For example, each of the first vibration generating apparatus 210 and the second vibration generating apparatus 220 may include the at least one vibration part 201 which is individually configured. For example, each of the first vibration generating apparatus 210 and the second vibration generating apparatus 220 may include a single vibration part 201.

Referring to FIGS. 10 and 13, the vibration part 201 may include a tetragonal shape which has a first length L1 parallel to a first direction X and a second length L2 parallel to a second direction Y intersecting with the first direction X. For example, the at least one vibration part 201 may include a square shape where the second length L2 is equal to the first length L1, or may include a rectangular shape where one of the first length L1 and the second length L2 is relatively longer, or but embodiments of the present disclosure are not limited thereto.

The first vibration generating apparatus 210 and the second vibration generating apparatus 220 may have the same size, or may have different sizes. For example, the first vibration generating apparatus 210 and the second vibration generating apparatus 220 may have substantially the same size. For example, the first vibration generating apparatus 210 and the second vibration generating apparatus 220 may have substantially the same size within an error range of a manufacturing process. The first vibration generating apparatus 210 and the second vibration generating apparatus 220 may be disposed spaced apart from each other in a third direction Z. At least a portion of the first vibration generating apparatus 210 may be provided to overlap the second vibration generating apparatus 220. For example, the first vibration generating apparatus 210 may overlap the second vibration generating apparatus 220. For example, the first vibration member 101 where the first vibration generating apparatus 210 is disposed and the second vibration member 102 where the second vibration generating apparatus 220 is disposed may be provided to overlap each other, and a center portion of the first vibration member 101 and a center portion of the second vibration member 102 may match therebetween. The first vibration generating apparatus 210 may be disposed at the center portion of the first vibration member 101, and the second vibration generating apparatus 220 may be disposed at the center portion of the second vibration member 102. Accordingly, the first vibration generating apparatus 210 may overlap the second vibration generating apparatus 220. A description thereof may be identically applied to FIGS. 14 to 21.

The first vibration member 101 and the second vibration member 102 may be disposed spaced apart from each other in the third direction Z and may be provided to include a first space 100S between the first vibration member 101 and the second vibration member 102. Also, a second surface 102b (or a rear surface) of the second vibration member 102 may be configured to include a second space 300S which is surrounded by an enclosure 300.

The first vibration generating apparatus 210 may be disposed at a second surface 101b of the first vibration member 101. For example, the first vibration generating apparatus 210 may be connected with or coupled to the second surface 101b of the first vibration member 101 by a first adhesive member 151. For example, the first vibration generating apparatus 210 may be disposed in the first space 100S between the first vibration member 101 and the second vibration member 102 and may be covered by the first vibration member 101, and thus, may be protected from an external impact.

The second vibration generating apparatus 220 may be disposed at the second surface 102b of the second vibration member 102. For example, the second vibration generating apparatus 220 may be connected with or coupled to the second surface 102b of the second vibration member 102 by a second adhesive member 152. For example, the second vibration generating apparatus 220 may be disposed in the second space 300S between the second vibration member 102 and the enclosure 300 and may be covered by the enclosure 300, and thus, may be protected from an external impact.

For example, the first vibration generating apparatus 210 and the second vibration generating apparatus 220 may be disposed with the second vibration member 102 therebetween. For example, the first vibration generating apparatus 210 and the second vibration generating apparatus 220 may be disposed to overlap each other with the second vibration member 102 therebetween. The first vibration generating apparatus 210 and the second vibration generating apparatus 220 may be disposed in different spaces.

For example, the first vibration generating apparatus 210 and the second vibration generating apparatus 220 may be disposed in different spaces. For example, the first vibration generating apparatus 210 may be disposed in the first space 100S. For example, the second vibration generating apparatus 220 may be disposed in the second space 300S.

The first vibration generating apparatus 210 and the second vibration generating apparatus 220 may be disposed to face different directions. For example, the first vibration generating apparatus 210 and the second vibration generating apparatus 220 may be disposed to face a downward direction in the third direction Z.

The first vibration generating apparatus 210 and the second vibration generating apparatus 220 may be identically disposed at second surfaces 101b and 102b (or rear surfaces) of a lower portion in the third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210 and a vibration driving signal applied to the second vibration generating apparatus 220 may have the same phase, so that the first vibration generating apparatus 210 and the second vibration generating apparatus 220 are displaced (or driven or vibrated) in the same direction, but embodiments of the present disclosure are not limited thereto.

According to an embodiment of the present disclosure, the first space 100S between the first vibration member 101 and the second vibration member 102 may be provided as a sealed space. Therefore, the firs space 100S may maintain a constant impedance component (or an air impedance or an elastic impedance) acting on the first vibration member 101 or the second vibration member 102, based on sealed air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

According to an embodiment of the present disclosure, the first vibration generating apparatus 210 provided in the first vibration member 101 and the second vibration generating apparatus 220 provided in the second vibration member 102 may be disposed to overlap each other and may be configured to be displaced (or vibrated or driven) in the same direction, and thus, a sound characteristic and/or a sound pressure level characteristic of a low-pitched sound band generated based on a vibration of each of the first vibration generating apparatus 210 and the second vibration generating apparatus 220 may be enhanced.

Referring to FIG. 14, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

Each of the first vibration generating apparatus 210 and the second vibration generating apparatus 220 may include at least one vibration part 201. For example, the at least one vibration part 201 may be a piezoelectric vibration part or a piezoelectric-type vibration part. For example, each of the first vibration generating apparatus 210 and the second vibration generating apparatus 220 may include the at least one vibration part 201 which is individually configured. For example, each of the first vibration generating apparatus 210 and the second vibration generating apparatus 220 may include a single vibration part 201.

The first vibration generating apparatus 210 may be disposed at a first surface 101a of the first vibration member 101. For example, the first vibration generating apparatus 210 may be connected with or coupled to the first surface 101a of the first vibration member 101 by the first adhesive member 151.

The second vibration generating apparatus 220 may be disposed at the first surface 102a of the second vibration member 102. For example, the second vibration generating apparatus 220 may be connected with or coupled to the first surface 102a of the second vibration member 102 by the second adhesive member 152. For example, the second vibration generating apparatus 220 may be disposed in the first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in different spaces. For example, the second vibration generating apparatus 220 may be disposed in the first space 100S.

For example, the first vibration generating apparatus 210 and the second vibration generating apparatus 220 may be disposed with the first vibration member 101 therebetween. For example, the first vibration generating apparatus 210 and the second vibration generating apparatus 220 may be disposed to overlap each other with the first vibration member 101 therebetween.

The first vibration generating apparatus 210 and the second vibration generating apparatus 220 may be disposed to face the same direction. For example, the first vibration generating apparatus 210 and the second vibration generating apparatus 220 may be disposed to face an upward direction in the third direction Z.

The first vibration generating apparatus 210 and the second vibration generating apparatus 220 may be identically disposed at first surfaces 101a and 102a (or upper surfaces) of an upper portion in the third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210 and a vibration driving signal applied to the second vibration generating apparatus 220 may have the same phase, so that the first vibration generating apparatus 210 and the second vibration generating apparatus 220 are displaced (or driven or vibrated) in the same direction, but embodiments of the present disclosure are not limited thereto.

According to an embodiment of the present disclosure, the first space 100S between the first vibration member 101 and the second vibration member 102 may be provided as a sealed space. Therefore, the firs space 100S may maintain a constant impedance component (or an air impedance or an elastic impedance) acting on the first vibration member 101 or the second vibration member 102, based on sealed air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

According to an embodiment of the present disclosure, the first vibration generating apparatus 210 provided in the first vibration member 101 and the second vibration generating apparatus 220 provided in the second vibration member 102 may be disposed to overlap each other and may be configured to be displaced (or vibrated or driven) in the same direction, and thus, a sound characteristic and/or a sound pressure level characteristic of a low-pitched sound band generated based on a vibration of each of the first vibration generating apparatus 210 and the second vibration generating apparatus 220 may be enhanced.

Referring to FIG. 15, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

Each of the first vibration generating apparatus 210 and the second vibration generating apparatus 220 may include at least one vibration part 201. For example, the at least one vibration part 201 may be a piezoelectric vibration part or a piezoelectric-type vibration part. For example, each of the first vibration generating apparatus 210 and the second vibration generating apparatus 220 may include the at least one vibration part 201 which is individually configured. For example, each of the first vibration generating apparatus 210 and the second vibration generating apparatus 220 may include a single vibration part 201.

The first vibration generating apparatus 210 may be disposed at a first surface 101a of the first vibration member 101. For example, the first vibration generating apparatus 210 may be connected with or coupled to the first surface 101a of the first vibration member 101 by the first adhesive member 151.

The second vibration generating apparatus 220 may be disposed at the second surface 102b of the second vibration member 102. For example, the second vibration generating apparatus 220 may be connected with or coupled to the second surface 102b of the second vibration member 102 by a second adhesive member 152. For example, the second vibration generating apparatus 220 may be disposed in the second space 300S between the second vibration member 102 and the enclosure 300 and may be covered by the enclosure 300, and thus, may be protected from an external impact.

For example, the first vibration generating apparatus 210 and the second vibration generating apparatus 220 may be disposed in different spaces. For example, the second vibration generating apparatus 220 may be disposed in the second space 300S.

For example, the first vibration generating apparatus 210 and the second vibration generating apparatus 220 may be disposed with the first vibration member 101 and the second vibration member 102 therebetween. For example, the first vibration generating apparatus 210 and the second vibration generating apparatus 220 may be disposed to overlap each other with the first vibration member 101 and the second vibration member 102 therebetween.

For example, the first vibration generating apparatus 210 and the second vibration generating apparatus 220 may be disposed with the first space 100S therebetween. For example, the first vibration generating apparatus 210 and the second vibration generating apparatus 220 may be disposed to overlap each other with the first space 100S therebetween.

The first vibration generating apparatus 210 and the second vibration generating apparatus 220 may be disposed to face different directions. For example, the first vibration generating apparatus 210 may be disposed to face an upward direction in the third direction Z. For example, the second vibration generating apparatus 220 may be disposed to face a downward direction in the third direction Z.

The first vibration generating apparatus 210 and the second vibration generating apparatus 220 may be disposed at a first surface 101a (or an upper surface) and a second surface 102b (or a rear surface) of opposite sides in the third direction Z in the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220 may have opposite phases, so that the first vibration generating apparatus 210 and the second vibration generating apparatus 220 are displaced (or driven or vibrated) in the same direction, but embodiments of the present disclosure are not limited thereto.

According to an embodiment of the present disclosure, the first space 100S between the first vibration member 101 and the second vibration member 102 may be provided as a sealed space. For example, the first vibration generating apparatus 210 and the second vibration generating apparatus 220 may be disposed with the first space 100S therebetween. Therefore, the firs space 100S may maintain a constant impedance component (or an air impedance or an elastic impedance) acting on the first vibration member 101 or the second vibration member 102, based on sealed air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

According to an embodiment of the present disclosure, the first vibration generating apparatus 210 provided in the first vibration member 101 and the second vibration generating apparatus 220 provided in the second vibration member 102 may be disposed to overlap each other and may be configured to be displaced (or vibrated or driven) in the same direction, and thus, a sound characteristic and/or a sound pressure level characteristic of a low-pitched sound band generated based on a vibration of each of the first vibration generating apparatus 210 and the second vibration generating apparatus 220 may be enhanced.

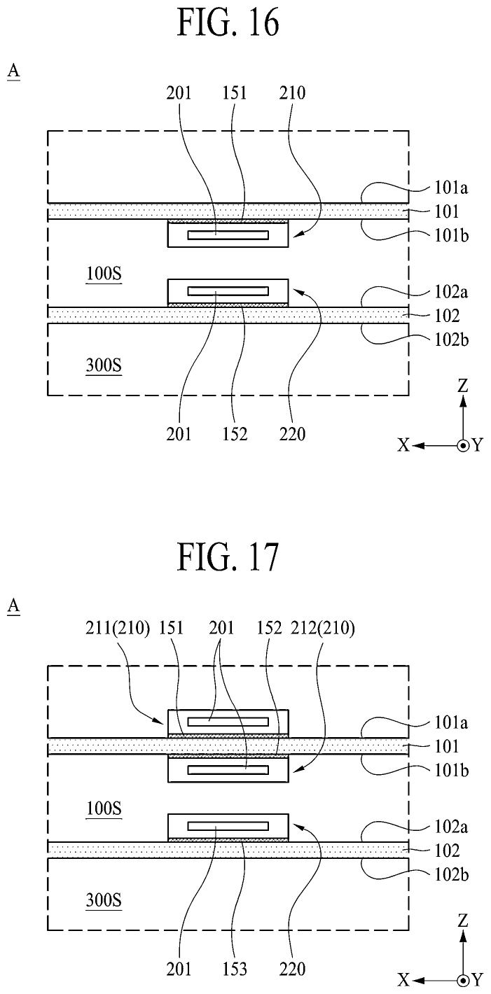

Referring to FIG. 16, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

Each of the first vibration generating apparatus 210 and the second vibration generating apparatus 220 may include at least one vibration part 201. For example, the at least one vibration part 201 may be a piezoelectric vibration part or a piezoelectric-type vibration part. For example, each of the first vibration generating apparatus 210 and the second vibration generating apparatus 220 may include the at least one vibration part 201 which is individually configured. For example, each of the first vibration generating apparatus 210 and the second vibration generating apparatus 220 may include a single vibration part 201.

The first vibration generating apparatus 210 may be disposed at a second surface 101b of the first vibration member 101. For example, the first vibration generating apparatus 210 may be connected with or coupled to the second surface 101b of the first vibration member 101 by a first adhesive member 151. For example, the first vibration generating apparatus 210 may be disposed in the first space 100S between the first vibration member 101 and the second vibration member 102 and may be covered by the first vibration member 101, and thus, may be protected from an external impact.

The second vibration generating apparatus 220 may be disposed at the first surface 102a of the second vibration member 102. For example, the second vibration generating apparatus 220 may be connected with or coupled to the first surface 102a of the second vibration member 102 by the second adhesive member 152. For example, the second vibration generating apparatus 220 may be disposed in the first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in the same space. For example, the first vibration generating apparatus 210 and the second vibration generating apparatus 220 may be disposed in first space 100S. For example, the first vibration generating apparatus 210 and the second vibration generating apparatus 220 may be disposed to face each other. For example, the first vibration generating apparatus 210 and the second vibration generating apparatus 220 may be disposed to face each other in the first space 100S.

The first vibration generating apparatus 210 and the second vibration generating apparatus 220 may be disposed to face different directions. For example, the first vibration generating apparatus 210 may be disposed to face a downward direction in the third direction Z. For example, the second vibration generating apparatus 220 may be disposed to face an upward direction in the third direction Z.

The first vibration generating apparatus 210 and the second vibration generating apparatus 220 may be disposed at a second surface 101b (or a rear surface) and a first surface 102a (or an upper surface) of opposite sides in the third direction Z in the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220) may have opposite phases, so that the first vibration generating apparatus 210) and the second vibration generating apparatus 220 are displaced (or driven or vibrated) in the same direction, but embodiments of the present disclosure are not limited thereto.

According to an embodiment of the present disclosure, the first space 100S between the first vibration member 101 and the second vibration member 102 may be provided as a sealed space. Therefore, the firs space 100S may maintain a constant impedance component (or an air impedance or an elastic impedance) acting on the first vibration member 101 or the second vibration member 102, based on sealed air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

According to an embodiment of the present disclosure, the first vibration generating apparatus 210 provided in the first vibration member 101 and the second vibration generating apparatus 220 provided in the second vibration member 102 may be disposed to overlap each other and may be configured to be displaced (or vibrated or driven) in the same direction, and thus, a sound characteristic and/or a sound pressure level characteristic of a low-pitched sound band generated based on a vibration of each of the first vibration generating apparatus 210 and the second vibration generating apparatus 220 may be enhanced.

Referring to FIG. 17, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators.

The first vibration generating apparatus 210 may include a first vibration generator 211 and a second vibration generator 212. The second vibration generating apparatus 220 may be configured with a single vibration generator.

Each of the first vibration generator 211 and the second vibration generator 212 of the first vibration generating apparatus 210 and the second vibration generating apparatus 220 may include at least one vibration part 201. For example, the at least one vibration part 201 may be a piezoelectric vibration part or a piezoelectric-type vibration part. For example, each of the first vibration generator 211, the second vibration generator 212, and the second vibration generating apparatus 220 may include a vibration part 201 which is individually configured.

The first vibration generator 211 may be disposed at a first surface 101a of the first vibration member 101. For example, the first vibration generator 211 may be connected with or coupled to the first surface 101a of the first vibration member 101 by the first adhesive member 151. Also, the second vibration generator 212 may be disposed at a second surface 101b of the first vibration member 101. For example, the second vibration generator 212 may be connected with or coupled to the second surface 101b of the first vibration member 101 by the second adhesive member 152. For example, the first vibration generator 211 and the second vibration generator 212 may be disposed with the first vibration member 101 therebetween. For example, the first vibration generator 211 and the second vibration generator 212 may be disposed to overlap each other with the first vibration member 101 therebetween.

The second vibration generating apparatus 220 may be disposed at the first surface 102a of the second vibration member 102. For example, the second vibration generating apparatus 220 may be connected with or coupled to the first surface 102a of the second vibration member 102 by a third adhesive member 153. The second vibration generator 212 and the second vibration generating apparatus 220 may be disposed in the first space 100S between the first vibration member 101 and the second vibration member 102 and may be covered by the first vibration member 101, and thus, may be protected from an external impact.

For example, the first vibration generator 211 and the second vibration generator 212 may be disposed with the first vibration member 101 therebetween. For example, the first vibration generator 211 and the second vibration generator 212 may be disposed to overlap each other with the first vibration member 101 therebetween.

For example, the first vibration generating apparatus 210 and the second vibration generating apparatus 220 may be disposed in different spaces. For example, the second vibration generating apparatus 220 and the second vibration generator 212 may be disposed in the first space 100S. For example, the second vibration generating apparatus 220 and the second vibration generator 212 may be disposed to face each other. For example, the second vibration generating apparatus 220) and the second vibration generator 212 may be disposed to face each other in the first space 100S.

The first vibration generating apparatus 210 and the second vibration generating apparatus 220 may be disposed to face different directions. For example, the second vibration generator 212 may be disposed to face a downward direction in the third direction Z. For example, the second vibration generating apparatus 220 may be disposed to face an upward direction in the third direction Z.

The first vibration generating apparatus 210 and the second vibration generating apparatus 220 may be disposed to face the same direction. For example, the first vibration generator 211 and the second vibration generating apparatus 220 may be disposed to face an upward direction in the third direction Z.

The first vibration generator 211 and the second vibration generator 212 of the first vibration generating apparatus 210 may have an inverted structure at each of the first surface 101a and the second surface 101b of the first vibration member 101. Also, the second vibration generating apparatus 220 may have an inverted structure with respect to one of the first vibration generator 211 and the second vibration generator 212 and may have a non-inverted structure with respect to the other of the first vibration generator 211 and the second vibration generator 212. For example, the second vibration generating apparatus 220 may have a non-inverted structure with respect to the first vibration generator 211 and may have an inverted structure with respect to the second vibration generator 212.

The first vibration generator 211, the second vibration generator 212, and the second vibration generating apparatus 220 may be configured to be displaced (or vibrated or driven) in the same direction. For example, a vibration driving signal applied to the first vibration generator 211 may have the same phase as the second vibration generating apparatus 220 and a vibration driving signal applied to the second vibration generator 212 may have a phase opposite to the second vibration generating apparatus 220, so that the first vibration generator 211, the second vibration generator 212, and the second vibration generating apparatus 220 are displaced (or vibrated or driven) in the same direction, but embodiments of the present disclosure are not limited thereto.

According to an embodiment of the present disclosure, the first space 100S between the first vibration member 101 and the second vibration member 102 may be provided as a sealed space. Therefore, the firs space 100S may maintain a constant impedance component (or an air impedance or an elastic impedance) acting on the first vibration member 101 or the second vibration member 102, based on sealed air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

According to an embodiment of the present disclosure, the first vibration generator 211 and the second vibration generator 212 provided in the first vibration member 101 and the second vibration generating apparatus 220 provided in the second vibration member 102 may be disposed to overlap each other and may be configured to be displaced (or vibrated or driven) in the same direction, and thus, a sound characteristic and/or a sound pressure level characteristic of the low-pitched sound band generated based on vibrations of the first vibration generator 211, the second vibration generator 212, and the second vibration generating apparatus 220 may be enhanced.

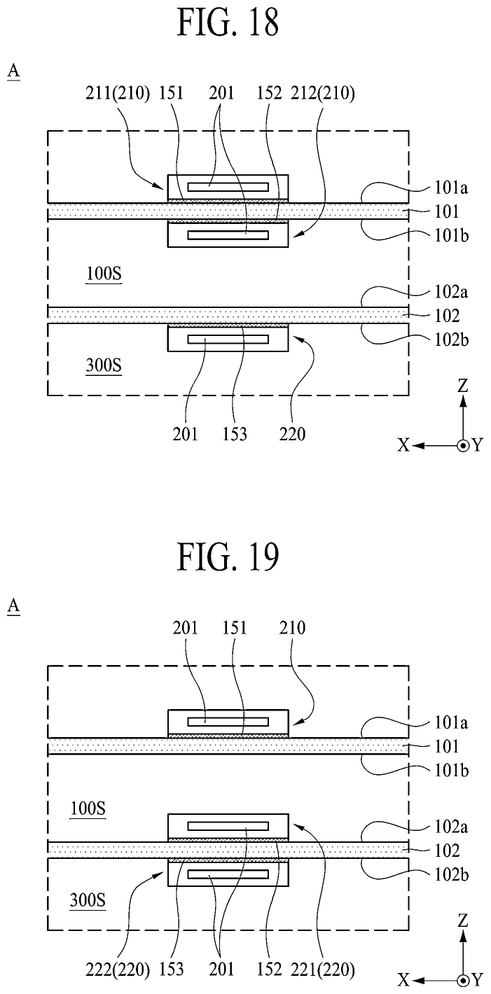

Referring to FIG. 18, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators.

The first vibration generating apparatus 210 may include a first vibration generator 211 and a second vibration generator 212. The second vibration generating apparatus 220 may be configured with a single vibration generator.

Each of the first vibration generator 211 and the second vibration generator 212 of the first vibration generating apparatus 210 and the second vibration generating apparatus 220 may include at least one vibration part 201. For example, the at least one vibration part 201 may be a piezoelectric vibration part or a piezoelectric-type vibration part. For example, each of the first vibration generator 211, the second vibration generator 212, and the second vibration generating apparatus 220 may include a vibration part 201 which is individually configured.

The first vibration generator 211 may be disposed at the first surface 101a of the first vibration member 101. For example, the first vibration generator 211 may be connected with or coupled to the first surface 101a of the first vibration member 101 by the first adhesive member 151. Also, the second vibration generator 212 may be disposed at the second surface 101b of the first vibration member 101. For example, the second vibration generator 212 may be connected with or coupled to the second surface 101b of the first vibration member 101 by the second adhesive member 152. The first vibration generator 211 and the second vibration generator 212 may be disposed with the first vibration member 101 therebetween. For example, the first vibration generator 211 and the second vibration generator 212 may be disposed to overlap each other with the first vibration member 101 therebetween.

The second vibration generating apparatus 220 may be disposed at the second surface 102b of the second vibration member 102. For example, the second vibration generating apparatus 220 may be connected with or coupled to the second surface 102b of the second vibration member 102 by the third adhesive member 153. The second vibration generating apparatus 220 may be disposed in the second space 300S between the second vibration member 102 and the enclosure 300 and may be covered by the enclosure 300, and thus, may be protected from an external impact.

For example, the first vibration generating apparatus 210 and the second vibration generating apparatus 220 may be disposed in different spaces. For example, the second vibration generator 212 and the second vibration generating apparatus 220 may be disposed in different spaces. For example, the second vibration generator 212 may be disposed in the first space 100S. For example, the second vibration generator 212 may be disposed in the first space 100S between the first vibration member 101 and the second vibration member 102. For example, the second vibration generating apparatus 220 may be disposed in the second space 300S.

For example, the second vibration generator 212 and the second vibration generating apparatus 220 may be disposed with the second vibration member 102 therebetween. For example, the second vibration generator 212 and the second vibration generating apparatus 220 may be disposed to overlap each other with the second vibration member 102 therebetween.

The first vibration generating apparatus 210 and the second vibration generating apparatus 220 may be disposed to face different directions. For example, the first vibration generator 211 may be disposed to face an upward direction in the third direction Z. For example, the second vibration generating apparatus 220 may be disposed to face a downward direction in the third direction Z.

The first vibration generating apparatus 210 and the second vibration generating apparatus 220 may be disposed to face the same direction. For example, the second vibration generator 212 and the second vibration generating apparatus 220 may be disposed to face a downward direction in the third direction Z.

The first vibration generator 211 and the second vibration generator 212 of the first vibration generating apparatus 210 may have an inverted structure at each of the first surface 101a and the second surface 101b of the first vibration member 101. Also, the second vibration generating apparatus 220 may have an inverted structure with respect to one of the first vibration generator 211 and the second vibration generator 212 and may have a non-inverted structure with respect to the other of the first vibration generator 211 and the second vibration generator 212. For example, the second vibration generating apparatus 220 may have an inverted structure with respect to the first vibration generator 211 and may have a non-inverted structure with respect to the second vibration generator 212.

The first vibration generator 211, the second vibration generator 212, and the second vibration generating apparatus 220 may be configured to be displaced (or vibrated or driven) in the same direction. For example, a vibration driving signal applied to the first vibration generator 211 may have a phase opposite to the second vibration generating apparatus 220, and a vibration driving signal applied to the second vibration generator 212 may have the same phase as the second vibration generating apparatus 220, but embodiments of the present disclosure are not limited thereto.

According to an embodiment of the present disclosure, the first space 100S between the first vibration member 101 and the second vibration member 102 may be provided as a sealed space. Therefore, the firs space 100S may maintain a constant impedance component (or an air impedance or an elastic impedance) acting on the first vibration member 101 or the second vibration member 102, based on sealed air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

According to an embodiment of the present disclosure, the first vibration generator 211 and the second vibration generator 212 provided in the first vibration member 101 and the second vibration generating apparatus 220 provided in the second vibration member 102 may be disposed to overlap each other and may be configured to be displaced (or vibrated or driven) in the same direction, and thus, a sound characteristic and/or a sound pressure level characteristic of the low-pitched sound band generated based on vibrations of the first vibration generator 211, the second vibration generator 212, and the second vibration generating apparatus 220 may be enhanced.

Referring to FIG. 19, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators.

The second vibration generating apparatus 220 may include a third vibration generator 221 and a fourth vibration generator 222. The first vibration generating apparatus 210 may be configured with a single vibration generator.

Each of the first vibration generating apparatus 210, the third vibration generator 221, and the fourth vibration generator 222 may include at least one vibration part 201. For example, the at least one vibration part 201 may be a piezoelectric vibration part or a piezoelectric-type vibration part. For example, each of the first vibration generating apparatus 210, the third vibration generator 221, and the fourth vibration generator 222 may include the at least one vibration part 201 which is individually configured. For example, each of the first vibration generating apparatus 210, the third vibration generator 221, and the fourth vibration generator 222 may include a single vibration part 201.

The first vibration generating apparatus 210 may be disposed at a first surface 101a of the first vibration member 101. For example, the first vibration generating apparatus 210 may be connected with or coupled to the first surface 101a of the first vibration member 101 by the first adhesive member 151.

The third vibration generator 221 of the second vibration generating apparatus 220 may be disposed at a first surface 102a of the second vibration member 102. For example, the third vibration generator 221 may be connected with or coupled to the first surface 102a of the second vibration member 102 by the second adhesive member 152. The fourth vibration generator 222 of the second vibration generating apparatus 220 may be disposed at a second surface 102b of the second vibration member 102. For example, the fourth vibration generator 222 may be connected with or coupled to the second surface 102b of the second vibration member 102 by the third adhesive member 153.

For example, the third vibration generator 221 and the fourth vibration generator 222 may be disposed in different spaces. For example, the third vibration generator 221 may be disposed in the first space 100S. For example, the third vibration generator 221 may be disposed in the first space 100S between the first vibration member 101 and the second vibration member 102. For example, the fourth vibration generator 222 may be disposed in the second space 300S.

For example, the third vibration generator 221 and the fourth vibration generator 222 may be disposed with the second vibration member 102 therebetween. For example, the third vibration generator 221 and the fourth vibration generator 222 may be disposed to face each other with the second vibration member 102 therebetween. For example, the third vibration generator 221 and the fourth vibration generator 222 may be disposed to overlap each other with the second vibration member 102 therebetween.

The first vibration generating apparatus 210 and the second vibration generating apparatus 220 may be disposed to face the same direction. For example, the first vibration generating apparatus 210 and the third vibration generator 221 may be disposed to face an upward direction in the third direction Z.

The first vibration generating apparatus 210 and the second vibration generating apparatus 220 may be disposed to face different directions. For example, the first vibration generating apparatus 210 may be disposed to face an upward direction in the third direction Z. For example, the fourth vibration generator 222 may be disposed to face a downward direction in the third direction Z.

The third vibration generator 221 and the fourth vibration generator 222 of the second vibration generating apparatus 220 may have an inverted structure at each of the first surface 102a and the second surface 102b of the second vibration member 102. Also, the first vibration generating apparatus 210 may have an inverted structure with respect to one of the third vibration generator 221 and the fourth vibration generator 222 and may have a non-inverted structure with respect to the other of the third vibration generator 221 and the fourth vibration generator 222. For example, the first vibration generating apparatus 210 may have a non-inverted structure with respect to the third vibration generator 221 and may have an inverted structure with respect to the fourth vibration generator 222. The first vibration generating apparatus 210, the third vibration generator 221, and the fourth vibration generator 222 may be configured to be displaced (or vibrated or driven) in the same direction. For example, a vibration driving signal applied to the third vibration generator 221 may have a phase same as the first vibration generating apparatus 210, and a vibration driving signal applied to the fourth vibration generator 222 may have the phase opposite to the first vibration generating apparatus 210, but embodiments of the present disclosure are not limited thereto.

According to an embodiment of the present disclosure, the first space 100S between the first vibration member 101 and the second vibration member 102 may be provided as a sealed space. Therefore, the firs space 100S may maintain a constant impedance component (or an air impedance or an elastic impedance) acting on the first vibration member 101 or the second vibration member 102, based on sealed air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

According to an embodiment of the present disclosure, the first vibration generating apparatus 210 provided in the first vibration member 101 and the third vibration generator 221 and the fourth vibration generator 222 provided in the second vibration member 102 may be disposed to overlap each other and may be configured to be displaced (or vibrated or driven) in the same direction, and thus, a sound characteristic and/or a sound pressure level characteristic of the low-pitched sound band generated based on vibrations of the first vibration generating apparatus 210, the third vibration generator 221, and the fourth vibration generator 222 may be enhanced.

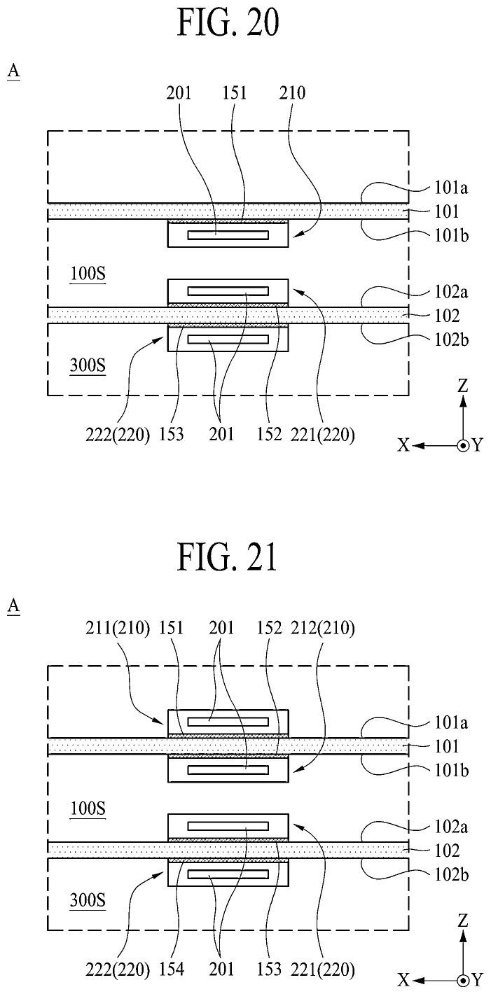

Referring to FIG. 20, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators.

The second vibration generating apparatus 220 may include a third vibration generator 221 and a fourth vibration generator 222. The first vibration generating apparatus 210 may be configured with a single vibration generator.

Each of the first vibration generating apparatus 210, the third vibration generator 221, and the fourth vibration generator 222 may include at least one vibration part 201. For example, the at least one vibration part 201 may be a piezoelectric vibration part or a piezoelectric-type vibration part. For example, each of the first vibration generating apparatus 210, the third vibration generator 221, and the fourth vibration generator 222 may include the at least one vibration part 201 which is individually configured. For example, each of the first vibration generating apparatus 210, the third vibration generator 221, and the fourth vibration generator 222 may include a single vibration part 201.

The first vibration generating apparatus 210 may be disposed at a second surface 101b of the first vibration member 101. For example, the first vibration generating apparatus 210 may be connected with or coupled to the second surface 101b of the first vibration member 101 by a first adhesive member 151. For example, the first vibration generating apparatus 210 may be disposed in the first space 100S between the first vibration member 101 and the second vibration member 102 and may be covered by the first vibration member 101, and thus, may be protected from an external impact.

The third vibration generator 221 of the second vibration generating apparatus 220 may be disposed at a first surface 102a of the second vibration member 102. For example, the third vibration generator 221 may be connected with or coupled to the first surface 102a of the second vibration member 102 by the second adhesive member 152. The fourth vibration generator 222 of the second vibration generating apparatus 220 may be disposed at a second surface 102b of the second vibration member 102. For example, the fourth vibration generator 222 may be connected with or coupled to the second surface 102b of the second vibration member 102 by the third adhesive member 153.

For example, the third vibration generator 221 and the fourth vibration generator 222 may be disposed in different spaces. For example, the third vibration generator 221 may be disposed in the first space 100S. For example, the third vibration generator 221 may be disposed in the first space 100S between the first vibration member 101 and the second vibration member 102. For example, the fourth vibration generator 222 may be disposed in the second space 300S.

For example, the first vibration generating apparatus 210 and the second vibration generating apparatus 220 may be disposed in the same space. For example, the first vibration generating apparatus 210 and the third vibration generator 221 of the second vibration generating apparatus 220 may be disposed in the same space. The first vibration generating apparatus 210 and the third vibration generator 221 of the second vibration generating apparatus 220 may be disposed in the first space 100S. For example, the first vibration generating apparatus 210 and the third vibration generator 221 of the second vibration generating apparatus 220 may be disposed in the first space 100S between the first vibration member 101 and the second vibration member 102.

For example, the third vibration generator 221 and the fourth vibration generator 222 may be disposed with the second vibration member 102 therebetween. For example, the third vibration generator 221 and the fourth vibration generator 222 may be disposed to face each other with the second vibration member 102 therebetween. For example, the third vibration generator 221 and the fourth vibration generator 222 may be disposed to overlap each other with the second vibration member 102 therebetween.

The first vibration generating apparatus 210 and the second vibration generating apparatus 220 may be disposed to face the same direction. For example, the first vibration generating apparatus 210 and the fourth vibration generator 222 may be disposed to face a downward direction in the third direction Z.

The first vibration generating apparatus 210 and the second vibration generating apparatus 220 may be disposed to face the different directions. For example, the first vibration generating apparatus 210 may be disposed to face a downward direction in the third direction Z. For example, the third vibration generator 221 may be disposed to face an upward direction in the third direction Z.

The third vibration generator 221 and the fourth vibration generator 222 of the second vibration generating apparatus 220 may have an inverted structure at each of the first surface 102a and the second surface 102b of the second vibration member 102. Also, the first vibration generating apparatus 210 may have an inverted structure with respect to one of the third vibration generator 221 and the fourth vibration generator 222 and may have a non-inverted structure with respect to the other of the third vibration generator 221 and the fourth vibration generator 222. For example, the first vibration generating apparatus 210 may have an inverted structure with respect to the third vibration generator 221 and may have a non-inverted structure with respect to the fourth vibration generator 222. The first vibration generating apparatus 210, the third vibration generator 221, and the fourth vibration generator 222 may be configured to be displaced (or vibrated or driven) in the same direction. For example, a vibration driving signal applied to the third vibration generator 221 may have a phase opposite to the first vibration generating apparatus 210, and a vibration driving signal applied to the fourth vibration generator 222 may have the same phase as the first vibration generating apparatus 210, but embodiments of the present disclosure are not limited thereto.

According to an embodiment of the present disclosure, the first space 100S between the first vibration member 101 and the second vibration member 102 may be provided as a sealed space. Therefore, the firs space 100S may maintain a constant impedance component (or an air impedance or an elastic impedance) acting on the first vibration member 101 or the second vibration member 102, based on sealed air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

According to an embodiment of the present disclosure, the first vibration generating apparatus 210 provided in the first vibration member 101 and the third vibration generator 221 and the fourth vibration generator 222 provided in the second vibration member 102 may be disposed to overlap each other and may be configured to be displaced (or vibrated or driven) in the same direction, and thus, a sound characteristic and/or a sound pressure level characteristic of the low-pitched sound band generated based on vibrations of the first vibration generating apparatus 210, the third vibration generator 221, and the fourth vibration generator 222 may be enhanced.

Referring to FIG. 21, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

Each of the first vibration generating apparatus 210 and the second vibration generating apparatus 220 may include a plurality of vibration generators.

The first vibration generating apparatus 210 may include the first vibration generator 211 and the second vibration generator 212. The second vibration generating apparatus 220 may include the third vibration generator 221 and the fourth vibration generator 222.

Each of the first vibration generator 211, the second vibration generator 212, the third vibration generator 221, and the fourth vibration generator 222 may include at least one vibration part 201. For example, the at least one vibration part 201 may be a piezoelectric vibration part or a piezoelectric-type vibration part. For example, each of the first vibration generator 211, the second vibration generator 212, the third vibration generator 221, and the fourth vibration generator 222 may include the at least one vibration part 201 which is individually configured. For example, each of the first vibration generator 211, the second vibration generator 212, the third vibration generator 221, and the fourth vibration generator 222 may include a single vibration part 201.

The first vibration generator 211 may be disposed at the first surface 101a of the first vibration member 101. For example, the first vibration generator 211 may be connected with or coupled to the first surface 101a of the first vibration member 101 by the first adhesive member 151. The second vibration generator 212 may be disposed at the second surface 101b of the first vibration member 101. For example, the second vibration generator 212 may be connected with or coupled to the second surface 101b of the first vibration member 101 by the second adhesive member 152.

The third vibration generator 221 may be disposed at the first surface 102a of the second vibration member 102. For example, the third vibration generator 221 may be connected with or coupled to the first surface 102a of the second vibration member 102 by the third adhesive member 153. The fourth vibration generator 222 may be disposed at the second surface 102b of the second vibration member 102. For example, the fourth vibration generator 222 may be connected with or coupled to the second surface 102b of the second vibration member 102 by the fourth adhesive member 154.

The first vibration generator 211 and the second vibration generator 212 of the first vibration generating apparatus 210 may have an inverted structure at each of the first surface 101a and the second surface 101b of the first vibration member 101. For example, the second vibration generator 212 may be disposed in the first space 100S between the first vibration member 101 and the second vibration member 102 and may be covered by the first vibration member 101, and thus, may be protected from an external impact.

For example, the first vibration generator 211 and the second vibration generator 212 may be disposed in different spaces. For example, the second vibration generator 212 may be disposed in the first space 100S. For example, the second vibration generator 212 may be disposed in the first space 100S between the first vibration generator 211 and the second vibration generator 212.

For example, the third vibration generator 221 and the fourth vibration generator 222 may be disposed in different spaces. For example, the third vibration generator 221 may be disposed in the first space 100S. For example, the third vibration generator 221 may be disposed in the first space 100S between the first vibration member 101 and the second vibration member 102. For example, the fourth vibration generator 222 may be disposed in the second space 300S.

For example, the second vibration generator 212 and the third vibration generator 221 may be disposed in the same space. For example, the second vibration generator 212 and the third vibration generator 221 may be disposed in the first space 100S.

For example, the first vibration generator 211 and the second vibration generator 212 may be disposed with the first vibration member 101 therebetween. For example, the first vibration generator 211 and the second vibration generator 212 may be disposed to face each other with the first vibration member 101 therebetween. For example, the first vibration generator 211 and the second vibration generator 212 may be disposed to overlap each other with the first vibration member 101 therebetween.

For example, the third vibration generator 221 and the fourth vibration generator 222 may be disposed with the second vibration member 102 therebetween. For example, the third vibration generator 221 and the fourth vibration generator 222 may be disposed to face each other with the second vibration member 102 therebetween. For example, the third vibration generator 221 and the fourth vibration generator 222 may be disposed to overlap each other with the second vibration member 102 therebetween.

For example, the first vibration generator 211 and the third vibration generator 221 may be disposed to face the same direction, and for example, may be disposed to face an upward direction in the third direction Z. For example, the second vibration generator 212 and the fourth vibration generator 222 may be disposed to face the same direction, and for example, may be disposed to face a downward direction in the third direction Z.

The third vibration generator 221 and the fourth vibration generator 222 of the second vibration generating apparatus 220 may have an inverted structure at each of the first surface 102a and the second surface 102b of the second vibration member 102. Also, the first vibration generator 211 may have a non-inverted structure with respect to the third vibration generator 221 and may have an inverted structure with respect to the fourth vibration generator 222. Also, the second vibration generator 212 may have an inverted structure with respect to the third vibration generator 221 and may have a non-inverted structure with respect to the fourth vibration generator 222. The first vibration generator 211, the second vibration generator 212, the third vibration generator 221, and the fourth vibration generator 222 may be configured to be displaced (or vibrated or driven) in the same direction. For example, vibration driving signals applied to the first vibration generator 211 and the third vibration generator 221 may have the same phase, and vibration driving signals applied to the second vibration generator 212 and the fourth vibration generator 222 may have same phases, but embodiments of the present disclosure are not limited thereto.

According to an embodiment of the present disclosure, the first space 100S between the first vibration member 101 and the second vibration member 102 may be provided as a sealed space. Therefore, the firs space 100S may maintain a constant impedance component (or an air impedance or an elastic impedance) acting on the first vibration member 101 or the second vibration member 102, based on sealed air. Therefore, one or more of peak and dip occurring in a reproduction frequency band of a sound (or a sound pressure level) generated based on a vibration of the first vibration member 101 or the second vibration member 102 may be reduced, and each of a highest sound pressure level and a lowest sound pressure level occurring in a reproduction frequency band of a sound (or a sound pressure level) generated based on a vibration of the first vibration member 101 or the second vibration member 102 may be reduced, and thus, the flatness of a sound pressure level may be enhanced.

According to an embodiment of the present disclosure, the first vibration generator 211 and the second vibration generator 212 provided in the first vibration member 101 and the third vibration generator 221 and the fourth vibration generator 222 provided in the second vibration member 102 may be disposed to overlap each other and may be configured to be displaced (or vibrated or driven) in the same direction, and thus, a sound characteristic and/or a sound pressure level characteristic of the low-pitched sound band generated based on vibrations of the first vibration generator 211, the second vibration generator 212, the third vibration generator 221, and the fourth vibration generator 222 may be enhanced.

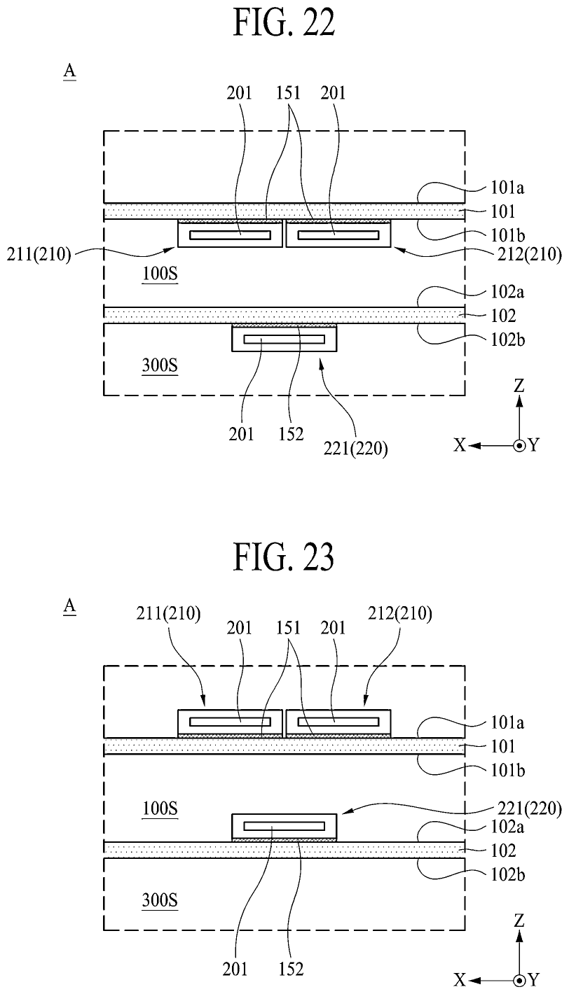

Referring to FIG. 22, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211 and a second vibration generator 212. Also, the second vibration generating apparatus 220 may include a single third vibration generator 221.

Each of the first vibration generator 211, the second vibration generator 212, and the third vibration generator 221 may include at least one vibration part 201. For example, the at least one vibration part 201 may be a piezoelectric vibration part or a piezoelectric-type vibration part. For example, each of the first vibration generator 211, the second vibration generator 212, and the third vibration generator 221 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration generator 211 and the second vibration generator 212 of the first vibration generating apparatus 210 may overlap the third vibration generator 221 of the second vibration generating apparatus 220.

Each of the first vibration generator 211 and the second vibration generator 212 may be disposed at a second surface 101b of the first vibration member 101. For example, the first vibration generator 211 and the second vibration generator 212 may be disposed at the second surface 101b of the first vibration member 101 so as to be spaced apart from each other in the first direction X. For example, each of the first vibration generator 211 and the second vibration generator 212 may be connected with or coupled to the second surface 101b of the first vibration member 101 by the first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. The first vibration generator 211 and the second vibration generator 212 may be disposed in the first space 100S between the first vibration member 101 and the second vibration member 102 and may be covered by the first vibration member 101, and thus, may be protected from an external impact.

The third vibration generator 221 may be disposed at the second surface 102b of the second vibration member 102. For example, the third vibration generator 221 may be connected with or coupled to the second surface 102b of the second vibration member 102 by the second adhesive member 152. The third vibration generator 221 may be disposed in the second space 300S between the second vibration member 102 and the enclosure 300 and may be covered by the enclosure 300, and thus, may be protected from an external impact.

For example, the first vibration generating apparatus 210 and the second vibration generating apparatus 220 may be disposed in different spaces. For example, the first vibration generating apparatus 210 may be disposed in the first space 100S. For example, the first vibration generating apparatus 210 may be disposed in the first space 100S between the first vibration member 101 and the second vibration member 102. For example, the second vibration generating apparatus 220 may be disposed in the second space 300S.

For example, the first vibration generating apparatus 210 and the second vibration generating apparatus 220 may be disposed with the second vibration member 102 therebetween. For example, the first vibration generating apparatus 210 and the second vibration generating apparatus 220 may be disposed to overlap each other with the second vibration member 102 therebetween.

The first vibration generating apparatus 210 and the second vibration generating apparatus 220 may be disposed to face the same direction. For example, the first vibration generating apparatus 210 and the second vibration generating apparatus 220 may be disposed to face a downward direction in the third direction Z.

The first vibration generator 211 and the second vibration generator 212 may be disposed to face the same direction. For example, the first vibration generator 211 and the second vibration generator 212 may be disposed to face a downward direction in the third direction Z.

The first vibration generator 211 and the second vibration generator 212 of the first vibration generating apparatus 210 may at least partially overlap the third vibration generator 221 of the second vibration generating apparatus 220. For example, the first vibration generator 211, the second vibration generator 212, and the third vibration generator 221 may have substantially the same size.

A center portion between the first vibration generator 211 and the second vibration generator 212 of the first vibration generating apparatus 210 may overlap a center portion of the third vibration generator 221 of the second vibration generating apparatus 220. For example, the first vibration generator 211 of the first vibration generating apparatus 210 may overlap a portion of a first region (or a left region) of the third vibration generator 221 of the second vibration generating apparatus 220. Also, the second vibration generator 212 of the first vibration generating apparatus 210 may overlap a portion of a second region (or a right region) of the third vibration generator 221 of the second vibration generating apparatus 220.

The first vibration generating apparatus 210 and the second vibration generating apparatus 220 may be identically disposed at the second surfaces 101b and 102b (or the rear surfaces) of the lower portion in the third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210 and a vibration driving signal applied to the second vibration generating apparatus 220 may have the same phase or may have a phase difference therebetween, but embodiments of the present disclosure are not limited thereto.

A vibration driving signal applied to the first vibration generator 211 of the first vibration generating apparatus 210 and a vibration driving signal applied to the second vibration generator 212 of the first vibration generating apparatus 210 may have the same phase or may have a phase difference therebetween. For example, the vibration driving signal applied to the first vibration generator 211 of the first vibration generating apparatus 210 and the vibration driving signal applied to the second vibration generator 212 of the first vibration generating apparatus 210 may have a phase difference therebetween caused by signal delay. For example, the vibration driving signal applied to the first vibration generator 211 of the first vibration generating apparatus 210 and the vibration driving signal applied to the second vibration generator 212 of the first vibration generating apparatus 210 may have the same phase as that of a vibration driving signal applied to the third vibration generator 221 of the second vibration generating apparatus 220. For example, the vibration driving signal applied to the first vibration generator 211 of the first vibration generating apparatus 210 and the vibration driving signal applied to the second vibration generator 212 of the first vibration generating apparatus 210 may have the same phase as or a phase difference with that of a vibration driving signal applied to the third vibration generator 221 of the second vibration generating apparatus 220. For example, the vibration driving signal applied to the first vibration generator 211 of the first vibration generating apparatus 210 and the vibration driving signal applied to the third vibration generator 221 of the second vibration generating apparatus 220 may have the same phase and may have a phase difference therebetween caused by signal delay. For example, the vibration driving signal applied to the second vibration generator 212 of the first vibration generating apparatus 210 and the vibration driving signal applied to the third vibration generator 221 of the second vibration generating apparatus 220 may have the same phase and may have a phase difference therebetween caused by signal delay.

According to an embodiment of the present disclosure, the first vibration generating apparatus 210 including the first vibration generator 211 and the second vibration generator 212 provided in the first vibration member 101 and the second vibration generating apparatus 220 including the third vibration generator 221 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 23, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211 and a second vibration generator 212. Also, the second vibration generating apparatus 220 may include a single third vibration generator 221.

Each of the first vibration generator 211, the second vibration generator 212, and the third vibration generator 221 may include at least one vibration part 201. For example, the at least one vibration part 201 may be a piezoelectric vibration part or a piezoelectric-type vibration part. For example, each of the first vibration generator 211, the second vibration generator 212, and the third vibration generator 221 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration apparatus 210 may overlap the third vibration generator 221 of the second vibration generating apparatus 220.

Each of the first vibration generator 211 and the second vibration generator 212 may be disposed at a first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by the first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto.

The third vibration generator 221 may be disposed at the first surface 102a of the second vibration member 102. For example, the third vibration generator 221 may be connected with or coupled to the first surface 102a of the second vibration member 102 by the second adhesive member 152. The third vibration generator 221 may be disposed in the first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in different spaces. For example, the second vibration generating apparatus 220 may be disposed in the first space 100S. For example, the second vibration generating apparatus 220 may be disposed in the first space 100S between the first vibration member 101 and the second vibration member 102.

For example, the first vibration generating apparatus 210 and the second vibration generating apparatus 220 may be disposed with the first vibration member 101 therebetween. For example, the first vibration generating apparatus 210 and the second vibration generating apparatus 220 may be disposed to overlap each other with the first vibration member 101 therebetween.

The first vibration generating apparatus 210 and the second vibration generating apparatus 220 may be disposed to face the same direction. For example, the first vibration generating apparatus 210 and the second vibration generating apparatus 220 may be disposed to face an upward direction in the third direction Z.

The first vibration generator 211 and the second vibration generator 212 may be disposed to face the same direction. For example, the first vibration generator 211 and the second vibration generator 212 may be disposed to face an upward direction in the third direction Z.

The first vibration generator 211 and the second vibration generator 212 of the first vibration generating apparatus 210 may at least partially overlap the third vibration generator 221 of the second vibration generating apparatus 220. For example, the first vibration generator 211, the second vibration generator 212, and the third vibration generator 221 may have substantially the same size.

A center portion between the first vibration generator 211 and the second vibration generator 212 of the first vibration generating apparatus 210 may overlap a center portion of the third vibration generator 221 of the second vibration generating apparatus 220. For example, the first vibration generator 211 of the first vibration generating apparatus 210 may overlap a portion of a first region (or a left region) of the third vibration generator 221 of the second vibration generating apparatus 220. Also, the second vibration generator 212 of the first vibration generating apparatus 210 may overlap a portion of a second region (or a right region) of the third vibration generator 221 of the second vibration generating apparatus 220.

The first vibration generating apparatus 210 and the second vibration generating apparatus 220 may be identically disposed at first surfaces 101a and 102a (or upper surfaces) of an upper portion in the third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210 and a vibration driving signal applied to the second vibration generating apparatus 220 may have the same phase or may have a phase difference therebetween. For example, the vibration driving signals respectively applied to the first vibration generating apparatus 210 and the second vibration generating apparatus 220 may be as described above with reference to FIG. 22, and thus, repeated descriptions thereof are omitted. According to an embodiment of the present disclosure, the first vibration generating apparatus 210 including the first vibration generator 211 and the second vibration generator 212 provided in the first vibration member 101 and the second vibration generating apparatus 220 including the third vibration generator 221 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

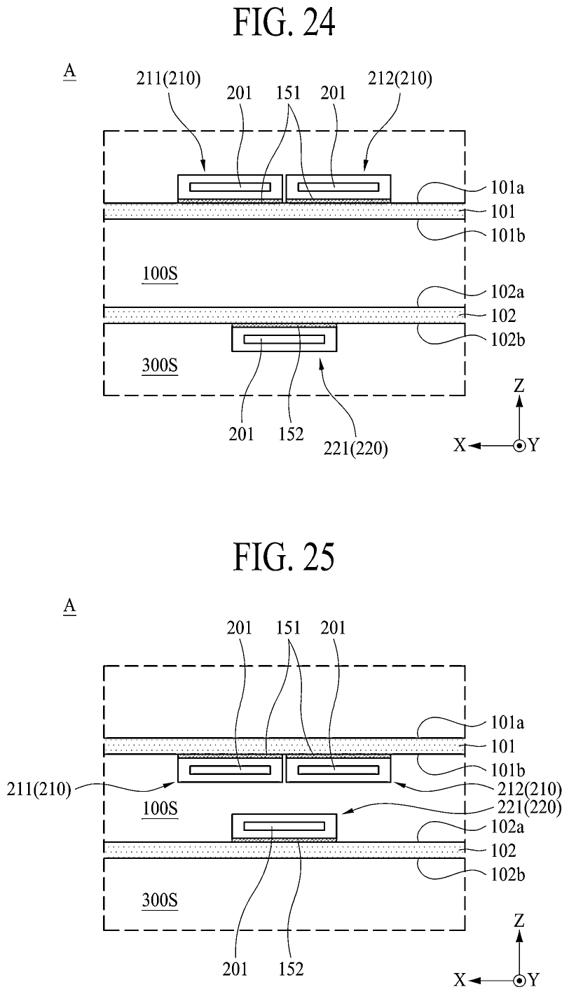

Referring to FIG. 24, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211 and a second vibration generator 212. Also, the second vibration generating apparatus 220 may include a single third vibration generator 221.

Each of the first vibration generator 211, the second vibration generator 212, and the third vibration generator 221 may include at least one vibration part 201. For example, the at least one vibration part 201 may be a piezoelectric vibration part or a piezoelectric-type vibration part. For example, each of the first vibration generator 211, the second vibration generator 212, and the third vibration generator 221 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration apparatus 210 may overlap the third vibration generator 221 of the second vibration generating apparatus 220.

The first vibration generating apparatus 210 may be disposed at the first surface 101a of the first vibration member 101. For example, the first vibration generating apparatus 210 may be connected with or coupled to the first surface 101a of the first vibration member 101 by the first adhesive member 151. The first vibration generating apparatus 210 may include the first vibration generator 211 and the second vibration generator 212, which are spaced apart from each other in the first direction X. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto.

The second vibration generating apparatus 220 may be disposed at the second surface 102b of the second vibration member 102. For example, the second vibration generating apparatus 220 may be connected with or coupled to the second surface 102b of the second vibration member 102 by the second adhesive member 152. The second vibration generating apparatus 220 may include a single third vibration generator 221. For example, the second vibration generating apparatus 220 may be disposed in the second space 300S between the second vibration member 102 and the enclosure 300 and may be covered by the enclosure 300, and thus, may be protected from an external impact.

For example, the first vibration generating apparatus 210 and the second vibration generating apparatus 220 may be disposed in different spaces. For example, the second vibration generating apparatus 220 may be disposed in the second space 300S.

For example, the first vibration generating apparatus 210 and the second vibration generating apparatus 220 may be disposed with the first vibration member 101 and the second vibration member 102 therebetween. For example, the first vibration generating apparatus 210 and the second vibration generating apparatus 220 may be disposed to overlap each other with the first vibration member 101 and the second vibration member 102 therebetween.

For example, the first vibration generating apparatus 210 and the second vibration generating apparatus 220 may be disposed with the first space 100S therebetween. For example, the first vibration generating apparatus 210 and the second vibration generating apparatus 220 may be disposed to overlap each other with the first space 100S therebetween.

The first vibration generating apparatus 210 and the second vibration generating apparatus 220 may be disposed to face different directions. For example, the first vibration generating apparatus 210 may be disposed to face an upward direction in the third direction Z. For example, the second vibration generating apparatus 220 may be disposed to face a downward direction in the third direction Z.

The first vibration generator 211 and the second vibration generator 212 may be disposed to face the same direction. For example, the first vibration generator 211 and the second vibration generator 212 may be disposed to face an upward direction in the third direction Z.

The first vibration generator 211 and the second vibration generator 212 of the first vibration generating apparatus 210 may at least partially overlap the third vibration generator 221 of the second vibration generating apparatus 220. For example, the first vibration generator 211, the second vibration generator 212, and the third vibration generator 221 may have substantially the same size.

A center portion between the first vibration generator 211 and the second vibration generator 212 of the first vibration generating apparatus 210 may overlap a center portion of the third vibration generator 221 of the second vibration generating apparatus 220. For example, the first vibration generator 211 of the first vibration generating apparatus 210 may overlap a portion of a first region (or a left region) of the third vibration generator 221 of the second vibration generating apparatus 220. Also, the second vibration generator 212 of the first vibration generating apparatus 210 may overlap a portion of a second region (or a right region) of the third vibration generator 221 of the second vibration generating apparatus 220.

The first vibration generating apparatus 210 and the second vibration generating apparatus 220 may be disposed at the first surface 101a (or the upper surface) and the second surface 102b (or the rear surface) of opposite sides in the third direction Z in the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220 may have opposite phases or may have a phase difference therebetween.

A vibration driving signal applied to the first vibration generator 211 of the first vibration generating apparatus 210 and a vibration driving signal applied to the second vibration generator 212 of the first vibration generating apparatus 210 may have the same phase or may have a phase difference therebetween. For example, the vibration driving signal applied to the first vibration generator 211 of the first vibration generating apparatus 210 and the vibration driving signal applied to the second vibration generator 212 of the first vibration generating apparatus 210 may have a phase difference therebetween caused by signal delay. For example, the vibration driving signal applied to the first vibration generator 211 of the first vibration generating apparatus 210 and the vibration driving signal applied to the second vibration generator 212 of the first vibration generating apparatus 210 may have a phase opposite to that of a vibration driving signal applied to the third vibration generator 221 of the second vibration generating apparatus 220. For example, the vibration driving signal applied to the first vibration generator 211 of the first vibration generating apparatus 210 and the vibration driving signal applied to the second vibration generator 212 of the first vibration generating apparatus 210 may have a phase opposite to or a phase difference with that of a vibration driving signal applied to the third vibration generator 221 of the second vibration generating apparatus 220. For example, the vibration driving signal applied to the first vibration generator 211 of the first vibration generating apparatus 210 and the vibration driving signal applied to the third vibration generator 221 of the second vibration generating apparatus 220 may have opposite phases or may have a phase difference therebetween caused by signal delay. For example, the vibration driving signal applied to the second vibration generator 212 of the first vibration generating apparatus 210 and the vibration driving signal applied to the third vibration generator 221 of the second vibration generating apparatus 220 may have a phase opposite to the vibration driving signal applied to the third vibration generator 221 of the second vibration generating apparatus 220 and may have a phase difference therebetween caused by signal delay.

According to an embodiment of the present disclosure, the first vibration generating apparatus 210 including the first vibration generator 211 and the second vibration generator 212 provided in the first vibration member 101 and the second vibration generating apparatus 220 including the third vibration generator 221 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 25, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211 and a second vibration generator 212. Also, the second vibration generating apparatus 220 may include a single third vibration generator 221.

Each of the first vibration generator 211, the second vibration generator 212, and the third vibration generator 221 may include at least one vibration part 201. For example, the at least one vibration part 201 may be a piezoelectric vibration part or a piezoelectric-type vibration part. For example, each of the first vibration generator 211, the second vibration generator 212, and the third vibration generator 221 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration apparatus 210 may overlap the third vibration generator 221 of the second vibration generating apparatus 220.

The first vibration generating apparatus 210 may be disposed at the second surface 101b of the first vibration member 101. For example, the first vibration generating apparatus 210 may be connected with or coupled to the second surface 101b of the first vibration member 101 by the first adhesive member 151. The first vibration generating apparatus 210 may include the first vibration generator 211 and the second vibration generator 212. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. For example, the first vibration generating apparatus 210 may be disposed in the first space 100S between the first vibration member 101 and the second vibration member 102 and may be covered by the first vibration member 101, and thus, may be protected from an external impact.

The second vibration generating apparatus 220 may be disposed at the first surface 102a of the second vibration member 102. For example, the second vibration generating apparatus 220 may be connected with or coupled to the first surface 102a of the second vibration member 102 by the second adhesive member 152. The second vibration generating apparatus 220 may include a single third vibration generator 221. For example, the second vibration generating apparatus 220 may be disposed in the first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in the same space. For example, the first vibration generating apparatus 210 and the second vibration generating apparatus 220 may be disposed in the first space 100S. For example, the first vibration generating apparatus 210 and the second vibration generating apparatus 220 may be disposed to face each other in the first space 100S. For example, the first vibration generating apparatus 210 and the second vibration generating apparatus 220 may be disposed to overlap each other in the first space 100S.

For example, the first vibration generating apparatus 210 and the second vibration generating apparatus 220 may be disposed to face different directions. For example, the first vibration generating apparatus 210 may be disposed to face a downward direction in the third direction Z. For example, the second vibration generating apparatus 220 may be disposed to face an upward direction in the third direction Z.

The first vibration generator 211 and the second vibration generator 212 may be disposed to face the same direction. For example, the first vibration generator 211 and the second vibration generator 212 may be disposed to face a downward direction in the third direction Z.

The first vibration generator 211 and the second vibration generator 212 of the first vibration generating apparatus 210 may at least partially overlap the third vibration generator 221 of the second vibration generating apparatus 220. For example, the first vibration generator 211, the second vibration generator 212, and the third vibration generator 221 may have substantially the same size.

A center portion between the first vibration generator 211 and the second vibration generator 212 of the first vibration generating apparatus 210 may overlap a center portion of the third vibration generator 221 of the second vibration generating apparatus 220. For example, the first vibration generator 211 of the first vibration generating apparatus 210 may overlap a portion of a first region (or a left region) of the third vibration generator 221 of the second vibration generating apparatus 220. Also, the second vibration generator 212 of the first vibration generating apparatus 210 may overlap a portion of a second region (or a right region) of the third vibration generator 221 of the second vibration generating apparatus 220.

The first vibration generating apparatus 210 and the second vibration generating apparatus 220 may be disposed at the second surface 101b (or the rear surface) and the first surface 102a (or the upper surface) of the opposite sides in the third direction Z in the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220 may have opposite phases, or may have a phase difference therebetween. For example, the vibration driving signals respectively applied to the first vibration generating apparatus 210 and the second vibration generating apparatus 220 may be as described above with reference to FIG. 24, and thus, repeated descriptions thereof are omitted.

According to an embodiment of the present disclosure, the first vibration generating apparatus 210 including the first vibration generator 211 and the second vibration generator 212 provided in the first vibration member 101 and the second vibration generating apparatus 220 including the third vibration generator 221 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

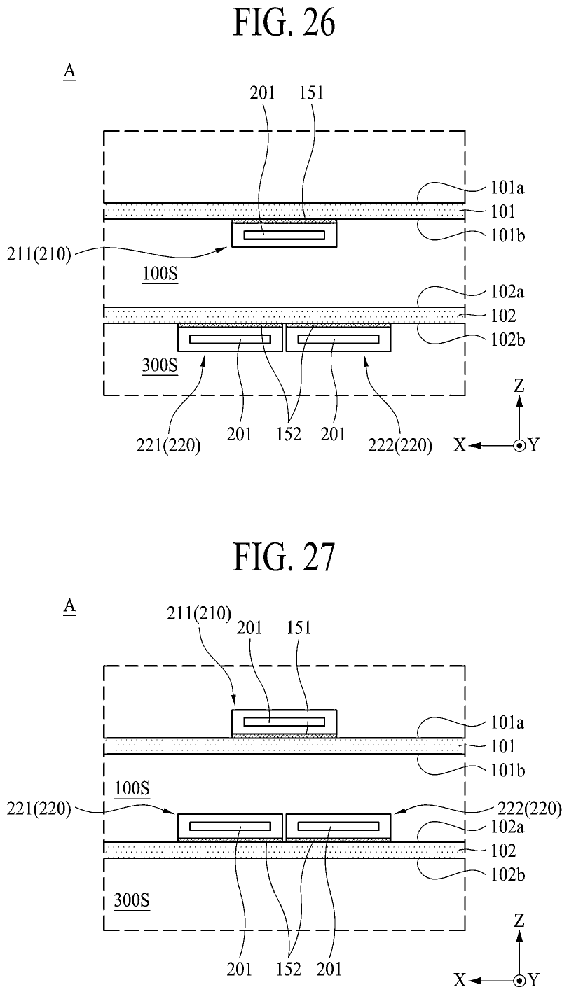

Referring to FIG. 26, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a single first vibration generator 211. Also, the second vibration generating apparatus 220 may include a second vibration generator 221 and a third vibration generator 222.

Each of the first vibration generator 211, the second vibration generator 221, and the third vibration generator 222 may include at least one vibration part 201. For example, the at least one vibration part 201 may be a piezoelectric vibration part or a piezoelectric-type vibration part. For example, each of the first vibration generator 211, the second vibration generator 221, and the third vibration generator 222 may include a vibration part 201 which is individually configured.

The first vibration generating apparatus 210 and the second vibration generating apparatus 220 may at least partially overlap each other. For example, the first vibration generating apparatus 210 may overlap at least a portion of the second vibration generating apparatus 220. For example, the first vibration generator 211 of the first vibration generating apparatus 210 may overlap at least a portion of each of the second vibration generator 221 and the third vibration generator 222 of the second vibration generating apparatus 220.

The first vibration generating apparatus 210 may be disposed at the second surface 101b of the first vibration member 101. For example, the first vibration generating apparatus 210 may be connected with or coupled to the second surface 101b of the first vibration member 101 by the first adhesive member 151. The first vibration generating apparatus 210 may include a single first vibration generator 211. For example, the first vibration generating apparatus 210 may be disposed in the first space 100S between the first vibration member 101 and the second vibration member 102 and may be covered by the first vibration member 101, and thus, may be protected from an external impact.

The second vibration generating apparatus 220 may be disposed at the second surface 102b of the second vibration member 102. For example, the second vibration generating apparatus 220 may be connected with or coupled to the second surface 102b of the second vibration member 102 by the second adhesive member 152. The second vibration generating apparatus 220 may include the second vibration generator 221 and the third vibration generator 222. For example, the second adhesive member 152 may be individually disposed in each of the second vibration generator 221 and the third vibration generator 222, or may be disposed in common in the second vibration generator 221 and the third vibration generator 222 which are provided as one body, but embodiments of the present disclosure are not limited thereto. For example, the second vibration generating apparatus 220 may be disposed in the second space 300S between the second vibration member 102 and the enclosure 300 and may be covered by the enclosure 300, and thus, may be protected from an external impact.

For example, the first vibration generating apparatus 210 and the second vibration generating apparatus 220 may be disposed in different spaces. For example, the first vibration generating apparatus 210 may be disposed in the first space 300S. For example, the second vibration generating apparatus 220 may be disposed in the second space 300S.

For example, the first vibration generating apparatus 210 and the second vibration generating apparatus 220 may be disposed with the second vibration member 102 therebetween. For example, the first vibration generating apparatus 210 and the second vibration generating apparatus 220 may be disposed to overlap each other with the second vibration member 102 therebetween.

The first vibration generating apparatus 210 and the second vibration generating apparatus 220 may be disposed to face the same direction. For example, the first vibration generating apparatus 210 and the second vibration generating apparatus 220 may be disposed to face a downward direction in the third direction Z.

For example, the second vibration generator 221 and the third vibration generator 222 may be disposed to face the same direction. For example, the second vibration generator 221 and the third vibration generator 222 may be disposed to face a downward direction in the third direction Z.

The first vibration generator 211 of the first vibration generating apparatus 210 may at least partially overlap the second vibration generator 221 and the third vibration generator 222 of the second vibration generating apparatus 220. For example, the first vibration generator 211, the second vibration generator 221, and the third vibration generator 222 may have substantially the same size.

A center portion of the first vibration generator 211 of the first vibration generating apparatus 210 may overlap a center portion between the second vibration generator 221 and the third vibration generator 222 of the second vibration generating apparatus 220. For example, a portion of a first region (or a left region) of the first vibration generator 211 of the first vibration generating apparatus 210 may overlap the second vibration generator 221 of the second vibration generating apparatus 220. Also, a portion of a second region (or a right region) of the first vibration generator 211 of the first vibration generating apparatus 210 may overlap the third vibration generator 222 of the second vibration generating apparatus 220.

The first vibration generating apparatus 210 and the second vibration generating apparatus 220 may be identically disposed at the second surfaces 101b and 102b (or the rear surfaces) of the lower portion in the third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210 and a vibration driving signal applied to the second vibration generating apparatus 220 may have the same phase or may have a phase difference therebetween, but embodiments of the present disclosure are not limited thereto.

Vibration driving signals respectively applied to the second vibration generator 221 and the third vibration generator 222 of the second vibration generating apparatus 220 may have the same phase or may have a phase difference therebetween. For example, the vibration driving signals respectively applied to the second vibration generator 221 and the third vibration generator 222 of the second vibration generating apparatus 220 may have a phase difference therebetween caused by signal delay. For example, the vibration driving signals respectively applied to the second vibration generator 221 and the third vibration generator 222 of the second vibration generating apparatus 220 may have the same phase as that of a vibration driving signal applied to the first vibration generator 211 of the first vibration generating apparatus 210. For example, at least one of the vibration driving signal applied to the second vibration generator 221 of the second vibration generating apparatus 220 and the vibration driving signal applied to the third vibration generator 222 of the second vibration generating apparatus 220 may have the same phase as or a phase difference with that of the vibration driving signal applied to the first vibration generator 211 of the first vibration generating apparatus 210. For example, the vibration driving signal applied to the first vibration generator 211 of the first vibration generating apparatus 210 and the vibration driving signal applied to the second vibration generator 221 of the second vibration generating apparatus 220 may have the same phase or may have a phase difference therebetween caused by signal delay. For example, the vibration driving signal applied to the first vibration generator 211 of the first vibration generating apparatus 210 and the vibration driving signal applied to the third vibration generator 222 of the second vibration generating apparatus 220 may have the same phase or may have a phase difference therebetween caused by signal delay.

According to an embodiment of the present disclosure, the first vibration generating apparatus 210 including the first vibration generator 211 provided in the first vibration member 101 and the second vibration generating apparatus 220) including the second vibration generator 221 and the third vibration generator 222 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 27, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a single first vibration generator 211. Also, the second vibration generating apparatus 220 may include a second vibration generator 221 and a third vibration generator 222.

Each of the first vibration generator 211, the second vibration generator 221, and the third vibration generator 222 may include at least one vibration part 201. For example, the at least one vibration part 201 may be a piezoelectric vibration part or a piezoelectric-type vibration part. For example, each of the first vibration generator 211, the second vibration generator 221, and the third vibration generator 222 may include a vibration part 201 which is individually configured.

The first vibration generating apparatus 210 and the second vibration generating apparatus 220 may at least partially overlap each other. For example, the first vibration generating apparatus 210 may overlap at least a portion of the second vibration generating apparatus 220. For example, the first vibration generator 211 of the first vibration generating apparatus 210 may overlap at least a portion of each of the second vibration generator 221 and the third vibration generator 222 of the second vibration generating apparatus 220.

The first vibration generating apparatus 210 may be disposed at the first surface 101a of the first vibration member 101. For example, the first vibration generating apparatus 210 may be connected with or coupled to the first surface 101a of the first vibration member 101 by the first adhesive member 151. The first vibration generating apparatus 210 may include a single first vibration generator 211.

The second vibration generating apparatus 220 may be disposed at the first surface 102a of the second vibration member 102. For example, the second vibration generating apparatus 220 may be connected with or coupled to the first surface 102a of the second vibration member 102 by the second adhesive member 152. The second vibration generating apparatus 220 may include the second vibration generator 221 and the third vibration generator 222. For example, the second adhesive member 152 may be individually disposed in each of the second vibration generator 221 and the third vibration generator 222, or may be disposed in common in the second vibration generator 221 and the third vibration generator 222 which are provided as one body, but embodiments of the present disclosure are not limited thereto. For example, the second vibration generating apparatus 220 may be disposed in the first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in different spaces. For example, the second vibration generating apparatus 220 may be disposed in the first space 100S.

For example, the first vibration generating apparatus 210 and the second vibration generating apparatus 220 may be disposed with the first vibration member 101 therebetween. For example, the first vibration generating apparatus 210 and the second vibration generating apparatus 220 may be disposed to overlap each other with the first vibration member 101 therebetween.

The first vibration generating apparatus 210 and the second vibration generating apparatus 220 may be disposed to face the same direction. For example, the first vibration generating apparatus 210 and the second vibration generating apparatus 220 may be disposed to face an upward direction in the third direction Z.

The second vibration generator 221 and the third vibration generator 222 may be disposed to face the same direction. For example, the second vibration generator 221 and the third vibration generator 222 may be disposed to face an upward direction in the third direction Z.

The first vibration generator 211 of the first vibration generating apparatus 210 may at least partially overlap the second vibration generator 221 and the third vibration generator 222 of the second vibration generating apparatus 220. For example, the first vibration generator 211, the second vibration generator 221, and the third vibration generator 222 may have substantially the same size.

A center portion of the first vibration generator 211 of the first vibration generating apparatus 210 may overlap a center portion between the second vibration generator 221 and the third vibration generator 222 of the second vibration generating apparatus 220. For example, a portion of a first region (or a left region) of the first vibration generator 211 of the first vibration generating apparatus 210 may overlap the second vibration generator 221 of the second vibration generating apparatus 220. Also, a portion of a second region (or a right region) of the first vibration generator 211 of the first vibration generating apparatus 210 may overlap the third vibration generator 222 of the second vibration generating apparatus 220.

The first vibration generating apparatus 210 and the second vibration generating apparatus 220 may be identically disposed at first surfaces 101a and 102a (or upper surfaces) of an upper side in the third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210 and a vibration driving signal applied to the second vibration generating apparatus 220 may have the same phase, or may have a phase difference therebetween. For example, the vibration driving signals respectively applied to the first vibration generating apparatus 210 and the second vibration generating apparatus 220 may be as described above with reference to FIG. 26, and thus, repeated descriptions thereof are omitted.

According to an embodiment of the present disclosure, the first vibration generating apparatus 210 including the first vibration generator 211 provided in the first vibration member 101 and the second vibration generating apparatus 220 including the second vibration generator 221 and the third vibration generator 222 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

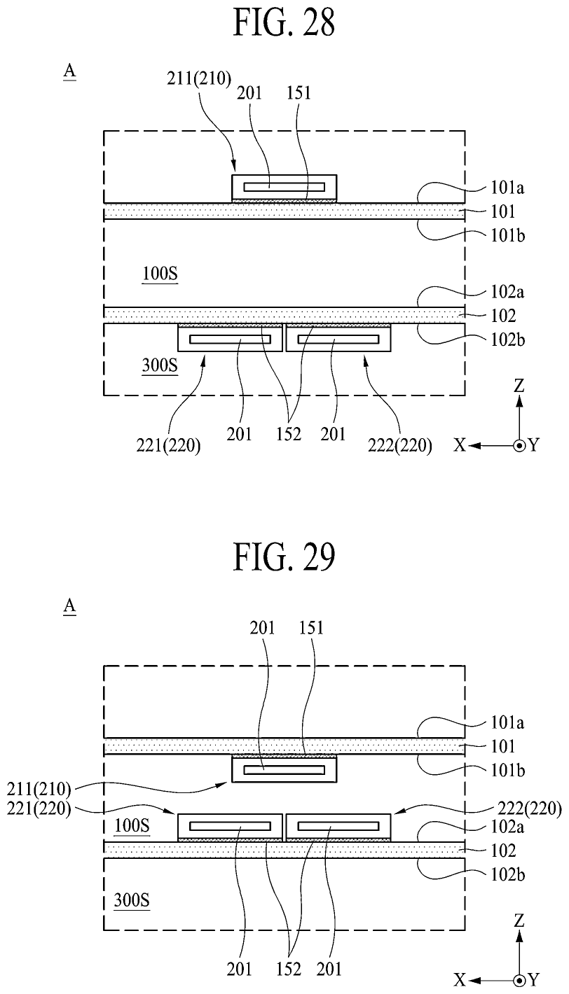

Referring to FIG. 28, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a single first vibration generator 211. Also, the second vibration generating apparatus 220 may include a second vibration generator 221 and a third vibration generator 222.

Each of the first vibration generator 211, the second vibration generator 221, and the third vibration generator 222 may include at least one vibration part 201. For example, the at least one vibration part 201 may be a piezoelectric vibration part or a piezoelectric-type vibration part. For example, each of the first vibration generator 211, the second vibration generator 221, and the third vibration generator 222 may include a vibration part 201 which is individually configured.

The first vibration generating apparatus 210 and the second vibration generating apparatus 220 may at least partially overlap each other. For example, the first vibration generating apparatus 210 may overlap at least a portion of the second vibration generating apparatus 220. For example, the first vibration generator 211 of the first vibration generating apparatus 210 may overlap at least a portion of each of the second vibration generator 221 and the third vibration generator 222 of the second vibration generating apparatus 220.

The first vibration generating apparatus 210 may be disposed at the first surface 101a of the first vibration member 101. For example, the first vibration generating apparatus 210 may be connected with or coupled to the first surface 101a of the first vibration member 101 by the first adhesive member 151. The first vibration generating apparatus 210 may include a single first vibration generator 211.

The second vibration generating apparatus 220 may be disposed at the second surface 102b of the second vibration member 102. For example, the second vibration generating apparatus 220 may be connected with or coupled to the second surface 102b of the second vibration member 102 by the second adhesive member 152. The second vibration generating apparatus 220 may include the second vibration generator 221 and the third vibration generator 222. For example, the second adhesive member 152 may be individually disposed in each of the second vibration generator 221 and the third vibration generator 222, or may be disposed in common in the second vibration generator 221 and the third vibration generator 222 which are provided as one body, but embodiments of the present disclosure are not limited thereto. For example, the second vibration generating apparatus 220 may be disposed in the second space 300S between the second vibration member 102 and the enclosure 300 and may be covered by the enclosure 300, and thus, may be protected from an external impact.

For example, the first vibration generating apparatus 210 and the second vibration generating apparatus 220 may be disposed in different spaces. For example, the second vibration generating apparatus 220 may be disposed in the second space 300S.

For example, the first vibration generating apparatus 210 and the second vibration generating apparatus 220 may be disposed with the first vibration member 101 and the second vibration member 102 therebetween. For example, the first vibration generating apparatus 210 and the second vibration generating apparatus 220 may be disposed to overlap each other with the first vibration member 101 and the second vibration member 102 therebetween.

For example, the first vibration generating apparatus 210 and the second vibration generating apparatus 220 may be disposed with the first space 100S therebetween. For example, the first vibration generating apparatus 210 and the second vibration generating apparatus 220 may be disposed to overlap each other with the first space 100S therebetween.

The first vibration generating apparatus 210 and the second vibration generating apparatus 220 may be disposed to face different directions. For example, the first vibration generating apparatus 210 may be disposed to face an upward direction in the third direction Z. For example, the second vibration generating apparatus 220 may be disposed to face a downward direction in the third direction Z.

For example, the second vibration generator 221 and the third vibration generator 222 may be disposed to face the same direction. For example, the second vibration generator 221 and the third vibration generator 222 may be disposed to face a downward direction in the third direction Z.

The first vibration generator 211 of the first vibration generating apparatus 210 may at least partially overlap the second vibration generator 221 and the third vibration generator 222 of the second vibration generating apparatus 220. For example, the first vibration generator 211, the second vibration generator 221, and the third vibration generator 222 may have substantially the same size.

A center portion of the first vibration generator 211 of the first vibration generating apparatus 210 may overlap a center portion between the second vibration generator 221 and the third vibration generator 222 of the second vibration generating apparatus 220. For example, a portion of a first region (or a left region) of the first vibration generator 211 of the first vibration generating apparatus 210 may overlap the second vibration generator 221 of the second vibration generating apparatus 220. Also, a portion of a second region (or a right region) of the first vibration generator 211 of the first vibration generating apparatus 210 may overlap the third vibration generator 222 of the second vibration generating apparatus 220.

The first vibration generating apparatus 210 and the second vibration generating apparatus 220 may be disposed at the first surface 101a (or the upper surface) and the second surface 102b (or the rear surface) of opposite sides in the third direction Z in the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220 may have opposite phases or may have a phase difference therebetween.

The vibration driving signals respectively applied to the second vibration generator 221 and the third vibration generator 222 of the second vibration generating apparatus 220 may have the same phase or may have a phase difference therebetween. For example, the vibration driving signals respectively applied to the second vibration generator 221 and the third vibration generator 222 of the second vibration generating apparatus 220 may have a phase difference therebetween caused by signal delay. For example, the vibration driving signals respectively applied to the second vibration generator 221 and the third vibration generator 222 of the second vibration generating apparatus 220 may have a phase opposite to that of a vibration driving signal applied to the first vibration generator 211 of the first vibration generating apparatus 210. For example, at least one of the vibration driving signal applied to the second vibration generator 221 of the second vibration generating apparatus 220 and the vibration driving signal applied to the third vibration generator 222 of the second vibration generating apparatus 220 may have a phase opposite to or a phase difference with that of the vibration driving signal applied to the first vibration generator 211 of the first vibration generating apparatus 210. For example, the vibration driving signal applied to the first vibration generator 211 of the first vibration generating apparatus 210 and the vibration driving signal applied to the second vibration generator 221 of the second vibration generating apparatus 220 may have opposite phases or may have a phase difference therebetween caused by signal delay. For example, the vibration driving signal applied to the first vibration generator 211 of the first vibration generating apparatus 210 and the vibration driving signal applied to the third vibration generator 222 of the second vibration generating apparatus 220 may have opposite phases or may have a phase difference therebetween caused by signal delay.

According to an embodiment of the present disclosure, the first vibration generating apparatus 210 including the first vibration generator 211 provided in the first vibration member 101 and the second vibration generating apparatus 220 including the second vibration generator 221 and the third vibration generator 222 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 29, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a single first vibration generator 211. Also, the second vibration generating apparatus 220 may include a second vibration generator 221 and a third vibration generator 222.

Each of the first vibration generator 211, the second vibration generator 221, and the third vibration generator 222 may include at least one vibration part 201. For example, the at least one vibration part 201 may be a piezoelectric vibration part or a piezoelectric-type vibration part. For example, each of the first vibration generator 211, the second vibration generator 221, and the third vibration generator 222 may include a vibration part 201 which is individually configured.

The first vibration generating apparatus 210 and the second vibration generating apparatus 220 may at least partially overlap each other. For example, the first vibration generating apparatus 210 may overlap at least a portion of the second vibration generating apparatus 220. For example, the first vibration generator 211 of the first vibration generating apparatus 210 may overlap at least a portion of each of the second vibration generator 221 and the third vibration generator 222 of the second vibration generating apparatus 220.

The first vibration generating apparatus 210 may be disposed at the second surface 101b of the first vibration member 101. For example, the first vibration generating apparatus 210 may be connected with or coupled to the second surface 101b of the first vibration member 101 by the first adhesive member 151. The first vibration generating apparatus 210 may include a single first vibration generator 211. For example, the first vibration generating apparatus 210 may be disposed in the first space 100S between the first vibration member 101 and the second vibration member 102 and may be covered by the first vibration member 101, and thus, may be protected from an external impact.

The second vibration generating apparatus 220 may be disposed at the first surface 102a of the second vibration member 102. For example, the second vibration generating apparatus 220 may be connected with or coupled to the first surface 102a of the second vibration member 102 by the second adhesive member 152. The second vibration generating apparatus 220 may include the second vibration generator 221 and the third vibration generator 222. For example, the second adhesive member 152 may be individually disposed in each of the second vibration generator 221 and the third vibration generator 222, or may be disposed in common in the second vibration generator 221 and the third vibration generator 222 which are provided as one body, but embodiments of the present disclosure are not limited thereto. For example, the second vibration generating apparatus 220 may be disposed in the first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in the same space. For example, the first vibration generating apparatus 210 and the second vibration generating apparatus 220 may be disposed in the first space 100S. For example, the first vibration generating apparatus 210 and the second vibration generating apparatus 220 may be disposed to face each other. For example, the first vibration generating apparatus 210 and the second vibration generating apparatus 220 may be disposed to face each other in the first space 100S. For example, the first vibration generating apparatus 210 and the second vibration generating apparatus 220 may be disposed to overlap each other in the first space 100S.

The first vibration generating apparatus 210 and the second vibration generating apparatus 220 may be disposed to face different directions. For example, the first vibration generating apparatus 210 may be disposed to face a downward direction in the third direction Z. For example, the second vibration generating apparatus 220 may be disposed to face an upward direction in the third direction Z.

The first vibration generator 211 of the first vibration generating apparatus 210 may at least partially overlap the second vibration generator 221 and the third vibration generator 222 of the second vibration generating apparatus 220. For example, the first vibration generator 211, the second vibration generator 221, and the third vibration generator 222 may have substantially the same size.

A center portion of the first vibration generator 211 of the first vibration generating apparatus 210 may overlap a center portion between the second vibration generator 221 and the third vibration generator 222 of the second vibration generating apparatus 220. For example, a portion of a first region (or a left region) of the first vibration generator 211 of the first vibration generating apparatus 210 may overlap the second vibration generator 221 of the second vibration generating apparatus 220. Also, a portion of a second region (or a right region) of the first vibration generator 211 of the first vibration generating apparatus 210 may overlap the third vibration generator 222 of the second vibration generating apparatus 220).

The first vibration generating apparatus 210 and the second vibration generating apparatus 220 may be disposed at the second surface 101b (or the rear surface) and the first surface 102a (or the upper surface) of the opposite sides in the third direction Z in the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220 may have opposite phases, or may have a phase difference therebetween. For example, the vibration driving signals respectively applied to the first vibration generating apparatus 210 and the second vibration generating apparatus 220) may be as described above with reference to FIG. 25, and thus, repeated descriptions thereof are omitted.

According to an embodiment of the present disclosure, the first vibration generating apparatus 210 including the first vibration generator 211 provided in the first vibration member 101 and the second vibration generating apparatus 220 including the second vibration generator 221 and the third vibration generator 222 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

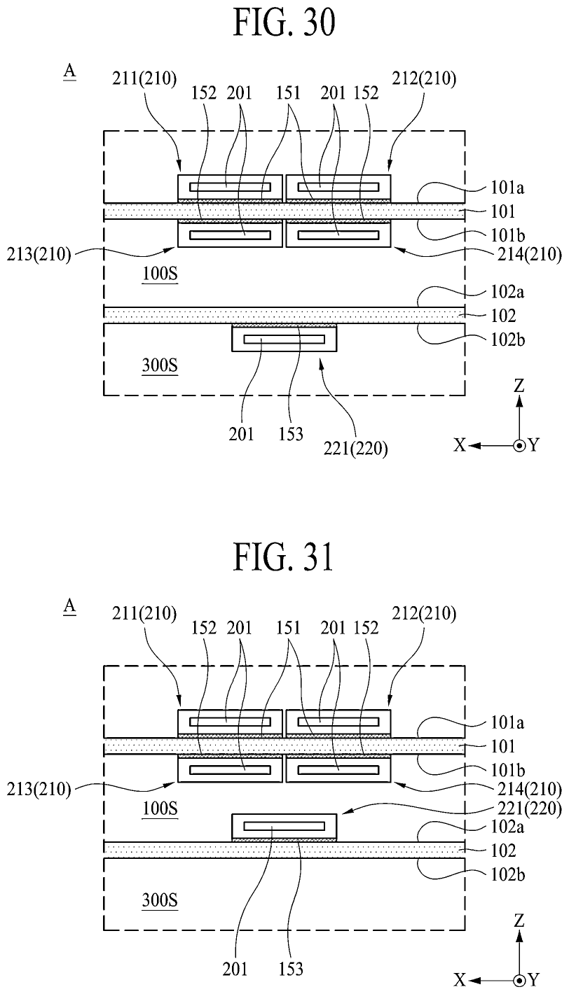

Referring to FIG. 30, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a single fifth vibration generator 221.

Each of the first vibration generator 211, the second vibration generator 212, the third vibration generator 213, the fourth vibration generator 214, and the fifth vibration generator 221 may include at least one vibration part 201. For example, the at least one vibration part 201 may be a piezoelectric vibration part or a piezoelectric-type vibration part. For example, each of the first vibration generator 211, the second vibration generator 212, the third vibration generator 213, the fourth vibration generator 214, and the fifth vibration generator 221 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration generator 211, the second vibration generator 212, the third vibration generator 213, and the fourth vibration generator 214 may overlap the fifth vibration generator 221 of the second vibration generating apparatus 220.

Each of the first vibration generator 211 and the second vibration generator 212 may be disposed at a first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by a first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at a second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by a second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the first and second vibration generators 211 and 212 and the third and fourth vibration generators 213 and 214 may be disposed to overlap each other with the first vibration member 101 therebetween.

The second vibration generating apparatus 220 may be disposed at the second surface 102b of the second vibration member 102. For example, the second vibration generating apparatus 220 may be connected with or coupled to the second surface 102b of the second vibration member 102 by a third adhesive member 153. The second vibration generating apparatus 220 may include a single fifth vibration generator 221. For example, the second vibration generating apparatus 220 may be disposed in a second space 300S between the second vibration member 102 and an enclosure 300 and may be covered by the enclosure 300, and thus, may be protected from an external impact.

For example, the first vibration generating apparatus 210 and the second vibration generating apparatus 220 may be disposed in different spaces. For example, the first vibration generating apparatus 210 may be disposed in a first space 100S. For example, the third vibration generator 213 and the fourth vibration generator 214 may be disposed in the first space 100S. For example, the second vibration generating apparatus 220 may be disposed in the second space 300S.

For example, the first and second vibration generators 211 and 212 and the third and fourth vibration generators 213 and 214 may be disposed in different spaces. For example, the third vibration generator 213 and the fourth vibration generator 214 may be disposed in the first space 100S. For example, the first and second vibration generators 211 and 212 and the third and fourth vibration generators 213 and 214 may be disposed with the first vibration member 101 therebetween. For example, the first and second vibration generators 211 and 212 and the third and fourth vibration generators 213 and 214 may be disposed to overlap each other with the first vibration member 101 therebetween.

For example, the third and vibration generators 213 and 214 and the second vibration generating apparatus 220 may be disposed with the second vibration member 102 therebetween. For example, the third and vibration generators 213 and 214 and the second vibration generating apparatus 220 may be disposed to overlap each other with the second vibration member 102 therebetween.

The first vibration generating apparatus 210 and the second vibration generating apparatus 220 may be disposed to face the same direction. For example, the third and vibration generators 213 and 214 and the second vibration generating apparatus 220 may be disposed to face a downward direction in a third direction Z.

The first vibration generating apparatus 210 and the second vibration generating apparatus 220 may be disposed to face different directions. For example, the first vibration generator 211 and the second vibration generator 212 may be disposed to face an upward direction in the third direction Z. For example, the second vibration generating apparatus 220 may be disposed to face a downward direction in the third direction Z.

The first vibration generating apparatus 210 may be disposed in a different direction. For example, the first and second vibration generators 211 and 212 and the third and fourth vibration generators 213 and 214 may be disposed to face different directions. For example, the first vibration generator 211 and the second vibration generator 212 may be disposed to face an upward direction in the third direction Z. For example, the third vibration generator 213 and the fourth vibration generator 214 may be disposed to face a downward direction in the third direction Z.

The first and second vibration generators 211 and 212 and the third and fourth vibration generators 213 and 214 may at least partially overlap the fifth vibration generator 221 of the second vibration generating apparatus 220. For example, the first vibration generator 211, the second vibration generator 212, the third vibration generator 213, the fourth vibration generator 214, and the fifth vibration generator 221 may have substantially the same size.

A center portion between the first vibration generator 211 and the second vibration generator 212 may overlap a center portion between the third vibration generator 213 and the fourth vibration generator 214. A center portion between the first and second vibration generators 211 and 212 and the third and fourth vibration generators 213 and 214 may overlap a center portion of the fifth vibration generator 221 of the second vibration generating apparatus 220. For example, the first vibration generator 211 and the third vibration generator 213 may overlap a portion of a first region (or a left region) of the fifth vibration generator 221 of the second vibration generating apparatus 220. Also, the second vibration generator 212 and the fourth vibration generator 214 may overlap a portion of a second region (or a right region) of the fifth vibration generator 221 of the second vibration generating apparatus 220.

The first and second vibration generators 211 and 212 and the third and fourth vibration generators 213 and 214 may have an inverted structure at each of the first surface 101a and the second surface 101b of the first vibration member 101. Also, the second vibration generating apparatus 220 may have an inverted structure with respect to one of the first and second vibration generators 211 and 212 and the third and fourth vibration generators 213 and 214 and may have a non-inverted structure with respect to the other of the first and second vibration generators 211 and 212 and the third and fourth vibration generators 213 and 214. For example, the second vibration generating apparatus 220 may have an inverted structure with respect to the first and second vibration generators 211 and 212 and may have a non-inverted structure with respect to the third and fourth vibration generators 213 and 214.

The first vibration generator 211, the second vibration generator 212, the third vibration generator 213, the fourth vibration generator 214, and the fifth vibration generator 221 may be configured to be displaced (or vibrated or driven) in the same direction. For example, a vibration driving signal applied to the first vibration generator 211 and the second vibration generator 212 may have the phase opposite to or a phase difference with that of a vibration driving signal applied to the fifth vibration generator 221 of the second vibration generating apparatus 220. A vibration driving signal applied to the third vibration generator 213 and the fourth vibration generator 214 may have the same phase as or a phase difference with that of the vibration driving signal applied to the fifth vibration generator 221 of the second vibration generating apparatus 220.

A vibration driving signal applied to the first vibration generator 211 and a vibration driving signal applied to the second vibration generator 212 may have the same phase or may have a phase difference therebetween. Also, a vibration driving signal applied to the third vibration generator 213 and a vibration driving signal applied to the fourth vibration generator 214 may have the same phase or may have a phase difference therebetween. Also, the vibration driving signals respectively applied to the first and second vibration generators 211 and 212 and the third and fourth vibration generators 213 and 214 may have opposite phases or may have a phase difference therebetween caused by signal delay. For example, the vibration driving signals respectively applied to the first and second vibration generators 211 and 212 may have the same phase or may have a phase difference therebetween caused by signal delay. Also, the vibration driving signals respectively applied to the third and fourth vibration generators 213 and 214 may have the same phase or may have a phase difference therebetween caused by signal delay. Also, the vibration driving signal applied to the first vibration generator 211 may have a phase opposite to that of the vibration driving signal applied to the third vibration generator 213 or may have a phase difference therebetween caused by signal delay, and may have a phase opposite to that of the vibration driving signal applied to the fourth vibration generator 214, or may have a phase difference therebetween caused by signal delay. Also, the vibration driving signal applied to the second vibration generator 212 may have a phase opposite to that of the vibration driving signal applied to the third vibration generator 213 or may have a phase difference therebetween caused by signal delay, and may have a phase opposite to that of the vibration driving signal applied to the fourth vibration generator 214 or may have a phase difference therebetween caused by signal delay. Also, the vibration driving signal applied to the fifth vibration generator 221 of the second vibration generating apparatus 220 may have a phase opposite to that of the vibration driving signal applied to each of the first and second vibration generators 211 and 212, or may have a phase difference, caused by signal delay, with the vibration driving signal applied to one of the first and second vibration generators 211 and 212. Also, the vibration driving signal applied to the fifth vibration generator 221 of the second vibration generating apparatus 220 may have the same phase as that of the vibration driving signal applied to each of the third and fourth vibration generators 213 and 214, or may have the same phase as that of the vibration driving signal applied to one of the third and fourth vibration generators 213 and 214 or may have a phase difference therebetween caused by signal delay.

According to an embodiment of the present disclosure, the first vibration generating apparatus 210 including the first to fourth vibration generators 211 to 214 provided in the first vibration member 101 and the second vibration generating apparatus 220 including the fifth vibration generator 221 provided in the second vibration member 102 may be disposed to at least partially overlap each other and may be configured to be displaced (or vibrated or driven) in the same direction by a vibration driving signal where a phase difference caused by signal delay is adjusted. and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 31, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a single fifth vibration generator 221.

Each of the first vibration generator 211, the second vibration generator 212, the third vibration generator 213, the fourth vibration generator 214, and the fifth vibration generator 221 may include at least one vibration part 201. For example, the at least one vibration part 201 may be a piezoelectric vibration part or a piezoelectric-type vibration part. For example, each of the first vibration generator 211, the second vibration generator 212, the third vibration generator 213, the fourth vibration generator 214, and the fifth vibration generator 221 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration generator 211, the second vibration generator 212, the third vibration generator 213, and the fourth vibration generator 214 may overlap the fifth vibration generator 221 of the second vibration generating apparatus 220.

Each of the first vibration generator 211 and the second vibration generator 212 may be disposed at a first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by a first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at a second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by a second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the first and second vibration generators 211 and 212 and the third and fourth vibration generators 213 and 214 may be disposed to overlap each other with the first vibration member 101 therebetween.

The second vibration generating apparatus 220 may be disposed at the first surface 102a of the second vibration member 102. For example, the second vibration generating apparatus 220 may be connected with or coupled to the first surface 102a of the second vibration member 102 by a third adhesive member 153. The second vibration generating apparatus 220 may include a single fifth vibration generator 221. For example, the second vibration generating apparatus 220 may be disposed in a first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in the same space. For example, the first vibration generating apparatus 210 may be disposed in the first space 100S. For example, the third vibration generator 213 and the fourth vibration generator 214 may be disposed in the first space 100S. For example, the second vibration generating apparatus 220 may be disposed in the first space 100S. For example, the third vibration generator 213, the fourth vibration generator 214, and the second vibration generating apparatus 220 may be disposed to face each other. For example, the third vibration generator 213, the fourth vibration generator 214, and the second vibration generating apparatus 220 may be disposed to face each other in the first space 100S. For example, the third vibration generator 213, the fourth vibration generator 214, and the second vibration generating apparatus 220 may be disposed to overlap each other in the first space 100S.

For example, the first and second vibration generators 211 and 212 and the third and fourth vibration generators 213 and 214 may be disposed in different spaces. For example, the third vibration generator 213 and the fourth vibration generator 214 may be disposed in the first space 100S. For example, the first and second vibration generators 211 and 212 and the third and fourth vibration generators 213 and 214 may be disposed with the first vibration member 101 therebetween. For example, the first and second vibration generators 211 and 212 and the third and fourth vibration generators 213 and 214 may be disposed to overlap each other with the first vibration member 101 therebetween. The first vibration generating apparatus 210 and the second vibration generating apparatus 220 may be disposed to face the same direction. For example, the first and second vibration generators 211 and 212 and the second vibration generating apparatus 220 may be disposed to face an upward direction in a third direction Z.

The first vibration generating apparatus 210 and the second vibration generating apparatus 220 may be disposed to face different directions. For example, the third vibration generator 213 and the fourth vibration generator 214 may be disposed to face a downward direction in the third direction Z. For example, the second vibration generating apparatus 220 may be disposed to face an upward direction in the third direction Z. The first vibration generating apparatus 210 may be disposed in a different direction. For example, the first and second vibration generators 211 and 212 and the third and fourth vibration generators 213 and 214 may be disposed to face different directions. For example, the first vibration generator 211 and the second vibration generator 212 may be disposed to face an upward direction in the third direction Z. For example, the third and fourth vibration generators 213 and 214 may be disposed to face a downward direction in the third direction Z.

The first and second vibration generators 211 and 212 and the third and fourth vibration generators 213 and 214 may at least partially overlap the fifth vibration generator 221 of the second vibration generating apparatus 220. For example, the first vibration generator 211, the second vibration generator 212, the third vibration generator 213, the fourth vibration generator 214, and the fifth vibration generator 221 may have substantially the same size.

A center portion between the first vibration generator 211 and the second vibration generator 212 may overlap a center portion between the third vibration generator 213 and the fourth vibration generator 214. A center portion between the first and second vibration generators 211 and 212 and the third and fourth vibration generators 213 and 214 may overlap a center portion of the fifth vibration generator 221 of the second vibration generating apparatus 220. For example, the first vibration generator 211 and the third vibration generator 213 may overlap a portion of a first region (or a left region) of the fifth vibration generator 221 of the second vibration generating apparatus 220. Also, the second vibration generator 212 and the fourth vibration generator 214 may overlap a portion of a second region (or a right region) of the fifth vibration generator 221 of the second vibration generating apparatus 220.

The first and second vibration generators 211 and 212 and the third and fourth vibration generators 213 and 214 may have an inverted structure at each of the first surface 101a and the second surface 101b of the first vibration member 101. Also, the second vibration generating apparatus 220 may have a non-inverted structure with respect to one of the first and second vibration generators 211 and 212 and the third and fourth vibration generators 213 and 214 and may have an inverted structure with respect to the other of the first and second vibration generators 211 and 212 and the third and fourth vibration generators 213 and 214. For example, the second vibration generating apparatus 220 may have a non-inverted structure with respect to the first and second vibration generators 211 and 212 and may have an inverted structure with respect to the third and fourth vibration generators 213 and 214.

The first vibration generator 211, the second vibration generator 212, the third vibration generator 213, the fourth vibration generator 214, and the fifth vibration generator 221 may be configured to be displaced (or vibrated or driven) in the same direction. For example, a vibration driving signal applied to the first vibration generator 211 and the second vibration generator 212 may have the same phase as or a phase difference with that of a vibration driving signal applied to the fifth vibration generator 221 of the second vibration generating apparatus 220. A vibration driving signal applied to the third vibration generator 213 and the fourth vibration generator 214 may have a phase opposite to or a phase difference with that of the vibration driving signal applied to the fifth vibration generator 221 of the second vibration generating apparatus 220.

The vibration driving signal applied to the fifth vibration generator 221 of the second vibration generating apparatus 220 may have the same phase as that of the vibration driving signal applied to each of the first and second vibration generators 211 and 212 and may have a phase difference therebetween caused by signal delay, or may have the same phase as that of the vibration driving signal applied to one of the first and second vibration generators 211 and 212 or may have a phase difference therebetween caused by signal delay. Also, the vibration driving signal applied to the fifth vibration generator 221 of the second vibration generating apparatus 220 may have a phase opposite to that of the vibration driving signal applied to each of the third and fourth vibration generators 213 and 214, or may have a phase difference, caused by signal delay, with that of the vibration driving signal applied to one of the third and fourth vibration generators 213 and 214.

According to an embodiment of the present disclosure, the first vibration generating apparatus 210 including the first to fourth vibration generators 211 to 214 provided in the first vibration member 101 and the second vibration generating apparatus 220 including the fifth vibration generator 221 provided in the second vibration member 102 may be disposed to at least partially overlap each other and may be configured to be displaced (or vibrated or driven) in the same direction by a vibration driving signal where a phase difference caused by signal delay is adjusted. and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

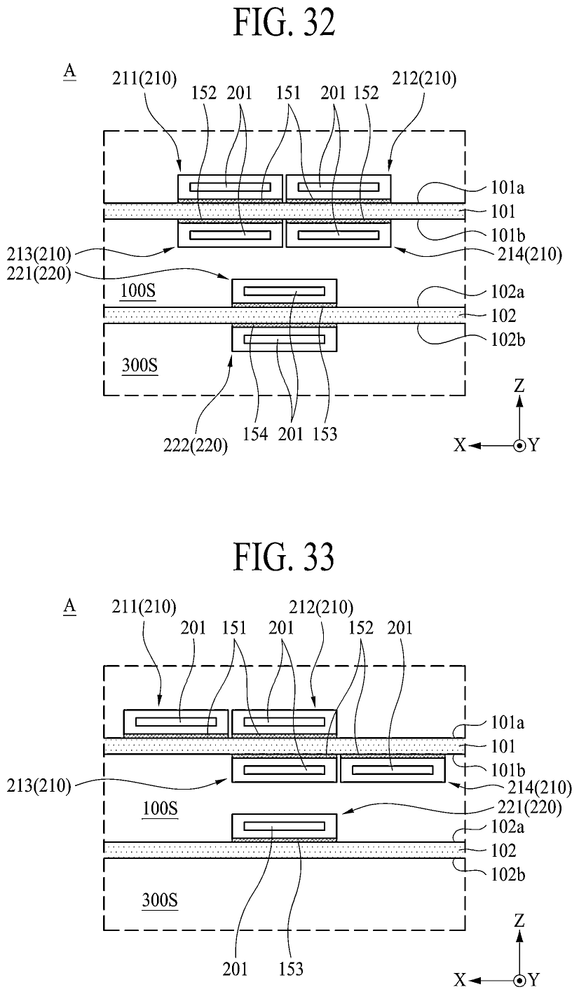

Referring to FIG. 32, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a fifth vibration generator 221 and a sixth vibration generator 222.

Each of the first vibration generator 211, the second vibration generator 212, the third vibration generator 213, the fourth vibration generator 214, the fifth vibration generator 221, and the sixth vibration generator 222 may include at least one vibration part 201. For example, the at least one vibration part 201 may be a piezoelectric vibration part or a piezoelectric-type vibration part. For example, each of the first vibration generator 211, the second vibration generator 212, the third vibration generator 213, the fourth vibration generator 214, the fifth vibration generator 221, and the sixth vibration generator 222 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration generator 211, the second vibration generator 212, the third vibration generator 213, and the fourth vibration generator 214 may overlap the fifth and sixth vibration generators 221 and 222 of the second vibration generating apparatus 220.

Each of the first vibration generator 211 and the second vibration generator 212 may be disposed at a first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by a first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at a second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by a second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the first and second vibration generators 211 and 212 and the third and fourth vibration generators 213 and 214 may be disposed to overlap each other with the first vibration member 101 therebetween.

The fifth vibration generator 221 may be disposed at the first surface 102a of the second vibration member 102. For example, the fifth vibration generator 221 may be connected with or coupled to the first surface 102a of the second vibration member 102 by the third adhesive member 153. The sixth vibration generator 222 may be disposed at the second surface 102b of the second vibration member 102. For example, the sixth vibration generator 222 may be connected with or coupled to the second surface 102b of the second vibration member 102 by the fourth adhesive member 154. The fifth vibration generator 221 and the sixth vibration generator 222 may be disposed with the second vibration member 102 therebetween. For example, the fifth vibration generator 221 and the sixth vibration generator 222 may be disposed to overlap each other with the second vibration member 102 therebetween.

The first vibration generating apparatus 210 and the second vibration generating apparatus 220 may be disposed in the same space. For example, the third and fourth vibration generators 213 and 214 and the fifth vibration generator 221 may be disposed in the same space. For example, the third and fourth vibration generators 213 and 214 and the fifth vibration generator 221 may be disposed in the first space 100S. The third and fourth vibration generators 213 and 214 and the fifth vibration generator 221 may be disposed to face each other. For example, the third and fourth vibration generators 213 and 214 and the fifth vibration generator 221 may be disposed to face each other in the first space 100S. For example, the third and fourth vibration generators 213 and 214 and the fifth vibration generator 221 may be disposed to face and overlap each other in the first space 100S.

The first vibration generating apparatus 210 may be disposed in a different space. For example, the first and second vibration generators 211 and 212 and the third and fourth vibration generators 213 and 214 may be disposed in different spaces. For example, the third and fourth vibration generators 213 and 214 may be disposed in the first space 100S. For example, the first and second vibration generators 211 and 212 and the third and fourth vibration generators 213 and 214 may be disposed with the first vibration member 101 therebetween. For example, the first and second vibration generators 211 and 212 and the third and fourth vibration generators 213 and 214 may be disposed to face each other with the first vibration member 101 therebetween. For example, the first and second vibration generators 211 and 212 and the third and fourth vibration generators 213 and 214 may be disposed to overlap each other with the first vibration member 101 therebetween.

The first vibration generating apparatus 210 and the second vibration generating apparatus 220 may be disposed in different spaces. For example, the first vibration generating apparatus 210 may be disposed in the first space 100S. For example, the second vibration generating apparatus 220 may be disposed in the second space 300S. For example, the third and fourth vibration generators 213 and 214 and the fifth vibration generator 221 may be disposed in different spaces from the sixth vibration generator 222. For example, the third and fourth vibration generators 213 and 214 and the fifth vibration generator 221 may be disposed in the first space 100S. The sixth vibration generator 222 may be disposed in the second space 300S. For example, the third and fourth vibration generators 213 and 214 and the fifth vibration generator 221 may be disposed to face each other in the first space 100S. For example, the third and fourth vibration generators 213 and 214 and the fifth vibration generator 221 may be disposed to face and overlap each other in the first space 100S. For example, the third and fourth vibration generators 213 and 214 and the fifth vibration generator 221 may be disposed to overlap each other in the first space 100S.

The second vibration generating apparatus 220 may be disposed in a different space. For example, the fifth and sixth vibration generators 221 and 222 may be disposed in different spaces. For example, the fifth vibration generator 221 may be disposed in the first space 100S. For example, the fifth and sixth vibration generators 221 and 222 may be disposed with the second vibration member 102 therebetween. For example, the fifth and sixth vibration generators 221 and 222 may be disposed to face each other with the second vibration member 102 therebetween. For example, the fifth and sixth vibration generators 221 and 222 may be disposed to overlap each other with the second vibration member 102 therebetween.

The first vibration generating apparatus 210) and the second vibration generating apparatus 220) may be disposed to face the same direction. For example. the first and second vibration generators 211 and 212 and the fifth vibration generator 221 may be disposed to face an upward direction in the third direction Z. For example, the third and fourth vibration generators 213 and 214 and the sixth vibration generator 222 may be disposed to face a downward direction in the third direction Z.

The first vibration generating apparatus 210) and the second vibration generating apparatus 220) may be disposed to face different directions. For example, the first and second vibration generators 211 and 212 may be disposed to face an upward direction in the third direction Z. For example, the sixth vibration generator 222 may be disposed to face a downward direction in the third direction Z. For example, the third and fourth vibration generators 213 and 214 may be disposed to face a downward direction in the third direction Z. The fifth vibration generator 221 may be disposed to face an upward direction in the third direction Z.

The first vibration generating apparatus 210) may be disposed in a different direction. For example, the first and second vibration generators 211 and 212 and the third and fourth vibration generators 213 and 214 may be disposed to face different directions. For example, the first and second vibration generators 211 and 212 may be disposed to face an upward direction in the third direction Z. For example. the third and fourth vibration generators 213 and 214 may be disposed to face a downward direction in the third direction Z.

The second vibration generating apparatus 220 may be disposed in a different direction. For example, the fifth vibration generator 221 and the sixth vibration generator 222 may be disposed to face different directions. For example, the fifth vibration generator 221 may be disposed to face an upward direction in the third direction Z. For example, the sixth vibration generator 222 may be disposed to face a downward direction in the third direction Z.

The first and second vibration generators 211 and 212 and the third and fourth vibration generators 213 and 214 may at least partially overlap the fifth and sixth vibration generators 221 and 222 of the second vibration generating apparatus 220. For example, the first vibration generator 211, the second vibration generator 212, the third vibration generator 213, the fourth vibration generator 214, the fifth vibration generator 221, and the sixth vibration generator 222 may have substantially the same size.

A center portion between the first vibration generator 211 and the second vibration generator 212 may overlap a center portion between the third vibration generator 213 and the fourth vibration generator 214. Also, a center portion between the first and second vibration generators 211 and 212 and the third and fourth vibration generators 213 and 214 may overlap a center portion between the fifth and sixth vibration generators 221 and 222 of the second vibration generating apparatus 220. For example, the first vibration generator 211 and the third vibration generator 213 may overlap a portion of a first region (or a left region) of each of the fifth and sixth vibration generators 221 and 222 of the second vibration generating apparatus 220. Also, the second vibration generator 212 and the fourth vibration generator 214 may overlap a portion of a second region (or a right region) of each of the fifth and sixth vibration generators 221 and 222 of the second vibration generating apparatus 220.

The first and second vibration generators 211 and 212 and the third and fourth vibration generators 213 and 214 may have an inverted structure at each of the first surface 101a and the second surface 101b of the first vibration member 101. Also, the fifth vibration generator 221 may have a non-inverted structure with respect to the first and second vibration generators 211 and 212 and may have an inverted structure with respect to the third and fourth vibration generators 213 and 214. Also, the sixth vibration generating apparatus 222 may have an inverted structure with respect to the first and second vibration generators 211 and 212 and may have a non-inverted structure with respect to the third and fourth vibration generators 213 and 214.

The first vibration generator 211, the second vibration generator 212, the third vibration generator 213, the fourth vibration generator 214, the fifth vibration generator 221, and the sixth vibration generator 222 may be configured to be displaced (or vibrated or driven) in the same direction. For example, a vibration driving signal applied to the first and second vibration generators 211 and 212 may have the same phase as or a phase difference with that of a vibration driving signal applied to the fifth vibration generator 221 and may have a phase opposite to or a phase difference with that of a vibration driving signal applied to the sixth vibration generator 222. Also, a vibration driving signal applied to the third and fourth vibration generators 213 and 214 may have a phase opposite to or a phase difference with that of the vibration driving signal applied to the fifth vibration generator 221 and may have the same phase as or a phase difference with that of the vibration driving signal applied to the sixth vibration generator 222.

The vibration driving signal applied to the fifth vibration generator 221 may have the same phase as that of the vibration driving signal applied to each of the first and second vibration generators 211 and 212 or may have a phase difference therebetween caused by signal delay, or may have the same phase as that of the vibration driving signal applied to one of the first and second vibration generators 211 and 212 or may have a phase difference therebetween caused by signal delay. Also, the vibration driving signal applied to the fifth vibration generator 221 may have a phase opposite to that of the vibration driving signal applied to each of the third and fourth vibration generators 213 and 214, or may have a phase difference, caused by signal delay, with that of the vibration driving signal applied to one of the third and fourth vibration generators 213 and 214. Also, the vibration driving signal applied to the sixth vibration generator 222 may have a phase opposite to that of the vibration driving signal applied to each of the first and second vibration generators 211 and 212, or may have a phase difference, caused by signal delay, with that of the vibration driving signal applied to one of the first and second vibration generators 211 and 212. Also, the vibration driving signal applied to the sixth vibration generator 222 may have the same phase as that of the vibration driving signal applied to each of the third and fourth vibration generators 213 and 214 or may have a phase difference therebetween caused by signal delay, or may have the same phase as that of the vibration driving signal applied to one of the third and fourth vibration generators 213 and 214 or may have a phase difference therebetween caused by signal delay.

According to an embodiment of the present disclosure, the first vibration generating apparatus 210 including the first to fourth vibration generators 211 to 214 provided in the first vibration member 101 and the second vibration generating apparatus 220 including the fifth and sixth vibration generators 221 and 222 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 33, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a single fifth vibration generator 221.

Each of the first vibration generator 211, the second vibration generator 212, the third vibration generator 213, the fourth vibration generator 214, and the fifth vibration generator 221 may include at least one vibration part 201. For example, the at least one vibration part 201 may be a piezoelectric vibration part or a piezoelectric-type vibration part. For example, each of the first vibration generator 211, the second vibration generator 212, the third vibration generator 213, the fourth vibration generator 214, and the fifth vibration generator 221 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration generator 211, the second vibration generator 212, the third vibration generator 213, and the fourth vibration generator 214 may overlap the fifth vibration generator 221 of the second vibration generating apparatus 220.

Each of the first vibration generator 211 and the second vibration generator 212 may be disposed at a first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by a first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at a second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by a second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the second vibration generator 212 and the third vibration generator 213 may be disposed to overlap each other with the first vibration member 101 therebetween. Also, the first and fourth vibration generators 211 and 214 may be disposed not to overlap the other vibration generator, or may be disposed to overlap at least a portion of the other vibration generator.

The fifth vibration generator 221 may be disposed at a first surface 102a of the second vibration member 102. For example, the fifth vibration generator 221 may be connected with or coupled to the first surface 102a of the second vibration member 102 by a third adhesive member 153. For example, the fifth vibration generator 221 may be disposed in a first space 100S between the first vibration member 101 and the second vibration member 102 and may be covered by the first vibration member 101, and thus, may be protected from an external impact.

Except for that the first and second vibration generators 211 and 212 disposed at the first surface 101 a of the first vibration member 101 of the first vibration generating apparatus 210) and the third and fourth vibration generators 213 and 214 disposed at the second surface 101b of the first vibration member 101 are disposed to have an asymmetrical structure with respect to each other, descriptions of an arrangement relationship between the first vibration generating apparatus 210 and the second vibration generating apparatus 220 and an applied vibration generating signal may be as described above with reference to FIG. 31, and thus, are omitted.

According to an embodiment of the present disclosure, the first vibration generating apparatus 210 including the first to fourth vibration generators 211 to 214 provided in the first vibration member 101 and the second vibration generating apparatus 220 including the fifth vibration generator 221 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

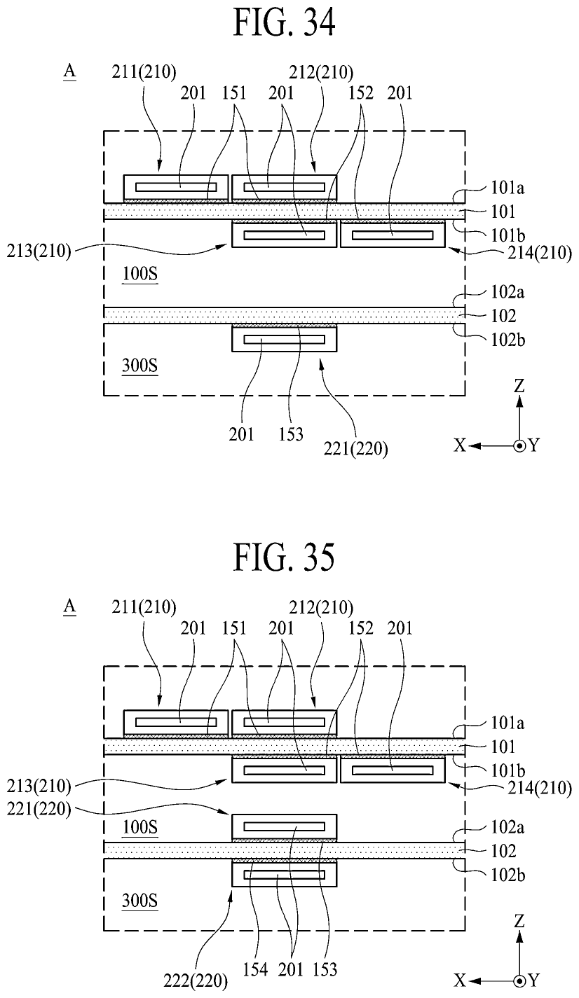

Referring to FIG. 34, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a single fifth vibration generator 221.

Each of the first vibration generator 211, the second vibration generator 212, the third vibration generator 213, the fourth vibration generator 214, and the fifth vibration generator 221 may include at least one vibration part 201. For example, the at least one vibration part 201 may be a piezoelectric vibration part or a piezoelectric-type vibration part. For example, each of the first vibration generator 211, the second vibration generator 212, the third vibration generator 213, the fourth vibration generator 214, and the fifth vibration generator 221 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration generator 211, the second vibration generator 212, the third vibration generator 213, and the fourth vibration generator 214 may overlap the fifth vibration generator 221 of the second vibration generating apparatus 220.

Each of the first vibration generator 211 and the second vibration generator 212 may be disposed at a first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by a first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at a second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by a second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the second vibration generator 212 and the third vibration generator 213 may be disposed to overlap each other with the first vibration member 101 therebetween. Also, the first and fourth vibration generators 211 and 214 may be disposed not to overlap the other vibration generator, or may be disposed to overlap at least a portion of the other vibration generator.

The fifth vibration generator 221 may be disposed at the second surface 102b of the second vibration member 102. For example, the fifth vibration generator 221 may be connected with or coupled to the second surface 102b of the second vibration member 102 by the third adhesive member 153. For example, the fifth vibration generator 221 may be disposed in the second space 300S between the second vibration member 102 and the enclosure 300 and may be covered by the enclosure 300, and thus, may be protected from an external impact.

Except for that the first and second vibration generators 211 and 212 disposed at the first surface 101a of the first vibration member 101 of the first vibration generating apparatus 210 and the third and fourth vibration generators 213 and 214 disposed at the second surface 101b of the first vibration member 101 are disposed to have an asymmetrical structure with respect to each other, descriptions of an arrangement relationship between the first vibration generating apparatus 210 and the second vibration generating apparatus 220 and an applied vibration generating signal may be as described above with reference to FIG. 30, and thus, are omitted.

According to an embodiment of the present disclosure, the first vibration generating apparatus 210 including the first to fourth vibration generators 211 to 214 provided in the first vibration member 101 and the second vibration generating apparatus 220 including the fifth vibration generator 221 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 35, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a fifth vibration generator 221 and a sixth vibration generator 222.

Each of the first vibration generator 211, the second vibration generator 212, the third vibration generator 213, the fourth vibration generator 214, the fifth vibration generator 221, and the sixth vibration generator 222 may include at least one vibration part 201. For example, the at least one vibration [art 201 may be a piezoelectric vibration part or a piezoelectric-type vibration part. For example, each of the first vibration generator 211, the second vibration generator 212, the third vibration generator 213, the fourth vibration generator 214, the fifth vibration generator 221, and the sixth vibration generator 222 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the first vibration generator 211, the second vibration generator 212, the third vibration generator 213, and the fourth vibration generator 214 may overlap the fifth and sixth vibration generators 221 and 222 of the second vibration generating apparatus 220.

Each of the first vibration generator 211 and the second vibration generator 212 may be disposed at a first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by a first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at a second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by a second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the second vibration generator 212 and the third vibration generator 213 may be disposed to overlap each other with the first vibration member 101 therebetween. Also, the first and fourth vibration generators 211 and 214 may be disposed not to overlap the other vibration generator, or may be disposed to overlap at least a portion of the other vibration generator.

The fifth vibration generator 221 may be disposed at the first surface 102a of the second vibration member 102. For example, the fifth vibration generator 221 may be connected with or coupled to the first surface 102a of the second vibration member 102 by the third adhesive member 153. The sixth vibration generator 222 may be disposed at the second surface 102b of the second vibration member 102. For example, the sixth vibration generator 222 may be connected with or coupled to the second surface 102b of the second vibration member 102 by the fourth adhesive member 154. The fifth vibration generator 221 and the sixth vibration generator 222 may be disposed with the second vibration member 102 therebetween. For example, the fifth vibration generator 221 and the sixth vibration generator 222 may be disposed to overlap each other with the second vibration member 102 therebetween.

Except for that the first and second vibration generators 211 and 212 disposed at the first surface 101a of the first vibration member 101 of the first vibration generating apparatus 210 and the third and fourth vibration generators 213 and 214 disposed at the second surface 101b of the first vibration member 101 are disposed to have an asymmetrical structure with respect to each other, descriptions of an arrangement relationship between the first vibration generating apparatus 210 and the second vibration generating apparatus 220 and an applied vibration generating signal may be as described above with reference to FIG. 32, and thus, are omitted.

According to an embodiment of the present disclosure, the first vibration generating apparatus 210 including the first to fourth vibration generators 211 to 214 provided in the first vibration member 101 and the second vibration generating apparatus 220 including the fifth and sixth vibration generators 221 and 222 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

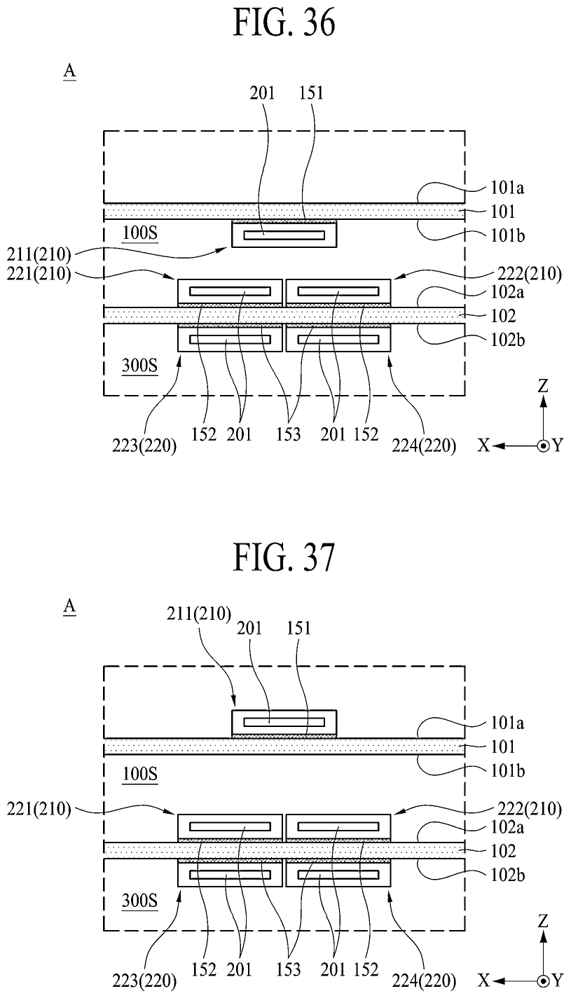

Referring to FIG. 36, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a single first vibration generator 211. Also, the second vibration generating apparatus 220 may include a second vibration generator 221, a third vibration generator 222, a fourth vibration generator 223, and a fifth vibration generator 224.

Each of the first vibration generator 211, the second vibration generator 221, the third vibration generator 222, the fourth vibration generator 223, and the fifth vibration generator 224 may include at least one vibration part 201. For example, the at least one vibration part 201 may be a piezoelectric vibration part or a piezoelectric-type vibration part. For example, each of the first vibration generator 211, the second vibration generator 221, the third vibration generator 222, the fourth vibration generator 223, and the fifth vibration generator 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the second vibration generator 221, the third vibration generator 222, the fourth vibration generator 223, and the fifth vibration generator 224 of the second vibration generating apparatus 220 may overlap the first vibration generator 211 of the first vibration generating apparatus 210.

The first vibration generating apparatus 210 may be disposed at a second surface 101b of the first vibration member 101. For example, the first vibration generating apparatus 210 may be connected with or coupled to the second surface 101b of the first vibration member 101 by the first adhesive member 151. The first vibration generating apparatus 210 may include a single first vibration generator 211. For example, the first vibration generating apparatus 210 may be disposed in the first space 100S between the first vibration member 101 and the second vibration member 102 and may be covered by the first vibration member 101, and thus, may be protected from an external impact.

Each of the second vibration generator 221 and the third vibration generator 222 may be disposed at a first surface 102a of the second vibration member 102. For example, the second vibration generator 221 and the third vibration generator 222 may be disposed at the first surface 102a of the second vibration member 102 so as to be spaced apart from each other in the first direction X. For example, each of the second vibration generator 221 and the third vibration generator 222 may be connected with or coupled to the first surface 102a of the second vibration member 102 by a second adhesive member 152. For example, the second adhesive member 152 may be individually disposed in each of the second vibration generator 221 and the third vibration generator 222, or may be disposed in common in the second vibration generator 221 and the third vibration generator 222 which are provided as one body, but embodiments of the present disclosure are not limited thereto. Also, each of the fourth vibration generator 223 and the fifth vibration generator 224 may be disposed at a second surface 102b of the second vibration member 102. For example, the fourth vibration generator 223 and the fifth vibration generator 224 may be disposed at the second surface 102b of the second vibration member 102 so as to be spaced apart from each other in the first direction X. For example, each of the fourth vibration generator 223 and the fifth vibration generator 224 may be connected with or coupled to the second surface 102b of the second vibration member 102 by a third adhesive member 153. For example, the third adhesive member 153 may be individually disposed in each of the fourth vibration generator 223 and the fifth vibration generator 224, or may be disposed in common in the fourth vibration generator 223 and the fifth vibration generator 224 which are provided as one body, but embodiments of the present disclosure are not limited thereto. For example, the second and third vibration generators 221 and 222 and the fourth and fifth vibration generators 223 and 224 may be disposed with the second vibration member 102 therebetween. For example, the second and third vibration generators 221 and 222 and the fourth and fifth vibration generators 223 and 224 may be disposed to overlap each other with the second vibration member 102 therebetween.

Except for that the first vibration generating apparatus 210 and the second vibration generating apparatus 220 are inverted into a mirror image and disposed, descriptions of an arrangement relationship between the first vibration generating apparatus 210 and the second vibration generating apparatus 220 and an applied vibration generating signal may be as described above with reference to FIG. 31, and thus, are omitted.

According to an embodiment of the present disclosure, the first vibration generating apparatus 210 including a single first vibration generator 211 provided in the first vibration member 101 and the second vibration generating apparatus 220 including the second to fifth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 37, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a single first vibration generator 211. Also, the second vibration generating apparatus 220 may include a second vibration generator 221, a third vibration generator 222, a fourth vibration generator 223, and a fifth vibration generator 224.

Each of the first vibration generator 211, the second vibration generator 221, the third vibration generator 222, the fourth vibration generator 223, and the fifth vibration generator 224 may include at least one vibration part 201. For example, the at least one vibration part 201 may be a piezoelectric vibration part or a piezoelectric-type vibration part. For example, each of the first vibration generator 211, the second vibration generator 221, the third vibration generator 222, the fourth vibration generator 223, and the fifth vibration generator 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the second vibration generator 221, the third vibration generator 222, the fourth vibration generator 223, and the fifth vibration generator 224 of the second vibration generating apparatus 220 may overlap the first vibration generator 211 of the first vibration generating apparatus 210.

The first vibration generating apparatus 210 may be disposed at the first surface 101a of the first vibration member 101. For example, the first vibration generating apparatus 210 may be connected with or coupled to the first surface 101a of the first vibration member 101 by the first adhesive member 151. The first vibration generating apparatus 210 may include a single first vibration generator 211.

Each of the second vibration generator 221 and the third vibration generator 222 may be disposed at a first surface 102a of the second vibration member 102. For example, the second vibration generator 221 and the third vibration generator 222 may be disposed at the first surface 102a of the second vibration member 102 so as to be spaced apart from each other in the first direction X. For example, each of the second vibration generator 221 and the third vibration generator 222 may be connected with or coupled to the first surface 102a of the second vibration member 102 by a second adhesive member 152. For example, the second adhesive member 152 may be individually disposed in each of the second vibration generator 221 and the third vibration generator 222, or may be disposed in common in the second vibration generator 221 and the third vibration generator 222 which are provided as one body, but embodiments of the present disclosure are not limited thereto. Also, each of the fourth vibration generator 223 and the fifth vibration generator 224 may be disposed at a second surface 102b of the second vibration member 102. For example, the fourth vibration generator 223 and the fifth vibration generator 224 may be disposed at the second surface 102b of the second vibration member 102 so as to be spaced apart from each other in the first direction X. For example, each of the fourth vibration generator 223 and the fifth vibration generator 224 may be connected with or coupled to the second surface 102b of the second vibration member 102 by a third adhesive member 153. For example, the third adhesive member 153 may be individually disposed in each of the fourth vibration generator 223 and the fifth vibration generator 224, or may be disposed in common in the fourth vibration generator 223 and the fifth vibration generator 224 which are provided as one body, but embodiments of the present disclosure are not limited thereto. For example, the second and third vibration generators 221 and 222 and the fourth and fifth vibration generators 223 and 224 may be disposed with the second vibration member 102 therebetween. For example, the second and third vibration generators 221 and 222 and the fourth and fifth vibration generators 223 and 224 may be disposed to overlap each other with the second vibration member 102 therebetween.

Except for that the first vibration generating apparatus 210 and the second vibration generating apparatus 220 are inverted into a mirror image and disposed, descriptions of an arrangement relationship between the first vibration generating apparatus 210 and the second vibration generating apparatus 220 and an applied vibration generating signal may be as described above with reference to FIG. 30, and thus, are omitted.

According to an embodiment of the present disclosure, the first vibration generating apparatus 210 including a single first vibration generator 211 provided in the first vibration member 101 and the second vibration generating apparatus 220 including the second to fifth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

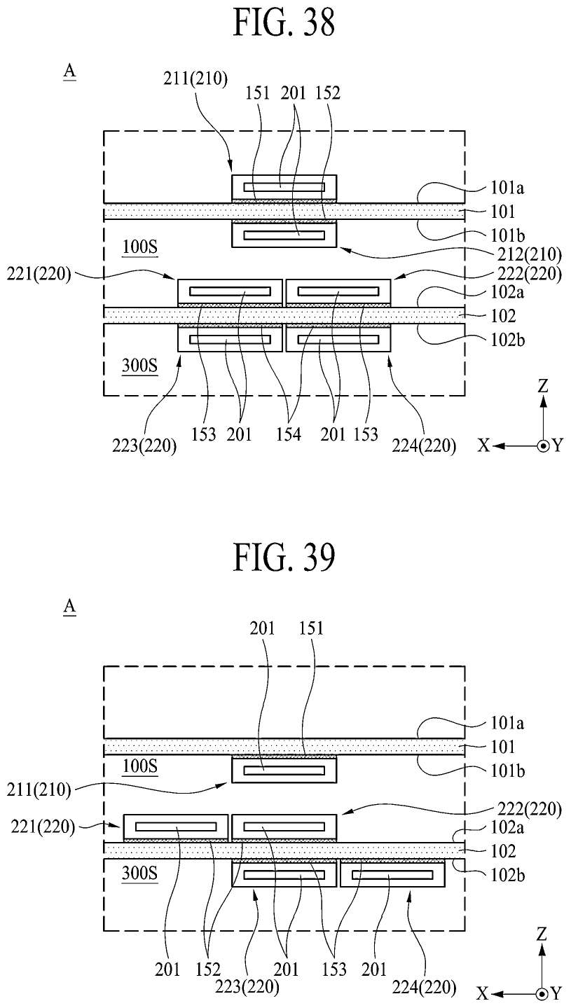

Referring to FIG. 38, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211 and a second vibration generator 212. Also, the second vibration generating apparatus 220 may include a third vibration generator 221, a fourth vibration generator 222, a fifth vibration generator 223, and a sixth vibration generator 224.

Each of the first vibration generator 211, the second vibration generator 212, the third vibration generator 221, the fourth vibration generator 222, the fifth vibration generator 223, and the sixth vibration generator 224 may include at least one vibration part 201. For example, the at least one vibration part 201 may be a piezoelectric vibration part or a piezoelectric-type vibration part. For example, each of the first vibration generator 211, the second vibration generator 212, the third vibration generator 221, the fourth vibration generator 222, the fifth vibration generator 223, and the sixth vibration generator 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the third vibration generator 221, the fourth vibration generator 222, the fifth vibration generator 223, and the sixth vibration generator 224 of the second vibration generating apparatus 220 may overlap the first and second vibration generators 211 and 212 of the first vibration generating apparatus 210.

The first vibration generator 211 may be disposed at the first surface 101a of the first vibration member 101. For example, the first vibration generator 211 may be connected with or coupled to the first surface 101a of the first vibration member 101 by the first adhesive member 151. Also, the second vibration generator 212 may be disposed at the second surface 101b of the first vibration member 101. For example, the second vibration generator 212 may be connected with or coupled to the second surface 101b of the first vibration member 101 by the second adhesive member 152. The first vibration generator 211 and the second vibration generator 212 may be disposed with the first vibration member 101 therebetween. For example, the first vibration generator 211 and the second vibration generator 212 may be disposed to overlap each other with the first vibration member 101 therebetween.

Each of the third vibration generator 221 and the fourth vibration generator 222 may be disposed at a first surface 102a of the second vibration member 102. For example, the third vibration generator 221 and the fourth vibration generator 222 may be disposed at the first surface 102a of the second vibration member 102 so as to be spaced apart from each other in the first direction X. For example, each of the third vibration generator 221 and the fourth vibration generator 222 may be connected with or coupled to the first surface 102a of the second vibration member 102 by a third adhesive member 153. For example, the third adhesive member 153 may be individually disposed in each of the third vibration generator 221 and the fourth vibration generator 222, or may be disposed in common in the third vibration generator 221 and the fourth vibration generator 222 which are provided as one body, but embodiments of the present disclosure are not limited thereto. Also, each of the fifth vibration generator 223 and the sixth vibration generator 224 may be disposed at a second surface 102b of the second vibration member 102. For example, the fifth vibration generator 223 and the sixth vibration generator 224 may be disposed at the second surface 102b of the second vibration member 102 so as to be spaced apart from each other in the first direction X. For example, each of the fifth vibration generator 223 and the sixth vibration generator 224 may be connected with or coupled to the second surface 102b of the second vibration member 102 by a fourth adhesive member 154. For example, the fourth adhesive member 154 may be individually disposed in each of the fifth vibration generator 223 and the sixth vibration generator 224, or may be disposed in common in the fifth vibration generator 223 and the sixth vibration generator 224 which are provided as one body, but embodiments of the present disclosure are not limited thereto. For example, the third and fourth vibration generators 221 and 222 and the fifth and sixth vibration generators 223 and 224 may be disposed with the second vibration member 102 therebetween. For example, the third and fourth vibration generators 221 and 222 and the fifth and sixth vibration generators 223 and 224 may be disposed to overlap each other with the second vibration member 102 therebetween.

Except for that the first vibration generating apparatus 210 and the second vibration generating apparatus 220 are inverted into a mirror image and disposed, descriptions of an arrangement relationship between the first vibration generating apparatus 210 and the second vibration generating apparatus 220 and an applied vibration generating signal may be as described above with reference to FIG. 32, and thus, are omitted.

According to an embodiment of the present disclosure, the first vibration generating apparatus 210 including the first and second vibration generators 211 and 212 provided in the first vibration member 101 and the second vibration generating apparatus 220 including the third to sixth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 39, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a single first vibration generator 211. Also, the second vibration generating apparatus 220 may include a second vibration generator 221, a third vibration generator 222, a fourth vibration generator 223, and a fifth vibration generator 224.

Each of the first vibration generator 211, the second vibration generator 221, the third vibration generator 222, the fourth vibration generator 223, and the fifth vibration generator 224 may include at least one vibration part 201. For example, the at least one vibration part 201 may be a piezoelectric vibration part or a piezoelectric-type vibration part. For example, each of the first vibration generator 211, the second vibration generator 221, the third vibration generator 222, the fourth vibration generator 223, and the fifth vibration generator 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the second vibration generator 221, the third vibration generator 222, the fourth vibration generator 223, and the fifth vibration generator 224 of the second vibration generating apparatus 220 may overlap the first vibration generator 211 of the first vibration generating apparatus 210.

The first vibration generator 211 may be disposed at a second surface 101b of the first vibration member 101. For example, the first vibration generator 211 may be connected with or coupled to the second surface 101b of the first vibration member 101 by the first adhesive member 151. For example, the first vibration generator 211 may be disposed in the first space 100S between the first vibration member 101 and the second vibration member 102 and may be covered by the first vibration member 101, and thus, may be protected from an external impact.

Each of the second vibration generator 221 and the third vibration generator 222 may be disposed at a first surface 102a of the second vibration member 102. For example, the second vibration generator 221 and the third vibration generator 222 may be disposed at the first surface 102a of the second vibration member 102 so as to be spaced apart from each other in the first direction X. For example, each of the second vibration generator 221 and the third vibration generator 222 may be connected with or coupled to the first surface 102a of the second vibration member 102 by a second adhesive member 152. For example, the second adhesive member 152 may be individually disposed in each of the second vibration generator 221 and the third vibration generator 222, or may be disposed in common in the second vibration generator 221 and the third vibration generator 222 which are provided as one body, but embodiments of the present disclosure are not limited thereto. Also, each of the fourth vibration generator 223 and the fifth vibration generator 224 may be disposed at a second surface 102b of the second vibration member 102. For example, the fourth vibration generator 223 and the fifth vibration generator 224 may be disposed at the second surface 102b of the second vibration member 102 so as to be spaced apart from each other in the first direction X. For example, each of the fourth vibration generator 223 and the fifth vibration generator 224 may be connected with or coupled to the second surface 102b of the second vibration member 102 by a third adhesive member 153. For example, the third adhesive member 153 may be individually disposed in each of the fourth vibration generator 223 and the fifth vibration generator 224, or may be disposed in common in the fourth vibration generator 223 and the fifth vibration generator 224 which are provided as one body, but embodiments of the present disclosure are not limited thereto. For example, the second and third vibration generators 221 and 222 and the fourth and fifth vibration generators 223 and 224 may be disposed with the second vibration member 102 therebetween. For example, the third and fourth vibration generators 222 and 223 may be disposed to overlap each other with the second vibration member 102 therebetween. Also, the second and fifth vibration generators 221 and 224 may be disposed not to overlap the other vibration generator, or may be disposed to overlap at least a portion of the other vibration generator.

Except for that the first vibration generating apparatus 210 and the second vibration generating apparatus 220 having an asymmetrical structure between the second and third vibration generators 221 and 222 disposed at the first surface 102a of the second vibration member 102 of the second vibration generating apparatus 220 and the fourth and fifth vibration generators 223 and 224 disposed at the second surface 102b of the second vibration member 102 are inverted into a mirror image and disposed, descriptions of an arrangement relationship between the first vibration generating apparatus 210 and the second vibration generating apparatus 220 and an applied vibration generating signal may be the same as or substantially the same as the detailed descriptions of FIG. 33, and thus, are omitted.

According to an embodiment of the present disclosure, the first vibration generating apparatus 210 including a single first vibration generator 211 provided in the first vibration member 101 and the second vibration generating apparatus 220 including the second to fifth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

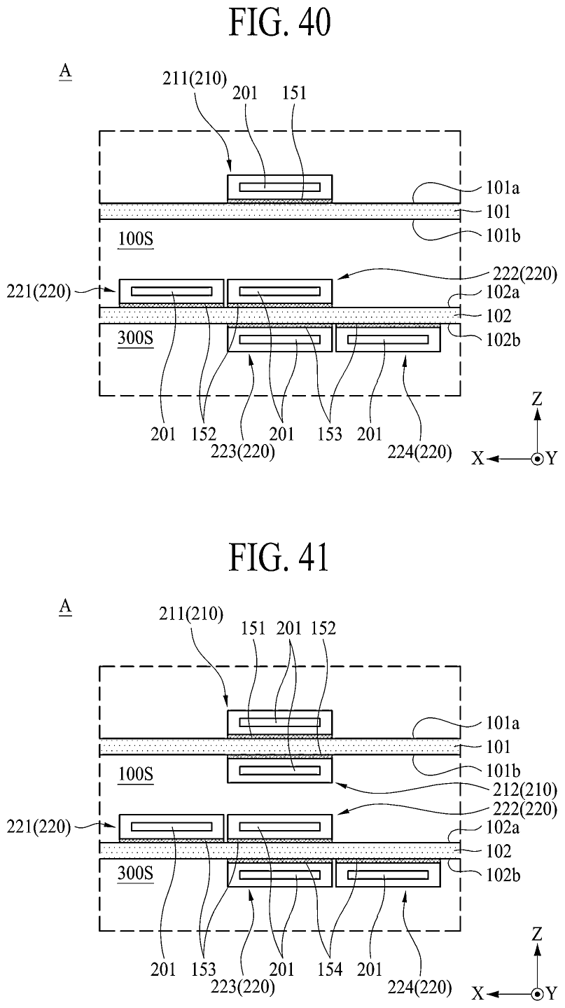

Referring to FIG. 40, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a single first vibration generator 211. Also, the second vibration generating apparatus 220 may include a second vibration generator 221, a third vibration generator 222, a fourth vibration generator 223, and a fifth vibration generator 224.

Each of the first vibration generator 211, the second vibration generator 221, the third vibration generator 222, the fourth vibration generator 223, and the fifth vibration generator 224 may include at least one vibration part 201. For example, the at least one vibration part 201 may be a piezoelectric vibration part or a piezoelectric-type vibration part. For example, each of the first vibration generator 211, the second vibration generator 221, the third vibration generator 222, the fourth vibration generator 223, and the fifth vibration generator 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the second vibration generator 221, the third vibration generator 222, the fourth vibration generator 223, and the fifth vibration generator 224 of the second vibration generating apparatus 220 may overlap the first vibration generator 211 of the first vibration generating apparatus 210.

The first vibration generator 211 may be disposed at the first surface 101a of the first vibration member 101. For example, the first vibration generator 211 may be connected with or coupled to the first surface 101a of the first vibration member 101 by the first adhesive member 151.

Each of the second vibration generator 221 and the third vibration generator 222 may be disposed at a first surface 102a of the second vibration member 102. For example, the second vibration generator 221 and the third vibration generator 222 may be disposed at the first surface 102a of the second vibration member 102 so as to be spaced apart from each other in the first direction X. For example, each of the second vibration generator 221 and the third vibration generator 222 may be connected with or coupled to the first surface 102a of the second vibration member 102 by a second adhesive member 152. For example, the second adhesive member 152 may be individually disposed in each of the second vibration generator 221 and the third vibration generator 222, or may be disposed in common in the second vibration generator 221 and the third vibration generator 222 which are provided as one body, but embodiments of the present disclosure are not limited thereto. Also, each of the fourth vibration generator 223 and the fifth vibration generator 224 may be disposed at a second surface 102b of the second vibration member 102. For example, the fourth vibration generator 223 and the fifth vibration generator 224 may be disposed at the second surface 102b of the second vibration member 102 so as to be spaced apart from each other in the first direction X. For example, each of the fourth vibration generator 223 and the fifth vibration generator 224 may be connected with or coupled to the second surface 102b of the second vibration member 102 by a third adhesive member 153. For example, the third adhesive member 153 may be individually disposed in each of the fourth vibration generator 223 and the fifth vibration generator 224, or may be disposed in common in the fourth vibration generator 223 and the fifth vibration generator 224 which are provided as one body, but embodiments of the present disclosure are not limited thereto. For example, the second and third vibration generators 221 and 222 and the fourth and fifth vibration generators 223 and 224 may be disposed with the second vibration member 102 therebetween. For example, the third and fourth vibration generators 222 and 223 may be disposed to overlap each other with the second vibration member 102 therebetween. Also, the second and fifth vibration generators 221 and 224 may be disposed not to overlap the other vibration generator, or may be disposed to overlap at least a portion of the other vibration generator.

Except for that the first vibration generating apparatus 210 and the second vibration generating apparatus 220 having an asymmetrical structure between the second and third vibration generators 221 and 222 disposed at the first surface 102a of the second vibration member 102 of the second vibration generating apparatus 220 and the fourth and fifth vibration generators 223 and 224 disposed at the second surface 102b of the second vibration member 102 are inverted into a mirror image and disposed, descriptions of an arrangement relationship between the first vibration generating apparatus 210 and the second vibration generating apparatus 220 and an applied vibration generating signal may be the same as or substantially the same as the detailed descriptions of FIG. 34, and thus, are omitted.

According to an embodiment of the present disclosure, the first vibration generating apparatus 210 including a single first vibration generator 211 provided in the first vibration member 101 and the second vibration generating apparatus 220 including the second to fifth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 41, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211 and a second vibration generator 212. Also, the second vibration generating apparatus 220 may include a third vibration generator 221, a fourth vibration generator 222, a fifth vibration generator 223, and a sixth vibration generator 224.

Each of the first vibration generator 211, the second vibration generator 212, the third vibration generator 221, the fourth vibration generator 222, the fifth vibration generator 223, and the sixth vibration generator 224 may include at least one vibration part 201. For example, the at least one vibration part 201 may be a piezoelectric vibration part or a piezoelectric-type vibration part. For example, each of the first vibration generator 211, the second vibration generator 212, the third vibration generator 221, the fourth vibration generator 222, the fifth vibration generator 223, and the sixth vibration generator 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, at least a portion of each of the third vibration generator 221, the fourth vibration generator 222, the fifth vibration generator 223, and the sixth vibration generator 224 of the second vibration generating apparatus 220 may overlap the first and second vibration generators 211 and 212 of the first vibration generating apparatus 210.

The first vibration generator 211 may be disposed at the first surface 101a of the first vibration member 101. For example, the first vibration generator 211 may be connected with or coupled to the first surface 101a of the first vibration member 101 by the first adhesive member 151. Also, the second vibration generator 212 may be disposed at the second surface 101b of the first vibration member 101. For example, the second vibration generator 212 may be connected with or coupled to the first surface 101a of the first vibration member 101 by the second adhesive member 152.

Each of the third vibration generator 221 and the fourth vibration generator 222 may be disposed at the first surface 102a of the second vibration member 102. For example, the third vibration generator 221 and the fourth vibration generator 222 may be disposed at the first surface 102a of the second vibration member 102 so as to be spaced apart from each other in the first direction X. For example, each of the third vibration generator 221 and the fourth vibration generator 222 may be connected with or coupled to the first surface 102a of the second vibration member 102 by the third adhesive member 153. For example, the third adhesive member 153 may be individually disposed in each of the third vibration generator 221 and the fourth vibration generator 222, or may be disposed in common in the third vibration generator 221 and the fourth vibration generator 222 which are provided as one body, but embodiments of the present disclosure are not limited thereto. Also, each of the fifth vibration generator 223 and the sixth vibration generator 224 may be disposed at the second surface 102b of the second vibration member 102. For example, the fifth vibration generator 223 and the sixth vibration generator 224 may be disposed at the second surface 102b of the second vibration member 102 so as to be spaced apart from each other in the first direction X. For example, each of the fifth vibration generator 223 and the sixth vibration generator 224 may be connected with or coupled to the second surface 102b of the second vibration member 102 by the fourth adhesive member 154. For example, the fourth adhesive member 154 may be individually disposed in each of the fifth vibration generator 223 and the sixth vibration generator 224, or may be disposed in common in the fifth vibration generator 223 and the sixth vibration generator 224 which are provided as one body, but embodiments of the present disclosure are not limited thereto. For example, the third and fourth vibration generators 221 and 222 and the fifth and sixth vibration generators 223 and 224 may be disposed with the second vibration member 102 therebetween. For example, the fourth and fifth vibration generators 222 and 223 may be disposed to overlap each other with the second vibration member 102 therebetween. Also, the third and sixth vibration generators 221 and 224 may be disposed not to overlap the other vibration generator, or may be disposed to overlap at least a portion of the other vibration generator.

Except for that the first vibration generating apparatus 210 and the second vibration generating apparatus 220 having an asymmetrical structure between the third and fourth vibration generators 221 and 222 disposed at the first surface 102a of the second vibration member 102 of the second vibration generating apparatus 220 and the fifth and sixth vibration generators 223 and 224 disposed at the second surface 102b of the second vibration member 102 are inverted into a mirror image and disposed, descriptions of an arrangement relationship between the first vibration generating apparatus 210 and the second vibration generating apparatus 220 and an applied vibration generating signal may be the same as or substantially the same as the detailed descriptions of FIG. 25, and thus, are omitted.

According to an embodiment of the present disclosure, the first vibration generating apparatus 210 including the first and second vibration generators 211 and 212 provided in the first vibration member 101 and the second vibration generating apparatus 220 including the third to sixth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

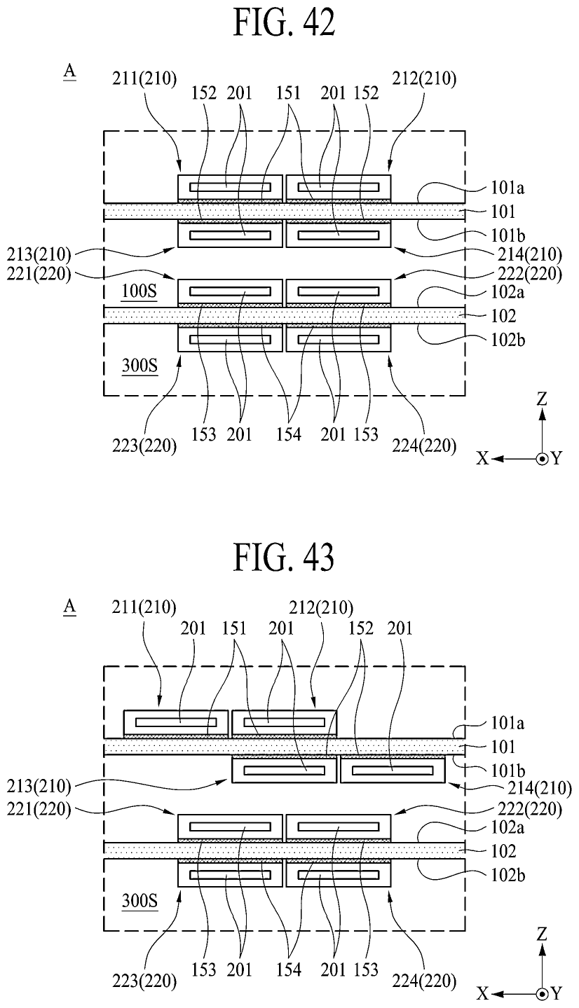

Referring to FIG. 42, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a fifth vibration generator 221, a sixth vibration generator 222, a seventh vibration generator 223, and an eighth vibration generator 224.

Each of the first vibration generator 211, the second vibration generator 212, the third vibration generator 213, the fourth vibration generator 214, the fifth vibration generator 221, the sixth vibration generator 222, the seventh vibration generator 223, and the eighth vibration generator 224 may include at least one vibration part 201. For example, the at least one vibration part 201 may be a piezoelectric vibration part or a piezoelectric-type vibration part. For example, each of the first to eighth vibration generators 211 to 214 and 221 to 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, the first to fourth vibration generators 211 to 214 of the first vibration generating apparatus 210 may overlap the fifth to eighth vibration generators 221 to 224 of the second vibration generating apparatus 220.

Each of the first vibration generator 211 and the second vibration generator 212 may be disposed at a first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by a first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at a second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by a second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the first and second vibration generators 211 and 212 and the third and fourth vibration generators 213 and 214 may be disposed to overlap each other with the first vibration member 101 therebetween.

Each of the fifth vibration generator 221 and the sixth vibration generator 222 may be disposed at a first surface 102a of the second vibration member 102. For example, the fifth vibration generator 221 and the sixth vibration generator 222 may be disposed at the first surface 102a of the second vibration member 102 so as to be spaced apart from each other in the first direction X. For example, each of the fifth vibration generator 221 and the sixth vibration generator 222 may be connected with or coupled to the first surface 102a of the second vibration member 102 by a third adhesive member 153. For example, the third adhesive member 153 may be individually disposed in each of the fifth vibration generator 221 and the sixth vibration generator 222, or may be disposed in common in the fifth vibration generator 221 and the sixth vibration generator 222 which are provided as one body, but embodiments of the present disclosure are not limited thereto. Also, each of the seventh vibration generator 223 and the eighth vibration generator 224 may be disposed at a second surface 102b of the second vibration member 102. For example, the seventh vibration generator 223 and the eighth vibration generator 224 may be disposed at the second surface 102b of the second vibration member 102 so as to be spaced apart from each other in the first direction X. For example, each of the seventh vibration generator 223 and the eighth vibration generator 224 may be connected with or coupled to the second surface 102b of the second vibration member 102 by a fourth adhesive member 154. For example, the fourth adhesive member 154 may be individually disposed in each of the seventh vibration generator 223 and the eighth vibration generator 224, or may be disposed in common in the seventh vibration generator 223 and the eighth vibration generator 224 which are provided as one body, but embodiments of the present disclosure are not limited thereto. For example, the fifth and sixth vibration generators 221 and 222 and the seventh and eighth vibration generators 223 and 224 may be disposed with the second vibration member 102 therebetween. For example, the fifth and sixth vibration generators 221 and 222 and the seventh and eighth vibration generators 223 and 224 may be disposed to overlap each other with the second vibration member 102 therebetween.

Except for that a plurality of vibration generators 211 and 212 of the first vibration generating apparatus 210 are provided at the first surface 101a of the first vibration member 101, a plurality of vibration generators 213 and 214 are provided at the second surface 101b of the first vibration member 101, a plurality of vibration generators 221 and 222 of the second vibration generating apparatus 220 are provided at the first surface 102a of the second vibration member 102, and a plurality of vibration generators 223 and 224 are provided at the second surface 102b of the second vibration member 102, descriptions of an arrangement relationship between the first vibration generating apparatus 210 and the second vibration generating apparatus 220 and an applied vibration generating signal may be the same as or substantially the same as the detailed descriptions of FIG. 21, and thus, may be omitted or may be briefly given.

For example, the first vibration generating apparatus 210 and the second vibration generating apparatus 220 may be disposed in the same space. For example, the third and fourth vibration generators 213 and 214 and the fifth and sixth vibration generators 221 and 222 may be disposed in the same space. For example, the third and fourth vibration generators 213 and 214 and the fifth and sixth vibration generators 221 and 222 may be disposed in the first space 100S. For example, the third and fourth vibration generators 213 and 214 and the fifth and sixth vibration generators 221 and 222 may be disposed in the first space 100S between the first vibration member 101 and the second vibration member 102. For example, the third and fourth vibration generators 213 and 214 and the fifth and sixth vibration generators 221 and 222 may be disposed to face each other in the first space 100S. For example, the third and fourth vibration generators 213 and 214 and the fifth and sixth vibration generators 221 and 222 may be disposed to overlap each other in the first space 100S. For example, the third and fourth vibration generators 213 and 214 and the fifth and sixth vibration generators 221 and 222 may be disposed to face and overlap each other in the first space 100S.

For example, the first vibration generating apparatus 210 and the second vibration generating apparatus 220 may be disposed in different spaces. For example, the first and second vibration generators 211 and 212 and the fifth and sixth vibration generators 221 and 222 may be disposed in different spaces. For example, the fifth and sixth vibration generators 221 and 222 may be disposed in the first space 100S. For example, the first and second vibration generators 211 and 212 and the fifth and sixth vibration generators 221 and 222 may be disposed with the first vibration member 101 therebetween. For example, the first and second vibration generators 211 and 212 and the fifth and sixth vibration generators 221 and 222 may be disposed to overlap each other with the first vibration member 101 therebetween.

For example, the first vibration generating apparatus 210 and the second vibration generating apparatus 220 may be disposed in different spaces. For example, the third and fourth vibration generators 213 and 214 and the seventh and eighth vibration generators 223 and 224 may be disposed in different spaces. For example, the third and fourth vibration generators 213 and 214 may be disposed in the first space 100S. For example, the seventh and eighth vibration generators 223 and 224 may be disposed in the second space 300S. For example, the third and fourth vibration generators 213 and 214 and the seventh and eighth vibration generators 223 and 224 may be disposed with the second vibration member 102 therebetween. For example, the third and fourth vibration generators 213 and 214 and the seventh and eighth vibration generators 223 and 224 may be disposed to overlap each other with the second vibration member 102 therebetween.

For example, the first vibration generating apparatus 210 may be disposed in a different space. For example, the third and fourth vibration generators 213 and 214 may be disposed in the first space 100S. For example, the first and second vibration generators 211 and 212 and the third and fourth vibration generators 213 and 214 may be disposed with the first vibration member 101 therebetween. For example, the first and second vibration generators 211 and 212 and the third and fourth vibration generators 213 and 214 may be disposed to overlap each other with the first vibration member 101 therebetween.

For example, the second vibration generating apparatus 220 may be disposed in a different space. For example, the fifth and sixth vibration generators 221 and 222 may be disposed in the first space 100S. For example, the seventh and eighth vibration generators 223 and 224 may be disposed in the second space 300S. For example, the fifth and sixth vibration generators 221 and 222 and the seventh and eighth vibration generators 223 and 224 may be disposed with the second vibration member 102 therebetween. For example, the fifth and sixth vibration generators 221 and 222 and the seventh and eighth vibration generators 223 and 224 may be disposed to overlap each other with the second vibration member 102 therebetween.

The first vibration generating apparatus 210 and the second vibration generating apparatus 220 may be disposed to face the same direction. For example, the first and second vibration generators 211 and 212 and the fifth and sixth vibration generators 221 and 222 may be disposed to face the same direction. For example, the first and second vibration generators 211 and 212 and the fifth and sixth vibration generators 221 and 222 may be disposed to face an upward direction in the third direction Z. For example, the third and fourth vibration generators 213 and 214 and the seventh and eighth vibration generators 223 and 224 may be disposed to face the same direction. For example, the third and fourth vibration generators 213 and 214 and the seventh and eighth vibration generators 223 and 224 may be disposed to face a downward direction in the third direction Z.

The first vibration generating apparatus 210 and the second vibration generating apparatus 220 may be disposed to face different directions. For example, the first and second vibration generators 211 and 212 and the seventh and eighth vibration generators 223 and 224 may be disposed to face different directions. For example, the first vibration generator 211 and the second vibration generator 212 may be disposed to face an upward direction in the third direction Z. For example, the seventh and eighth vibration generators 223 and 224 may be disposed to face a downward direction in the third direction Z. For example, the third and fourth vibration generators 213 and 214 and the fifth and sixth vibration generators 221 and 222 may be disposed to face different directions. For example, the third and fourth vibration generators 213 and 214 may be disposed to face a downward direction in the third direction Z. For example, the fifth and sixth vibration generators 221 and 222 may be disposed to face an upward direction in the third direction Z.

The first vibration generating apparatus 210 may be disposed in a different direction. For example, the first vibration generator 211 and the second vibration generator 212 may be disposed to face an upward direction in the third direction Z. For example, the third and fourth vibration generators 213 and 214 may be disposed to face a downward direction in the third direction Z.

The second vibration generating apparatus 220 may be disposed in a different direction. For example, the fifth vibration generator 221 and the sixth vibration generator 222 may be disposed to face an upward direction in the third direction Z. For example, the seventh and eighth vibration generators 223 and 224 may be disposed to face a downward direction in the third direction Z.

According to an embodiment of the present disclosure, the first vibration generating apparatus 210 including the first to fourth vibration generators 211 to 214 provided in the first vibration member 101 and the second vibration generating apparatus 220 including the fifth to eighth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 43, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a fifth vibration generator 221, a sixth vibration generator 222, a seventh vibration generator 223, and an eighth vibration generator 224.

Each of the first vibration generator 211, the second vibration generator 212, the third vibration generator 213, the fourth vibration generator 214, the fifth vibration generator 221, the sixth vibration generator 222, the seventh vibration generator 223, and the eighth vibration generator 224 may include at least one vibration part 201. For example, the at least one vibration part 201 may be a piezoelectric vibration part or a piezoelectric-type vibration part. For example, each of the first to eighth vibration generators 211 to 214 and 221 to 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, the first to fourth vibration generators 211 to 214 of the first vibration generating apparatus 210 may overlap the fifth to eighth vibration generators 221 to 224 of the second vibration generating apparatus 220.

Each of the first vibration generator 211 and the second vibration generator 212 may be disposed at a first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by a first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at a second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by a second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the second vibration generator 212 and the third vibration generator 213 may be disposed to overlap each other with the first vibration member 101 therebetween. Also, the first and fourth vibration generators 211 and 214 may be disposed not to overlap the other vibration generator, or may be disposed to overlap at least a portion of the other vibration generator.

Each of the fifth vibration generator 221 and the sixth vibration generator 222 may be disposed at a first surface 102a of the second vibration member 102. For example, the fifth vibration generator 221 and the sixth vibration generator 222 may be disposed at the first surface 102a of the second vibration member 102 so as to be spaced apart from each other in the first direction X. For example, each of the fifth vibration generator 221 and the sixth vibration generator 222 may be connected with or coupled to the first surface 102a of the second vibration member 102 by a third adhesive member 153. For example, the third adhesive member 153 may be individually disposed in each of the fifth vibration generator 221 and the sixth vibration generator 222, or may be disposed in common in the fifth vibration generator 221 and the sixth vibration generator 222 which are provided as one body, but embodiments of the present disclosure are not limited thereto. Also, each of the seventh vibration generator 223 and the eighth vibration generator 224 may be disposed at a second surface 102b of the second vibration member 102. For example, the seventh vibration generator 223 and the eighth vibration generator 224 may be disposed at the second surface 102b of the second vibration member 102 so as to be spaced apart from each other in the first direction X. For example, each of the seventh vibration generator 223 and the eighth vibration generator 224 may be connected with or coupled to the second surface 102b of the second vibration member 102 by a fourth adhesive member 154. For example, the fourth adhesive member 154 may be individually disposed in each of the seventh vibration generator 223 and the eighth vibration generator 224, or may be disposed in common in the seventh vibration generator 223 and the eighth vibration generator 224 which are provided as one body. but embodiments of the present disclosure are not limited thereto. For example, the fifth and sixth vibration generators 221 and 222 and the seventh and eighth vibration generators 223 and 224 may be disposed with the second vibration member 102 therebetween. For example, the fifth and sixth vibration generators 221 and 222 and the seventh and eighth vibration generators 223 and 224 may be disposed to overlap each other with the second vibration member 102 therebetween.

Except for that a plurality of vibration generators 211 and 212 of the first vibration generating apparatus 210 are provided at the first surface 101a of the first vibration member 101, a plurality of vibration generators 213 and 214 are provided at the second surface 101b of the first vibration member 101, a plurality of vibration generators 221 and 222 of the second vibration generating apparatus 220 are provided at the first surface 102a of the second vibration member 102, and a plurality of vibration generators 223 and 224 are provided at the second surface 102b of the second vibration member 102 and the first and second vibration generators 211 and 212 disposed at the first surface 101a of the first vibration member 101 and the third and fourth vibration generators 213 and 214 disposed at the second surface 101b of the first vibration member 101 are disposed to have an asymmetrical structure with respect to each other, descriptions of an arrangement relationship between the first vibration generating apparatus 210) and the second vibration generating apparatus 220 and an applied vibration generating signal may be the same as or substantially the same as the detailed descriptions of FIGS. 21 and 42, and thus, may be omitted.

According to an embodiment of the present disclosure, the first vibration generating apparatus 210) including the first to fourth vibration generators 211 to 214 provided in the first vibration member 101 and the second vibration generating apparatus 220 including the fifth to eighth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

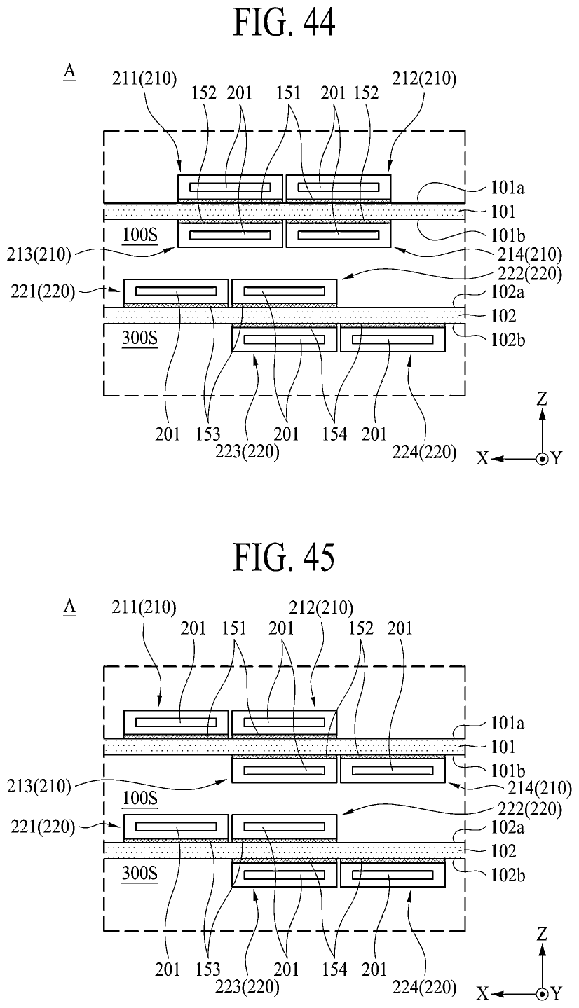

Referring to FIG. 44, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a fifth vibration generator 221, a sixth vibration generator 222, a seventh vibration generator 223, and an eighth vibration generator 224.

Each of the first vibration generator 211, the second vibration generator 212, the third vibration generator 213, the fourth vibration generator 214, the fifth vibration generator 221, the sixth vibration generator 222, the seventh vibration generator 223, and the eighth vibration generator 224 may include at least one vibration part 201. For example, the at least one vibration part 201 may be a piezoelectric vibration part or a piezoelectric-type vibration part. For example, each of the first to eighth vibration generators 211 to 214 and 221 to 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, the first to fourth vibration generators 211 to 214 of the first vibration generating apparatus 210 may overlap the fifth to eighth vibration generators 221 to 224 of the second vibration generating apparatus 220.

Each of the first vibration generator 211 and the second vibration generator 212 may be disposed at the first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by the first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at the second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by the second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the first and second vibration generators 211 and 212 and the third and fourth vibration generators 213 and 214 may be disposed to overlap each other with the first vibration member 101 therebetween.

Each of the fifth vibration generator 221 and the sixth vibration generator 222 may be disposed at the first surface 102a of the second vibration member 102. For example, the fifth vibration generator 221 and the sixth vibration generator 222 may be disposed at the first surface 102a of the second vibration member 102 so as to be spaced apart from each other in the first direction X. For example, each of the fifth vibration generator 221 and the sixth vibration generator 222 may be connected with or coupled to the first surface 102a of the second vibration member 102 by the third adhesive member 153. For example, the third adhesive member 153 may be individually disposed in each of the fifth vibration generator 221 and the sixth vibration generator 222, or may be disposed in common in the fifth vibration generator 221 and the sixth vibration generator 222 which are provided as one body, but embodiments of the present disclosure are not limited thereto. Also, each of the seventh vibration generator 223 and the eighth vibration generator 224 may be disposed at the second surface 102b of the second vibration member 102. For example, the seventh vibration generator 223 and the eighth vibration generator 224 may be disposed at the second surface 102b of the second vibration member 102 so as to be spaced apart from each other in the first direction X. For example, each of the seventh vibration generator 223 and the eighth vibration generator 224 may be connected with or coupled to the second surface 102b of the second vibration member 102 by the fourth adhesive member 154. For example, the fourth adhesive member 154 may be individually disposed in each of the seventh vibration generator 223 and the eighth vibration generator 224, or may be disposed in common in the seventh vibration generator 223 and the eighth vibration generator 224 which are provided as one body, but embodiments of the present disclosure are not limited thereto. For example, the fifth and sixth vibration generators 221 and 222 and the seventh and eighth vibration generators 223 and 224 may be disposed with the second vibration member 102 therebetween. For example, the sixth and seventh vibration generators 222 and 223 may be disposed to overlap each other with the second vibration member 102 therebetween. Also, the fifth and eighth vibration generators 221 and 224 may be disposed to overlap or not to overlap the other vibration generator with the second vibration member 102 therebetween.

Except for that a plurality of vibration generators 211 and 212 of the first vibration generating apparatus 210 are provided at the first surface 101a of the first vibration member 101, a plurality of vibration generators 213 and 214 are provided at the second surface 101b of the first vibration member 101, a plurality of vibration generators 221 and 222 of the second vibration generating apparatus 220 are provided at the first surface 102a of the second vibration member 102, and a plurality of vibration generators 223 and 224 are provided at the second surface 102b of the second vibration member 102, and the plurality of vibration generators 221 and 222 provided at the first surface 102a of the second vibration member 102 and the plurality of vibration generators 223 and 224 provided at the second surface 102b of the second vibration member 102 are disposed to have an asymmetrical structure therebetween, descriptions of an arrangement relationship between the first vibration generating apparatus 210 and the second vibration generating apparatus 220 and an applied vibration generating signal may be the same as or substantially the same as the detailed descriptions of FIGS. 21 and 42, and thus, may be omitted.

According to an embodiment of the present disclosure, the first vibration generating apparatus 210 including the first to fourth vibration generators 211 to 214 provided in the first vibration member 101 and the second vibration generating apparatus 220 including the fifth to eighth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 45, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

At least one of the first vibration generating apparatus 210 and the second vibration generating apparatus 220 may include a plurality of vibration generators. For example, the first vibration generating apparatus 210 may include a first vibration generator 211, a second vibration generator 212, a third vibration generator 213, and a fourth vibration generator 214. Also, the second vibration generating apparatus 220 may include a fifth vibration generator 221, a sixth vibration generator 222, a seventh vibration generator 223, and an eighth vibration generator 224.

Each of the first vibration generator 211, the second vibration generator 212, the third vibration generator 213, the fourth vibration generator 214, the fifth vibration generator 221, the sixth vibration generator 222, the seventh vibration generator 223, and the eighth vibration generator 224 may include at least one vibration part 201. For example, the at least one vibration [art 201 may be a piezoelectric vibration part or a piezoelectric-type vibration part. For example, each of the first to eighth vibration generators 211 to 214 and 221 to 224 may include a vibration part 201 which is individually configured.

The first vibration generating apparatus 210 may at least partially overlap the second vibration generating apparatus 220. For example, at least a portion of the first vibration generating apparatus 210 may overlap the second vibration generating apparatus 220. For example, the first to fourth vibration generators 211 to 214 of the first vibration generating apparatus 210 may overlap the fifth to eighth vibration generators 221 to 224 of the second vibration generating apparatus 220.

Each of the first vibration generator 211 and the second vibration generator 212 may be disposed at the first surface 101a of the first vibration member 101. For example, the first vibration generator 211 and the second vibration generator 212 may be disposed at the first surface 101a of the first vibration member 101 so as to be spaced apart from each other in the first direction X. For example, each of the first vibration generator 211 and the second vibration generator 212 may be connected with or coupled to the first surface 101a of the first vibration member 101 by the first adhesive member 151. For example, the first adhesive member 151 may be individually disposed in each of the first vibration generator 211 and the second vibration generator 212, or may be disposed in common in the first vibration generator 211 and the second vibration generator 212 which are provided as one body, but embodiments of the present disclosure are not limited thereto. Also, each of the third vibration generator 213 and the fourth vibration generator 214 may be disposed at the second surface 101b of the first vibration member 101. For example, the third vibration generator 213 and the fourth vibration generator 214 may be disposed at the second surface 101b of the first vibration member 101 so as to be spaced apart from each other in the first direction X. For example, each of the third vibration generator 213 and the fourth vibration generator 214 may be connected with or coupled to the second surface 101b of the first vibration member 101 by the second adhesive member 152. For example, the second adhesive member 152 may be individually disposed in each of the third vibration generator 213 and the fourth vibration generator 214, or may be disposed in common in the third vibration generator 213 and the fourth vibration generator 214 which are provided as one body, but embodiments of the present disclosure are not limited thereto. For example, the first and second vibration generators 211 and 212 and the third and fourth vibration generators 213 and 214 may be disposed with the first vibration member 101 therebetween. For example, the second and third vibration generators 212 and 213 may be disposed to overlap each other with the first vibration member 101 therebetween. Also, the first and fourth vibration generators 211 and 214 may be disposed to overlap or not to overlap each other with the first vibration member 101 therebetween.

Each of the fifth vibration generator 221 and the sixth vibration generator 222 may be disposed at the first surface 102a of the second vibration member 102. For example, the fifth vibration generator 221 and the sixth vibration generator 222 may be disposed at the first surface 102a of the second vibration member 102 so as to be spaced apart from each other in the first direction X. For example, each of the fifth vibration generator 221 and the sixth vibration generator 222 may be connected with or coupled to the first surface 102a of the second vibration member 102 by the third adhesive member 153. For example, the third adhesive member 153 may be individually disposed in each of the fifth vibration generator 221 and the sixth vibration generator 222, or may be disposed in common in the fifth vibration generator 221 and the sixth vibration generator 222 which are provided as one body, but embodiments of the present disclosure are not limited thereto. Also, each of the seventh vibration generator 223 and the eighth vibration generator 224 may be disposed at the second surface 102b of the second vibration member 102. For example, the seventh vibration generator 223 and the eighth vibration generator 224 may be disposed at the second surface 102b of the second vibration member 102 so as to be spaced apart from each other in the first direction X. For example, each of the seventh vibration generator 223 and the eighth vibration generator 224 may be connected with or coupled to the second surface 102b of the second vibration member 102 by the fourth adhesive member 154. For example, the fourth adhesive member 154 may be individually disposed in each of the seventh vibration generator 223 and the eighth vibration generator 224, or may be disposed in common in the seventh vibration generator 223 and the eighth vibration generator 224 which are provided as one body, but embodiments of the present disclosure are not limited thereto. For example, the fifth and sixth vibration generators 221 and 222 and the seventh and eighth vibration generators 223 and 224 may be disposed with the second vibration member 102 therebetween. For example, the sixth and seventh vibration generators 221 and 223 may be disposed to overlap each other with the second vibration member 102 therebetween. Also, the fifth and eighth vibration generators 221 and 224 may be disposed to overlap or not to overlap the other vibration generator with the second vibration member 102 therebetween.

Except for that a plurality of vibration generators 211 and 212 of the first vibration generating apparatus 210 are provided at the first surface 101a of the first vibration member 101, a plurality of vibration generators 213 and 214 are provided at the second surface 101b of the first vibration member 101, a plurality of vibration generators 221 and 222 of the second vibration generating apparatus 220 are provided at the first surface 102a of the second vibration member 102, and a plurality of vibration generators 223 and 224 are provided at the second surface 102b of the second vibration member 102, the first and second vibration generators 211 and 212 disposed at the first surface 101a of the first vibration member 101 and the third and fourth vibration generators 213 and 214 disposed at the second surface 101b of the first vibration member 101 are disposed to have an asymmetrical structure, and the plurality of vibration generators 221 and 222 provided at the first surface 102a of the second vibration member 102 and the plurality of vibration generators 223 and 224 provided at the second surface 102b of the second vibration member 102 are disposed to have an asymmetrical structure therebetween, descriptions of an arrangement relationship between the first vibration generating apparatus 210 and the second vibration generating apparatus 220 and an applied vibration generating signal may be the same as or substantially the same as the detailed descriptions of FIGS. 21 and 42, and thus, may be omitted.

According to an embodiment of the present disclosure, the first vibration generating apparatus 210 including the first to fourth vibration generators 211 to 214 provided in the first vibration member 101 and the second vibration generating apparatus 220 including the fifth to eighth vibration generators 221 to 224 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

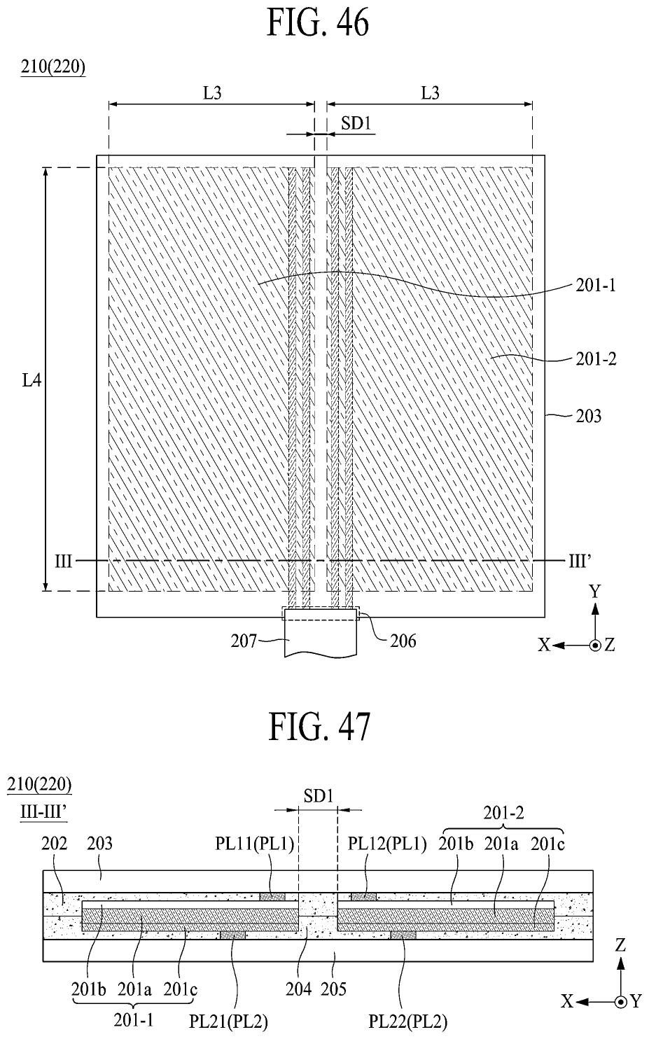

FIG. 46 illustrates a vibration generating apparatus according to another embodiment of the present disclosure. FIG. 47 is a cross-sectional view taken along line III-III′ illustrated in FIG. 46 according to another embodiment of the present disclosure. FIGS. 46 and 47 illustrate a first vibration generating apparatus or a second vibration generating apparatus of a vibration apparatus according to another embodiment of the present disclosure.

Referring to FIGS. 46 and 47, a vibration generating apparatus 210 and 220 (or a first vibration generating apparatus 210 or a second vibration generating apparatus 220) according to another embodiment of the present disclosure may include a first vibration part 201-1 and a second vibration part 201-2.

The first and second vibration parts 201-1 and 201-2 may be electrically disconnected from each other and may be disposed to be spaced apart from each other in a first direction X. The first and second vibration parts 201-1 and 201-2 may be spaced apart from each other in parallel. Each of the first and second vibration parts 201-1 and 201-2 may alternately and repeatedly contract and/or expand based on a piezoelectric effect, and thus, may vibrate. For example, the first and second vibration parts 201-1 and 201-2 may be arranged or tiled at a certain separation interval (or distance) SD1 in the first direction X. Therefore, the vibration generating apparatus 210 and 220 (or the first vibration generating apparatus 210 or the second vibration generating apparatus 220) where the first and second vibration parts 201-1 and 201-2 are tiled may be a vibration array, a vibration array part, a vibration module array part, a vibration array structure, a tiling vibration array, a tiling array module, or a tiling vibration film, but embodiments of the present disclosure are not limited thereto.

The first and second vibration parts 201-1 and 201-2 according to an embodiment of the present disclosure may each have a tetragonal shape which has a third length L3 and a fourth length L4. For example, each of the first and second vibration parts 201-1 and 201-2 may have a rectangular shape which has the third length L3 of 5 cm or more and the fourth length L4 of 10 cm or more, but embodiments of the present disclosure are not limited thereto.

The first and second vibration parts 201-1 and 201-2 may be disposed or tiled on the same plane, and thus, the vibration generating apparatus 210 and 220 (or the first vibration generating apparatus 210 or the second vibration generating apparatus 220) may increase in screen size, based on tiling of the first and second vibration parts 201-1 and 201-2 having a relatively small size.

The first and second vibration parts 201-1 and 201-2 may be arranged or tiled at the certain separation interval (or distance) SD1, and thus, may be implemented as one vibration apparatus (or a single vibration generating apparatus or a single vibration generator) which is not independently driven and is driven as one stable single-body type. According to an embodiment of the present disclosure, with respect to the first direction X, the separation distance SD1 between the first and second vibration parts 201-1 and 201-2 may be 0.1 mm or more and less than 3 cm, but embodiments of the present disclosure are not limited thereto.

According to an embodiment of the present disclosure, the first and second vibration parts 201-1 and 201-2 may be arranged or tiled at the separation distance (or interval) SD1 of 0.1 mm or more and less than 3 cm, and thus, may be driven as one vibration apparatus, thereby increasing a reproduction band and a sound pressure level characteristic of a sound generated based on a single-body vibration of the first and second vibration parts 201-1 and 201-2. For example, the first and second vibration parts 201-1 and 201-2 may be arranged at the separation interval (or distance) SD1 of 0.1 mm or more and less than 5 mm, so as to increase a reproduction band of a sound generated based on a single-body vibration of the first and second vibration parts 201-1 and 201-2 and increase a sound pressure level characteristic of a sound of a low-pitched sound band (for example, 500 Hz or less).

According to an embodiment of the present disclosure, in a case where the first and second vibration parts 201-1 and 201-2 are disposed at the separation distance SD1 of less than 0. 1 mm or without the separation distance SD1, the reliability of the first and second vibration parts 201-1 and 201-2 or the vibration apparatus 200 may be reduced due to damage or the occurrence of a crack caused by a physical contact between the first and second vibration parts 201-1 and 201-2 when each of the first and second vibration parts 201-1 and 201-2 is vibrating.

According to an embodiment of the present disclosure, in a case where the first and second vibration parts 201-1 and 201-2 are arranged at the separation distance SD1 of 3 cm or more, the first and second vibration parts 201-1 and 201-2 may not be driven as one vibration apparatus due to an independent vibration of each of the first and second vibration parts 201-1 and 201-2. Therefore, a reproduction band and a sound pressure level characteristic of a sound generated based on vibrations of the first and second vibration parts 201-1 and 201-2 may be reduced. For example, in a case where the first and second vibration parts 201-1 and 201-2 are arranged at the separation interval SD1 of 3 cm or more, a sound characteristic and a sound pressure level characteristic of the low-pitched sound band (for example, 500 Hz or less) may be reduced.

According to an embodiment of the present disclosure, in a case where the first and second vibration parts 201-1 and 201-2 are arranged at the separation interval SD1 of 5 mm, because the first and second vibration parts 201-1 and 201-2 are not driven as one vibration apparatus, a sound characteristic and a sound pressure level characteristic of the low-pitched sound band (for example, 200 Hz or less) may be reduced.

According to another embodiment of the present disclosure, in a case where the first and second vibration parts 201-1 and 201-2 are arranged at the separation interval SD1 of 1 mm, as the first and second vibration parts 201-1 and 201-2 vibrate as one vibration apparatus, a reproduction band of a sound may increase and a sound pressure level characteristic of a sound of the low-pitched sound band (for example, 500 Hz or less) may increase. For example, in a case where the first and second vibration parts 201-1 and 201-2 are arranged at the separation interval SD1 of 1 mm, the vibration generating apparatus 210 and 220 may be implemented as a vibration body which increase in screen size as a separation distance between the first and second vibration parts 201-1 and 201-2 are optimized. Accordingly, the first and second vibration parts 201-1 and 201-2 may be driven as a large-screen vibration body based on a single-body vibration thereof, and thus, a reproduction band of a sound generated based on a single-body vibration of the first and second vibration parts 201-1 and 201-2 and a sound characteristic and/or a sound pressure level characteristic of the low-pitched sound band may increase or may be enhanced.

Therefore, in order to implement a single-body vibration (or one vibration apparatus) of the first and second vibration parts 201-1 and 201-2, the separation distance SD1 between the first and second vibration parts 201-1 and 201-2 may be set to 0.1 mm or more and less than 3 cm. Also, in order to implement a single-body vibration (or one vibration apparatus) of the first and second vibration parts 201-1 and 201-2 and increase a sound pressure level of a sound of the low-pitched sound band, the separation distance SD1 between the first and second vibration parts 201-1 and 201-2 may be set to 0.1 mm or more and less than 5 mm.

According to an embodiment of the present disclosure, each of the first and second vibration parts 201-1 and 201-2 may include a vibration layer 201a, a first electrode layer 201b, and a second electrode layer 201c.

The vibration layer 201a of each of the first and second vibration parts 201-1 and 201-2 may include an electro active material or a piezoelectric material including a piezoelectric effect. For example, the vibration layer 201a of each of the first and second vibration parts 201-1 and 201-2 may be configured to be equal to one of the vibration layers 201a described above with reference to FIGS. 11 and 12, and thus, like reference numerals refer to like elements and repeated descriptions thereof are omitted. For example, in FIG. 46, the vibration layer 201a of FIG. 11 is illustrated, but the vibration layer 201a of FIG. 12 may be provided.

According to an embodiment of the present disclosure, each of the first and second vibration parts 201-1 and 201-2 may include one vibration layer 201a of the vibration layers 201a described above with reference to FIGS. 11 and 12, or may include different vibration layers 201a.

The first electrode layer 201b may be disposed at a first surface of the vibration layer 201a and may be electrically connected with the first surface of the vibration layer 201a. This may be substantially the same as the first electrode layer 201b described above with reference to FIG. 11, and thus, like reference numerals refer to like elements and repeated descriptions thereof are omitted.

The second electrode layer 201c may be disposed at a second surface of the vibration layer 201a and may be electrically connected with the second surface of the vibration layer 201a. This may be substantially the same as the second electrode layer 201c described above with reference to FIG. 11, and thus, like reference numerals refer to like elements and repeated descriptions thereof are omitted.

The vibration generating apparatus 210 and 220 (or the first vibration generating apparatus 210 or the second vibration generating apparatus 220) according to another embodiment of the present disclosure may further include a first cover member 203 and a second cover member 205.

The first cover member 203 may be disposed at a first surface of the vibration generating apparatus 210 and 220 (or the first vibration generating apparatus 210 or the second vibration generating apparatus 220). For example, the first cover member 203 may cover the first electrode layer 201b disposed on a first surface of each of the first and second vibration parts 201-1 and 201-2, and thus, may be connected with the first surface of each of the first and second vibration parts 201-1 and 201-2 in common or may support the first surface of each of the first and second vibration parts 201-1 and 201-2 in common. Accordingly, the first cover member 203 may protect the first electrode layer 201b or the first surface of each of the first and second vibration parts 201-1 and 201-2.

The second cover member 205 may be disposed at a second surface of the vibration generating apparatus 210 and 220 (or the first vibration generating apparatus 210 or the second vibration generating apparatus 220). For example, the second cover member 205 may cover the second electrode layer 201c disposed on a second surface of each of the first and second vibration parts 201-1 and 201-2, and thus, may be connected with the second surface of each of the first and second vibration parts 201-1 and 201-2 in common or may support the second surface of each of the first and second vibration parts 201-1 and 201-2 in common. Accordingly, the second cover member 205 may protect the second electrode layer 201c or the second surface of each of the first and second vibration parts 201-1 and 201-2.

Each of the first cover member 203 and the second cover member 205 according to an embodiment of the present disclosure may include one or more materials of plastic, fiber, and wood, but embodiments of the present disclosure are not limited thereto. For example, the first cover member 203 and the second cover member 205 may include the same material or different materials. For example, the first cover member 203 and the second cover member 205 may be a polyimide film or a polyethylene terephthalate film, but embodiments of the present disclosure are not limited thereto.

The first cover member 203 according to an embodiment of the present disclosure may be disposed at the first surface of each of the first and second vibration parts 201-1 and 201-2 by a first adhesive layer 202. For example, the first cover member 203 may be directly disposed at the first surface of each of the first and second vibration parts 201-1 and 201-2 by a film laminating process using the first adhesive layer 202. Accordingly, the first and second vibration parts 201-1 and 201-2 may be arranged (or integrated) or tiled at the separation interval SD1 in the first cover member 203.

The second cover member 205 according to an embodiment of the present disclosure may be disposed at the second surface of each of the first and second vibration parts 201-1 and 201-2 by a second adhesive layer 204. For example, the second cover member 205 may be directly disposed at the second surface of each of the first and second vibration parts 201-1 and 201-2 by a film laminating process using the second adhesive layer 204. Accordingly, the first and second vibration parts 201-1 and 201-2 may be arranged (or integrated) or tiled at the separation interval SD1 in the second cover member 205.

The first adhesive layer 202 may be disposed between the first and second vibration parts 201-1 and 201-2 and at the first surface of each of the first and second vibration parts 201-1 and 201-2. For example, the first adhesive layer 202 may be formed at a rear surface (or an inner surface) of the first cover member 203 facing the first surface of each of the first and second vibration parts 201-1 and 201-2, and thus, may be filled between the first and second vibration parts 201-1 and 201-2 and may be disposed between the first cover member 203 and the first surface of each of the first and second vibration parts 201-1 and 201-2.

The second adhesive layer 204 may be disposed between the first and second vibration parts 201-1 and 201-2 and at the second surface of each of the first and second vibration parts 201-1 and 201-2. For example, the second adhesive layer 204 may be formed at a front surface (or an inner surface) of the second cover member 205 facing the second surface of each of the first and second vibration parts 201-1 and 201-2, and thus, may be filled between the first and second vibration parts 201-1 and 201-2 and may be disposed between the second cover member 205 and the second surface of each of the first and second vibration parts 201-1 and 201-2.

The first and second adhesive layers 202 and 204 may be connected with or coupled to each other between the first and second vibration parts 201-1 and 201-2. Therefore, the first and second vibration parts 201-1 and 201-2 may be surrounded by the first and second adhesive layers 202 and 204. For example, the first and second adhesive layers 202 and 204 may be configured between the first cover member 203 and the second cover member 205 to fully surround each of the first and second vibration parts 201-1 and 201-2. For example, each of the first and second vibration parts 201-1 and 201-2 may be buried or embedded between the first adhesive layer 202 and the second adhesive layer 204.

The first and second adhesive layers 202 and 204 according to an embodiment of the present disclosure may include an electrical insulating material which has adhesive properties and is capable of compression and decompression. For example, each of the first and second adhesive layers 202 and 204 may include epoxy resin, acrylic resin, silicone resin, or urethane resin, but embodiments of the present disclosure are not limited thereto. For example, each of the first and second adhesive layers 202 and 204 may be configured to be transparent, semitransparent, or opaque.

The vibration generating apparatus 210 and 220 (or the first vibration generating apparatus 210 or the second vibration generating apparatus 220) according to another embodiment of the present disclosure may further include a first power supply line PL1, a second power supply line PL2, and a pad part 206.

The first power supply line PL1 may be disposed in the first cover member 203. For example, the first power supply line PL1 may be disposed at a rear surface of the first cover member 203 facing the first surface of each of the first and second vibration parts 201-1 and 201-2. The first power supply line PL1 may be electrically connected with the first electrode layer 201b of each of the first and second vibration parts 201-1 and 201-2. For example, the first power supply line PL1 may be directly and electrically connected with the first electrode layer 201b of each of the first and second vibration parts 201-1 and 201-2. For example, the first power supply line PL1 may be electrically connected with the first electrode layer 201b of each of the first and second vibration parts 201-1 and 201-2 by an anisotropic conductive film. As another example, the first power supply line PL1 may be electrically connected with the first electrode layer 201b of each of the first and second vibration parts 201-1 and 201-2 by a conductive material (or particle) included in the first adhesive layer 202.

The first power supply line PL1 according to an embodiment of the present disclosure may include first and second upper power lines PL11 and PL12 which are disposed in a second direction Y. For example, the first upper power line PL11 may be electrically connected with the first electrode layer 201b of the first vibration part 201-1. The second upper power line PL12 may be electrically connected with the first electrode layer 201b of the second vibration part 201-2.

The second power supply line PL2 may be disposed in the second cover member 205. For example, the second power supply line PL2 may be disposed at a front surface of the second cover member 205 facing the second surface of each of the first and second vibration parts 201-1 and 201-2. The second power supply line PL2 may be electrically connected with the second electrode layer 201c of each of the first and second vibration parts 201-1 and 201-2. For example, the second power supply line PL2 may be directly and electrically connected with the second electrode layer 201c of each of the first and second vibration parts 201-1 and 201-2. For example, the second power supply line PL2 may be electrically connected with the second electrode layer 201c of each of the first and second vibration parts 201-1 and 201-2 by an anisotropic conductive film. As another example, the second power supply line PL2 may be electrically connected with the second electrode layer 201c of each of the first and second vibration parts 201-1 and 201-2 by a conductive material (or particle) included in the second adhesive layer 204.

The second power supply line PL2 according to an embodiment of the present disclosure may include first and second lower power lines PL21 and PL22 which are disposed in the second direction Y. For example, the first lower power line PL21 may be electrically connected with the second electrode layer 201c of the first vibration part 201-1. The second lower power line PL22 may be electrically connected with the second electrode layer 201c of the second vibration part 201-2. According to an embodiment of the present disclosure, the first upper power line PL11 may be disposed not to overlap the first lower power line PL21. In a case where the first upper power line PL11 is disposed not to overlap the first lower power line PL21, a problem of a short circuit defect between the first upper power line PL11 and the first lower power line PL21 may be solved. According to an embodiment of the present disclosure, the second upper power line PL12 may be disposed not to overlap the second lower power line PL22. In a case where the second upper power line PL12 is disposed not to overlap the second lower power line PL22, a problem of a short circuit defect between the second upper power line PL12 and the second lower power line PL22 may be solved.

The pad part 206 may be electrically connected to the first power supply line PL1 and the second power supply line PL2. For example, the pad part 206 may be provided at one edge portion (or one periphery portion) of one of the first cover member 203 and the second cover member 205 so as to be electrically connected to one side (or one end or one portion) of each of the first power supply line PL1 and the second power supply line PL2.

The pad part 206 according to an embodiment of the present disclosure may include a first pad electrode which is electrically connected to one end of the first power supply line PL1 and a second pad electrode which is electrically connected to one end of the second power supply line PL2.

A first pad electrode may be connected with one end (or one side) of each of the first and second upper power lines PL11 and PL12 of the first power supply line PL1 in common. For example, the one end of each of the first and second upper power lines PL11 and PL12 may branch from the first pad electrode. The second pad electrode may be connected with one end of each of the first and second lower power lines PL21 and PL22 of the second power supply line PL2 in common. For example, the one end (or one side) of each of the first and second lower power lines PL21 and PL22 may branch from the second pad electrode.

The vibration generating apparatus 210 and 220 (or the first vibration generating apparatus 210 or the second vibration generating apparatus 220) according to another embodiment of the present disclosure may further include a signal cable 207.

The signal cable 207 may be electrically connected with the pad part 206 disposed in the vibration generating apparatus 210 and 220 and may supply a vibration driving signal (or a sound signal), supplied from a sound processing circuit, to the vibration generating apparatus 210 and 220. The signal cable 207 according to an embodiment of the present disclosure may include a first terminal electrically connected with the first pad electrode of the pad part 206 and a second terminal electrically connected with the second pad electrode of the pad part 206. For example, the signal cable 207 may be a flexible printed circuit board (PCB), a flexible flat cable, a single-sided flexible printed circuit, a single-sided flexible PCB, a flexible multi-layer printed circuit, or a flexible multi-layer PCB, but embodiments of the present disclosure are not limited thereto.

The sound processing circuit may generate an alternating current (AC) vibration driving signal including a first vibration driving signal and a second vibration driving signal, based on sound data. The first vibration driving signal may be one of a positive (+) vibration driving signal and a negative (−) vibration driving signal, and the second vibration driving signal may be one of the positive (+) vibration driving signal and the negative (−) vibration driving signal. For example, the first vibration driving signal may be supplied to the first electrode layer 201b of each of the first and second vibration parts 201-1 and 201-2 through the first terminal of the signal cable 207, the first pad electrode of the pad part 206, and the first power supply line PL1. The second vibration driving signal may be supplied to the second electrode layer 201c of each of the first and second vibration parts 201-1 and 201-2 through the second terminal of the signal cable 207, the second pad electrode of the pad part 206, and the second power supply line PL2.

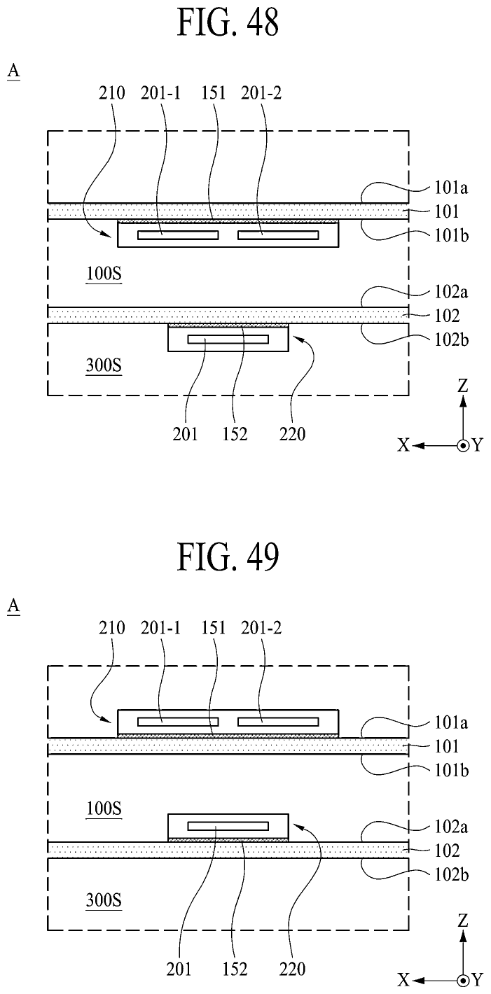

FIGS. 48 to 71 illustrate an arrangement structure of the vibration generating apparatus illustrated in the region A of FIG. 9 according to another embodiment of the present disclosure. FIGS. 48 to 71 illustrate various examples of an arrangement structure of a vibration generating apparatus including the plurality of vibration parts described above with reference to FIGS. 46 and 47, in the apparatus 8 described above with reference to FIG. 9. FIGS. 48 to 71 illustrate an embodiment where the arrangement of a vibration generating apparatus is applied to the apparatus 8 and may be identically applied to the apparatuses 1 to 7 described above with reference to FIGS. 1 to 8. Therefore, in the following description, like elements except the arrangement of a vibration generating apparatus and relevant elements are referred to by like reference numerals, and repeated descriptions thereof are omitted or will be briefly given.

Referring to FIG. 48, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In an apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. For example, the first and second vibration parts 201-1 and 201-2 may be electrically disconnected from each other and may be disposed to be spaced apart from each other in a first direction X. Each of the first and second vibration parts 201-1 and 201-2 may be disposed at a center portion of the first vibration generating apparatus 210 or the second vibration generating apparatus 220. For example, each of the first and second vibration parts 201-1 and 201-2 may be disposed at the other center portion, except an edge portion, of the first vibration generating apparatus 210 or the second vibration generating apparatus 220. The first and second vibration parts 201-1 and 201-2 may be configured to be displaced (or vibrated or driven) in the same direction. Vibration driving signals respectively applied to the first and second vibration parts 201-1 and 201-2 may have the same phase or opposite phases, but embodiments of the present disclosure are not limited thereto.

According to an embodiment of the present disclosure, in the first vibration generating apparatus 210 or the second vibration generating apparatus 220, the first and second vibration parts 201-1 and 201-2 may be implemented as one vibration apparatus (or a single vibration apparatus) which is not independently driven and is completely driven as one single-body type. The first vibration generating apparatus 210 or the second vibration generating apparatus 220 may be driven as a large-screen vibration body based on a single vibration of the first and second vibration parts 201-1 and 201-2, and thus, a reproduction band of a sound generated based on a single-body vibration of the first and second vibration parts 201-1 and 201-2 and a sound characteristic and/or a sound pressure level characteristic of the low-pitched sound band may increase or may be enhanced.

The first vibration member 101 and the second vibration member 102 may be disposed spaced apart from each other in the third direction Z and may be provided to include a first space 100S between the first vibration member 101 and the second vibration member 102. Also, a second surface 102b (or a rear surface) of the second vibration member 102 may be configured to include a second space 300S which is surrounded by an enclosure 300.

As illustrated in FIG. 48, a first vibration generating apparatus 210 may include a plurality of vibration parts 201-1 and 201-2. For example, the first vibration generating apparatus 210 may include a first vibration part 201-1 and a second vibration part 201-2. Also, a second vibration generating apparatus 220 may include at least one vibration part 201. For example, the second vibration generating apparatus 220 may include a vibration part 201 which is individually provided. For example, the second vibration generating apparatus 220 may include a single vibration part 201. The first vibration generating apparatus 210 may at least partially overlap the second vibration generating apparatus 220. For example, at least a portion of the first vibration generating apparatus 210 may overlap the second vibration generating apparatus 220.

The first vibration generating apparatus 210 may be disposed at a second surface 101b of the first vibration member 101. For example, the first vibration generating apparatus 210 may be connected with or coupled to the second surface 101b of the first vibration member 101 by a first adhesive member 151. The first vibration generating apparatus 210 may include a first vibration part 201-1 and a second vibration part 201-2. For example, the first vibration generating apparatus 210 may be disposed in the first space 100S between the first vibration member 101 and the second vibration member 102 and may be covered by the first vibration member 101, and thus, may be protected from an external impact.

The second vibration generating apparatus 220 may be disposed at a second surface 102b of the second vibration member 102. For example, the second vibration generating apparatus 220 may be connected with or coupled to the second surface 102b of the second vibration member 102 by a second adhesive member 152. The second vibration generating apparatus 220 may include a single vibration part 201. For example, the second vibration generating apparatus 220 may be disposed in a second space 300S between the second vibration member 102 and an enclosure 300 and may be covered by the enclosure 300, and thus, may be protected from an external impact.

For example, the first vibration generating apparatus 210 and the second vibration generating apparatus 220 may be disposed in different spaces. For example, the first vibration generating apparatus 210 may be disposed in the first space 100S. For example, the first vibration generating apparatus 210 may be disposed in the first space 100S between the first vibration member 101 and the second vibration member 102. For example, the second vibration generating apparatus 220 may be disposed in the second space 300S.

For example, the first vibration generating apparatus 210 and the second vibration generating apparatus 220 may be disposed with the second vibration member 102 therebetween. For example, the first vibration generating apparatus 210 and the second vibration generating apparatus 220 may be disposed to overlap each other with the second vibration member 102 therebetween.

The first vibration generating apparatus 210 and the second vibration generating apparatus 220 may be disposed to face the same direction. For example, the first vibration generating apparatus 210 and the second vibration generating apparatus 220 may be disposed to face a downward direction in the third direction Z.

The first vibration part 201-1 and the second vibration part 201-2 of the first vibration generating apparatus 210 may at least partially overlap the vibration part 201 of the second vibration generating apparatus 220. For example, the first vibration part 201-1, the second vibration part 201-2, and the vibration part 201 may have substantially the same size. Also, the first vibration generating apparatus 210 including the first vibration part 201-1 and the second vibration part 201-2 may have a size which is greater than that of the second vibration generating apparatus 220 including the single vibration part 201.

A center portion between the first vibration part 201-1 and the second vibration part 201-2 of the first vibration generating apparatus 210 may overlap a center portion of the vibration part 201 of the second vibration generating apparatus 220. For example, the first vibration part 201-1 of the first vibration generating apparatus 210 may overlap a first region (or a left region) of the vibration part 201 of the second vibration generating apparatus 220. Also, the second vibration part 201-2 of the first vibration generating apparatus 210 may overlap a second region (or a right region) of the vibration part 201 of the second vibration generating apparatus 220.

The first vibration generating apparatus 210 and the second vibration generating apparatus 220) may be identically disposed at the second surfaces 101b and 102b (or the rear surfaces) of the lower portion in the third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210 and a vibration driving signal applied to the second vibration generating apparatus 220) may have the same phase or may have a phase difference therebetween, but embodiments of the present disclosure are not limited thereto.

Vibration driving signals respectively applied to the first vibration part 201-1 and the second vibration part 201-2 of the first vibration generating apparatus 210 may have the same phase, or may have a phase difference therebetween. For example, the vibration driving signals respectively applied to the first vibration part 201-1 and the second vibration part 201-2 of the first vibration generating apparatus 210 may have a phase difference therebetween caused by signal delay. For example. the vibration driving signals respectively applied to the first vibration part 201-1 and the second vibration part 201-2 of the first vibration generating apparatus 210 may have the same phase as that of a vibration driving signal applied to the second vibration generating apparatus 220. For example, at least one of the vibration driving signal applied to the first vibration part 201-1 of the first vibration generating apparatus 210 and the vibration driving signal applied to the second vibration part 201-2 may have the same phase as or a phase difference with that of the vibration driving signal applied to the second vibration generating apparatus 220. For example, the vibration driving signal applied to the first vibration part 201-1 of the first vibration generating apparatus 210 may have the same phase as that of the vibration driving signal applied to the second vibration generating apparatus 220 or may have a phase difference therebetween caused by signal delay. For example, the vibration driving signal applied to the second vibration part 201-2 of the first vibration generating apparatus 210 may have the same phase as that of the vibration driving signal applied to the second vibration generating apparatus 220 or may have a phase difference therebetween caused by signal delay.

According to an embodiment of the present disclosure, the first vibration generating apparatus 210 including the first vibration part 201-1 and the second vibration part 201-2 provided in the first vibration member 101 and the second vibration generating apparatus 220 including the single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 49, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2.

As illustrated in FIG. 49, a first vibration generating apparatus 210 may include a plurality of vibration parts 201-1 and 201-2. For example, the first vibration generating apparatus 210 may include a first vibration part 201-1 and a second vibration part 201-2. Also, a second vibration generating apparatus 220 may include at least one vibration part 201. For example, the second vibration generating apparatus 220 may include a vibration part 201 which is individually provided. For example, the second vibration generating apparatus 220 may include a single vibration part 201. The first vibration generating apparatus 210 may at least partially overlap the second vibration generating apparatus 220. For example, at least a portion of the first vibration generating apparatus 210 may overlap the second vibration generating apparatus 220. The first vibration generating apparatus 210 may be disposed at a first surface 101a of the first vibration member 101. For example, the first vibration generating apparatus 210 may be connected with or coupled to the first surface 101a of the first vibration member 101 by a first adhesive member 151. The first vibration generating apparatus 210 may include the first vibration part 201-1 and the second vibration part 201-2.

The second vibration generating apparatus 220 may be disposed at a first surface 102a of the second vibration member 102. For example, the second vibration generating apparatus 220 may be connected with or coupled to the first surface 102a of the second vibration member 102 by a second adhesive member 152. The second vibration generating apparatus 220 may include a single vibration part 201. For example, the second vibration generating apparatus 220 may be disposed in a first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in different spaces. For example, the second vibration generating apparatus 220 may be disposed in the first space 100S. For example, the second vibration generating apparatus 220 may be disposed in the first space 100S between the first vibration member 101 and the second vibration member 102.

For example, the first vibration generating apparatus 210 and the second vibration generating apparatus 220 may be disposed with the first vibration member 101 therebetween. For example, the first vibration generating apparatus 210 and the second vibration generating apparatus 220 may be disposed to overlap each other with the first vibration member 101 therebetween.

The first vibration generating apparatus 210 and the second vibration generating apparatus 220 may be disposed to face the same direction. For example, the first vibration generating apparatus 210 and the second vibration generating apparatus 220 may be disposed to face an upward direction in the third direction Z.

The first vibration part 201-1 and the second vibration part 201-2 of the first vibration generating apparatus 210 may at least partially overlap the vibration part 201 of the second vibration generating apparatus 220. For example, the first vibration part 201-1, the second vibration part 201-2, and the vibration part 201 may have substantially the same size. Also, the first vibration generating apparatus 210 including the first vibration part 201-1 and the second vibration part 201-2 may have a size which is greater than that of the second vibration generating apparatus 220 including the single vibration part 201.

A center portion between the first vibration part 201-1 and the second vibration part 201-2 of the first vibration generating apparatus 210 may overlap a center portion of the vibration part 201 of the second vibration generating apparatus 220. For example, the first vibration part 201-1 of the first vibration generating apparatus 210 may overlap a portion of a first region (or a left region) of the vibration part 201 of the second vibration generating apparatus 220. Also, the second vibration part 201-2 of the first vibration generating apparatus 210 may overlap a portion of a second region (or a right region) of the vibration part 201 of the second vibration generating apparatus 220.

The first vibration generating apparatus 210 and the second vibration generating apparatus 220 may be identically disposed at first surfaces 101a and 102a (or upper surfaces) of an upper side in a third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210 and a vibration driving signal applied to the second vibration generating apparatus 220 may have the same phase, or may have a phase difference therebetween. For example, the vibration driving signals respectively applied to the first vibration generating apparatus 210 and the second vibration generating apparatus 220 may be as described above with reference to FIG. 48, and thus, repeated descriptions thereof are omitted.

According to an embodiment of the present disclosure, the first vibration generating apparatus 210 including the first vibration part 201-1 and the second vibration part 201-2 provided in the first vibration member 101 and the second vibration generating apparatus 220 including the single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

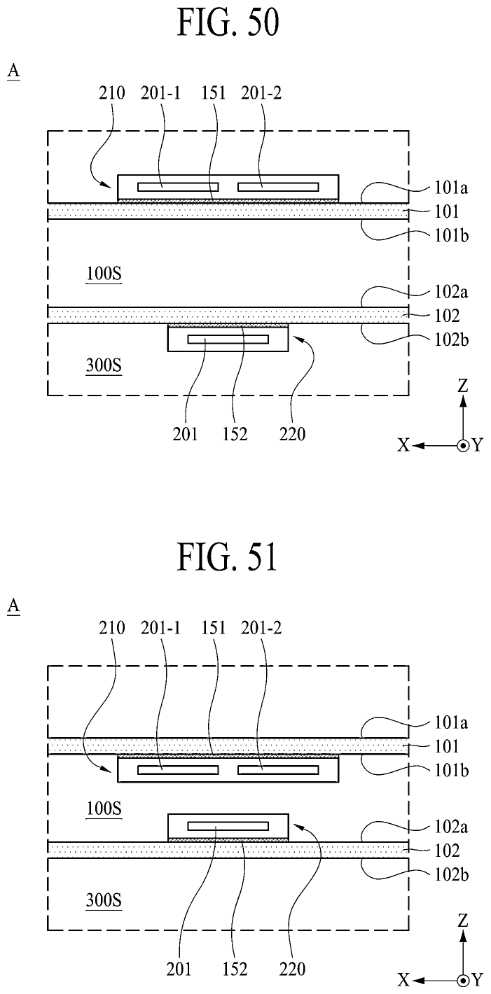

Referring to FIG. 50, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2.

As illustrated in FIG. 50, a first vibration generating apparatus 210 may include a plurality of vibration parts 201-1 and 201-2. For example, the first vibration generating apparatus 210 may include a first vibration part 201-1 and a second vibration part 201-2. Also, a second vibration generating apparatus 220 may include at least one vibration part 201. For example, the second vibration generating apparatus 220 may include a vibration part 201 which is individually provided. For example, the second vibration generating apparatus 220 may include a single vibration part 201. The first vibration generating apparatus 210 may at least partially overlap the second vibration generating apparatus 220. For example, at least a portion of the first vibration generating apparatus 210 may overlap the second vibration generating apparatus 220.

The first vibration generating apparatus 210 may be disposed at a first surface 101a of the first vibration member 101. For example, the first vibration generating apparatus 210 may be connected with or coupled to the first surface 101a of the first vibration member 101 by a first adhesive member 151. The first vibration generating apparatus 210 may include the first vibration part 201-1 and the second vibration part 201-2.

The second vibration generating apparatus 220 may be disposed at a second surface 102b of the second vibration member 102. For example, the second vibration generating apparatus 220 may be connected with or coupled to the second surface 102b of the second vibration member 102 by a second adhesive member 152. The second vibration generating apparatus 220 may include a single vibration part 201. For example, the second vibration generating apparatus 220 may be disposed in a second space 300S between the second vibration member 102 and an enclosure 300 and may be covered by the enclosure 300, and thus, may be protected from an external impact.

For example, the first vibration generating apparatus 210 and the second vibration generating apparatus 220 may be disposed in different spaces. For example, the second vibration generating apparatus 220 may be disposed in the second space 300S.

For example, the first vibration generating apparatus 210 and the second vibration generating apparatus 220 may be disposed with the first vibration member 101 and the second vibration member 102 therebetween. For example, the first vibration generating apparatus 210 and the second vibration generating apparatus 220 may be disposed to overlap each other with the first vibration member 101 and the second vibration member 102 therebetween.

For example, the first vibration generating apparatus 210 and the second vibration generating apparatus 220 may be disposed with the first space 100S therebetween. For example, the first vibration generating apparatus 210 and the second vibration generating apparatus 220 may be disposed to overlap each other with the first space 100S therebetween.

The first vibration generating apparatus 210 and the second vibration generating apparatus 220 may be disposed to face different directions. For example, the first vibration generating apparatus 210 may be disposed to face an upward direction in the third direction Z. For example, the second vibration generating apparatus 220 may be disposed to face a downward direction in the third direction Z.

The first vibration part 201-1 and the second vibration part 201-2 of the first vibration generating apparatus 210 may at least partially overlap the vibration part 201 of the second vibration generating apparatus 220. For example, the first vibration part 201-1, the second vibration part 201-2, and the vibration part 201 may have substantially the same size. Also, the first vibration generating apparatus 210 including the first vibration part 201-1 and the second vibration part 201-2 may have a size which is greater than that of the second vibration generating apparatus 220 including the single vibration part 201.

A center portion between the first vibration part 201-1 and the second vibration part 201-2 of the first vibration generating apparatus 210 may overlap a center portion of the vibration part 201 of the second vibration generating apparatus 220. For example, the first vibration part 201-1 of the first vibration generating apparatus 210 may overlap a portion of a first region (or a left region) of the vibration part 201 of the second vibration generating apparatus 220. Also, the second vibration part 201-2 of the first vibration generating apparatus 210 may overlap a portion of a second region (or a right region) of the vibration part 201 of the second vibration generating apparatus 220.

The first vibration generating apparatus 210 and the second vibration generating apparatus 220 may be disposed at the first surface 101a (or the upper surface) and the second surface 102b (or the rear surface) of opposite sides in the third direction Zin the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220 may have opposite phases or may have a phase difference therebetween.

Vibration driving signals respectively applied to the first vibration part 201-1 and the second vibration part 201-2 of the first vibration generating apparatus 210 may have the same phase, or may have a phase difference therebetween. For example, the vibration driving signals respectively applied to the first vibration part 201-1 and the second vibration part 201-2 of the first vibration generating apparatus 210 may have a phase difference therebetween caused by signal delay. For example, the vibration driving signals respectively applied to the first vibration part 201-1 and the second vibration part 201-2 of the first vibration generating apparatus 210 may have a phase opposite to that of a vibration driving signal applied to the second vibration generating apparatus 220. For example, at least one of the vibration driving signal applied to the first vibration part 201-1 of the first vibration generating apparatus 210 and the vibration driving signal applied to the second vibration part 201-2 may have a phase opposite to or a phase difference with that of the vibration driving signal applied to the second vibration generating apparatus 220. For example, the vibration driving signal applied to the first vibration part 201-1 of the first vibration generating apparatus 210 may have a phase opposite to that of the vibration driving signal applied to the second vibration generating apparatus 220 or may have a phase difference therebetween caused by signal delay. For example, the vibration driving signal applied to the second vibration part 201-2 of the first vibration generating apparatus 210 may have a phase opposite to that of the vibration driving signal applied to the second vibration generating apparatus 220 or may have a phase difference therebetween caused by signal delay.

According to an embodiment of the present disclosure, the first vibration generating apparatus 210 including the first vibration part 201-1 and the second vibration part 201-2 provided in the first vibration member 101 and the second vibration generating apparatus 220 including a single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 51, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2.

As illustrated in FIG. 51, a first vibration generating apparatus 210 may include a plurality of vibration parts 201-1 and 201-2. For example, the first vibration generating apparatus 210 may include a first vibration part 201-1 and a second vibration part 201-2. Also, a second vibration generating apparatus 220 may include at least one vibration part 201. For example, the second vibration generating apparatus 220 may include a vibration portion 201 which is individually provided. For example, the second vibration generating apparatus 220 may include a single vibration part 201. The first vibration generating apparatus 210 may at least partially overlap the second vibration generating apparatus 220. For example, at least a portion of the first vibration generating apparatus 210 may overlap the second vibration generating apparatus 220.

The first vibration generating apparatus 210 may be disposed at a second surface 101b of the first vibration member 101. For example, the first vibration generating apparatus 210 may be connected with or coupled to the second surface 101b of the first vibration member 101 by a first adhesive member 151. The first vibration generating apparatus 210 may include a first vibration part 201-1 and a second vibration part 201-2. For example, the first vibration generating apparatus 210 may be disposed in the first space 100S between the first vibration member 101 and the second vibration member 102 and may be covered by the first vibration member 101, and thus, may be protected from an external impact.

The second vibration generating apparatus 220 may be disposed at a first surface 102a of the second vibration member 102. For example, the second vibration generating apparatus 220 may be connected with or coupled to the first surface 102a of the second vibration member 102 by a second adhesive member 152. The second vibration generating apparatus 220 may include a single vibration part 201. For example, the second vibration generating apparatus 220 may be disposed in a first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in the same space. For example, the first vibration generating apparatus 210 and the second vibration generating apparatus 220 may be disposed in the first space 100S. For example, the first vibration generating apparatus 210 and the second vibration generating apparatus 220 may be disposed to face each other in the first space 100S. For example, the first vibration generating apparatus 210 and the second vibration generating apparatus 220 may be disposed to overlap each other in the first space 100S.

For example, the first vibration generating apparatus 210 and the second vibration generating apparatus 220 may be disposed to face different directions. For example, the first vibration generating apparatus 210 may be disposed to face a downward direction in the third direction Z. For example, the second vibration generating apparatus 220 may be disposed to face an upward direction in the third direction Z.

The first vibration part 201-1 and the second vibration part 201-2 of the first vibration generating apparatus 210 may at least partially overlap the vibration part 201 of the second vibration generating apparatus 220. For example, the first vibration part 201-1, the second vibration part 201-2, and the vibration part 201 may have substantially the same size. Also, the first vibration generating apparatus 210 including the first vibration part 201-1 and the second vibration part 201-2 may have a size which is greater than that of the second vibration generating apparatus 220 including the single vibration part 201.

A center portion between the first vibration part 201-1 and the second vibration part 201-2 of the first vibration generating apparatus 210 may overlap a center portion of the vibration part 201 of the second vibration generating apparatus 220. For example, the first vibration part 201-1 of the first vibration generating apparatus 210 may overlap a portion of a first region (or a left region) of the vibration part 201 of the second vibration generating apparatus 220. Also, the second vibration part 201-2 of the first vibration generating apparatus 210 may overlap a portion of a second region (or a right region) of the vibration part 201 of the second vibration generating apparatus 220.

The first vibration generating apparatus 210 and the second vibration generating apparatus 220 may be disposed at the second surface 101b (or the rear surface) and the first surface 102a (or the upper surface) of the opposite sides in the third direction Z in the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220 may have opposite phases, or may have a phase difference therebetween. For example, the vibration driving signals respectively applied to the first vibration generating apparatus 210 and the second vibration generating apparatus 220 may be as described above with reference to FIG. 50, and thus, repeated descriptions thereof are omitted.

According to an embodiment of the present disclosure, the first vibration generating apparatus 210 including the first vibration part 201-1 and the second vibration part 201-2 provided in the first vibration member 101 and the second vibration generating apparatus 220 including a single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

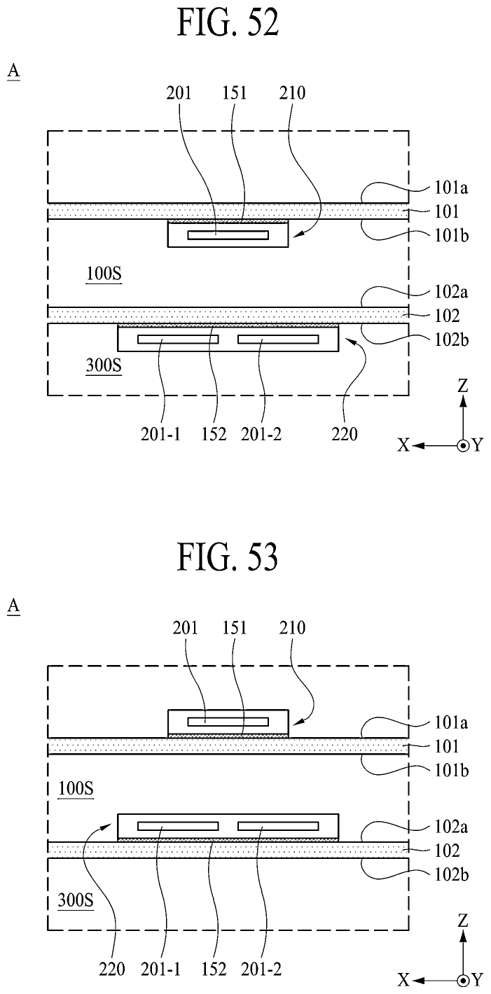

Referring to FIG. 52, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2.

As illustrated in FIG. 52, a first vibration generating apparatus 210 may include at least one vibration part 201. For example, the first vibration generating apparatus 210 may include a vibration part 201 which is individually provided. Also, a second vibration generating apparatus 220 may include a plurality of vibration parts 201-1 and 201-2. For example, the second vibration generating apparatus 220 may include a first vibration part 201-1 and a second vibration part 201-2. The first vibration generating apparatus 210 may at least partially overlap the second vibration generating apparatus 220. For example, at least a portion of the second vibration generating apparatus 220 may overlap the first vibration generating apparatus 210.

The first vibration generating apparatus 210 may be disposed at a second surface 101b of the first vibration member 101. For example, the first vibration generating apparatus 210 may be connected with or coupled to the second surface 101b of the first vibration member 101 by a first adhesive member 151. The first vibration generating apparatus 210 may include a single vibration part 201. For example, the first vibration generating apparatus 210 may be disposed in a first space 100S between the first vibration member 101 and the second vibration member 102 and may be covered by the first vibration member 101, and thus, may be protected from an external impact.

The second vibration generating apparatus 220 may be disposed at a second surface 102b of the second vibration member 102. For example, the second vibration generating apparatus 220 may be connected with or coupled to the second surface 102b of the second vibration member 102 by a second adhesive member 152. The second vibration generating apparatus 220 may include a first vibration part 201-1 and a second vibration part 201-2. For example, the second vibration generating apparatus 220 may be disposed in a second space 300S between the second vibration member 102 and an enclosure 300 and may be covered by the enclosure 300, and thus, may be protected from an external impact.

For example, the first vibration generating apparatus 210 and the second vibration generating apparatus 220 may be disposed in different spaces. For example, the first vibration generating apparatus 210 may be disposed in the first space 300S. For example, the second vibration generating apparatus 220 may be disposed in the second space 300S.

For example, the first vibration generating apparatus 210 and the second vibration generating apparatus 220 may be disposed with the second vibration member 102 therebetween. For example, the first vibration generating apparatus 210 and the second vibration generating apparatus 220 may be disposed to overlap each other with the second vibration member 102 therebetween.

The first vibration generating apparatus 210 and the second vibration generating apparatus 220 may be disposed to face the same direction. For example. the first vibration generating apparatus 210) and the second vibration generating apparatus 220) may be disposed to face a downward direction in the third direction Z.

The vibration part 201 of the first vibration generating apparatus 210 may at least partially overlap the first vibration part 201-1 and the second vibration part 201-2 of the second vibration generating apparatus 220. For example, the first vibration part 201-1, the second vibration part 201-2, and the vibration part 201 may have substantially the same size. Also, the first vibration generating apparatus 210 including the single vibration part 201 may have a size which is less than that of the second vibration generating apparatus 220 including the first vibration part 201-1 and the second vibration part 201-2.

A center portion of the vibration part 201 of the first vibration generating apparatus 210 may overlap a center portion between the first vibration part 201-1 and the second vibration part 201-2 of the second vibration generating apparatus 220. For example, the first vibration part 201-1 of the second vibration generating apparatus 220 may overlap a first region (or a left region) of the vibration part 201 of the first vibration generating apparatus 210. Also, the second vibration part 201-2 of the second vibration generating apparatus 220 may overlap a second region (or a right region) of the vibration part 201 of the first vibration generating apparatus 210.

The first vibration generating apparatus 210 and the second vibration generating apparatus 220 may be identically disposed at the second surfaces 101b and 102b (or the rear surfaces) of the lower portion in the third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210) and a vibration driving signal applied to the second vibration generating apparatus 220 may have the same phase or may have a phase difference therebetween, but embodiments of the present disclosure are not limited thereto.

Vibration driving signals respectively applied to the first vibration part 201-1 and the second vibration part 201-2 of the second vibration generating apparatus 220 may have the same phase, or may have a phase difference therebetween. For example, the vibration driving signals respectively applied to the first vibration part 201-1 and the second vibration part 201-2 of the second vibration generating apparatus 220 may have a phase difference therebetween caused by signal delay. For example, the vibration driving signals respectively applied to the first vibration part 201-1 and the second vibration part 201-2 of the second vibration generating apparatus 220 may have the same phase as that of a vibration driving signal applied to the first vibration generating apparatus 210. For example, at least one of the vibration driving signal applied to the first vibration part 201-1 of the second vibration generating apparatus 220 and the vibration driving signal applied to the second vibration part 201-2 of the second vibration generating apparatus 220 may have the same phase as or a phase difference with that of the vibration driving signal applied to the first vibration generating apparatus 210. For example, the vibration driving signal applied to the first vibration part 201-1 of the second vibration generating apparatus 220 may have the same phase as that of the vibration driving signal applied to the first vibration generating apparatus 210 or may have a phase difference therebetween caused by signal delay. For example, the vibration driving signal applied to the second vibration part 201-2 of the second vibration generating apparatus 220 may have the same phase as that of the vibration driving signal applied to the first vibration generating apparatus 210 or may have a phase difference therebetween caused by signal delay.

According to an embodiment of the present disclosure, the first vibration generating apparatus 210 including the single vibration part 201 provided in the first vibration member 101 and the second vibration generating apparatus 220 including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 53, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2.

As illustrated in FIG. 53, a first vibration generating apparatus 210 may include at least one vibration part 201. For example, the first vibration generating apparatus 210 may include a vibration part 201 which is individually provided. Also, a second vibration generating apparatus 220 may include a plurality of vibration parts 201-1 and 201-2. For example, the second vibration generating apparatus 220 may include a first vibration part 201-1 and a second vibration part 201-2. The first vibration generating apparatus 210 may at least partially overlap the second vibration generating apparatus 220. For example, at least a portion of the second vibration generating apparatus 220 may overlap the first vibration generating apparatus 210.

The first vibration generating apparatus 210 may be disposed at the first surface 101a of the first vibration member 101. For example, the first vibration generating apparatus 210 may be connected with or coupled to the first surface 101a of the first vibration member 101 by the first adhesive member 151. The first vibration generating apparatus 210 may include the single vibration part 201.

The second vibration generating apparatus 220 may be disposed at the first surface 102a of the second vibration member 102. For example, the second vibration generating apparatus 220 may be connected with or coupled to the first surface 102a of the second vibration member 102 by the second adhesive member 152. The second vibration generating apparatus 220 may include a first vibration part 201-1 and a second vibration part 201-2. For example, the second vibration generating apparatus 220 may be disposed in the first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in different spaces. For example, the second vibration generating apparatus 220 may be disposed in the first space 100S.

For example, the first vibration generating apparatus 210 and the second vibration generating apparatus 220 may be disposed with the first vibration member 101 therebetween. For example, the first vibration generating apparatus 210 and the second vibration generating apparatus 220 may be disposed to overlap each other with the first vibration member 101 therebetween.

The first vibration generating apparatus 210 and the second vibration generating apparatus 220 may be disposed to face the same direction. For example, the first vibration generating apparatus 210 and the second vibration generating apparatus 220 may be disposed to face an upward direction in the third direction Z.

The vibration part 201 of the first vibration generating apparatus 210 may at least partially overlap the first vibration part 201-1 and the second vibration part 201-2 of the second vibration generating apparatus 220. For example, the first vibration part 201-1, the second vibration part 201-2, and the vibration part 201 may have substantially the same size. Also, the first vibration generating apparatus 210 including the single vibration part 201 may have a size which is less than that of the second vibration generating apparatus 220 including the first vibration part 201-1 and the second vibration part 201-2.

A center portion of the vibration part 201 of the first vibration generating apparatus 210 may overlap a center portion between the first vibration part 201-1 and the second vibration part 201-2 of the second vibration generating apparatus 220. For example, the first vibration part 201-1 of the second vibration generating apparatus 220 may overlap a first region (or a left region) of the vibration part 201 of the first vibration generating apparatus 210. Also, the second vibration part 201-2 of the second vibration generating apparatus 220 may overlap a second region (or a right region) of the vibration part 201 of the first vibration generating apparatus 210.

The first vibration generating apparatus 210 and the second vibration generating apparatus 220 may be identically disposed at first surfaces 101a and 102a (or upper surfaces) of an upper side in the third direction Z in the first vibration member 101 and the second vibration member 102 thereof to have a non-inverted structure and may be configured to be displaced (or driven or vibrated) in the same direction. For example, a vibration driving signal applied to the first vibration generating apparatus 210 and a vibration driving signal applied to the second vibration generating apparatus 220 may have the same phase, or may have a phase difference therebetween. For example, the vibration driving signals respectively applied to the first vibration generating apparatus 210 and the second vibration generating apparatus 220 may be as described above with reference to FIG. 52, and thus, repeated descriptions thereof are omitted.

According to an embodiment of the present disclosure, the first vibration generating apparatus 210 including the single vibration part 201 provided in the first vibration member 101 and the second vibration generating apparatus 220 including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

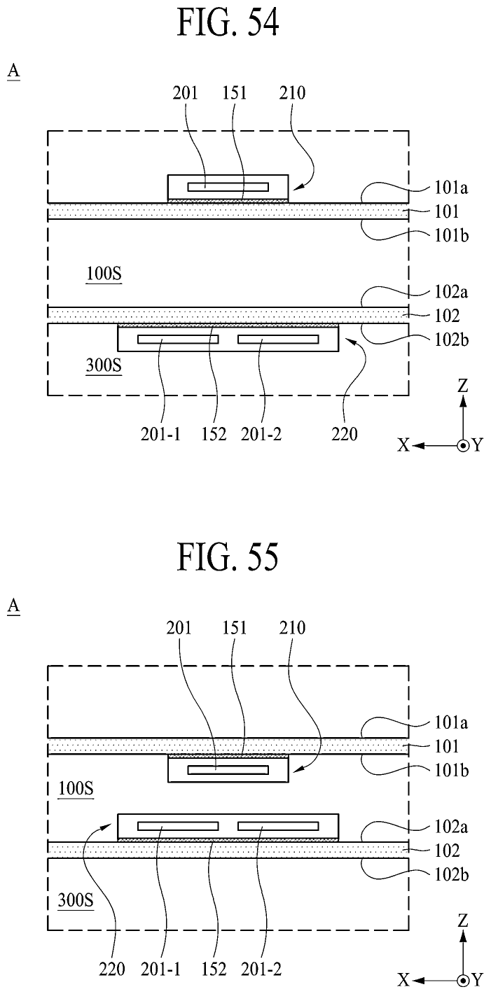

Referring to FIG. 54, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2.

As illustrated in FIG. 54, a first vibration generating apparatus 210 may include at least one vibration part 201. For example, the first vibration generating apparatus 210 may include a vibration part 201 which is individually provided. Also, a second vibration generating apparatus 220 may include a plurality of vibration parts 201-1 and 201-2. For example, the second vibration generating apparatus 220 may include a first vibration part 201-1 and a second vibration part 201-2. The first vibration generating apparatus 210 may at least partially overlap the second vibration generating apparatus 220. For example, at least a portion of the second vibration generating apparatus 220 may overlap the first vibration generating apparatus 210.

The first vibration generating apparatus 210 may be disposed at the first surface 101a of the first vibration member 101. For example, the first vibration generating apparatus 210 may be connected with or coupled to the first surface 101a of the first vibration member 101 by the first adhesive member 151. The first vibration generating apparatus 210 may include the single vibration part 201.

The second vibration generating apparatus 220 may be disposed at a second surface 102b of the second vibration member 102. For example, the second vibration generating apparatus 220 may be connected with or coupled to the second surface 102b of the second vibration member 102 by a second adhesive member 152. The second vibration generating apparatus 220 may include a first vibration part 201-1 and a second vibration part 201-2. For example, the second vibration generating apparatus 220 may be disposed in a second space 300S between the second vibration member 102 and an enclosure 300 and may be covered by the enclosure 300, and thus, may be protected from an external impact.

For example, the first vibration generating apparatus 210 and the second vibration generating apparatus 220 may be disposed in different spaces. For example, the second vibration generating apparatus 220 may be disposed in the second space 300S.

For example, the first vibration generating apparatus 210 and the second vibration generating apparatus 220 may be disposed with the first vibration member 101 and the second vibration member 102 therebetween. For example, the first vibration generating apparatus 210 and the second vibration generating apparatus 220 may be disposed to overlap each other with the first vibration member 101 and the second vibration member 102 therebetween.

For example, the first vibration generating apparatus 210 and the second vibration generating apparatus 220 may be disposed with the first space 100S therebetween. For example, the first vibration generating apparatus 210 and the second vibration generating apparatus 220 may be disposed to overlap each other with the first space 100S therebetween.

The first vibration generating apparatus 210 and the second vibration generating apparatus 220 may be disposed to face different directions. For example, the first vibration generating apparatus 210 may be disposed to face an upward direction in the third direction Z. For example, the second vibration generating apparatus 220 may be disposed to face a downward direction in the third direction Z.

The vibration part 201 of the first vibration generating apparatus 210 may at least partially overlap the first vibration part 201-1 and the second vibration part 201-2 of the second vibration generating apparatus 220. For example, the first vibration part 201-1, the second vibration part 201-2, and the vibration portion 201 may have substantially the same size. Also, the first vibration generating apparatus 210 including the single vibration part 201 may have a size which is less than that of the second vibration generating apparatus 220 including the first vibration part 201-1 and the second vibration part 201-2.

A center portion of the vibration part 201 of the first vibration generating apparatus 210 may overlap a center portion between the first vibration part 201-1 and the second vibration part 201-2 of the second vibration generating apparatus 220. For example, the first vibration part 201-1 of the second vibration generating apparatus 220 may overlap a first region (or a left region) of the vibration part 201 of the first vibration generating apparatus 210. Also, the second vibration part 201-2 of the second vibration generating apparatus 220 may overlap a second region (or a right region) of the vibration part 201 of the first vibration generating apparatus 210.

The first vibration generating apparatus 210 and the second vibration generating apparatus 220 may be disposed at the first surface 101a (or the upper surface) and the second surface 102b (or the rear surface) of opposite sides in the third direction Z in the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220 may have opposite phases or may have a phase difference therebetween.

Vibration driving signals respectively applied to the first vibration part 201-1 and the second vibration part 201-2 of the second vibration generating apparatus 220 may have the same phase, or may have a phase difference therebetween. For example, the vibration driving signals respectively applied to the first vibration part 201-1 and the second vibration part 201-2 of the second vibration generating apparatus 220 may have a phase difference therebetween caused by signal delay. For example, the vibration driving signals respectively applied to the first vibration part 201-1 and the second vibration part 201-2 of the second vibration generating apparatus 220 may have a phase opposite to that of a vibration driving signal applied to the first vibration generating apparatus 210. For example, at least one of the vibration driving signal applied to the first vibration part 201-1 of the second vibration generating apparatus 220 and the vibration driving signal applied to the second vibration part 201-2 of the second vibration generating apparatus 220 may have a phase opposite to or a phase difference with that of the vibration driving signal applied to the first vibration generating apparatus 220. For example, the vibration driving signal applied to the first vibration part 201-1 of the second vibration generating apparatus 220 may have a phase opposite to that of the vibration driving signal applied to the first vibration generating apparatus 210 or may have a phase difference therebetween caused by signal delay. For example, the vibration driving signal applied to the second vibration part 201-2 of the second vibration generating apparatus 220 may have a phase opposite to that of the vibration driving signal applied to the first vibration generating apparatus 210 or may have a phase difference therebetween caused by signal delay.

According to an embodiment of the present disclosure, the first vibration generating apparatus 210 including the single vibration part 201 provided in the first vibration member 101 and the second vibration generating apparatus 220 including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 55, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2.

As illustrated in FIG. 55, a first vibration generating apparatus 210 may include at least one vibration part 201. For example, a first vibration generating apparatus 210 may include a vibration part 201 which is individually provided. For example, the first vibration generating apparatus 210 may include a single vibration part 201. Also, the second vibration generating apparatus 220 may include a plurality of vibration parts 201-1 and 201-2. For example, the second vibration generating apparatus 220 may include a first vibration part 201-1 and a second vibration part 201-2. The first vibration generating apparatus 210 may at least partially overlap the second vibration generating apparatus 220. For example, at least a portion of the second vibration generating apparatus 220 may overlap the first vibration generating apparatus 210.

The first vibration generating apparatus 210 may be disposed at a second surface 101b of the first vibration member 101. For example, the first vibration generating apparatus 210 may be connected with or coupled to the second surface 101b of the first vibration member 101 by a first adhesive member 151. The first vibration generating apparatus 210 may include a single vibration part 201. For example, the first vibration generating apparatus 210 may be disposed in a first space 100S between the first vibration member 101 and the second vibration member 102 and may be covered by the first vibration member 101, and thus, may be protected from an external impact.

The second vibration generating apparatus 220 may be disposed at the first surface 102a of the second vibration member 102. For example, the second vibration generating apparatus 220 may be connected with or coupled to the first surface 102a of the second vibration member 102 by the second adhesive member 152. The second vibration generating apparatus 220 may include a first vibration part 201-1 and a second vibration part 201-2. For example, the second vibration generating apparatus 220 may be disposed in the first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in the same space. For example, the first vibration generating apparatus 210 and the second vibration generating apparatus 220 may be disposed in the first space 100S. For example, the first vibration generating apparatus 210 and the second vibration generating apparatus 220 may be disposed to face each other. For example, the first vibration generating apparatus 210 and the second vibration generating apparatus 220 may be disposed to face each other in the first space 100S. For example, the first vibration generating apparatus 210 and the second vibration generating apparatus 220 may be disposed to overlap each other in the first space 100S.

The first vibration generating apparatus 210 and the second vibration generating apparatus 220 may be disposed to face different directions. For example, the first vibration generating apparatus 210 may be disposed to face a downward direction in the third direction Z. For example, the second vibration generating apparatus 220 may be disposed to face an upward direction in the third direction Z.

The vibration part 201 of the first vibration generating apparatus 210 may at least partially overlap the first vibration part 201-1 and the second vibration part 201-2 of the second vibration generating apparatus 220. For example, the first vibration part 201-1, the second vibration part 201-2, and the vibration part 201 may have substantially the same size. Also, the first vibration generating apparatus 210 including the single vibration part 201 may have a size which is less than that of the second vibration generating apparatus 220 including the first vibration part 201-1 and the second vibration part 201-2.

A center portion of the vibration part 201 of the first vibration generating apparatus 210 may overlap a center portion between the first vibration part 201-1 and the second vibration part 201-2 of the second vibration generating apparatus 220. For example, the first vibration part 201-1 of the second vibration generating apparatus 220 may overlap a first region (or a left region) of the vibration part 201 of the first vibration generating apparatus 210. Also, the second vibration part 201-2 of the second vibration generating apparatus 220 may overlap a second region (or a right region) of the vibration part 201 of the first vibration generating apparatus 210.

The first vibration generating apparatus 210 and the second vibration generating apparatus 220 may be disposed at the second surface 101b (or the rear surface) and the first surface 102a (or the upper surface) of the opposite sides in the third direction Z in the first vibration member 101 and the second vibration member 102 thereof to have an inverted structure and may be configured to be displaced (or driven or vibrated) in the same direction. For example, a vibration driving signal applied to the first vibration generating apparatus 210 and a vibration driving signal applied to the second vibration generating apparatus 220 may have opposite phases, or may have a phase difference therebetween. For example, the vibration driving signals respectively applied to the first vibration generating apparatus 210 and the second vibration generating apparatus 220 may be as described above with reference to FIG. 54, and thus, repeated descriptions thereof are omitted.

According to an embodiment of the present disclosure, the first vibration generating apparatus 210 including the single vibration part 201 provided in the first vibration member 101 and the second vibration generating apparatus 220 including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

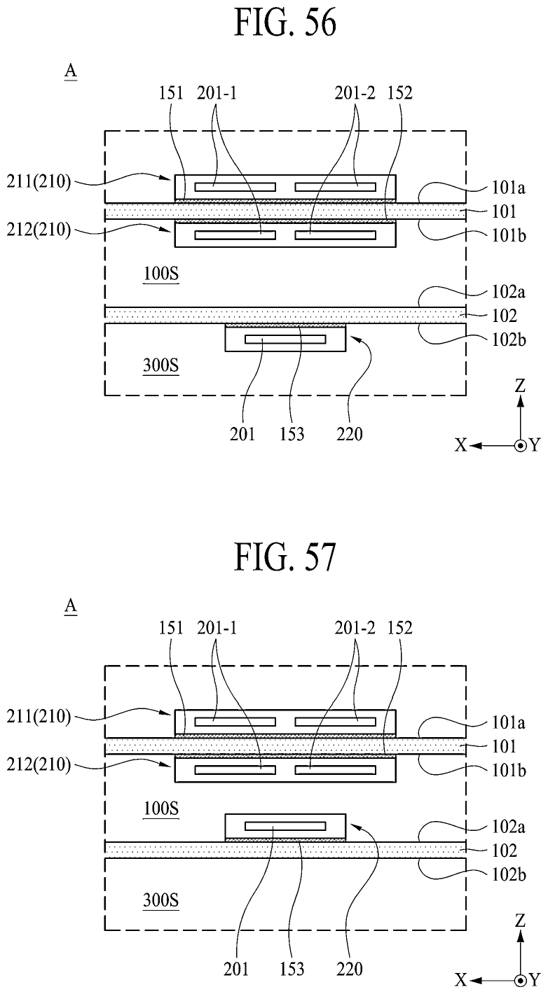

Referring to FIG. 56, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 56, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a single vibration generator. Also, the second vibration generating apparatus 220 may include at least one vibration part 201. For example, the second vibration generating apparatus 220 may include a vibration part 201 which is individually provided. The first vibration generating apparatus 210 may at least partially overlap the second vibration generating apparatus 220. For example, at least a portion of the second vibration generating apparatus 220 may overlap the first vibration generating apparatus 210.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be disposed to overlap each other with the first vibration member 101 therebetween. Each of the first vibration generator 211 and the second vibration generator 212 may include a first vibration part 201-1 and a second vibration part 201-2. In another embodiment of the present disclosure, the first vibration generator 211 may include the first vibration part 201-1 and the second vibration part 201-2 and the second vibration generator 212 may include the single vibration part 201, but embodiments of the present disclosure are not limited thereto.

The second vibration generating apparatus 220 may be disposed at a second surface 102b of the second vibration member 102. For example, the second vibration generating apparatus 220 may be connected with or coupled to the second surface 102b of the second vibration member 102 by a third adhesive member 153. The second vibration generating apparatus 220 may include a single vibration part 201. For example, the second vibration generating apparatus 220 may be disposed in a second space 300S between the second vibration member 102 and an enclosure 300 and may be covered by the enclosure 300, and thus, may be protected from an external impact.

For example, the first vibration generating apparatus 210 and the second vibration generating apparatus 220 may be disposed in different spaces. For example, the first vibration generating apparatus 210 may be disposed in a first space 100S. For example, the second vibration generator 212 may be disposed in the first space 100S. For example, the second vibration generating apparatus 220 may be disposed in a second space 300S.

For example, the second vibration generator 212 and the second vibration generating apparatus 220 may be disposed with the second vibration member 102 therebetween. For example, the second vibration generator 212 and the second vibration generating apparatus 220 may be disposed to overlap each other with the second vibration member 102 therebetween.

The first vibration generating apparatus 210 and the second vibration generating apparatus 220 may be disposed to face the same direction. For example, the second vibration generator 212 and the second vibration generating apparatus 220 may be disposed to face a downward direction in the third direction Z.

The first vibration generating apparatus 210 and the second vibration generating apparatus 220 may be disposed to face different directions. For example, the first vibration generator 211 may be disposed to face an upward direction in the third direction Z. For example, the second vibration generating apparatus 220 may be disposed to face a downward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The first vibration part 201-1 and the second vibration part 201-2 of the first vibration generator 211 and the first vibration part 201-1 and the second vibration part 201-2 of the second vibration generator 212 may at least partially overlap the vibration part 201 of the second vibration generating apparatus 220. For example, the first vibration part 201-1, the second vibration part 201-2, and the vibration part 201 may have substantially the same size. Also, the first vibration generator 211 and the second vibration generator 212 each including the first vibration part 201-1 and the second vibration part 201-2 may have a size which is greater than that of the second vibration generating apparatus 220 including the single vibration part 201.

A center portion between the first vibration part 201-1 and the second vibration part 201-2 of the first vibration generator 211 may overlap a center portion between the first vibration part 201-1 and the second vibration part 201-2 of the second vibration generator 212. Also, a center portion between the first vibration part 201-1 and the second vibration part 201-2 of the first vibration generator 211 and the second vibration generator 212 may overlap a center portion of the vibration part 201 of the second vibration generating apparatus 220. For example, the first vibration part 201-1 of the first vibration generator 211 and the first vibration part 201-1 of the second vibration generator 212 may overlap a portion of a first region (or a left region) of the vibration part 201 of the second vibration generating apparatus 220. Also, the second vibration part 201-2 of the first vibration generator 211 and the second vibration part 201-2 of the second vibration generator 212 may overlap a portion of a second region (or a right region) of the vibration part 201 of the second vibration generating apparatus 220.

The first vibration generator 211 and the second vibration generator 212 may have an inverted structure at each of the first surface 101a and the second surface 101b of the first vibration member 101. Also, the second vibration generating apparatus 220 may have an inverted structure with respect to one of the first vibration generator 211 and the second vibration generator 212 and may have a non-inverted structure with respect to the other of the first vibration generator 211 and the second vibration generator 212. For example, the second vibration generating apparatus 220 may have an inverted structure with respect to the first vibration generator 211 and may have a non-inverted structure with respect to the second vibration generator 212.

The first vibration generator 211, the second vibration generator 212, and the second vibration generating apparatus 220 may be configured to be displaced (or vibrated or driven) in the same direction. For example, a vibration driving signal applied to the first vibration generator 211 may have a phase opposite to or a phase difference with that of a vibration driving signal applied to the second vibration generating apparatus 220. A vibration driving signal applied to the second vibration generator 212 may have the same phase as or a phase difference with that of the vibration driving signal applied to the second vibration generating apparatus 220.

Vibration driving signals respectively applied to the first vibration part 201-1 and the second vibration part 201-2 of the first vibration generator 211 may have the same phase, or may have a phase difference therebetween. Also, vibration driving signals respectively applied to the first vibration part 201-1 and the second vibration part 201-2 of the second vibration generator 212 may have the same phase, or may have a phase difference therebetween. Also, vibration driving signals respectively applied to the first vibration generator 211 and the second vibration generator 212 may have opposite phases, or may have a phase difference therebetween. Also, vibration driving signals respectively applied to the first vibration part 201-1 and the second vibration part 201-2 of the first vibration generator 211 may have a phase difference therebetween caused by signal delay. Also, vibration driving signals respectively applied to the first vibration part 201-1 and the second vibration part 201-2 of the second vibration generator 212 may have a phase difference therebetween caused by signal delay. Also, a vibration driving signal applied to the first vibration part 201-1 of the first vibration generator 211 may have a phase opposite to that of a vibration driving signal applied to the first vibration part 201-1 of the second vibration generator 212 and may have a phase opposite to that of a vibration driving signal applied to the second vibration part 201-2 of the second vibration generator 212, or may have a phase difference therebetween caused by signal delay. Also, a vibration driving signal applied to the second vibration part 201-2 of the first vibration generator 211 may have a phase opposite to that of a vibration driving signal applied to the first vibration portion 201-1 of the second vibration generator 212 or may have a phase difference therebetween caused by signal delay, and may have a phase opposite to that of a vibration driving signal applied to the second vibration part 201-2 of the second vibration generator 212. Also, the vibration driving signal applied to the second vibration generating apparatus 220 may have a phase opposite to that of vibration driving signals respectively applied to the first vibration part 201-1 and the second vibration part 201-2 of the first vibration generator 211, or may have a phase difference, caused by signal delay, with the vibration driving signal applied to one of the first vibration part 201-1 and the second vibration part 201-2 of the first vibration generator 211. Also, the vibration driving signal applied to the second vibration generating apparatus 220 may have a phase same as that of the vibration driving signals respectively applied to the first vibration part 201-1 and the second vibration part 201-2 of the second vibration generator 212, or may have the same phase as that of the vibration driving signal applied to one of the first vibration part 201-1 and the second vibration part 201-2 of the second vibration generator 212 or may have a phase difference therebetween caused by signal delay.

According to an embodiment of the present disclosure, the first vibration generator 211 and the second vibration generator 212 each including the first vibration part 201-1 and the second vibration part 201-2 provided in the first vibration member 101 and the second vibration generating apparatus 220 including the single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 57, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 57, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a single vibration generator. Also, the second vibration generating apparatus 220 may include at least one vibration part 201. For example, the second vibration generating apparatus 220 may include a vibration part 201 which is individually provided. The first vibration generating apparatus 210 may at least partially overlap the second vibration generating apparatus 220. For example, at least a portion of the first vibration generating apparatus 210 may overlap the second vibration generating apparatus 220.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be disposed to overlap each other with the first vibration member 101 therebetween. Each of the first vibration generator 211 and the second vibration generator 212 may include a first vibration part 201-1 and a second vibration part 201-2. In another embodiment of the present disclosure, the first vibration generator 211 may include the first vibration part 201-1 and the second vibration part 201-2 and the second vibration generator 212 may include the single vibration part 201, but embodiments of the present disclosure are not limited thereto.

The second vibration generating apparatus 220 may be disposed at a first surface 102a of the second vibration member 102. For example, the second vibration generating apparatus 220 may be connected with or coupled to the first surface 102a of the second vibration member 102 by a third adhesive member 153. The second vibration generating apparatus 220 may include a single vibration part 201. For example, the second vibration generating apparatus 220 may be disposed in a first space 100S between the first vibration member 101 and the second vibration member 102 and may be covered by the first vibration member 101, and thus, may be protected from an external impact.

For example, the first vibration generating apparatus 210 and the second vibration generating apparatus 220 may be disposed in the same space. For example, the first vibration generating apparatus 210 may be disposed in the first space 100S. For example, the second vibration generator 212 may be disposed in the first space 100S. For example, the second vibration generating apparatus 220 may be disposed in the first space 100S. For example, the second vibration generator 212 and the second vibration generating apparatus 220 may be disposed to face each other. For example, the second vibration generator 212 and the second vibration generating apparatus 220 may be disposed to face each other in the first space 100S. For example, the second vibration generator 212 and the second vibration generating apparatus 220 may be disposed to overlap each other in the first space 100S.

The first vibration generating apparatus 210) and the second vibration generating apparatus 220 may be disposed to face the same direction. For example, the first vibration generator 211 and the second vibration generating apparatus 220 may be disposed to face an upward direction in a third direction Z.

The first vibration generating apparatus 210 and the second vibration generating apparatus 220) may be disposed to face different directions. For example, the second vibration generator 212 may be disposed to face a downward direction in the third direction Z. For example, the second vibration generating apparatus 220 may be disposed to face an upward direction in the third direction Z.

The first vibration generating apparatus 210) may be disposed in a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The first vibration part 201-1 and the second vibration part 201-2 of the first vibration generator 211 and the first vibration part 201-1 and the second vibration part 201-2 of the second vibration generator 212 may at least partially overlap the vibration part 201 of the second vibration generating apparatus 220. For example, the first vibration part 201-1, the second vibration part 201-2, and the vibration part 201 may have substantially the same size. Also, the first vibration generator 211 and the second vibration generator 212 each including the first vibration part 201-1 and the second vibration part 201-2 may have a size which is greater than that of the second vibration generating apparatus 220 including the single vibration part 201.

A center portion between the first vibration part 201-1 and the second vibration part 201-2 of the first vibration generator 211 may overlap a center portion between the first vibration part 201-1 and the second vibration part 201-2 of the second vibration generator 212. Also, a center portion between the first vibration part 201-1 and the second vibration part 201-2 of each of the first vibration generator 211 and the second vibration generator 212 may overlap a center portion of the vibration part 201 of the second vibration generating apparatus 220. For example, the first vibration part 201-1 of the first vibration generator 211 and the first vibration part 201-1 of the second vibration generator 212 may overlap a portion of a first region (or a left region) of the vibration part 201 of the second vibration generating apparatus 220. Also, the second vibration part 201-2 of the first vibration generator 211 and the second vibration part 201-2 of the second vibration generator 212 may overlap a portion of a second region (or a right region) of the vibration part 201 of the second vibration generating apparatus 220.

The first vibration generator 211 and the second vibration generator 212 may have an inverted structure at each of the first surface 101a and the second surface 101b of the first vibration member 101. Also, the second vibration generating apparatus 220 may have an inverted structure with respect to one of the first vibration generator 211 and the second vibration generator 212 and may have a non-inverted structure with respect to the other of the first vibration generator 211 and the second vibration generator 212. For example, the second vibration generating apparatus 220 may have a non-inverted structure with respect to the first vibration generator 211 and may have an inverted structure with respect to the second vibration generator 212.

The first vibration generator 211, the second vibration generator 212, and the second vibration generating apparatus 220 may be configured to be displaced (or vibrated or driven) in the same direction. For example, a vibration driving signal applied to the first vibration generator 211 may have a phase same as or a phase difference with that of a vibration driving signal applied to the second vibration generating apparatus 220. A vibration driving signal applied to the second vibration generator 212 may have the phase opposite to or a phase difference with that of the vibration driving signal applied to the second vibration generating apparatus 220. For example, the vibration driving signal applied to each of the first vibration generator 211 and the second vibration generator 212 may be as described above with reference to FIG. 56, and thus, repeated descriptions thereof are omitted.

The vibration driving signal applied to the second vibration generating apparatus 220 may have the same phase as that of the vibration driving signal applied to each of the first and second vibration parts 201-1 and 201-2 of the first vibration generator 211, or may have the same phase as that of the vibration driving signal applied to one of the first and second vibration parts 201-1 and 201-2 of the first vibration generator 211 or may have a phase difference therebetween caused by signal delay. Also, the vibration driving signal applied to the second vibration generating apparatus 220 may have a phase opposite to that of the vibration driving signal applied to each of the first and second vibration parts 201-1 and 201-2 of the second vibration generator 212, or may have a phase difference, caused by signal delay, with that of the vibration driving signal applied to one of the first and second vibration parts 201-1 and 201-2 of the second vibration generator 212.

According to an embodiment of the present disclosure, the first vibration generator 211 and the second vibration generator 212 each including the first vibration part 201-1 and the second vibration part 201-2 provided in the first vibration member 101 and the second vibration generating apparatus 220 including the single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

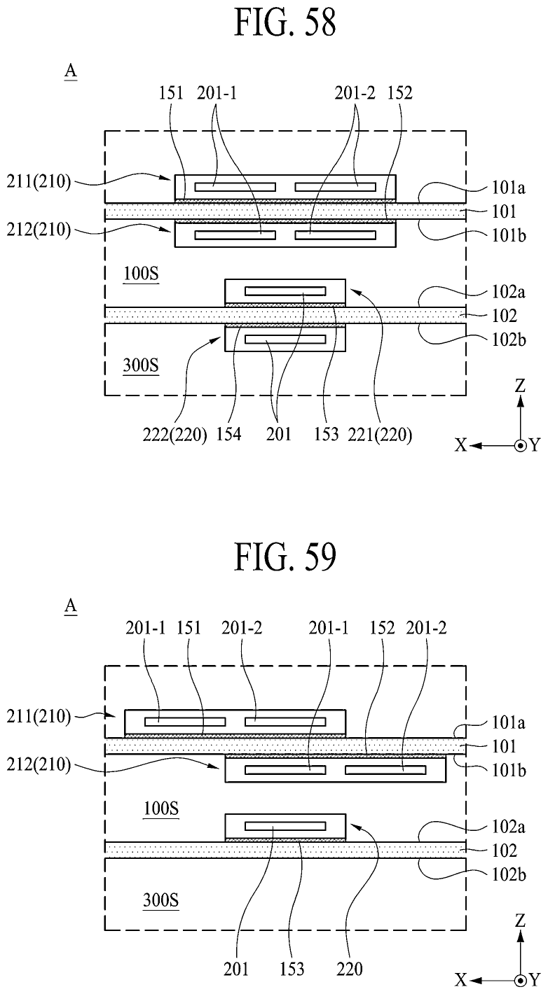

Referring to FIG. 58, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 58, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a third vibration generator 221 and a fourth vibration generator 222. Also, each of the third vibration generator 221 and the fourth vibration generator 222 of the second vibration generating apparatus 220 may include at least one vibration part 201. For example, the third vibration generator 221 may include a vibration part 201 which is individually provided, and the fourth vibration generator 222 may include a vibration part 201 which is individually provided. The first vibration generating apparatus 210 may at least partially overlap the second vibration generating apparatus 220. For example, at least a portion of the first vibration generating apparatus 210 may overlap the second vibration generating apparatus 220.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be disposed to overlap each other with the first vibration member 101 therebetween. Each of the first vibration generator 211 and the second vibration generator 212 may include a first vibration part 201-1 and a second vibration part 201-2. In another embodiment of the present disclosure, the first vibration generator 211 may include the first vibration part 201-1 and the second vibration part 201-2 and the second vibration generator 212 may include the single vibration part 201, but embodiments of the present disclosure are not limited thereto.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be disposed to overlap each other with the second vibration member 102 therebetween. Each of the third vibration generator 221 and the fourth vibration generator 222 may include a single vibration part 201. In another embodiment of the present disclosure, one of the third vibration generator 221 and the fourth vibration generator 222 may include the first vibration part 201-1 and the second vibration part 201-2, and the other vibration generator may include the single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

For example, the first vibration generating apparatus 210 and the second vibration generating apparatus 220 may be disposed in the same space. For example, the second vibration generator 212 and the third vibration generator 221 may be disposed in the same space. For example, the second vibration generator 212 and the third vibration generator 221 may be disposed in the first space 100S. The second vibration generator 212 and the third vibration generator 221 may be disposed to face each other. For example, the second vibration generator 212 and the third vibration generator 221 may be disposed to face each other in the first space 100S. For example, the second vibration generator 212 and the third vibration generator 221 may be disposed to face and overlap each other in the first space 100S.

The first vibration generator 211 and the second vibration generator 212 may be disposed in different spaces. For example, the second vibration generator 212 may be disposed in the first space 100S.

The first vibration generating apparatus 210 and the second vibration generating apparatus 220 may be disposed in different spaces. For example, the second vibration generator 212 and the third vibration generator 221 may be disposed in same spaces. For example, the second vibration generator 212 and the third vibration generator 221 may be disposed in the first space 100S. The fourth vibration generator 222 may be disposed in the second space 300S.

The third vibration generator 221 and the fourth vibration generator 222 may be disposed in different spaces. For example, the third vibration generator 221 may be disposed in the first space 100S.

The first vibration generating apparatus 210 and the second vibration generating apparatus 220 may be disposed to face the same direction. For example, the first vibration generator 211 and the third vibration generator 221 may be disposed to face an upward direction in the third direction Z. For example, the second vibration generator 212 and the fourth vibration generator 222 may be disposed to face a downward direction in the third direction Z. The first vibration generating apparatus 210 and the second vibration generating apparatus 220 may be disposed to face different directions. For example, the first vibration generator 211 may be disposed to face an upward direction in the third direction Z. For example, the fourth vibration generator 222 may be disposed to face a downward direction in the third direction Z. For example, the second vibration generator 212 may be disposed to face a downward direction in the third direction Z. The third vibration generator 221 may be disposed to face an upward direction in the third direction Z.

The first vibration generating apparatus 210 may be disposed in a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The first vibration part 201-1 and the second vibration part 201-2 of the first vibration generator 211 and the first vibration portion 201-1 and the second vibration part 201-2 of the second vibration generator 212 may at least partially overlap the vibration part 201 of the third vibration generator 221 and the vibration part 201 of the fourth vibration generator 222. For example, the first vibration part 201-1, the second vibration part 201-2, and the vibration part 201 may have substantially the same size. Also, the first vibration generator 211 and the second vibration generator 212 each including the first vibration part 201-1 and the second vibration part 201-2 may have a size which is greater than that of the third vibration generator 221 and the fourth vibration generator 222 each including the single vibration part 201.

A center portion between the first vibration part 201-1 and the second vibration part 201-2 of the first vibration generator 211 may overlap a center portion between the first vibration part 201-1 and the second vibration part 201-2 of the second vibration generator 212. Also, a center portion of the vibration part 201 of the third vibration generator 221 may overlap a center portion of the vibration part 201 of the fourth vibration generator 222. Also, a center portion between the first vibration part 201-1 and the second vibration part 201-2 of each of the first vibration generator 211 and the second vibration generator 212 may overlap a center portion of the vibration part 201 of each of the third vibration generator 221 and the fourth vibration generator 222. For example, the first vibration part 201-1 of the first vibration generator 211 and the first vibration part 201-1 of the second vibration generator 212 may overlap a portion of a first region (or a left region) of the vibration part 201 of the third vibration generator 221 and the vibration part 201 of the fourth vibration generator 222. Also, the second vibration part 201-2 of the first vibration generator 211 and the second vibration part 201-2 of the second vibration generator 212 may overlap a portion of a second region (or a right region) of each of the vibration part 201 of the third vibration generator 221 and the vibration part 201 of the fourth vibration generator 222.

The first vibration generator 211 and the second vibration generator 212 may have an inverted structure at each of the first surface 101a and the second surface 101b of the first vibration member 101. Also, the third vibration generator 221 may have a non-inverted structure with respect to the first vibration generator 211 and may have an inverted structure with respect to the second vibration generator 212. Also, the fourth vibration generator 222 may have an inverted structure with respect to the first vibration generator 211 and may have a non-inverted structure with respect to the second vibration generator 212.

The first vibration generator 211, the second vibration generator 212, the third vibration generator 221, and the fourth vibration generator 222 may be configured to be displaced (or vibrated or driven) in the same direction. For example, a vibration driving signal applied to the first vibration generator 211 may have the same phase as or a phase difference with that of a vibration driving signal applied to the third vibration generator 221 and may have a phase opposite to or a phase difference with that of a vibration driving signal applied to the fourth vibration generator 222. Also, the vibration driving signal applied to the second vibration generator 212 may have a phase opposite to or a phase difference with that of the vibration driving signal applied to the third vibration generator 221 and may have the same phase as or a phase difference with that of the vibration driving signal applied to the fourth vibration generator 222. For example, the vibration driving signal applied to each of the first vibration generator 211 and the second vibration generator 212 may be as described above with reference to FIG. 56, and thus, repeated descriptions thereof are omitted.

The vibration driving signal applied to the third vibration generator 221 may have the same phase as that of the vibration driving signal applied to each of the first and second vibration parts 201-1 and 201-2 of the first vibration generator 211, or may have the same phase as that of the vibration driving signal applied to one of the first and second vibration parts 201-1 and 201-2 of the first vibration generator 211 or may have a phase difference therebetween caused by signal delay. Also, the vibration driving signal applied to the third vibration generator 221 may have a phase opposite to that of the vibration driving signal applied to each of the first and second vibration part 201-1 and 201-2 of the second vibration generator 212, or may have a phase difference, caused by signal delay, with that of the vibration driving signal applied to one of the first and second vibration parts 201-1 and 201-2 of the second vibration generator 212. Also, the vibration driving signal applied to the fourth vibration generator 222 may have a phase opposite to that of the vibration driving signal applied to each of the first and second vibration parts 201-1 and 201-2 of the first vibration generator 211, or may have a phase difference, caused by signal delay, with that of the vibration driving signal applied to one of the first and second vibration parts 201-1 and 201-2 of the first vibration generator 211. Also, the vibration driving signal applied to the fourth vibration generator 222 may have the same phase as that of the vibration driving signal applied to each of the first and second vibration portions 201-1 and 201-2 of the second vibration generator 212, or may have the same phase as that of the vibration driving signal applied to one of the first and second vibration parts 201-1 and 201-2 of the second vibration generator 212 or may have a phase difference therebetween caused by signal delay.

According to an embodiment of the present disclosure, the first vibration generator 211 and the second vibration generator 212 each including the first vibration part 201-1 and the second vibration part 201-2 provided in the first vibration member 101 and the third vibration generator 221 and the fourth vibration generator 222 each including the single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 59, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 59, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a single vibration generator. Also, the second vibration generating apparatus 220 may include at least one vibration part 201. For example, the second vibration generating apparatus 220 may include a vibration part 201 which is individually provided. The first vibration generating apparatus 210 may at least partially overlap the second vibration generating apparatus 220. For example, at least a portion of the first vibration generating apparatus 210 may overlap the second vibration generating apparatus 220.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be staggeredly disposed with the first vibration member 101 therebetween. For example, the first vibration generator 211 and the second vibration generator 212 may be disposed to at least partially overlap each other with the first vibration member 101 therebetween. Each of the first vibration generator 211 and the second vibration generator 212 may include a first vibration part 201-1 and a second vibration part 201-2. In another embodiment of the present disclosure, one of the first vibration generator 211 and the second vibration generator 212 may include the first vibration part 201-1 and the second vibration part 201-2, and the other vibration generator may include a single vibration part 201. For example, the first vibration generator 211 may include the first vibration part 201-1 and the second vibration part 201-2 and the second vibration generator 212 may include the single vibration part 201, but embodiments of the present disclosure are not limited thereto.

The second vibration generating apparatus 220 may be disposed at a first surface 102a of the second vibration member 102. For example, the second vibration generating apparatus 220 may be connected with or coupled to the first surface 102a of the second vibration member 102 by a third adhesive member 153. The second vibration generating apparatus 220 may include a single vibration part 201. For example, the second vibration generating apparatus 220 may be disposed in a first space 100S between the first vibration member 101 and the second vibration member 102 and may be covered by the first vibration member 101, and thus, may be protected from an external impact.

The first vibration generating apparatus 210 and the second vibration generating apparatus 220 may be disposed in the same space. For example, the second vibration generator 212 and the second vibration generating apparatus 220 may be disposed in the first space 100S. For example, the second vibration generator 212 and the second vibration generating apparatus 220 may be disposed to face each other. For example, the second vibration generator 212 and the second vibration generating apparatus 220 may be disposed to face each other in the first space 100S. For example, the second vibration generator 212 and the second vibration generating apparatus 220 may be disposed to face and at least partially overlap each other in the first space 100S.

The first vibration generator 211 and the second vibration generator 212 may be disposed in different spaces. For example, the second vibration generator 212 may be disposed in the first space 100S.

The first vibration generating apparatus 210 and the second vibration generating apparatus 220 may be disposed to face the same direction. For example, the first vibration generator 211 and the second vibration generating apparatus 220 may be disposed to face an upward direction in a third direction Z.

The first vibration generating apparatus 210 and the second vibration generating apparatus 220 may be disposed to face different directions. For example, the second vibration generator 212 may be disposed to face a downward direction in the third direction Z. For example, the second vibration generating apparatus 220 may be disposed to face an upward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The first vibration generator 211 and the second vibration generator 212 may be disposed to have an asymmetrical structure therebetween. For example, one of the first vibration part 201-1 and the second vibration part 201-2 of the first vibration generator 211 may overlap one of the first vibration part 201-1 and the second vibration part 201-2 of the second vibration generator 212 and may not overlap the other of the first vibration part 201-1 and the second vibration part 201-2 of the second vibration generator 212. For example, the first vibration part 201-1 of the first vibration generator 211 may not overlap the second vibration generator 212, and the second vibration part 201-2 of the first vibration generator 211 may overlap the first vibration part 201-1 of the second vibration generator 212. Also, one or more of the first vibration part 201-1 and the second vibration part 201-2 of the first vibration generator 211 and the first vibration part 201-1 and the second vibration part 201-2 of the second vibration generator 212 may overlap the vibration part 201 of the second vibration generating apparatus 220, and the other one or more of the first vibration part 201-1 and the second vibration part 201-2 of the first vibration generator 211 and the first vibration part 201-1 and the second vibration part 201-2 of the second vibration generator 212 may not overlap the vibration part 201 of the second vibration generating apparatus 220. For example, the first vibration part 201-1, the second vibration part 201-2, and the vibration part 201 may have substantially the same size. Also, the first vibration generator 211 and the second vibration generator 212 each including the first vibration part 201-1 and the second vibration part 201-2 may have a size which is greater than that of the second vibration generating apparatus 220.

The first vibration part 201-1 of the first vibration generator 211 may not overlap the second vibration generator 212 and the second vibration generating apparatus 220. Also, the second vibration part 201-2 of the first vibration generator 211 may overlap the first vibration part 201-1 of the second vibration generator 212 and the vibration part 201 of the second vibration generating apparatus 220. For example, the second vibration part 201-2 of the first vibration generator 211, the first vibration part 201-1 of the second vibration generator 212, and the vibration part 201 of the second vibration generating apparatus 220 may overlap one another. Also, the first vibration part 201-1 of the first vibration generator 211 and the second vibration part 201-2 of the second vibration generator 212 may not overlap the vibration part 201 of the second vibration generating apparatus 220.

The first vibration generator 211 and the second vibration generator 212 may have an inverted structure at each of the first surface 101a and the second surface 101b of the first vibration member 101 and may be disposed in an asymmetrical structure therebetween. Also, the second vibration generating apparatus 220 may have an inverted structure with respect to one of the first vibration generator 211 and the second vibration generator 212 and may have a non-inverted structure with respect to the other of the first vibration generator 211 and the second vibration generator 212. For example, the second vibration generating apparatus 220 may have a non-inverted structure with respect to the first vibration generator 211, overlap the second vibration part 201-2 of the first vibration generator 211, have an inverted structure with respect to the second vibration generator 212, and overlap the first vibration part 201-1 of the second vibration generator 212.

The first vibration generator 211, the second vibration generator 212, and the second vibration generating apparatus 220 may be configured to be displaced (or vibrated or driven) in the same direction. For example, a vibration driving signal applied to the first vibration generator 211 may have the same phase as or a phase difference with that of a vibration driving signal applied to the second vibration generating apparatus 220. A vibration driving signal applied to the second vibration generator 212 may have a phase opposite to or a phase difference with that of the vibration driving signal applied to the second vibration generating apparatus 220. For example, the vibration driving signal applied to each of the first vibration generator 211 and the second vibration generator 212 may be as described above with reference to FIG. 56, and thus, repeated descriptions thereof are omitted. Also, the vibration driving signal applied to the second vibration generating apparatus 220 may be as described above with reference to FIG. 57, and thus, repeated descriptions thereof are omitted.

According to an embodiment of the present disclosure, the first vibration generator 211 and the second vibration generator 212 each including the first vibration part 201-1 and the second vibration part 201-2 provided in the first vibration member 101 and the second vibration generating apparatus 220 including the single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

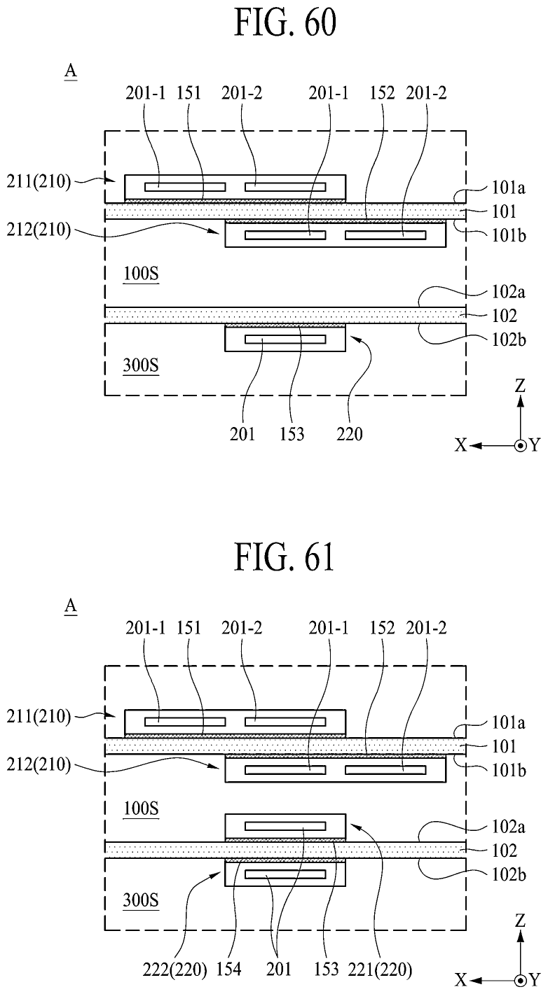

Referring to FIG. 60, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 60, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a single vibration generator. Also, the second vibration generating apparatus 220 may include at least one vibration part 201. For example, the second vibration generating apparatus 220 may include a vibration part 201 which is individually provided. The first vibration generating apparatus 210 may at least partially overlap the second vibration generating apparatus 220. For example, at least a portion of the first vibration generating apparatus 210 may overlap the second vibration generating apparatus 220.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be staggeredly disposed with the first vibration member 101 therebetween. For example, the first vibration generator 211 and the second vibration generator 212 may be disposed to at least partially overlap each other with the first vibration member 101 therebetween. Each of the first vibration generator 211 and the second vibration generator 212 may include a first vibration part 201-1 and a second vibration part 201-2. In another embodiment of the present disclosure, one of the first vibration generator 211 and the second vibration generator 212 may include the first vibration part 201-1 and the second vibration part 201-2, and the other vibration generator may include a single vibration part 201. For example, the first vibration generator 211 may include the first vibration part 201-1 and the second vibration part 201-2 and the second vibration generator 212 may include the single vibration part 201, but embodiments of the present disclosure are not limited thereto.

The second vibration generating apparatus 220 may be disposed at a second surface 102b of the second vibration member 102. For example, the second vibration generating apparatus 220 may be connected with or coupled to the second surface 102b of the second vibration member 102 by a third adhesive member 153. The second vibration generating apparatus 220 may include a single vibration part 201. For example, the second vibration generating apparatus 220 may be disposed in a second space 300S between the second vibration member 102 and an enclosure 300 and may be covered by the enclosure 300, and thus, may be protected from an external impact.

The first vibration generating apparatus 210 and the second vibration generating apparatus 220 may be disposed in different spaces. For example, the second vibration generator 212 may be disposed in the first space 100S. For example, the second vibration generating apparatus 220 may be disposed in the second space 300S.

The first vibration generator 211 and the second vibration generator 212 may be disposed in different spaces. For example, the second vibration generator 212 may be disposed in the first space 100S.

For example, the second vibration generator 212 and the second vibration generating apparatus 220 may be disposed with the second vibration member 102 therebetween. For example, the second vibration generator 212 and the second vibration generating apparatus 220 may be disposed to at least partially overlap each other with the second vibration member 102 therebetween.

The first vibration generating apparatus 210 and the second vibration generating apparatus 220 may be disposed to face the same direction. For example, the second vibration generator 212 and the second vibration generating apparatus 220 may be disposed to face a downward direction in the third direction Z.

The first vibration generating apparatus 210 and the second vibration generating apparatus 220 may be disposed to face different directions. For example, the first vibration generator 211 may be disposed to face an upward direction in the third direction Z. For example, the second vibration generating apparatus 220 may be disposed to face a downward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The first vibration generator 211 and the second vibration generator 212 may be disposed to have an asymmetrical structure therebetween. For example, one of the first vibration part 201-1 and the second vibration part 201-2 of the first vibration generator 211 may overlap one of the first vibration part 201-1 and the second vibration part 201-2 of the second vibration generator 212 and may not overlap the other of the first vibration part 201-1 and the second vibration part 201-2 of the second vibration generator 212. For example, the first vibration part 201-1 of the first vibration generator 211 may not overlap the second vibration generator 212, and the second vibration part 201-2 of the first vibration generator 211 may overlap the first vibration part 201-1 of the second vibration generator 212. Also, one or more of the first vibration part 201-1 and the second vibration part 201-2 of the first vibration generator 211 and the first vibration part 201-1 and the second vibration part 201-2 of the second vibration generator 212 may overlap the vibration part 201 of the second vibration generating apparatus 220, and the other one or more of the first vibration part 201-1 and the second vibration part 201-2 of the first vibration generator 211 and the first vibration part 201-1 and the second vibration part 201-2 of the second vibration generator 212 may not overlap the vibration part 201 of the second vibration generating apparatus 220. For example, the first vibration part 201-1, the second vibration part 201-2, and the vibration part 201 may have substantially the same size. Also, the first vibration generator 211 and the second vibration generator 212 each including the first vibration part 201-1 and the second vibration part 201-2 may have a size which is greater than that of the second vibration generating apparatus 220 including the single vibration part 201.

The first vibration part 201-1 of the first vibration generator 211 may not overlap the second vibration generator 212 and the second vibration generating apparatus 220. Also, the second vibration part 201-2 of the first vibration generator 211 may overlap the first vibration part 201-1 of the second vibration generator 212 and the vibration part 201 of the second vibration generating apparatus 220. For example, the second vibration part 201-2 of the first vibration generator 211, the first vibration part 201-1 of the second vibration generator 212, and the vibration part 201 of the second vibration generating apparatus 220 may overlap one another. Also, the first vibration part 201-1 of the first vibration generator 211 and the second vibration part 201-2 of the second vibration generator 212 may not overlap the vibration part 201 of the second vibration generating apparatus 220.

The first vibration generator 211 and the second vibration generator 212 may have an inverted structure at each of the first surface 101a and the second surface 101b of the first vibration member 101 and may be disposed in an asymmetrical structure therebetween. Also, the second vibration generating apparatus 220 may have an inverted structure with respect to one of the first vibration generator 211 and the second vibration generator 212 and may have a non-inverted structure with respect to the other of the first vibration generator 211 and the second vibration generator 212. For example, the second vibration generating apparatus 220 may have an inverted structure with respect to the first vibration generator 211, overlap the second vibration part 201-2 of the first vibration generator 211, have a non-inverted structure with respect to the second vibration generator 212, and overlap the first vibration part 201-1 of the second vibration generator 212.

The first vibration generator 211, the second vibration generator 212, and the second vibration generating apparatus 220 may be configured to be displaced (or vibrated or driven) in the same direction. For example, a vibration driving signal applied to the first vibration generator 211 may have same phase opposite to or a phase difference with that of a vibration driving signal applied to the second vibration generating apparatus 220. A vibration driving signal applied to the second vibration generator 212 may have a phase same as or a phase difference with that of the vibration driving signal applied to the second vibration generating apparatus 220. For example, the vibration driving signal applied to each of the first vibration generating apparatus 210 and the second vibration generating apparatus 220 may be as described above with reference to FIG. 56, and thus, repeated descriptions thereof are omitted.

According to an embodiment of the present disclosure, the first vibration generator 211 and the second vibration generator 212 each including the first vibration part 201-1 and the second vibration part 201-2 provided in the first vibration member 101 and the second vibration generating apparatus 220 including the single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 61, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 61, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a third vibration generator 221 and a fourth vibration generator 222. Also, each of the third vibration generator 221 and the fourth vibration generator 222 of the second vibration generating apparatus 220 may include at least one vibration part 201. For example, the third vibration generator 221 may include a vibration part 201 which is individually provided, and the fourth vibration generator 222 may include a vibration part 201 which is individually provided. The first vibration generating apparatus 210 may at least partially overlap the second vibration generating apparatus 220. For example, at least a portion of the first vibration generating apparatus 210 may overlap the second vibration generating apparatus 220.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be staggeredly disposed with the first vibration member 101 therebetween. For example, the first vibration generator 211 and the second vibration generator 212 may be disposed to at least partially overlap each other with the first vibration member 101 therebetween. Each of the first vibration generator 211 and the second vibration generator 212 may include a first vibration part 201-1 and a second vibration part 201-2. In another embodiment of the present disclosure, one of the first vibration generator 211 and the second vibration generator 212 may include the first vibration part 201-1 and the second vibration part 201-2, and the other vibration generator may include a single vibration part 201. For example, the first vibration generator 211 may include the first vibration part 201-1 and the second vibration part 201-2 and the second vibration generator 212 may include the single vibration part 201, but embodiments of the present disclosure are not limited thereto.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be disposed to overlap each other with the second vibration member 102 therebetween. Each of the third vibration generator 221 and the fourth vibration generator 222 may include a single vibration portion 201. In another embodiment of the present disclosure, one of the third vibration generator 221 and the fourth vibration generator 222 may include the first vibration portion 201-1 and the second vibration portion 201-2, and the other vibration generator may include the single vibration portion 201. For example, the third vibration generator 221 may include the first vibration portion 201-1 and the second vibration portion 201-2 and the fourth vibration generator 222 may include the single vibration portion 201, but embodiments of the present disclosure are not limited thereto.

The first vibration generating apparatus 210 and the second vibration generating apparatus 220 may be disposed in different spaces. For example, the second vibration generator 212 may be disposed in the first space 100S. For example, the fourth vibration generator 222 may be disposed in the second space 300S.

The first vibration generating apparatus 210 and the second vibration generating apparatus 220 may be disposed in the same space. For example, the second vibration generator 212 and the third vibration generator 221 may be disposed in the first space 100S. For example, the second vibration generator 212 and the third vibration generator 221 may be disposed to face each other. For example, the second vibration generator 212 and the third vibration generator 221 may be disposed to face each other in the first space 100S. For example, the second vibration generator 212 and the third vibration generator 221 may be disposed to at least partially overlap each other in the first space 100S.

The first vibration generator 211 and the second vibration generator 212 may be disposed in different spaces. For example, the second vibration generator 212 may be disposed in the first space 100S.

The third vibration generator 221 and the fourth vibration generator 222 may be disposed in different spaces. For example, the third vibration generator 221 may be disposed in the first space 100S. For example, the fourth vibration generator 222 may be disposed in the second space 300S.

The first vibration generating apparatus 210 and the second vibration generating apparatus 220 may be disposed to face the same direction. For example, the first vibration generator 211 and the third vibration generator 221 may be disposed to face an upward direction in the third direction Z. For example, the second vibration generator 212 and the fourth vibration generator 222 may be disposed to face a downward direction in the third direction Z. The first vibration generating apparatus 210 and the second vibration generating apparatus 220 may be disposed to face different directions. For example, the first vibration generator 211 may be disposed to face an upward direction in the third direction Z. For example, the fourth vibration generator 222 may be disposed to face a downward direction in the third direction Z. For example, the second vibration generator 212 may be disposed to face a downward direction in the third direction Z. The third vibration generator 221 may be disposed to face an upward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The second vibration generating apparatus 220 may be disposed in a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The first vibration generator 211 and the second vibration generator 212 may be disposed to have an asymmetrical structure therebetween. For example, one of the first vibration part 201-1 and the second vibration part 201-2 of the first vibration generator 211 may overlap one of the first vibration part 201-1 and the second vibration part 201-2 of the second vibration generator 212 and may not overlap the other of the first vibration part 201-1 and the second vibration part 201-2 of the second vibration generator 212. For example, the first vibration part 201-1 of the first vibration generator 211 may not overlap the second vibration generator 212, and the second vibration part 201-2 of the first vibration generator 211 may overlap the first vibration part 201-1 of the second vibration generator 212. Also, one or more of the first vibration part 201-1 and the second vibration part 201-2 of the first vibration generator 211 and the first vibration part 201-1 and the second vibration part 201-2 of the second vibration generator 212 may overlap the vibration part 201 of the third vibration generator 221 and the vibration part 201 of the fourth vibration generator 222, and the other one or more of the first vibration portion 201-1 and the second vibration part 201-2 of the first vibration generator 211 and the first vibration part 201-1 and the second vibration part 201-2 of the second vibration generator 212 may not overlap the vibration part 201 of the third vibration generator 221 and the vibration part 201 of the fourth vibration generator 222. For example, the first vibration part 201-1, the second vibration part 201-2, and the vibration part 201 may have substantially the same size. Also, the first vibration generator 211 and the second vibration generator 212 each including the first vibration part 201-1 and the second vibration part 201-2 may have a size which is greater than that of the third vibration generator 221 and the fourth vibration generator 222.

The first vibration part 201-1 of the first vibration generator 211 may not overlap the second vibration generator 212, the third vibration generator 221, and the fourth vibration generator 222. Also, the second vibration part 201-2 of the first vibration generator 211 may overlap the first vibration part 201-1 of the second vibration generator 212, the vibration part 201 of the third vibration generator 221, and the vibration part 201 of the fourth vibration generator 222. For example, the second vibration part 201-2 of the first vibration generator 211, the first vibration part 201-1 of the second vibration generator 212, the vibration portion 201 of the third vibration generator 221, and the vibration part 201 of the fourth vibration generator 222 may overlap one another. Also, the first vibration part 201-1 of the first vibration generator 211 and the second vibration part 201-2 of the second vibration generator 212 may not overlap the vibration part 201 of the third vibration generator 221 and the vibration part 201 of the fourth vibration generator 222.

The first vibration generator 211 and the second vibration generator 212 may have an inverted structure at each of the first surface 101a and the second surface 101b of the first vibration member 101 and may be disposed in an asymmetrical structure therebetween. Also, the third vibration generator 221 may have a non-inverted structure with respect to the first vibration generator 211, overlap the second vibration part 201-2 of the first vibration generator 211, have an inverted structure with respect to the second vibration generator 212, and overlap the first vibration part 201-1 of the second vibration generator 212. Also, the fourth vibration generator 222 may have an inverted structure with respect to the first vibration generator 211, overlap the second vibration part 201-2 of the first vibration generator 211, have a non-inverted structure with respect to the second vibration generator 212, and overlap the first vibration part 201-1 of the second vibration generator 212.

The first vibration generator 211, the second vibration generator 212, the third vibration generator 221, and the fourth vibration generator 222 may be configured to be displaced (or vibrated or driven) in the same direction. For example, a vibration driving signal applied to the first vibration generator 211 may have the same phase as or a phase difference with that of a vibration driving signal applied to the third vibration generator 221 and may have a phase opposite to or a phase difference with that of a vibration driving signal applied to the fourth vibration generator 222. Also, the vibration driving signal applied to the second vibration generator 212 may have a phase opposite to or a phase difference with that of the vibration driving signal applied to the third vibration generator 221 and may have the same phase as or a phase difference with that of the vibration driving signal applied to the fourth vibration generator 222. For example, the vibration driving signal applied to each of the first vibration generator 211 and the second vibration generator 212 may be as described above with reference to FIG. 56, and thus, repeated descriptions thereof are omitted.

According to an embodiment of the present disclosure, the first vibration generator 211 and the second vibration generator 212 each including the first vibration part 201-1 and the second vibration part 201-2 provided in the first vibration member 101 and the third vibration generator 221 and the fourth vibration generator 222 each including the single vibration part 201 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

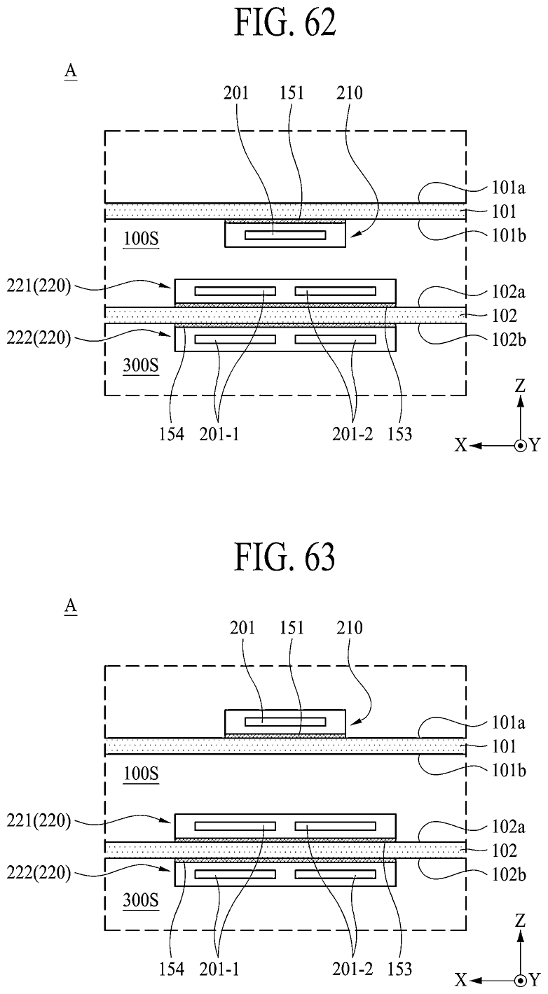

Referring to FIG. 62, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 62, a first vibration generating apparatus 210 may include a single vibration generator. Also, the first vibration generating apparatus 210 may include at least one vibration part 201. For example, the first vibration generating apparatus 210 may include a vibration part 201 which is individually provided. Also, a second vibration generating apparatus 220 may include a third vibration generator 221 and a fourth vibration generator 222. Also, each of the third vibration generator 221 and the fourth vibration generator 222 of the second vibration generating apparatus 220 may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 may at least partially overlap the second vibration generating apparatus 220. For example, at least a portion of the second vibration generating apparatus 220 may overlap the first vibration generating apparatus 210.

The first vibration generating apparatus 210 may be disposed at a second surface 101b of the first vibration member 101. For example, the first vibration generating apparatus 210 may be connected with or coupled to the second surface 101b of the first vibration member 101 by a first adhesive member 151. The first vibration generating apparatus 210 may include a single vibration part 201. For example, the first vibration generating apparatus 210 may be disposed in a first space 100S between the first vibration member 101 and the second vibration member 102 and may be covered by the first vibration member 101, and thus, may be protected from an external impact.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be disposed to overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in the same space. For example, the first vibration generating apparatus 210 and the third vibration generator 221 may be disposed in the same space. For example, the first vibration generating apparatus 210 and the third vibration generator 221 may be disposed in the first space 100S. For example, the first vibration generating apparatus 210 and the third vibration generator 221 may be disposed to face each other. For example, the first vibration generating apparatus 210 and the third vibration generator 221 may be disposed to face each other in the first space 100S. For example, the first vibration generating apparatus 210 and the third vibration generator 221 may be disposed to at least partially overlap each other in the first space 100S.

The third vibration generator 221 and the fourth vibration generator 222 may be disposed in different spaces. For example, the third vibration generator 221 may be disposed in the first space 100S. For example, the fourth vibration generator 222 may be disposed in the second space 300S.

The first vibration generating apparatus 210 and the second vibration generating apparatus 220 may be disposed to face the same direction. For example, the first vibration generating apparatus 210 and the second vibration generating apparatus 220 may be disposed to face a downward direction in the third direction Z. For example, the first vibration generating apparatus 210 and the fourth vibration generator 222 may be disposed to face a downward direction in the third direction Z.

The first vibration generating apparatus 210 and the second vibration generating apparatus 220 may be disposed to face different directions. For example, the first vibration generating apparatus 210 may be disposed to face a downward direction in the third direction Z. For example, the third vibration generator 221 may be disposed to face an upward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

At least a portion of the vibration part 201 of the first vibration generating apparatus 210 may overlap the first vibration part 201-1 and the second vibration part 201-2 of the third vibration generator 221 and the first vibration part 201-1 and the second vibration part 201-2 of the fourth vibration generator 222. For example, the first vibration part 201-1, the second vibration part 201-2, and the vibration part 201 may have substantially the same size. Also, the third vibration generator 221 and the fourth vibration generator 222 each including the first vibration part 201-1 and the second vibration part 201-2 may have a size which is greater than that of the first vibration generating apparatus 210 including the single vibration part 201. Also, the first vibration generating apparatus 210 including the single vibration part 201 may have a size which is less than that of the third vibration generator 221 and the fourth vibration generator 222 each including the first vibration part 201-1 and the second vibration part 201-2.

A center portion between the first vibration part 201-1 and the second vibration part 201-2 of the third vibration generator 221 may overlap a center portion between the first vibration part 201-1 and the second vibration part 201-2 of the fourth vibration generator 222. Also, a center portion of the vibration part 201 of the first vibration generating apparatus 210 may overlap a center portion between the first vibration part 201-1 and the second vibration part 201-2 of each of the third vibration generator 221 and the fourth vibration generator 222. For example, a portion of a first region (or a left region) of the vibration part 201 of the first vibration generating apparatus 210 may overlap the first vibration part 201-1 of the third vibration generator 221 and the first vibration part 201-1 of the fourth vibration generator 222. Also, a portion of a second region (or a right region) of the vibration part 201 of the first vibration generating apparatus 210 may overlap the second vibration part 201-2 of the third vibration generator 221 and the second vibration part 201-2 of the fourth vibration generator 222.

The third vibration generator 221 and the fourth vibration generator 222 may have an inverted structure at each of the first surface 102a and the second surface 102b of the second vibration member 102. Also, the first vibration generating apparatus 210 may have an inverted structure with respect to one of the third vibration generator 221 and the fourth vibration generator 222 and may have a non-inverted structure with respect to the other of the third vibration generator 221 and the fourth vibration generator 222. For example, the first vibration generating apparatus 210 may have an inverted structure with respect to the third vibration generator 221 and may have a non-inverted structure with respect to the fourth vibration generator 222.

The first vibration generating apparatus 210, the third vibration generator 221, and the fourth vibration generator 222 may be configured to be displaced (or vibrated or driven) in the same direction. For example, a vibration driving signal applied to the first vibration generating apparatus 210 may have a phase opposite to or a phase difference with that of a vibration driving signal applied to the third vibration generator 221. Also, the vibration driving signal applied to the first vibration generating apparatus 210 may have the same phase as or a phase difference with that of a vibration driving signal applied to the fourth vibration generator 222.

Vibration driving signals respectively applied to the first vibration part 201-1 and the second vibration part 201-2 of the third vibration generator 221 may have the same phase, or may have a phase difference therebetween. Also, vibration driving signals respectively applied to the first vibration part 201-1 and the second vibration part 201-2 of the fourth vibration generator 222 may have the same phase, or may have a phase difference therebetween. Also, vibration driving signals respectively applied to the third vibration generator 221 and the fourth vibration generator 222 may have opposite phases, or may have a phase difference therebetween. For example, the vibration driving signals respectively applied to the first vibration part 201-1 and the second vibration part 201-2 of the third vibration generator 221 may have a phase difference therebetween caused by signal delay. Also, the vibration driving signals respectively applied to the first vibration part 201-1 and the second vibration part 201-2 of the fourth vibration generator 222 may have a phase difference therebetween caused by signal delay. Also, the vibration driving signal applied to the first vibration part 201-1 of the third vibration generator 221 may have a phase opposite to that of the vibration driving signal applied to the first vibration part 201-1 of the fourth vibration generator 222 and may have a phase opposite to that of the vibration driving signal applied to the second vibration part 201-2 of the fourth vibration generator 222, or may have a phase difference therebetween caused by signal delay. Also, the vibration driving signal applied to the second vibration part 201-2 of the third vibration generator 221 may have a phase opposite to that of the vibration driving signal applied to the first vibration part 201-1 of the fourth vibration generator 222 or may have a phase difference therebetween caused by signal delay and may have a phase opposite to that of the vibration driving signal applied to the second vibration part 201-2 of the fourth vibration generator 222. Also, the vibration driving signal applied to the first vibration generating apparatus 210 may have a phase opposite to that of the vibration driving signal applied to each of the first vibration part 201-1 and the second vibration part 201-2 of the third vibration generator 221, or may have a phase difference, caused by signal delay, with that of the vibration driving signal applied to one of the first vibration part 201-1 and the second vibration part 201-2 of the third vibration generator 221. Also, the vibration driving signal applied to the first vibration generating apparatus 210 may have the same phase as that of the vibration driving signal applied to each of the first vibration part 201-1 and the second vibration part 201-2 of the fourth vibration generator 222, or may have the same phase as that of the vibration driving signal applied to one of the first vibration part 201-1 and the second vibration part 201-2 of the fourth vibration generator 222 and may have a phase difference therebetween caused by signal delay.

According to an embodiment of the present disclosure, the first vibration generating apparatus 210 including the single vibration part 201 provided in the first vibration member 101 and the third vibration generator 221 and the fourth vibration generator 222 each including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 63, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 63, a first vibration generating apparatus 210 may include a single vibration generator. Also, the first vibration generating apparatus 210 may include at least one vibration part 201. For example, the first vibration generating apparatus 210 may include a vibration part 201 which is individually provided. Also, a second vibration generating apparatus 220 may include a third vibration generator 221 and a fourth vibration generator 222. Also, each of the third vibration generator 221 and the fourth vibration generator 222 of the second vibration generating apparatus 220) may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 may at least partially overlap the second vibration generating apparatus 220. For example, at least a portion of the second vibration generating apparatus 220 may overlap the first vibration generating apparatus 210.

The first vibration generating apparatus 210 may be disposed at the first surface 101a of the first vibration member 101. For example, the first vibration generating apparatus 210 may be connected with or coupled to the first surface 101a of the first vibration member 101 by the first adhesive member 151. The first vibration generating apparatus 210 may include the single vibration part 201.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be disposed to overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in different spaces. For example, the first vibration generating apparatus 210 and the third vibration generator 221 may be disposed in different spaces. For example, the third vibration generator 221 may be disposed in the first space 100S.

The third vibration generator 221 and the fourth vibration generator 222 may be disposed in different spaces. For example, the fourth vibration generator 222 may be disposed in the second space 300S.

For example, the first vibration generating apparatus 210 and the third vibration generator 221 may be disposed with the first vibration member 101 therebetween. For example, the first vibration generating apparatus 210 and the third vibration generator 221 may be disposed to at least partially overlap each other with the first vibration member 101 therebetween.

The first vibration generating apparatus 210 and the second vibration generating apparatus 220 may be disposed to face the same direction. For example, the first vibration generating apparatus 210 and the third vibration generator 221 may be disposed to face an upward direction in the third direction Z.

The first vibration generating apparatus 210 and the second vibration generating apparatus 220 may be disposed to face different directions. For example, the first vibration generating apparatus 210 may be disposed to face an upward direction in the third direction Z. For example, the fourth vibration generator 222 may be disposed to face a downward direction in the third direction Z. The second vibration generating apparatus 220 may be disposed in a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

At least a portion of the vibration part 201 of the first vibration generating apparatus 210 may overlap the first vibration part 201-1 and the second vibration part 201-2 of the third vibration generator 221 and the first vibration part 201-1 and the second vibration part 201-2 of the fourth vibration generator 222. For example, the first vibration part 201-1, the second vibration part 201-2, and the vibration part 201 may have substantially the same size. Also, the third vibration generator 221 and the fourth vibration generator 222 each including the first vibration part 201-1 and the second vibration part 201-2 may have a size which is greater than that of the first vibration generating apparatus 210 including the single vibration part 201. Also, the first vibration generating apparatus 210 including the single vibration part 201 may have a size which is less than that of the third vibration generator 221 and the fourth vibration generator 222 each including the first vibration part 201-1 and the second vibration part 201-2.

A center portion between the first vibration part 201-1 and the second vibration part 201-2 of the third vibration generator 221 may overlap a center portion between the first vibration part 201-1 and the second vibration part 201-2 of the fourth vibration generator 212. Also, a center portion of the vibration part 201 of the first vibration generating apparatus 210 may overlap a center portion between the first vibration part 201-1 and the second vibration part 201-2 of the third vibration generator 221 and the fourth vibration generator 222. For example, a portion of a first region (or a left region) of the vibration part 201 of the first vibration generating apparatus 210 may overlap the first vibration part 201-1 of the third vibration generator 221 and the first vibration part 201-1 of the fourth vibration generator 222. Also, a portion of a second region (or a right region) of the vibration part 201 of the first vibration generating apparatus 210 may overlap the second vibration part 201-2 of the third vibration generator 221 and the second vibration part 201-2 of the fourth vibration generator 222.

The third vibration generator 221 and the fourth vibration generator 222 may have an inverted structure at each of the first surface 102a and the second surface 102b of the second vibration member 102. Also, the first vibration generating apparatus 210 may have an inverted structure with respect to one of the third vibration generator 221 and the fourth vibration generator 222 and may have a non-inverted structure with respect to the other of the third vibration generator 221 and the fourth vibration generator 222. For example, the first vibration generating apparatus 210 may have a non-inverted structure with respect to the third vibration generator 221 and may have an inverted structure with respect to the fourth vibration generator 222.

The first vibration generating apparatus 210, the third vibration generator 221, and the fourth vibration generator 222 may be configured to be displaced (or vibrated or driven) in the same direction. For example, a vibration driving signal applied to the first vibration generating apparatus 210 may have the same phase as or a phase difference with that of a vibration driving signal applied to the third vibration generator 221. Also, the vibration driving signal applied to the first vibration generating apparatus 210 may have a phase opposite to or a phase difference with that of the vibration driving signal applied to the fourth vibration generator 222. For example, the vibration driving signal applied to each of the third vibration generator 221 and the fourth vibration generator 222 may be as described above with reference to FIG. 62, and thus, repeated descriptions thereof are omitted.

The vibration driving signal applied to the first vibration generating apparatus 210 may have the same phase as that of the vibration driving signal applied to each of the first and second vibration parts 201-1 and 201-2 of the third vibration generator 221 or may have a phase difference therebetween caused by signal delay, or may have the same phase as that of the vibration driving signal applied to one of the first and second vibration parts 201-1 and 201-2 of the third vibration generator 221 or may have a phase difference therebetween caused by signal delay. Also, the vibration driving signal applied to the first vibration generating apparatus 210 may have the phase opposite to that of the vibration driving signal applied to each of the first and second vibration parts 201-1 and 201-2 of the fourth vibration generator 222 or may have a phase difference therebetween caused by signal delay, or may have the phase opposite to that of the vibration driving signal applied to one of the first and second vibration parts 201-1 and 201-2 of the fourth vibration generator 222 and may have a phase difference therebetween caused by signal delay.

According to an embodiment of the present disclosure, the first vibration generating apparatus 210 including the single vibration part 201 provided in the first vibration member 101 and the third vibration generator 221 and the fourth vibration generator 222 each including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

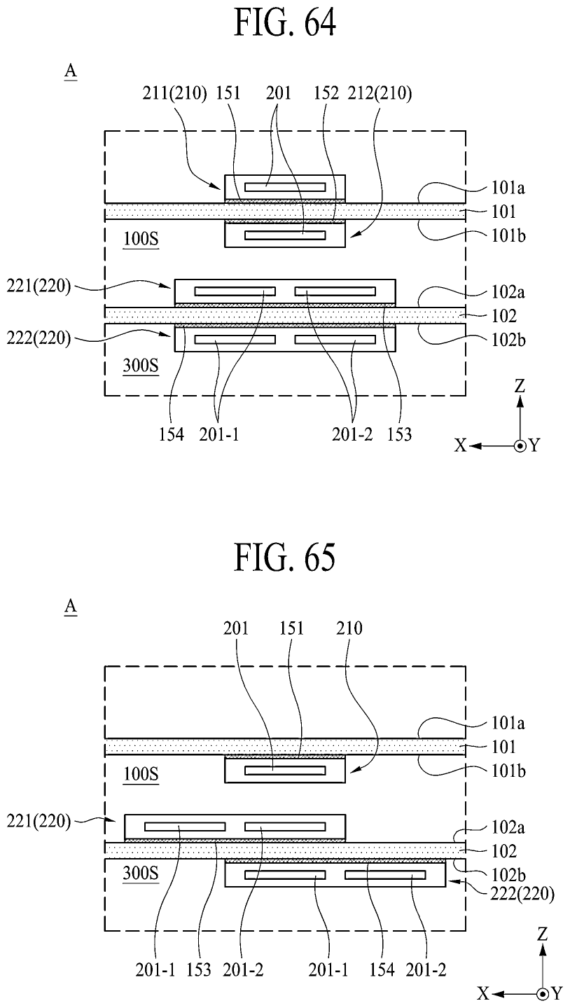

Referring to FIG. 64, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, each of the first vibration generating apparatus 210 and the second vibration generating apparatus 220 may include a plurality of vibration generators.

As illustrated in FIG. 64, a first vibration generating apparatus 210 may include a first vibration generator 211 and a second vibration generator 212. Also, each of the first vibration generator 211 and the second vibration generator 212 of the first vibration generating apparatus 210 may include at least one vibration part 201. For example, the first vibration generator 211 may include a vibration part 201 which is individually provided, and the second vibration generator 212 may include a vibration part 201 which is individually provided. Also, a second vibration generating apparatus 220 may include a third vibration generator 221 and a fourth vibration generator 222. Also, each of the third vibration generator 221 and the fourth vibration generator 222 of the second vibration generating apparatus 220 may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 and the second vibration generating apparatus 220 may at least partially overlap each other. For example, at least a portion of the second vibration generating apparatus 220 may overlap the first vibration generating apparatus 210.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be disposed to overlap each other with the first vibration member 101 therebetween. Each of the first vibration generator 211 and the second vibration generator 212 may include a single vibration part 201. In another embodiment of the present disclosure, one of the first vibration generator 211 and the second vibration generator 212 may include a first vibration part 201-1 and a second vibration part 201-2, and the other vibration generator may include a single vibration part 201, but embodiments of the present disclosure are not limited thereto. For example, the first vibration generator 211 may include the first vibration part 201-1 and the second vibration part 201-2 and the second vibration generator 212 may include the single vibration part 201, but embodiments of the present disclosure are not limited thereto.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be disposed to overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in different spaces. For example, the first vibration generator 211 and the third vibration generator 221 may be disposed in different spaces. For example, the third vibration generator 221 may be disposed in the first space 100S.

For example, the first vibration generator 211 and the second vibration generator 212 may be disposed in different spaces. For example, the second vibration generator 212 may be disposed in the first space 100S.

The first vibration generating apparatus 210 and the second vibration generating apparatus 220 may be disposed in the same space. For example, the second vibration generator 212 and the third vibration generator 221 may be disposed in the same space. For example, the second vibration generator 212 and the third vibration generator 221 may be disposed in the first space 100S. For example, the second vibration generator 212 and the third vibration generator 221 may be disposed to face each other. For example, the second vibration generator 212 and the third vibration generator 221 may be disposed to face each other in the first space 100S. For example, the second vibration generator 212 and the third vibration generator 221 may be disposed to at least partially overlap each other in the first space 100S.

The third vibration generator 221 and the fourth vibration generator 222 may be disposed in different spaces. For example, the third vibration generator 221 may be disposed in the first space 100S. For example, the fourth vibration generator 222 may be disposed in the second space 300S.

The first vibration generating apparatus 210 and the second vibration generating apparatus 220 may be disposed to face the same direction. For example, the first vibration generating apparatus 210 and the second vibration generating apparatus 220 may be disposed to face an upward direction in the third direction Z. For example, the first vibration generator 211 and the third vibration generator 221 may be disposed to face an upward direction in the third direction Z. For example, the second vibration generator 212 and the fourth vibration generator 222 may be disposed to face a downward direction in the third direction Z.

The first vibration generating apparatus 210 and the second vibration generating apparatus 220 may be disposed to face different directions. For example, the first vibration generator 211 may be disposed to face an upward direction in the third direction Z. The fourth vibration generator 222 may be disposed to face a downward direction in the third direction Z. For example, the second vibration generator 212 may be disposed to face a downward direction in the third direction Z. For example, the third vibration generator 221 may be disposed to face an upward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The vibration part 201 of the first vibration generator 211 and the vibration part 201 of the second vibration generator 212 may at least partially overlap the first vibration part 201-1 and the second vibration part 201-2 of the third vibration generator 221 and the first vibration part 201-1 and the second vibration part 201-2 of the fourth vibration generator 222. For example, the first vibration part 201-1, the second vibration part 201-2, and the vibration part 201 may have substantially the same size. Also, the first vibration generator 211 and the second vibration generator 212 each including the single vibration part 201 may have a size which is less than that of the third vibration generator 221 and the fourth vibration generator 222 each including the first vibration part 201-1 and the second vibration part 201-2.

A center portion of the vibration part 201 of the first vibration generator 211 may overlap a center portion of the vibration portion 201 of the second vibration generator 212. Also, a center portion between the first vibration part 201-1 and the second vibration part 201-2 of the third vibration generator 221 may overlap a center portion between the first vibration part 201-1 and the second vibration v 201-2 of the fourth vibration generator 222. Also, a center portion of the vibration part 201 of each of the first vibration generator 211 and the second vibration generator 212 may overlap a center portion between the first vibration part 201-1 and the second vibration part 201-2 of each of the third vibration generator 221 and the fourth vibration generator 222. For example, a portion of a first region (or a left region) of the vibration part 201 of each of the first vibration generator 211 and the second vibration generator 212 may overlap the first vibration part 201-1 of the third vibration generator 221 and the first vibration part 201-1 of the fourth vibration generator 222. Also, a portion of a second region (or a right region) of the vibration part 201 of each of the first vibration generator 211 and the second vibration generator 212 may overlap the second vibration part 201-2 of the third vibration generator 221 and the second vibration part 201-2 of the fourth vibration generator 222.

The third vibration generator 221 and the fourth vibration generator 222 may have an inverted structure at each of the first surface 102a and the second surface 102b of the second vibration member 102. Also, the first vibration generator 211 may have a non-inverted structure with respect to the third vibration generator 221 and may have an inverted structure with respect to the fourth vibration generator 222. Also, the second vibration generator 212 may have an inverted structure with respect to the third vibration generator 221 and may have a non-inverted structure with respect to the fourth vibration generator 222.

The first vibration generator 211, the second vibration generator 212, the third vibration generator 221, and the fourth vibration generator 222 may be configured to be displaced (or vibrated or driven) in the same direction. For example, a vibration driving signal applied to the first vibration generator 211 may have the same phase as or a phase difference with that of a vibration driving signal applied to the third vibration generator 221 and may have a phase opposite to or a phase difference with that of a vibration driving signal applied to the fourth vibration generator 222. Also, the vibration driving signal applied to the second vibration generator 212 may have a phase opposite to or a phase difference with that of the vibration driving signal applied to the third vibration generator 221 and may have the same phase as or a phase difference with that of the vibration driving signal applied to the fourth vibration generator 222. For example, the vibration driving signal applied to each of the third vibration generator 221 and the fourth vibration generator 222 may be as described above with reference to FIG. 62, and thus, repeated descriptions thereof are omitted.

The vibration driving signal applied to the first vibration generator 211 may have the same phase as that of the vibration driving signal applied to each of the first vibration part 201-1 and the second vibration part 201-2 of the third vibration generator 221 or may have a phase difference therebetween caused by signal delay, or may have the same phase as that of the vibration driving signal applied to one of the first vibration part 201-1 and the second vibration part 201-2 of the third vibration generator 221 or may have a phase difference therebetween caused by signal delay. Also, the vibration driving signal applied to the first vibration generator 211 may have a phase opposite to that of the vibration driving signal applied to each of the first vibration part 201-1 and the second vibration part 201-2 of the fourth vibration generator 222, or may have a phase difference, caused by signal delay, with that of the vibration driving signal applied to one of the first vibration part 201-1 and the second vibration part 201-2 of the fourth vibration generator 222. Also, the vibration driving signal applied to the second vibration generator 212 may have a phase opposite to that of the vibration driving signal applied to each of the first vibration part 201-1 and the second vibration part 201-2 of the third vibration generator 221, or may have a phase difference, caused by signal delay, with that of the vibration driving signal applied to one of the first vibration part 201-1 and the second vibration part 201-2 of the third vibration generator 221. Also, the vibration driving signal applied to the second vibration generator 212 may have the same phase as that of the vibration driving signal applied to each of the first vibration part 201-1 and the second vibration part 201-2 of the fourth vibration generator 222 or may have a phase difference therebetween caused by signal delay, or may have the same phase as that of the vibration driving signal applied to one of the first vibration part 201-1 and the second vibration part 201-2 of the fourth vibration generator 222 or may have a phase difference therebetween caused by signal delay.

According to an embodiment of the present disclosure, the first vibration generator 211 and the second vibration generator 212 each including the single vibration part 201 provided in the first vibration member 101 and the third vibration generator 221 and the fourth vibration generator 222 each including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 65, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 65, a first vibration generating apparatus 210 may include a single vibration generator. Also, the first vibration generating apparatus 210 may include at least one vibration part 201. For example, the first vibration generating apparatus 210 may include a vibration part 201 which is individually provided. Also, a second vibration generating apparatus 220 may include a third vibration generator 221 and a fourth vibration generator 222. Also, each of the third vibration generator 221 and the fourth vibration generator 222 of the second vibration generating apparatus 220 may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 may at least partially overlap the second vibration generating apparatus 220. For example, at least a portion of the second vibration generating apparatus 220 may overlap the first vibration generating apparatus 210.

The first vibration generating apparatus 210 may be disposed at a second surface 101b of the first vibration member 101. For example, the first vibration generating apparatus 210 may be connected with or coupled to the second surface 101b of the first vibration member 101 by a first adhesive member 151. The first vibration generating apparatus 210 may include a single vibration part 201. For example, the first vibration generating apparatus 210 may be disposed in a first space 100S between the first vibration member 101 and the second vibration member 102 and may be covered by the first vibration member 101, and thus, may be protected from an external impact.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be staggeredly disposed with the second vibration member 102 therebetween. For example, the third vibration generator 221 and the fourth vibration generator 222 may be disposed to at least partially overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in the same space. For example, the first vibration generating apparatus 210 and the third vibration generator 221 may be disposed in the same space. For example, the first vibration generating apparatus 210 and the third vibration generator 221 may be disposed in the first space 100S. For example, the first vibration generating apparatus 210 and the third vibration generator 221 may be disposed to face each other. For example, the first vibration generating apparatus 210 and the third vibration generator 221 may be disposed to face each other in the first space 100S. For example, the first vibration generating apparatus 210 and the third vibration generator 221 may be staggeredly disposed to face each other in the first space 100S. For example, the first vibration generating apparatus 210 and the third vibration generator 221 may be disposed to at least partially overlap each other in the first space 100S.

For example, the first vibration generating apparatus 210 and the second vibration generating apparatus 220 may be disposed in different spaces. For example, the first vibration generating apparatus 210 and the fourth vibration generator 222 may be disposed in different spaces. For example, the first vibration generating apparatus 210 may be disposed in the first space 100S. For example, the fourth vibration generator 222 may be disposed in the second space 300S.

The first vibration generating apparatus 210 and the second vibration generating apparatus 220 may be disposed to face the same direction. For example, the first vibration generating apparatus 210 and the second vibration generating apparatus 220 may be disposed to face a downward direction in the third direction Z.

For example, the first vibration generating apparatus 210 and the fourth vibration generator 222 may be disposed to face a downward direction in the third direction Z.

The first vibration generating apparatus 210 and the second vibration generating apparatus 220 may be disposed to face different directions. For example, the first vibration generating apparatus 210 may be disposed to face a downward direction in the third direction Z. For example, the third vibration generator 221 may be disposed to face an upward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The third vibration generator 221 and the fourth vibration generator 222 may be disposed to have an asymmetrical structure therebetween. For example, one of the first vibration part 201-1 and the second vibration part 201-2 of the third vibration generator 221 may overlap one of the first vibration part 201-1 and the second vibration part 201-2 of the fourth vibration generator 222 and may not overlap the other of the first vibration part 201-1 and the second vibration part 201-2 of the fourth vibration generator 222. For example, the first vibration part 201-1 of the third vibration generator 221 may not overlap the fourth vibration generator 222, and the second vibration part 201-2 of the third vibration generator 221 may overlap the first vibration part 201-1 of the fourth vibration generator 222. Also, one or more of the first vibration part 201-1 and the second vibration part 201-2 of the third vibration generator 221 and the first vibration part 201-1 and the second vibration part 201-2 of the fourth vibration generator 222 may overlap the vibration part 201 of the first vibration generating apparatus 210, and the other one or more of the first vibration part 201-1 and the second vibration part 201-2 of the third vibration generator 221 and the first vibration part 201-1 and the second vibration part 201-2 of the fourth vibration generator 222 may not overlap the vibration part 201 of the first vibration generating apparatus 210. For example, the first vibration part 201-1, the second vibration part 201-2, and the vibration part 201 may have substantially the same size. Also, the first vibration generating apparatus 220 including the single vibration part 201 may have a size which is less than that of the third vibration generator 221 and the fourth vibration generator 222 each including the first vibration part 201-1 and the second vibration part 201-2.

The first vibration generating apparatus 210 may not overlap the first vibration part 201-1 of the third vibration generator 221 and the second vibration part 201-2 of the fourth vibration generator 222. Also, the vibration part 201 of the first vibration generating apparatus 210 may overlap the second vibration part 201-2 of the third vibration generator 221 and the first vibration part 201-1 of the fourth vibration generator 222. For example, the vibration part 201 of the first vibration generating apparatus 210, the second vibration part 201-2 of the third vibration generator 221, and the first vibration part 201-1 of the fourth vibration generator 222 may overlap one another. Also, the vibration part 201 of the first vibration generating apparatus 210 may not overlap the first vibration part 201-1 of the third vibration generator 221 and the second vibration part 201-2 of the fourth vibration generator 222.

The third vibration generator 221 and the fourth vibration generator 222 may have an inverted structure at each of the first surface 102a and the second surface 102b of the second vibration member 102 and may be disposed in an asymmetrical structure therebetween. Also, the first vibration generating apparatus 210 may have an inverted structure with respect to the third vibration generator 221, overlap the second vibration part 201-2 of the third vibration generator 221, have a non-inverted structure with respect to the fourth vibration generator 222, and overlap the first vibration part 201-1 of the fourth vibration generator 222.

The first vibration generating apparatus 210, the third vibration generator 221, and the fourth vibration generator 222 may be configured to be displaced (or vibrated or driven) in the same direction. For example, a vibration driving signal applied to the first vibration generating apparatus 210 may have a phase opposite to or a phase difference with that of a vibration driving signal applied to the third vibration generator 221. Also, the vibration driving signal applied to the first vibration generating apparatus 210 may have the same phase as or a phase difference with that of the vibration driving signal applied to the fourth vibration generator 222. For example, the vibration driving signal applied to each of the first vibration generating apparatus 210, the third vibration generator 221, and the fourth vibration generator 222 may be as described above with reference to FIG. 62, and thus, repeated descriptions thereof are omitted.

According to an embodiment of the present disclosure, the first vibration generating apparatus 210 including the single vibration part 201 provided in the first vibration member 101 and the third vibration generator 221 and the fourth vibration generator 222 each including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

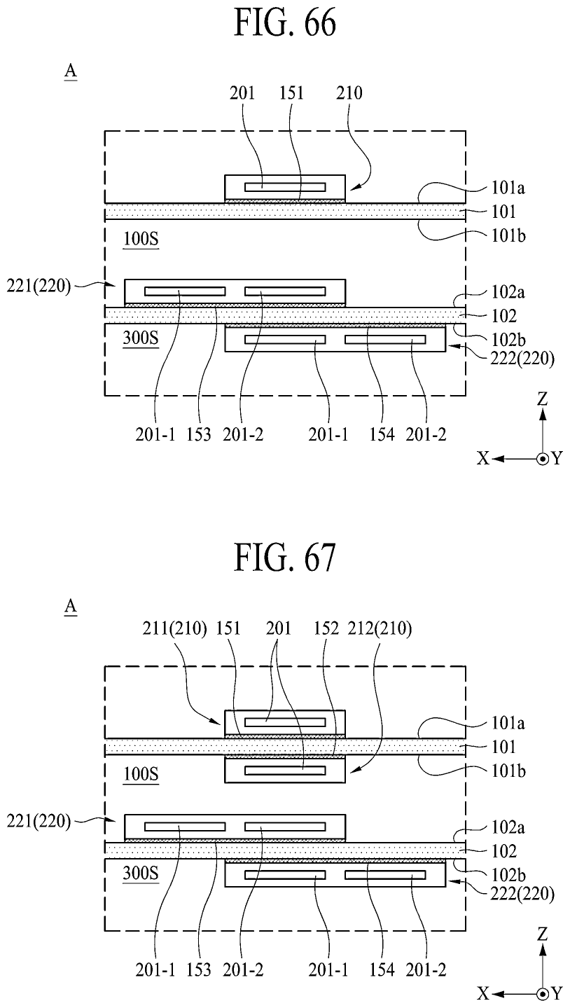

Referring to FIG. 66, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, at least one of the first vibration generating apparatus 210 and the second vibration generating apparatus 220 may include a plurality of vibration generators.

As illustrated in FIG. 66, a first vibration generating apparatus 210 may include a single vibration generator. Also, the first vibration generating apparatus 210 may include at least one vibration part 201. For example, the first vibration generating apparatus 210 may include a vibration part 201 which is individually provided. Also, a second vibration generating apparatus 220 may include a third vibration generator 221 and a fourth vibration generator 222. Also, each of the third vibration generator 221 and the fourth vibration generator 222 of the second vibration generating apparatus 220) may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 may at least partially overlap the second vibration generating apparatus 220. For example, at least a portion of the second vibration generating apparatus 220 may overlap the first vibration generating apparatus 210.

The first vibration generating apparatus 210 may be disposed at the first surface 101a of the first vibration member 101. For example, the first vibration generating apparatus 210) may be connected with or coupled to the first surface 101a of the first vibration member 101 by the first adhesive member 151. The first vibration generating apparatus 210 may include the single vibration part 201.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be staggeredly disposed with the second vibration member 102 therebetween. For example, the third vibration generator 221 and the fourth vibration generator 222 may be disposed to at least partially overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in different spaces. For example, the first vibration generating apparatus 210 and the third vibration generator 221 may be disposed in different spaces. For example, the third vibration generator 221 may be disposed in the first space 100S.

The third vibration generator 221 and the fourth vibration generator 222 may be disposed in different spaces. For example, the third vibration generator 221 may be disposed in the first space 100S. For example, the fourth vibration generator 222 may be disposed in the second space 300S.

The first vibration generating apparatus 210 and the second vibration generating apparatus 220 may be disposed with the first vibration member 101 therebetween. For example, the first vibration generating apparatus 210 and the third vibration generator 221 may be disposed with the first vibration member 101 therebetween. For example, the first vibration generating apparatus 210 and the third vibration generator 221 may be disposed to at least partially overlap each other with the first vibration member 101 therebetween.

The first vibration generating apparatus 210 and the second vibration generating apparatus 220 may be disposed to face the same direction. For example, the first vibration generating apparatus 210 and the second vibration generating apparatus 220 may be disposed to face an upward direction in the third direction Z. For example, the first vibration generating apparatus 210 and the third vibration generator 221 may be disposed to face an upward direction in the third direction Z.

The first vibration generating apparatus 210 and the second vibration generating apparatus 220 may be disposed to face different directions. For example, the first vibration generating apparatus 210 may be disposed to face an upward direction in the third direction Z. For example, the fourth vibration generator 222 may be disposed to face a downward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The third vibration generator 221 and the fourth vibration generator 222 may be disposed to have an asymmetrical structure therebetween. For example, one of the first vibration part 201-1 and the second vibration part 201-2 of the third vibration generator 221 may overlap one of the first vibration part 201-1 and the second vibration part 201-2 of the fourth vibration generator 222 and may not overlap the other of the first vibration part 201-1 and the second vibration part 201-2 of the fourth vibration generator 222. For example, the first vibration part 201-1 of the third vibration generator 221 may not overlap the fourth vibration generator 222, and the second vibration part 201-2 of the third vibration generator 221 may overlap the first vibration part 201-1 of the fourth vibration generator 222. Also, one of the first vibration part 201-1 and the second vibration part 201-2 of the third vibration generator 221 and the first vibration part 201-1 and the second vibration part 201-2 of the fourth vibration generator 222 may overlap the vibration part 201 of the first vibration generating apparatus 210, and the other of the first vibration part 201-1 and the second vibration part 201-2 of the third vibration generator 221 and the first vibration part 201-1 and the second vibration part 201-2 of the fourth vibration generator 222 may not overlap the vibration part 201 of the first vibration generating apparatus 210. For example, the first vibration part 201-1, the second vibration part 201-2, and the vibration part 201 may have substantially the same size. Also, the first vibration generating apparatus 220 including the single vibration part 201 may have a size which is less than that of the third vibration generator 221 and the fourth vibration generator 222 each including the first vibration part 201-1 and the second vibration part 201-2.

The first vibration generating apparatus 210 may not overlap the first vibration part 201-1 of the third vibration generator 221 and the second vibration part 201-2 of the fourth vibration generator 222. Also, the vibration part 201 of the first vibration generating apparatus 210 may overlap the second vibration part 201-2 of the third vibration generator 221 and the first vibration part 201-1 of the fourth vibration generator 222. For example, the vibration part 201 of the first vibration generating apparatus 210, the second vibration part 201-2 of the third vibration generator 221, and the first vibration part 201-1 of the fourth vibration generator 222 may overlap one another. Also, the vibration part 201 of the first vibration generating apparatus 210 may not overlap the first vibration part 201-1 of the third vibration generator 221 and the second vibration part 201-2 of the fourth vibration generator 222.

The third vibration generator 221 and the fourth vibration generator 222 may have an inverted structure at each of the first surface 102a and the second surface 102b of the second vibration member 102 and may be disposed in an asymmetrical structure therebetween. Also, the first vibration generating apparatus 210 may have a non-inverted structure with respect to the third vibration generator 221, overlap the second vibration part 201-2 of the third vibration generator 221, have an inverted structure with respect to the fourth vibration generator 222, and overlap the first vibration part 201-1 of the fourth vibration generator 222.

The first vibration generating apparatus 210, the third vibration generator 221, and the fourth vibration generator 222 may be configured to be displaced (or vibrated or driven) in the same direction. For example, a vibration driving signal applied to the first vibration generating apparatus 210 may have the same phase as or a phase difference with that of a vibration driving signal applied to the third vibration generator 221. Also, the vibration driving signal applied to the first vibration generating apparatus 210 may have a phase opposite to or a phase difference with that of the vibration driving signal applied to the fourth vibration generator 222. For example, the vibration driving signal applied to each of the first vibration generating apparatus 210, the third vibration generator 221, and the fourth vibration generator 222 may be as described above with reference to FIG. 63, and thus, repeated descriptions thereof are omitted.

According to an embodiment of the present disclosure, the first vibration generating apparatus 210 including the single vibration part 201 provided in the first vibration member 101 and the third vibration generator 221 and the fourth vibration generator 222 each including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 67, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, each of the first vibration generating apparatus 210 and the second vibration generating apparatus 220 may include a plurality of vibration generators.

As illustrated in FIG. 67, a first vibration generating apparatus 210 may include a first vibration generator 211 and a second vibration generator 212. Also, each of the first vibration generator 211 and the second vibration generator 212 of the first vibration generating apparatus 210 may include at least one vibration part 201. For example, the first vibration generator 211 may include a vibration part 201 which is individually provided, and the second vibration generator 212 may include a vibration part 201 which is individually provided. Also, a second vibration generating apparatus 220 may include a third vibration generator 221 and a fourth vibration generator 222. Also, each of the third vibration generator 221 and the fourth vibration generator 222 of the second vibration generating apparatus 220 may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 and the second vibration generating apparatus 220 may at least partially overlap each other. For example, at least a portion of the second vibration generating apparatus 220 may overlap the first vibration generating apparatus 210.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be disposed to overlap each other with the first vibration member 101 therebetween. Each of the first vibration generator 211 and the second vibration generator 212 may include a single vibration part 201. In another embodiment of the present disclosure, one of the first vibration generator 211 and the second vibration generator 212 may include the first vibration part 201-1 and the second vibration part 201-2, and the other vibration generator may include a single vibration v 201. For example, the first vibration generator 211 may include the first vibration part 201-1 and the second vibration part 201-2 and the second vibration generator 212 may include the single vibration part 201, but embodiments of the present disclosure are not limited thereto.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be staggeredly disposed with the second vibration member 102 therebetween. For example, the third vibration generator 221 and the fourth vibration generator 222 may be disposed to at least partially overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in different spaces. For example, the first vibration generator 211 and the third vibration generator 221 may be disposed in different spaces. For example, the third vibration generator 221 may be disposed in the first space 100S. For example, the first vibration generator 211 and the fourth vibration generator 222 may be disposed in different spaces. For example, the fourth vibration generator 222 may be disposed in the second space 300S. For example, the second vibration generator 212 and the fourth vibration generator 222 may be disposed in different spaces. For example, the second vibration generator 212 may be disposed in the first space 100S.

The first vibration generating apparatus 210 and the second vibration generating apparatus 220 may be disposed in the same space. For example, the second vibration generator 212 and the third vibration generator 221 may be disposed in the same space. For example, the second vibration generator 212 and the third vibration generator 221 may be disposed in the first space 100S. For example, the second vibration generator 212 and the third vibration generator 221 may be disposed to face each other. For example, the second vibration generator 212 and the third vibration generator 221 may be disposed to face each other in the first space 100S. For example, the second vibration generator 212 and the third vibration generator 221 may be staggeredly disposed in the first space 100S. For example, the second vibration generator 212 and the third vibration generator 221 may be disposed to at least partially overlap each other in the first space 100S.

The first vibration generator 211 and the second vibration generator 212 may be disposed in different spaces. For example, the second vibration generator 212 may be disposed in the first space 100S.

The third vibration generator 221 and the fourth vibration generator 222 may be disposed in different spaces. For example, the third vibration generator 221 may be disposed in the first space 100S. For example, the fourth vibration generator 222 may be disposed in the second space 300S.

The first vibration generating apparatus 210 and the second vibration generating apparatus 220 may be disposed to face the same direction. For example, the first vibration generating apparatus 210 and the second vibration generating apparatus 220 may be disposed to face an upward direction in the third direction Z. For example, the first vibration generator 211 and the third vibration generator 221 may be disposed to face an upward direction in the third direction Z. For example, the first vibration generating apparatus 210 and the second vibration generating apparatus 220 may be disposed to face a downward direction in the third direction Z. For example, the second vibration generator 212 and the fourth vibration generator 222 may be disposed to face a downward direction in the third direction Z.

The first vibration generating apparatus 210 and the second vibration generating apparatus 220 may be disposed to face different directions. For example, the first vibration generator 211 may be disposed to face an upward direction in the third direction Z. The fourth vibration generator 222 may be disposed to face a downward direction in the third direction Z. For example, the second vibration generator 212 may be disposed to face a downward direction in the third direction Z. For example, the third vibration generator 221 may be disposed to face an upward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The third vibration generator 221 and the fourth vibration generator 222 may be disposed to have an asymmetrical structure therebetween. For example, one of the first vibration part 201-1 and the second vibration part 201-2 of the third vibration generator 221 may overlap one of the first vibration part 201-1 and the second vibration part 201-2 of the fourth vibration generator 222 and may not overlap the other of the first vibration part 201-1 and the second vibration part 201-2 of the fourth vibration generator 222. For example, the first vibration part 201-1 of the third vibration generator 221 may not overlap the fourth vibration generator 222, and the second vibration part 201-2 of the third vibration generator 221 may overlap the first vibration part 201-1 of the fourth vibration generator 222. Also, one or more of the first vibration part 201-1 and the second vibration part 201-2 of the third vibration generator 221 and the first vibration part 201-1 and the second vibration part 201-2 of the fourth vibration generator 222 may overlap the first vibration generator 211 and the second vibration generator 212, and the other one or more of the first vibration part 201-1 and the second vibration part 201-2 of the third vibration generator 221 and the first vibration part 201-1 and the second vibration part 201-2 of the fourth vibration generator 222 may not overlap the first vibration generator 211 and the second vibration generator 212. For example, the first vibration part 201-1, the second vibration part 201-2, and the vibration part 201 may have substantially the same size. Also, the first vibration generator 211 and the second vibration generator 212 each including the single vibration part 201 may have a size which is less than that of the third vibration generator 221 and the fourth vibration generator 222 each including the first vibration part 201-1 and the second vibration part 201-2.

The first vibration generator 211 and the second vibration generator 212 may not overlap the first vibration part 201-1 of the third vibration generator 221 and the second vibration part 201-2 of the fourth vibration generator 222. Also, the vibration part 201 of each of the first vibration generator 211 and the second vibration generator 212 may overlap the second vibration part 201-2 of the third vibration generator 221 and the first vibration part 201-1 of the fourth vibration generator 222. For example, the vibration part 201 of each of the first vibration generator 211 and the second vibration generator 212, the second vibration part 201-2 of the third vibration generator 221, and the first vibration part 201-1 of the fourth vibration generator 222 may overlap one another. Also, the vibration part 201 of each of the first vibration generator 211 and the second vibration generator 212 may not overlap the first vibration part 201-1 of the third vibration generator 221 and the second vibration part 201-2 of the fourth vibration generator 222.

The third vibration generator 221 and the fourth vibration generator 222 may have an inverted structure at each of the first surface 102a and the second surface 102b of the second vibration member 102 and may be disposed in an asymmetrical structure therebetween. Also, the first vibration generator 211 may have a non-inverted structure with respect to the third vibration generator 221, overlap the second vibration part 201-2 of the third vibration generator 221, have an inverted structure with respect to the fourth vibration generator 222, and overlap the first vibration part 201-1 of the fourth vibration generator 222. Also, the second vibration generator 212 may have an inverted structure with respect to the third vibration generator 221, overlap the second vibration part 201-2 of the third vibration generator 221, have a non-inverted structure with respect to the fourth vibration generator 222, and overlap the first vibration part 201-1 of the fourth vibration generator 222.

The first vibration generator 211, the second vibration generator 212, the third vibration generator 221, and the fourth vibration generator 222 may be configured to be displaced (or vibrated or driven) in the same direction. For example, a vibration driving signal applied to the first vibration generator 211 may have the same phase as or a phase difference with that of a vibration driving signal applied to the third vibration generator 221 and may have a phase opposite to or a phase difference with that of a vibration driving signal applied to the fourth vibration generator 222. Also, the vibration driving signal applied to the second vibration generator 212 may have a phase opposite to or a phase difference with that of the vibration driving signal applied to the third vibration generator 221 and may have the same phase as or a phase difference with that of the vibration driving signal applied to the fourth vibration generator 222. For example, the vibration driving signal applied to each of the first vibration generator 211, the second vibration generator 212, the third vibration generator 221, and the fourth vibration generator 222 may be as described above with reference to FIG. 64, and thus, repeated descriptions thereof are omitted.

According to an embodiment of the present disclosure, the first vibration generator 211 and the second vibration generator 212 each including the single vibration part 201 provided in the first vibration member 101 and the third vibration generator 221 and the fourth vibration generator 222 each including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

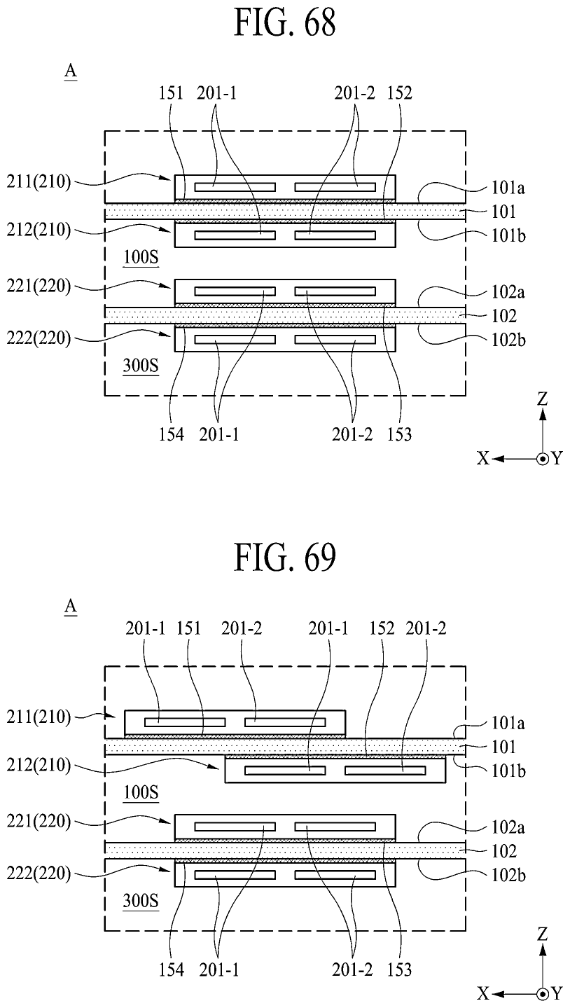

Referring to FIG. 68, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, each of the first vibration generating apparatus 210 and the second vibration generating apparatus 220 may include a plurality of vibration generators.

As illustrated in FIG. 68, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a third vibration generator 221 and a fourth vibration generator 222. Also, each of the third vibration generator 221 and the fourth vibration generator 222 of the second vibration generating apparatus 220 may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 may at least partially overlap the second vibration generating apparatus 220. For example, at least a portion of the first vibration generating apparatus 210 may overlap the second vibration generating apparatus 220.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be disposed to overlap each other with the first vibration member 101 therebetween. Each of the first vibration generator 211 and the second vibration generator 212 may include a first vibration part 201-1 and a second vibration part 201-2. In another embodiment of the present disclosure, the first vibration generator 211 may include the first vibration part 201-1 and the second vibration part 201-2 and the second vibration generator 212 may include the single vibration part 201, but embodiments of the present disclosure are not limited thereto.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be disposed to overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in different spaces. For example, the first vibration generator 211 and the third vibration generator 221 may be disposed in different spaces. For example, the third vibration generator 221 may be disposed in the first space 100S. For example, the first vibration generator 211 and the fourth vibration generator 222 may be disposed in different spaces. For example, the fourth vibration generator 222 may be disposed in the second space 300S. For example, the second vibration generator 212 and the fourth vibration generator 222 may be disposed in different spaces. For example, the second vibration generator 221 may be disposed in the first space 100S.

The first vibration generating apparatus 210 and the second vibration generating apparatus 220 may be disposed in the same space. For example, the second vibration generator 212 and the third vibration generator 221 may be disposed in the same space. For example, the second vibration generator 212 and the third vibration generator 221 may be disposed in the first space 100S. For example, the second vibration generator 212 and the third vibration generator 221 may be disposed to face each other. For example, the second vibration generator 212 and the third vibration generator 221 may be disposed to face each other in the first space 100S. For example, the second vibration generator 212 and the third vibration generator 221 may be disposed to overlap each other in the first space 100S. For example, the second vibration generator 212 and the third vibration generator 221 may be disposed to face and overlap each other in the first space 100S.

The first vibration generator 211 and the second vibration generator 212 may be disposed in different spaces. For example, the second vibration generator 212 may be disposed in the first space 100S.

The third vibration generator 221 and the fourth vibration generator 222 may be disposed in different spaces. For example, the third vibration generator 221 may be disposed in the first space 100S. For example, the fourth vibration generator 222 may be disposed in the second space 300S.

The first vibration generating apparatus 210 and the second vibration generating apparatus 220 may be disposed to face the same direction. For example, the first vibration generating apparatus 210 and the second vibration generating apparatus 220 may be disposed to face a downward direction in the third direction Z. For example, the first vibration generator 211 and the third vibration generator 221 may be disposed to face an upward direction in the third direction Z. For example, the second vibration generator 212 and the fourth vibration generator 222 may be disposed to face a downward direction in the third direction Z.

The first vibration generating apparatus 210 and the second vibration generating apparatus 220 may be disposed to face different directions. For example, the first vibration generator 211 may be disposed to face an upward direction in the third direction Z. The fourth vibration generator 222 may be disposed to face a downward direction in the third direction Z. For example, the second vibration generator 212 may be disposed to face a downward direction in the third direction Z. For example, the third vibration generator 221 may be disposed to face an upward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The first vibration generator 211, the second vibration generator 212, the third vibration generator 221, and the fourth vibration generator 222 may overlap one another. For example, the first vibration part 201-1 of the first vibration generator 211, the first vibration part 201-1 of the second vibration generator 212, the first vibration portion 201-1 of the third vibration generator 221, and the first vibration part 201-1 of the fourth vibration generator 222 may overlap one another. Also, the second vibration part 202-1 of the first vibration generator 211, the second vibration part 202-1 of the second vibration generator 212, the second vibration part 202-1 of the third vibration generator 221, and the second vibration part 202-1 of the fourth vibration generator 222 may overlap one another. For example, the first vibration part 201-1 and the second vibration part 201-2 may have substantially the same size. Also, the first vibration generator 211, the second vibration generator 212, the third vibration generator 221, and the fourth vibration generator 222 may have substantially the same size.

The first vibration generator 211 and the second vibration generator 212 may have an inverted structure at each of the first surface 101a and the second surface 101b of the first vibration member 101. Also, the third vibration generator 221 and the fourth vibration generator 222 may have an inverted structure at each of the first surface 102a and the second surface 102b of the second vibration member 102. Also, the first vibration generator 211 may have a non-inverted structure with respect to the third vibration generator 221 and may have an inverted structure with respect to the fourth vibration generator 222. Also, the second vibration generator 212 may have an inverted structure with respect to the third vibration generator 221 and may have a non-inverted structure with respect to the fourth vibration generator 222.

The first vibration generator 211, the second vibration generator 212, the third vibration generator 221, and the fourth vibration generator 222 may be configured to be displaced (or vibrated or driven) in the same direction. For example, a vibration driving signal applied to the first vibration generator 211 may have the same phase as or a phase difference with that of a vibration driving signal applied to the third vibration generator 221 and may have a phase opposite to or a phase difference with that of a vibration driving signal applied to the fourth vibration generator 222. Also, the vibration driving signal applied to the second vibration generator 212 may have a phase opposite to or a phase difference with that of the vibration driving signal applied to the third vibration generator 221 and may have the same phase as or a phase difference with that of the vibration driving signal applied to the fourth vibration generator 222. For example, the vibration driving signal applied to each of the first vibration generator 211 and the second vibration generator 212 may be as described above with reference to FIG. 56, and thus, repeated descriptions thereof are omitted. For example, the vibration driving signal applied to each of the third vibration generator 221 and the fourth vibration generator 222 may be as described above with reference to FIG. 62, and thus, repeated descriptions thereof are omitted.

A vibration driving signal applied to the first vibration portion 201-1 of the first vibration generator 211 may have the same phase as that of a vibration driving signal applied to the first vibration part 201-1 of the third vibration generator 221 and may have a phase opposite to that of a vibration driving signal applied to the first vibration part 201-1 of the fourth vibration generator 222. Also, a vibration driving signal applied to the second vibration part 201-1 of the first vibration generator 211 may have the same phase as that of a vibration driving signal applied to the second vibration part 201-2 of the third vibration generator 221 and may have a phase opposite to that of a vibration driving signal applied to the second vibration part 201-2 of the fourth vibration generator 222. Also, a vibration driving signal applied to the first vibration part 201-1 of the second vibration generator 212 may have a phase opposite to that of the vibration driving signal applied to the first vibration part 201-1 of the third vibration generator 221 and may have the same phase as that of the vibration driving signal applied to the first vibration part 201-1 of the fourth vibration generator 222. Also, a vibration driving signal applied to the second vibration part 201-2 of the second vibration generator 212 may have a phase opposite to that of the vibration driving signal applied to the second vibration part 201-2 of the third vibration generator 221 and may have the same phase as that of the vibration driving signal applied to the second vibration part 201-2 of the fourth vibration generator 222.

According to an embodiment of the present disclosure, the first vibration generator 211 and the second vibration generator 212 each including the first vibration part 201-1 and the second vibration part 201-2 provided in the first vibration member 101 and the third vibration generator 221 and the fourth vibration generator 222 each including the first vibration part 201-1 and the second vibration part 201-2 provided in the second vibration member 102 may be disposed to overlap one another and may be configured to be displaced (or vibrated or driven) in the same direction, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 69, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, each of the first vibration generating apparatus 210 and the second vibration generating apparatus 220 may include a plurality of vibration generators.

As illustrated in FIG. 69, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a third vibration generator 221 and a fourth vibration generator 222. Also, each of the third vibration generator 221 and the fourth vibration generator 222 of the second vibration generating apparatus 220 may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 may at least partially overlap the second vibration generating apparatus 220. For example, at least a portion of the first vibration generating apparatus 210 may overlap the second vibration generating apparatus 220.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be staggeredly disposed with the first vibration member 101 therebetween. For example, the first vibration generator 211 and the second vibration generator 212 may be disposed to overlap each other with the first vibration member 101 therebetween. Each of the first vibration generator 211 and the second vibration generator 212 may include a first vibration part 201-1 and a second vibration part 201-2. In another embodiment of the present disclosure, one of the first vibration generator 211 and the second vibration generator 212 may include the first vibration part 201-1 and the second vibration part 201-2, and the other vibration generator may include a single vibration part 201. For example, the first vibration generator 211 may include the first vibration part 201-1 and the second vibration part 201-2 and the second vibration generator 212 may include the single vibration part 201, but embodiments of the present disclosure are not limited thereto.

The third vibration generator 221 may be disposed at a first surface 102a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 154. For example, the third vibration generator 221 and the fourth vibration generator 222 may be disposed with the second vibration member 102 therebetween. For example, the third vibration generator 221 and the fourth vibration generator 222 may be disposed to overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in different spaces. For example, the first vibration generator 211 and the third vibration generator 221 may be disposed in different spaces. For example, the third vibration generator 221 may be disposed in the first space 100S. For example, the first vibration generator 211 and the fourth vibration generator 222 may be disposed in different spaces. For example, the fourth vibration generator 222 may be disposed in the second space 300S. For example, the second vibration generator 212 and the fourth vibration generator 222 may be disposed in different spaces. For example, the second vibration generator 221 may be disposed in the first space 100S.

The first vibration generating apparatus 210 and the second vibration generating apparatus 220 may be disposed in the same space. For example, the second vibration generator 212 and the third vibration generator 221 may be disposed in the same space. For example, the second vibration generator 212 and the third vibration generator 221 may be disposed in the first space 100S. For example, the second vibration generator 212 and the third vibration generator 221 may be disposed to face each other. For example, the second vibration generator 212 and the third vibration generator 221 may be disposed to face each other in the first space 100S. For example, the second vibration generator 212 and the third vibration generator 221 may be disposed to overlap each other in the first space 100S. For example, the second vibration generator 212 and the third vibration generator 221 may be staggeredly disposed to face each other in the first space 100S.

The first vibration generator 211 and the second vibration generator 212 may be disposed in different spaces. For example, the second vibration generator 212 may be disposed in the first space 100S.

The third vibration generator 221 and the fourth vibration generator 222 may be disposed in different spaces. For example, the third vibration generator 221 may be disposed in the first space 100S. For example, the fourth vibration generator 222 may be disposed in the second space 300S.

The first vibration generating apparatus 210 and the second vibration generating apparatus 220 may be disposed to face the same direction. For example, the first vibration generating apparatus 210 and the second vibration generating apparatus 220 may be disposed to face a downward direction in the third direction Z. For example, the first vibration generator 211 and the third vibration generator 221 may be disposed to face an upward direction in the third direction Z. For example, the second vibration generator 212 and the fourth vibration generator 222 may be disposed to face a downward direction in the third direction Z.

The first vibration generating apparatus 210 and the second vibration generating apparatus 220 may be disposed to face different directions. For example, the first vibration generator 211 may be disposed to face an upward direction in the third direction Z. The fourth vibration generator 222 may be disposed to face a downward direction in the third direction Z. For example, the second vibration generator 212 may be disposed to face a downward direction in the third direction Z. For example, the third vibration generator 221 may be disposed to face an upward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The first vibration generator 211 and the second vibration generator 212 may be disposed to have an asymmetrical structure therebetween. For example, one of the first vibration part 201-1 and the second vibration part 201-2 of the first vibration generator 211 may overlap one of the first vibration part 201-1 and the second vibration part 201-2 of the second vibration generator 212 and may not overlap the other of the first vibration part 201-1 and the second vibration part 201-2 of the second vibration generator 212. For example, the first vibration part 201-1 of the first vibration generator 211 may not overlap the second vibration generator 212, and the second vibration part 201-2 of the first vibration generator 211 may overlap the first vibration part 201-1 of the second vibration generator 212. Also, one or more of the first vibration part 201-1 and the second vibration part 201-2 of the first vibration generator 211 and the first vibration part 201-1 and the second vibration part 201-2 of the second vibration generator 212 may overlap a center portion between the first vibration part 201-1 and the second vibration part 201-2 of each of the third vibration generator 221 and the fourth vibration generator 222, and the other one or more of the first vibration part 201-1 and the second vibration part 201-2 of the first vibration generator 211 and the first vibration part 201-1 and the second vibration part 201-2 of the second vibration generator 212 may overlap at least a portion of the first vibration part 201-1 or the second vibration part 201-2 of each of the third vibration generator 221 and the fourth vibration generator 222. For example, the first vibration part 201-1 and the second vibration part 201-2 may have substantially the same size. Also, the first vibration generator 211, the second vibration generator 212, the third vibration generator 221, and the fourth vibration generator 222 each including the first vibration part 201-1 and the second vibration part 201-2 may have substantially the same size.

The first vibration part 201-1 of the first vibration generator 211 may overlap a portion of a first region (or a left region) of the first vibration part 201-1 of each of the third vibration generator 221 and the fourth vibration generator 222. Also, the second vibration part 201-2 of the first vibration generator 211 and the first vibration part 201-1 of the second vibration generator 212 may overlap a portion of a second region (or a right region) of the first vibration part 201-1 of each of the third vibration generator 221 and the fourth vibration generator 222 and a portion of a first region (or a left region) of the second vibration part 201-2 of each of the third vibration generator 221 and the fourth vibration generator 222. The second vibration part 201-2 of the second vibration generator 212 may overlap a portion of a second region (or a right region) of the second vibration part 201-2 of each of the third vibration generator 221 and the fourth vibration generator 222.

The first vibration generator 211 and the second vibration generator 212 may have an inverted structure at each of the first surface 101a and the second surface 101b of the first vibration member 101 and may be disposed in an asymmetrical structure therebetween. Also, the third vibration generator 221 and the fourth vibration generator 222 may have an inverted structure at each of the first surface 102a and the second surface 102b of the second vibration member 102. Also, the first vibration generator 211 may have a non-inverted structure with respect to the third vibration generator 221 and may at least partially overlap the third vibration generator 221, and moreover, may have an inverted structure with respect to the fourth vibration generator 222 and may at least partially overlap the fourth vibration generator 222. Also, the second vibration generator 212 may have an inverted structure with respect to the third vibration generator 221 and may at least partially overlap the third vibration generator 221, and moreover, may have a non-inverted structure with respect to the fourth vibration generator 222 and may at least partially overlap the fourth vibration generator 222.

The first vibration generator 211, the second vibration generator 212, the third vibration generator 221, and the fourth vibration generator 222 may be configured to be displaced (or vibrated or driven) in the same direction. For example, a vibration driving signal applied to the first vibration generator 211 may have the same phase as or a phase difference with that of a vibration driving signal applied to the third vibration generator 221 and may have a phase opposite to or a phase difference with that of a vibration driving signal applied to the fourth vibration generator 222. Also, the vibration driving signal applied to the second vibration generator 212 may have a phase opposite to or a phase difference with that of the vibration driving signal applied to the third vibration generator 221 and may have the same phase as or a phase difference with that of the vibration driving signal applied to the fourth vibration generator 222. For example, the vibration driving signal applied to each of the first vibration generator 211 and the second vibration generator 212 may be as described above with reference to FIG. 56, and thus, repeated descriptions thereof are omitted. For example, the vibration driving signal applied to each of the third vibration generator 221 and the fourth vibration generator 222 may be as described above with reference to FIG. 62, and thus, repeated descriptions thereof are omitted.

A vibration driving signal applied to the first vibration part 201-1 of the first vibration generator 211 may have the same phase as or a phase difference with that of a vibration driving signal applied to the first vibration part 201-1 of the third vibration generator 221 and may have a phase opposite to or a phase difference with that of a vibration driving signal applied to the first vibration part 201-1 of the fourth vibration generator 222. Also, a vibration driving signal applied to the second vibration part 201-2 of the first vibration generator 211 may have the same phase as or a phase difference with that of a vibration driving signal applied to the second vibration part 201-2 of the third vibration generator 221 and may have a phase opposite to or a phase difference with that of a vibration driving signal applied to the second vibration part 201-2 of the fourth vibration generator 222. Also, a vibration driving signal applied to the first vibration part 201-1 of the second vibration generator 212 may have a phase opposite to or a phase difference with that of the vibration driving signal applied to the first vibration part 201-1 of the third vibration generator 221 and may have the same phase as or a phase difference with that of the vibration driving signal applied to the first vibration part 201-1 of the fourth vibration generator 222. Also, a vibration driving signal applied to the second vibration part 201-2 of the second vibration generator 212 may have a phase opposite to or a phase difference with that of the vibration driving signal applied to the second vibration part 201-2 of the third vibration generator 221 and may have the same phase as or a phase difference with that of the vibration driving signal applied to the second vibration part 201-2 of the fourth vibration generator 222.

According to an embodiment of the present disclosure, the first vibration generator 211 and the second vibration generator 212 each including the first vibration part 201-1 and the second vibration part 201-2 provided in the first vibration member 101 and the third vibration generator 221 and the fourth vibration generator 222 each including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

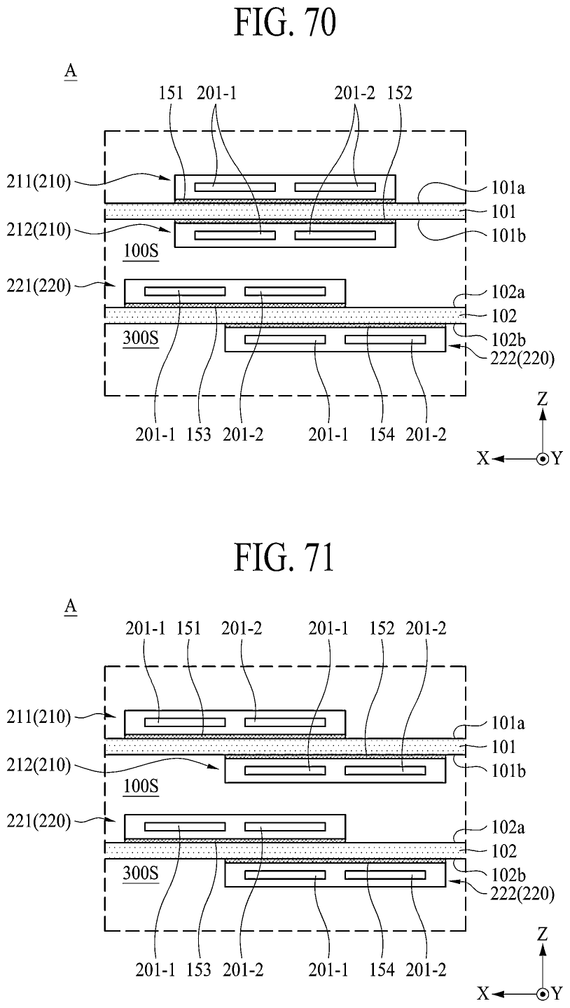

Referring to FIG. 70, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, each of the first vibration generating apparatus 210 and the second vibration generating apparatus 220 may include a plurality of vibration generators.

As illustrated in FIG. 70, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a third vibration generator 221 and a fourth vibration generator 222. Also, each of the third vibration generator 221 and the fourth vibration generator 222 of the second vibration generating apparatus 220 may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 may at least partially overlap the second vibration generating apparatus 220. For example, at least a portion of the first vibration generating apparatus 210 may overlap the second vibration generating apparatus 220.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be disposed to overlap each other with the first vibration member 101 therebetween. Each of the first vibration generator 211 and the second vibration generator 212 may include a first vibration part 201-1 and a second vibration part 201-2. In another embodiment of the present disclosure, the first vibration generator 211 may include the first vibration part 201-1 and the second vibration part 201-2 and the second vibration generator 212 may include the single vibration part 201, but embodiments of the present disclosure are not limited thereto.

The third vibration generator 221 may be disposed at a first surface 101a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 152. For example, the third vibration generator 221 and the fourth vibration generator 222 may be disposed with the second vibration member 102 therebetween. For example, the third vibration generator 221 and the fourth vibration generator 222 may be staggeredly disposed with the second vibration member 102 therebetween. For example, the third vibration generator 221 and the fourth vibration generator 222 may be disposed to overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in different spaces. For example, the first vibration generator 211 and the third vibration generator 221 may be disposed in different spaces. For example, the third vibration generator 221 may be disposed in the first space 100S. For example, the first vibration generator 211 and the fourth vibration generator 222 may be disposed in different spaces. For example, the fourth vibration generator 222 may be disposed in the second space 300S. For example, the second vibration generator 212 and the fourth vibration generator 222 may be disposed in different spaces. For example, the second vibration generator 221 may be disposed in the first space 100S.

The first vibration generating apparatus 210 and the second vibration generating apparatus 220 may be disposed in the same space. For example, the second vibration generator 212 and the third vibration generator 221 may be disposed in the same space. For example, the second vibration generator 212 and the third vibration generator 221 may be disposed in the first space 100S. For example, the second vibration generator 212 and the third vibration generator 221 may be disposed to face each other. For example, the second vibration generator 212 and the third vibration generator 221 may be disposed to face each other in the first space 100S. For example, the second vibration generator 212 and the third vibration generator 221 may be disposed to face and overlap each other in the first space 100S. For example, the second vibration generator 212 and the third vibration generator 221 may be disposed to at least partially overlap each other in the first space 100S. For example, the second vibration generator 212 and the third vibration generator 221 may be staggeredly disposed to face each other in the first space 100S.

The first vibration generator 211 and the second vibration generator 212 may be disposed in different spaces. For example, the second vibration generator 212 may be disposed in the first space 100S.

The third vibration generator 221 and the fourth vibration generator 222 may be disposed in different spaces. For example, the third vibration generator 221 may be disposed in the first space 100S. For example, the fourth vibration generator 222 may be disposed in the second space 300S.

The first vibration generating apparatus 210 and the second vibration generating apparatus 220 may be disposed to face the same direction. For example, the first vibration generating apparatus 210 and the second vibration generating apparatus 220 may be disposed to face a downward direction in the third direction Z. For example, the first vibration generator 211 and the third vibration generator 221 may be disposed to face an upward direction in the third direction Z. For example, the second vibration generator 212 and the fourth vibration generator 222 may be disposed to face a downward direction in the third direction Z.

The first vibration generating apparatus 210 and the second vibration generating apparatus 220 may be disposed to face different directions. For example, the first vibration generator 211 may be disposed to face an upward direction in the third direction Z. The fourth vibration generator 222 may be disposed to face a downward direction in the third direction Z. For example, the second vibration generator 212 may be disposed to face a downward direction in the third direction Z. For example, the third vibration generator 221 may be disposed to face an upward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The third vibration generator 221 and the fourth vibration generator 222 may be disposed to have an asymmetrical structure therebetween. For example, one of the first vibration portion 201-1 and the second vibration portion 201-2 of the third vibration generator 221 may overlap one of the first vibration part 201-1 and the second vibration part 201-2 of the fourth vibration generator 222 and may not overlap the other of the first vibration part 201-1 and the second vibration part 201-2 of the fourth vibration generator 222. For example, the first vibration part 201-1 of the third vibration generator 221 may not overlap the fourth vibration generator 222, and the second vibration part 201-2 of the third vibration generator 221 may overlap the first vibration part 201-1 of the fourth vibration generator 222. Also, one or more of the first vibration part 201-1 and the second vibration part 201-2 of the third vibration generator 221 and the first vibration part 201-1 and the second vibration part 201-2 of the fourth vibration generator 222 may overlap a center portion between the first vibration part 201-1 and the second vibration part 201-2 of each of the first vibration generator 211 and the second vibration generator 212, and the other one or more of the first vibration part 201-1 and the second vibration part 201-2 of the third vibration generator 221 and the first vibration part 201-1 and the second vibration part 201-2 of the fourth vibration generator 222 may overlap at least a portion of the first vibration part 201-1 or the second vibration part 201-2 of each of the first vibration generator 211 and the second vibration generator 212. For example, the first vibration part 201-1 and the second vibration part 201-2 may have substantially the same size. Also, the first vibration generator 211, the second vibration generator 212, the third vibration generator 221, and the fourth vibration generator 222 each including the first vibration part 201-1 and the second vibration part 201-2 may have substantially the same size.

The first vibration part 201-1 of the third vibration generator 221 may overlap a portion of a first region (or a left region) of the first vibration part 201-1 of each of the first vibration generator 211 and the second vibration generator 212. The second vibration part 201-2 of the third vibration generator 221 and the first vibration part 201-1 of the fourth vibration generator 222 may overlap a portion of a second region (or a right region) of the first vibration part 201-1 of the first vibration generator 211 and the second vibration generator 212 and a portion of a first region (or a left region) of the second vibration part 201-2 of each of the first vibration generator 211 and the second vibration generator 212. The second vibration part 201-2 of the fourth vibration generator 222 may overlap a portion of a second region (or a right region) of the second vibration part 201-2 of each of the first vibration generator 211 and the second vibration generator 212.

The first vibration generator 211 and the second vibration generator 212 may have an inverted structure at each of the first surface 101a and the second surface 101b of the first vibration member 101. Also, the third vibration generator 221 and the fourth vibration generator 222 may have an inverted structure at each of the first surface 102a and the second surface 102b of the second vibration member 102 and may be disposed in an asymmetrical structure therebetween. Also, the first vibration generator 211 may have a non-inverted structure with respect to the third vibration generator 221 and may at least partially overlap the third vibration generator 221, and moreover, may have an inverted structure with respect to the fourth vibration generator 222 and may at least partially overlap the fourth vibration generator 222. Also, the second vibration generator 212 may have an inverted structure with respect to the third vibration generator 221 and may at least partially overlap the third vibration generator 221, and moreover, may have a non-inverted structure with respect to the fourth vibration generator 222 and may at least partially overlap the fourth vibration generator 222.

The first vibration generator 211, the second vibration generator 212, the third vibration generator 221, and the fourth vibration generator 222 may be configured to be displaced (or vibrated or driven) in the same direction. For example, a vibration driving signal applied to the first vibration generator 211 may have the same phase as or a phase difference with that of a vibration driving signal applied to the third vibration generator 221 and may have a phase opposite to or a phase difference with that of a vibration driving signal applied to the fourth vibration generator 222. Also, the vibration driving signal applied to the second vibration generator 212 may have a phase opposite to or a phase difference with that of the vibration driving signal applied to the third vibration generator 221 and may have the same phase as or a phase difference with that of the vibration driving signal applied to the fourth vibration generator 222. For example, the vibration driving signal applied to each of the first vibration generator 211, the second vibration generator 212, the third vibration generator 221, and the fourth vibration generator 222 may be as described above with reference to FIG. 69, and thus, repeated descriptions thereof are omitted.

According to an embodiment of the present disclosure, the first vibration generator 211 and the second vibration generator 212 each including the first vibration part 201-1 and the second vibration part 201-2 provided in the first vibration member 101 and the third vibration generator 221 and the fourth vibration generator 222 each including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced.

Referring to FIG. 71, an apparatus 1 to 8 according to an embodiment of the present disclosure may include a first vibration member 101, a first vibration generating apparatus 210 provided in the first vibration member 101, a second vibration member 102, and a second vibration generating apparatus 220 provided in the second vibration member 102.

In the apparatus 1 to 8 according to an embodiment of the present disclosure, at least one of a first vibration generating apparatus 210 and a second vibration generating apparatus 220 may include a plurality of vibration parts 201-1 and 201-2. For example, at least one of the first vibration generating apparatus 210 and the second vibration generating apparatus 220 may include a first vibration part 201-1 and a second vibration part 201-2. Also, each of the first vibration generating apparatus 210 and the second vibration generating apparatus 220 may include a plurality of vibration generators.

As illustrated in FIG. 71, a first vibration generating apparatus 210 may include a first vibration generator 211 and a second vibration generator 212. Also, each of the first vibration generator 211 and the second vibration generator 212 of the first vibration generating apparatus 210 may include a plurality of vibration parts 201-1 and 201-2. For example, the first vibration generator 211 may include a first vibration part 201-1 and a second vibration part 201-2, and the second vibration generator 212 may include a first vibration part 201-1 and a second vibration part 201-2. Also, a second vibration generating apparatus 220 may include a third vibration generator 221 and a fourth vibration generator 222. Also, each of the third vibration generator 221 and the fourth vibration generator 222 of the second vibration generating apparatus 220 may include a plurality of vibration parts 201-1 and 201-2. For example, the third vibration generator 221 may include a first vibration part 201-1 and a second vibration part 201-2, and the fourth vibration generator 222 may include a first vibration part 201-1 and a second vibration part 201-2. The first vibration generating apparatus 210 may at least partially overlap the second vibration generating apparatus 220. For example, at least a portion of the first vibration generating apparatus 210 may overlap the second vibration generating apparatus 220.

The first vibration generator 211 may be disposed at a first surface 101a of the first vibration member 101. For example, the first vibration generator 211 may be connected with or coupled to the first surface 101a of the first vibration member 101 by a first adhesive member 151. Also, the second vibration generator 212 may be disposed at a second surface 101b of the first vibration member 101. For example, the second vibration generator 212 may be connected with or coupled to the second surface 101b of the first vibration member 101 by a second adhesive member 152. For example, the first vibration generator 211 and the second vibration generator 212 may be disposed with the first vibration member 101 therebetween. For example, the first vibration generator 211 and the second vibration generator 212 may be staggeredly disposed with the first vibration member 101 therebetween. For example, the first vibration generator 211 and the second vibration generator 212 may be disposed to overlap each other with the first vibration member 101 therebetween. Each of the first vibration generator 211 and the second vibration generator 212 may include a first vibration part 201-1 and a second vibration part 201-2. In another embodiment of the present disclosure, one of the first vibration generator 211 and the second vibration generator 212 may include the first vibration part 201-1 and the second vibration part 201-2, and the other vibration generator may include a single vibration part 201. For example, the first vibration generator 211 may include the first vibration part 201-1 and the second vibration part 201-2 and the second vibration generator 212 may include the single vibration part 201, but embodiments of the present disclosure are not limited thereto.

The third vibration generator 221 may be disposed at a first surface 101a of the second vibration member 102. For example, the third vibration generator 221 may be connected with or coupled to the first surface 102a of the second vibration member 102 by a third adhesive member 153. Also, the fourth vibration generator 222 may be disposed at a second surface 102b of the second vibration member 102. For example, the fourth vibration generator 222 may be connected with or coupled to the second surface 102b of the second vibration member 102 by a fourth adhesive member 152. For example, the third vibration generator 221 and the fourth vibration generator 222 may be disposed with the second vibration member 102 therebetween. For example, the third vibration generator 221 and the fourth vibration generator 222 may be staggeredly disposed with the second vibration member 102 therebetween. For example, the third vibration generator 221 and the fourth vibration generator 222 may be disposed to overlap each other with the second vibration member 102 therebetween. Each of the third vibration generator 221 and the fourth vibration generator 222 may include a first vibration part 201-1 and a second vibration part 201-2. In another embodiment of the present disclosure, one of the third vibration generator 221 and the fourth vibration generator 222 may include the first vibration part 201-1 and the second vibration part 201-2, and the other vibration generator may include a single vibration part 201. For example, the third vibration generator 221 may include the first vibration part 201-1 and the second vibration part 201-2 and the fourth vibration generator 222 may include the single vibration part 201, but embodiments of the present disclosure are not limited thereto.

The first vibration generating apparatus 210 and the second vibration generating apparatus 220 may be disposed in different spaces. For example, the first vibration generator 211 and the third vibration generator 221 may be disposed in different spaces. For example, the third vibration generator 221 may be disposed in the first space 100S. For example, the first vibration generator 211 and the fourth vibration generator 222 may be disposed in different spaces. For example, the fourth vibration generator 222 may be disposed in the second space 300S. For example, the second vibration generator 212 and the fourth vibration generator 222 may be disposed in different spaces. For example, the second vibration generator 221 may be disposed in the first space 100S.

The first vibration generating apparatus 210 and the second vibration generating apparatus 220 may be disposed in the same space. For example, the second vibration generator 212 and the third vibration generator 221 may be disposed in the same space. For example, the second vibration generator 212 and the third vibration generator 221 may be disposed in the first space 100S. For example, the second vibration generator 212 and the third vibration generator 221 may be disposed to face each other. For example, the second vibration generator 212 and the third vibration generator 221 may be disposed to face each other in the first space 100S. For example, the second vibration generator 212 and the third vibration generator 221 may be disposed to face and overlap each other in the first space 100S. For example, the second vibration generator 212 and the third vibration generator 221 may be disposed to at least partially overlap each other in the first space 100S. For example, the second vibration generator 212 and the third vibration generator 221 may be staggeredly disposed to face each other in the first space 100S.

The first vibration generator 211 and the second vibration generator 212 may be disposed in different spaces. For example, the second vibration generator 212 may be disposed in the first space 100S.

The third vibration generator 221 and the fourth vibration generator 222 may be disposed in different spaces. For example, the third vibration generator 221 may be disposed in the first space 100S. For example, the fourth vibration generator 222 may be disposed in the second space 300S.

The first vibration generating apparatus 210 and the second vibration generating apparatus 220 may be disposed to face the same direction. For example, the first vibration generating apparatus 210 and the second vibration generating apparatus 220 may be disposed to face a downward direction in the third direction Z. For example, the first vibration generator 211 and the third vibration generator 221 may be disposed to face an upward direction in the third direction Z. For example, the second vibration generator 212 and the fourth vibration generator 222 may be disposed to face a downward direction in the third direction Z.

The first vibration generating apparatus 210 and the second vibration generating apparatus 220 may be disposed to face different directions. For example, the first vibration generator 211 may be disposed to face an upward direction in the third direction Z. The fourth vibration generator 222 may be disposed to face a downward direction in the third direction Z. For example, the second vibration generator 212 may be disposed to face a downward direction in the third direction Z. For example, the third vibration generator 221 may be disposed to face an upward direction in the third direction Z.

The first vibration generating apparatus 210 may be disposed to face a different direction. For example, the first vibration generator 211 and the second vibration generator 212 may be disposed to face different directions. For example, the first vibration generator 211 may be disposed to face an upward direction in a third direction Z. For example, the second vibration generator 212 may be disposed to face a downward direction in the third direction Z.

The second vibration generating apparatus 220 may be disposed to face a different direction. For example, the third vibration generator 221 and the fourth vibration generator 222 may be disposed to face different directions. For example, the third vibration generator 221 may be disposed to face an upward direction in the third direction Z. For example, the fourth vibration generator 222 may be disposed to face a downward direction in the third direction Z.

The first vibration generator 211 and the second vibration generator 212 may be disposed to have an asymmetrical structure therebetween. Also, the third vibration generator 221 and the fourth vibration generator 222 may be disposed to have an asymmetrical structure therebetween.

For example, one of the first vibration part 201-1 and the second vibration part 201-2 of the first vibration generator 211 may overlap one of the first vibration part 201-1 and the second vibration part 201-2 of the second vibration generator 212 and may not overlap the other of the first vibration part 201-1 and the second vibration part 201-2 of the second vibration generator 212. Also, one of the first vibration part 201-1 and the second vibration part 201-2 of the third vibration generator 221 may overlap one of the first vibration part 201-1 and the second vibration part 201-2 of the fourth vibration generator 222 and may not overlap the other of the first vibration part 201-1 and the second vibration part 201-2 of the fourth vibration generator 222. For example, the first vibration part 201-1 of the first vibration generator 211 may not overlap the second vibration generator 212, and the second vibration part 201-2 of the first vibration generator 211 may overlap the first vibration part 201-1 of the second vibration generator 212. Also, the first vibration part 201-1 of the third vibration generator 221 may not overlap the fourth vibration generator 222, and the second vibration part 201-2 of the third vibration generator 221 may overlap the first vibration part 201-1 of the fourth vibration generator 222. For example, the first vibration part 201-1 and the second vibration part 201-2 may have substantially the same size. Also, the first vibration generator 211, the second vibration generator 212, the third vibration generator 221, and the fourth vibration generator 222 may have substantially the same size.

The first vibration part 201-1 of the first vibration generator 211 may overlap the first vibration part 201-1 of the third vibration generator 221. The second vibration part 201-2 of the first vibration generator 211, the first vibration part 201-1 of the second vibration generator 212, the second vibration part 201-2 of the third vibration generator 221, and the first vibration part 201-1 of the fourth vibration generator 222 may overlap one another. The second vibration part 201-2 of the second vibration generator 212 may overlap the second vibration part 201-2 of the fourth vibration generator 222.

The first vibration generator 211 and the second vibration generator 212 may have an inverted structure at each of the first surface 101a and the second surface 101b of the first vibration member 101 and may be disposed in an asymmetrical structure therebetween. Also, the third vibration generator 221 and the fourth vibration generator 222 may have an inverted structure at each of the first surface 102a and the second surface 102b of the second vibration member 102 and may be disposed in an asymmetrical structure therebetween. Also, the first vibration generator 211 may have a non-inverted structure with respect to the third vibration generator 221 and may at least partially overlap the third vibration generator 221, and moreover, may have an inverted structure with respect to the fourth vibration generator 222 and may at least partially overlap the fourth vibration generator 222. Also, the second vibration generator 212 may have an inverted structure with respect to the third vibration generator 221 and may at least partially overlap the third vibration generator 221, and moreover, may have a non-inverted structure with respect to the fourth vibration generator 222 and may at least partially overlap the fourth vibration generator 222.

The first vibration generator 211, the second vibration generator 212, the third vibration generator 221, and the fourth vibration generator 222 may be configured to be displaced (or vibrated or driven) in the same direction. For example, a vibration driving signal applied to the first vibration generator 211 may have the same phase as or a phase difference with that of a vibration driving signal applied to the third vibration generator 221 and may have a phase opposite to or a phase difference with that of a vibration driving signal applied to the fourth vibration generator 222. Also, the vibration driving signal applied to the second vibration generator 212 may have a phase opposite to or a phase difference with that of the vibration driving signal applied to the third vibration generator 221 and may have the same phase as or a phase difference with that of the vibration driving signal applied to the fourth vibration generator 222. For example, the vibration driving signal applied to each of the first vibration generator 211, the second vibration generator 212, the third vibration generator 221, and the fourth vibration generator 222 may be as described above with reference to FIG. 69, and thus, repeated descriptions thereof are omitted.

According to an embodiment of the present disclosure, the first vibration generator 211 and the second vibration generator 212 each including the first vibration part 201-1 and the second vibration part 201-2 provided in the first vibration member 101 and the third vibration generator 221 and the fourth vibration generator 222 each including the first vibration part 201-1 and the second vibration part 201-2 provided in the second vibration member 102 may be disposed to at least partially overlap each other and may be configured to be displaced (or vibrated or driven) in the same direction by a vibration driving signal where a phase difference caused by signal delay is adjusted, and thus, a sound characteristic and/or a sound pressure level characteristic of the low-pitched sound band generated based on vibrations of the first vibration generating apparatus 210 and the second vibration generating apparatus 220 may be enhanced and the flatness of a sound pressure level in the low-pitched sound band may be enhanced. in FIG. 1 according to another embodiment of the present disclosure. FIG. 72 illustrates an embodiment where at least one weight member is additionally provided in the apparatuses 1 to 8 described above with reference to FIGS. 1 to 71. In the following description, therefore, like elements except at least one weight member and relevant elements are referred to by like reference numerals, and repeated descriptions thereof are omitted or will be briefly given.

Referring to FIG. 72, an apparatus 9 according to another embodiment of the present disclosure may include a first vibration member 101, a second vibration member 102, a first vibration generator 211 and a second vibration generator 212 each provided in the first vibration member 101, a third vibration generator 221 and a fourth vibration generator 222 each provided in the second vibration member 102, and at least one weight member 500.

Descriptions of each of the first vibration member 101, the second vibration member 102, the first vibration generator 211 and the second vibration generator 212 each provided in the first vibration member 101, and the third vibration generator 221 and the fourth vibration generator 222 each provided in the second vibration member 102 may be substantially the same as the descriptions of FIGS. 1 to 71, and thus, repeated descriptions thereof are omitted or will be briefly given.

The at least one weight member 500 may be disposed in one or more of the first vibration generator 211, the second vibration generator 212, the third vibration generator 221, and the fourth vibration generator 222. The at least one weight member 500 may be disposed in or attached on one or more of the first vibration generator 211 and the second vibration generator 212. For example, the at least one weight member 500 may have a polygonal pillar shape or a circular pillar shape, but embodiments of the present disclosure are not limited thereto.

The at least one weight member 500 may overlap one or more of a center portion of and an edge portion of at least one of the first vibration generating apparatus 210 and the second vibration generating apparatus 220. The at least one weight member 500 may include a first weight member 501, a second weight member 502, a third weight member 503, a fourth weight member 504, a fifth weight member 505, and a sixth weight member 506. For example, the first weight member 501 may be disposed at a center portion of the first vibration generator 211. The second weight member 502 may be disposed at a center portion of the third vibration generator 221. The third weight member 503 may be disposed at one edge portion of the third vibration generator 221. The fourth weight member 504 may be disposed at the other edge portion of the third vibration generator 221. The fifth weight member 505 may be attached on or disposed at one side of a first surface 101a of the first vibration member 101. The sixth weight member 506 may be attached on or disposed at the other side of the first surface 101a of the first vibration member 101, but embodiments of the present disclosure are not limited thereto.

The at least one weight member 500 may be configured to decrease dip where a sound pressure level decreases in a specific frequency of a reproduction frequency band of a sound (or a sound pressure level) generated based on vibrations of the first vibration generator 211, the second vibration generator 212, the third vibration generator 221, and the fourth vibration generator 222.

The at least one weight member 500 may increase a weight of a region of the first vibration member 101 overlapping the first vibration generator 211 and the second vibration generator 212, or may increase a weight of a region of the second vibration member 102 overlapping the third vibration generator 221 and the fourth vibration generator 222, or may increase a weight of a partial region of the first vibration member 101 or the second vibration member 102, thereby decreasing a lowest resonance frequency (or a lowest natural frequency) of the first vibration member 101 and the second vibration member 102. Therefore, the first vibration generator 211, the second vibration generator 212, the third vibration generator 221, and the fourth vibration generator 222 may vibrate at a relatively low frequency due to a reduction in lowest resonance frequency (or a lowest natural frequency) based on an increase in weight caused by the at least one weight member 500. Accordingly, a sound characteristic and/or a sound pressure level characteristic of a low-pitched sound band generated based on vibrations of the first vibration generator 211, the second vibration generator 212, the third vibration generator 221, and the fourth vibration generator 222 may be enhanced. For example, the at least one weight member 500 may be a local mass, a point mass, a resonance pad, a mass member, a weight pendulum, or a mass element, but embodiments of the present disclosure are not limited thereto. For example, the low-pitched sound band may be 300 Hz or less or 500 Hz or less, but embodiments of the present disclosure are not limited thereto.

The at least one weight member 500 may be configured to correct a mode shape of a primary vibration mode and a secondary vibration mode of the first vibration member 101 or the second vibration member 102 based on vibrations of the first vibration generator 211, the second vibration generator 212, the third vibration generator 221, and the fourth vibration generator 222. The at least one weight member 500 may be configured to accelerate a primary peak vibration mode of the first vibration member 101 or the second vibration member 102. For example, the at least one weight member 500 may move a primary peak of a sound (or a sound pressure level), generated based on a vibration of the first vibration member 101 or the second vibration member 102, to the low-pitched sound band, and thus, may increase or enhance a sound characteristic and/or a sound pressure level characteristic of the low-pitched sound band, thereby extending a low-pitched sound band of the sound generated based on the vibration of the first vibration member 101 or the second vibration member 102.

The apparatus 9 according to another embodiment of the present disclosure may have substantially the same effect as the apparatuses 1 to 8 described above with reference to FIGS. 1 to 71. The apparatus 9 according to another embodiment of the present disclosure may further include the at least one weight member 500, and thus, may increase or enhance a sound characteristic and/or a sound pressure level characteristic of the low-pitched sound band, thereby extending the low-pitched sound band of the sound generated based on the vibration of the first vibration member 101 or the second vibration member 102.

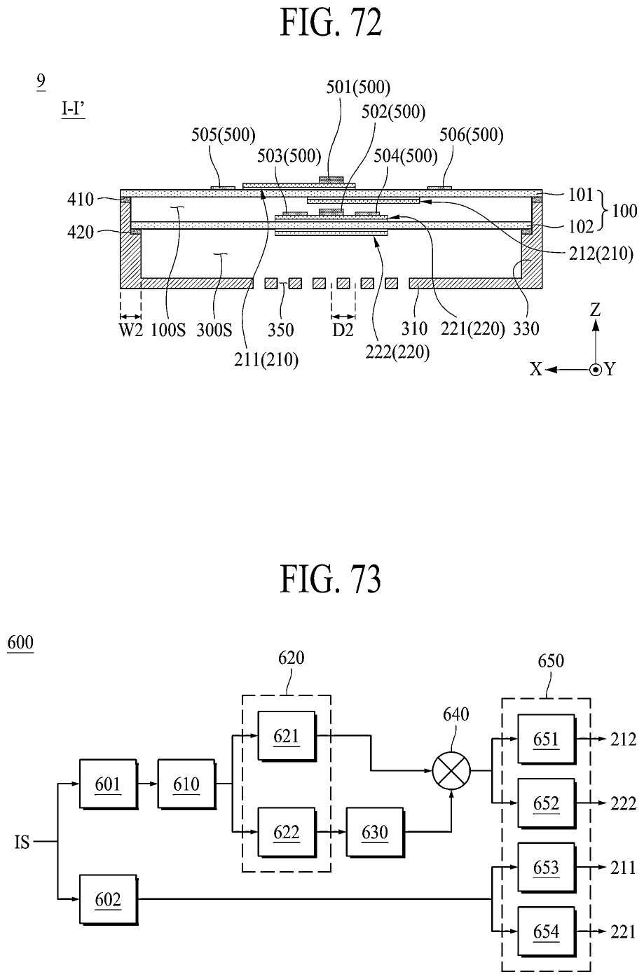

FIG. 73 illustrates a block diagram of a sound processing circuit 600 according to an embodiment of the present disclosure. FIG. 73 illustrates an example where a sound processing circuit is applied based on an arrangement structure of the vibration generating apparatus illustrated in FIG. 21, but embodiments of the present disclosure are not limited thereto.

Referring to FIG. 73, the sound processing circuit 600 according to an embodiment of the present disclosure may include a first channel 601, a second channel 602, a signal separation circuit 610, a filter circuit 620, a signal inversion circuit 630, a mixing circuit 640, and a driving signal generating unit 650.

The first channel 601 may receive an input signal IS input thereto according to control by a host controller of an apparatus and may transfer the received input signal IS to the signal separation circuit 610. The first channel 601 may include a signal buffer which is based on the number of signals output by signal-processing the input signal IS. For example, the capacitance of the signal buffer of the first channel 601 may be 4 μF, but embodiments of the present disclosure are not limited thereto.

The second channel 602 may receive the input signal IS input thereto according to control by the host controller of the apparatus and may transfer the received input signal IS to driving signal generators 653 and 654. The second channel 602 may include a signal buffer which is based on the number of signals output by signal-processing the input signal IS. For example, the capacitance of the signal buffer of the second channel 602 may be 4 (F, but embodiments of the present disclosure are not limited thereto.

The signal separation circuit 610 may be configured to separate the input signal IS, input from the first channel 601, into a first pitched sound band signal and a second pitched sound band signal. For example, the signal separation circuit 610 may be configured to separate the input signal IS into the first pitched sound band signal and the second pitched sound band signal with respect to 250 Hz, but a range of a frequency does not limit details of the present disclosure. For example, the signal separation circuit 610 may include a crossover circuit, but embodiments of the present disclosure are not limited thereto.

The filter circuit 620 may be configured to output the first pitched sound band signal or the second pitched sound band signal among the first pitched sound band signal and the second pitched sound band signal obtained through signal separation by the signal separation circuit 610. The filter circuit 620 may include a first filter circuit 621 and a second filter circuit 622. The first filter circuit 621 may be configured to output the second pitched sound band signal. The first filter circuit 621 may be configured to output an input signal of 250 Hz or more. The second filter circuit 622 may be configured to output the first pitched sound band signal. For example, the second filter circuit 622 may be configured to output an input signal of less than 250 Hz.

The signal inversion circuit 630 (or a phase inversion circuit) may be configured to invert and output a phase of the first pitched sound band signal input from the second filter circuit 622. For example, the signal inversion circuit 630 may be configured to invert a phase of the input signal by 180 degrees and may output a phase-inverted input signal.

The mixing circuit 640 may mix the second pitched sound band signal, input from the first filter circuit 521, with a phase-inverted first pitched sound band signal input from the signal inversion circuit 630 to output a mixing signal.

The driving signal generating unit 650 may generate and output first to fourth vibration driving signals, based on each of a signal input from the mixing circuit 640 and a signal input from the second channel 602. The driving signal generating unit 650 may include a first driving signal generator 651, a second driving signal generator 652, a third driving signal generator 653, and a fourth driving signal generator 654, which each include a digital-to-analog converter and an amplifier. For example, the first driving signal generator 651 may be configured to output a first vibration driving signal applied to the second vibration generator 212. The second driving signal generator 652 may be configured to output a second vibration driving signal applied to the fourth vibration generator 222. The third driving signal generator 653 may be configured to output a third vibration driving signal applied to the first vibration generator 211. The fourth driving signal generator 654 may be configured to output a fourth vibration driving signal applied to the third vibration generator 221.

The sound processing circuit 600 according to an embodiment of the present disclosure may supply vibration driving signals having opposite phases to the first vibration generator 211 disposed at the first surface 101a of the first vibration member 101 and the third vibration generator 221 disposed at the first surface 102a of the second vibration member 102, and the second vibration generator 212 disposed at the second surface 101b of the first vibration member 101 and the fourth vibration generator 222 disposed at the second surface 102b of the second vibration member 102, having a structure which is inverted from each other. Therefore, the first vibration generator 211, the second vibration generator 212, the third vibration generator 221, and the fourth vibration generator 222 may be driven in the same direction, and thus, a center vibration mode of the first vibration member 101 and the second vibration member 102 may be maximized. Accordingly, one or more of peak and dip occurring in a reproduction frequency band of a sound (or a sound pressure level) generated based on vibrations of the first vibration member 101 and the second vibration member 102 may decrease, and each of a highest sound pressure level and a lowest sound pressure level occurring in the reproduction frequency band of the sound (or the sound pressure level) generated based on vibrations of the first vibration member 101 and the second vibration member 102 may be reduced, thereby enhancing the flatness of a sound pressure level.

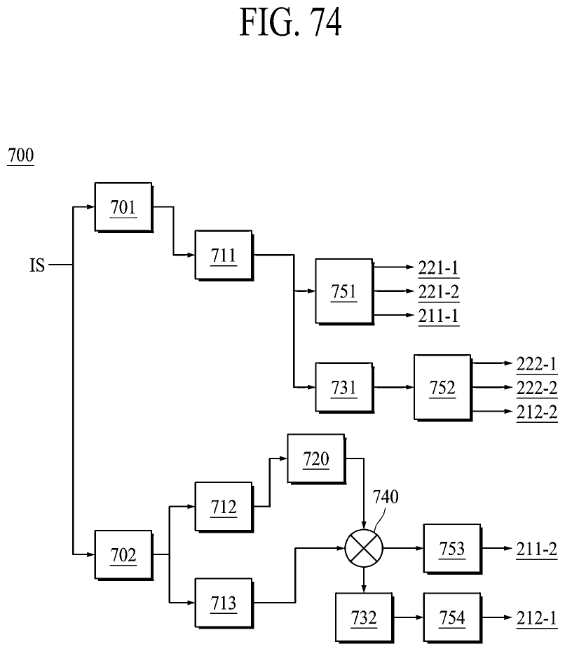

FIG. 74 illustrates a block diagram of a sound processing circuit 700 according to another embodiment of the present disclosure. FIG. 74 illustrates an example where a sound processing circuit is applied based on the apparatus 9 illustrated in FIG. 72, but embodiments of the present disclosure are not limited thereto.

Referring to FIG. 74, the sound processing circuit 700 according to another embodiment of the present disclosure may include a first channel 701, a second channel 702, a first filter circuit 711, a second filter circuit 712, a third filter circuit 713, a signal delay circuit 720, a first signal inversion circuit 731, a second signal inversion circuit 732, a mixing circuit 740, a first driving signal generating unit 751, a second driving signal generating unit 752, a third driving signal generating unit 753, and a fourth driving signal generating unit 754.

The first channel 701 may receive an input signal IS input thereto according to control by the host controller of the apparatus and may transfer the received input signal IS to the first filter circuit 711. The first channel 701 may include a signal buffer which is based on the number of signals output by signal-processing the input signal IS. For example, the capacitance of the signal buffer of the first channel 701 may be 12 μF, but embodiments of the present disclosure are not limited thereto.

The second channel 702 may receive the input signal IS input thereto according to control by the host controller of the apparatus and may transfer the received input signal IS to each of the second filter circuit 712 and the third filter circuit 713. The second channel 702 may include a signal buffer which is based on the number of signals output by signal-processing the input signal IS. For example, the capacitance of the signal buffer of the second channel 702 may be 4 μF, but embodiments of the present disclosure are not limited thereto.

The first filter circuit 711 may be configured to separate and output a signal of a first pitched sound band in the input signal IS input from the first channel 701. For example, the first filter circuit 711 may be configured to output an input signal of less than 400 Hz in the input signal IS input from the first channel 701, but a range of a frequency does not limit details of the present disclosure. For example, the first filter circuit 711 may include a low pass filter, but embodiments of the present disclosure are not limited thereto.

The second filter circuit 712 may be configured to separate and output a signal of the first pitched sound band in the input signal IS input from the second channel 702. For example, the second filter circuit 712 may be configured to output an input signal of less than 400 Hz in the input signal IS input from the second channel 702, but a range of a frequency does not limit details of the present disclosure. For example, the second filter circuit 712 may include a low pass filter, but embodiments of the present disclosure are not limited thereto.

The third filter circuit 713 may be configured to separate and output a signal of the second pitched sound band in the input signal IS input from the second channel 702. For example, the third filter circuit 713 may be configured to output an input signal of 400 Hz or more in the input signal IS input from the second channel 702, but a range of a frequency does not limit details of the present disclosure. For example, the third filter circuit 713 may include a high pass filter, but embodiments of the present disclosure are not limited thereto.

The signal delay circuit 720 may delay a signal of the first pitched sound band input from the second filter circuit 712 to output a first pitched sound band correction signal. For example, the signal delay circuit 720 may be configured to output the first pitched sound band correction signal where a phase of a signal is shifted or the signal is shifted. For example, a signal delay time may be 4.44 msec, but embodiments of the present disclosure are not limited thereto.

The first signal inversion circuit 731 (or a phase inversion circuit) may be configured to invert a phase of a signal of the first pitched sound band input from the first filter circuit 711 and output a phase-inverted signal. For example, the first signal inversion circuit 731 may be configured to invert a phase of an input signal by 180 degrees and output a phase-inverted signal.

The mixing circuit 740 may mix the first pitched sound band correction signal, input from the signal delay circuit 720, with a second pitched sound band signal input from the third filter circuit 713 to output a mixing signal.

The second signal inversion circuit 732 (or a phase inversion circuit) may be configured to invert a phase of a mixing signal input from the mixing circuit 740. For example, the second signal inversion circuit 732 may be configured to invert a phase of an input signal by 180 degrees and output a phase-inverted signal.

The first driving signal generating unit 751 may include a digital-to-analog converter and an amplifier. The first driving signal generating unit 751 may be configured to output a first vibration driving signal, based on a signal input from the first filter circuit 711. The first vibration driving signal may be applied to the first vibration parts 201-1 and 211-1 of the first vibration generator 211 and may be applied to the first vibration parts 201-1 and 221-1 and the second vibration parts 201-2 and 221-2 of the third vibration generator 221.

The second driving signal generating unit 752 may include a digital-to-analog converter and an amplifier. The second driving signal generating unit 752 may be configured to output a second vibration driving signal, based on an inverted signal input from the first signal inversion circuit 731. The second vibration driving signal may be applied to the second vibration parts 201-2 and 212-2 of the second vibration generator 212 and may be applied to the first vibration parts 201-1 and 222-1 and the second vibration parts 201-2 and 222-2 of the fourth vibration generator 222.

The third driving signal generating unit 753 may include a digital-to-analog converter and an amplifier. The third driving signal generating unit 753 may be configured to output a third vibration driving signal, based on the mixing signal input from the mixing circuit 740. The first vibration driving signal may be applied to the second vibration parts 201-1 and 211-2 of the first vibration generator 211.

The fourth driving signal generating unit 754 may include a digital-to-analog converter and an amplifier. The fourth driving signal generating unit 754 may be configured to output a fourth vibration driving signal, based on the inverted signal input from the second signal inversion circuit 732. The fourth vibration driving signal may be applied to the first vibration parts 201-1 and 212-1 of the second vibration generator 212.

The sound processing circuit 700 according to an embodiment of the present disclosure may be provided in each of the first vibration member 101 and the second vibration member 102 and may perform control so that the first vibration generator 211, the second vibration generator 212, the third vibration generator 221, and the fourth vibration generator 222 each including the first vibration part 201-1 and the second vibration part 201-2 vibrate in the same direction, based on a vibration driving signal where a phase of a signal is adjusted and a phase difference is adjusted by signal delay. Therefore, as the first vibration generator 211, the second vibration generator 212, the third vibration generator 221, and the fourth vibration generator 222 are vibration-driven in the same direction, a center vibration mode of the first vibration member 101 and the second vibration member 102 may be maximized and a mode shape of a peripheral vibration mode may be corrected, and thus, one or more of peak and dip occurring in a reproduction frequency band of a sound (or a sound pressure level) generated based on vibrations of the first vibration member 101 and the second vibration member 102 may decrease. Also, each of a highest sound pressure level and a lowest sound pressure level occurring in the reproduction frequency band of the sound (or the sound pressure level) generated based on vibrations of the first vibration member 101 and the second vibration member 102 may be reduced, thereby enhancing the flatness of a sound pressure level.

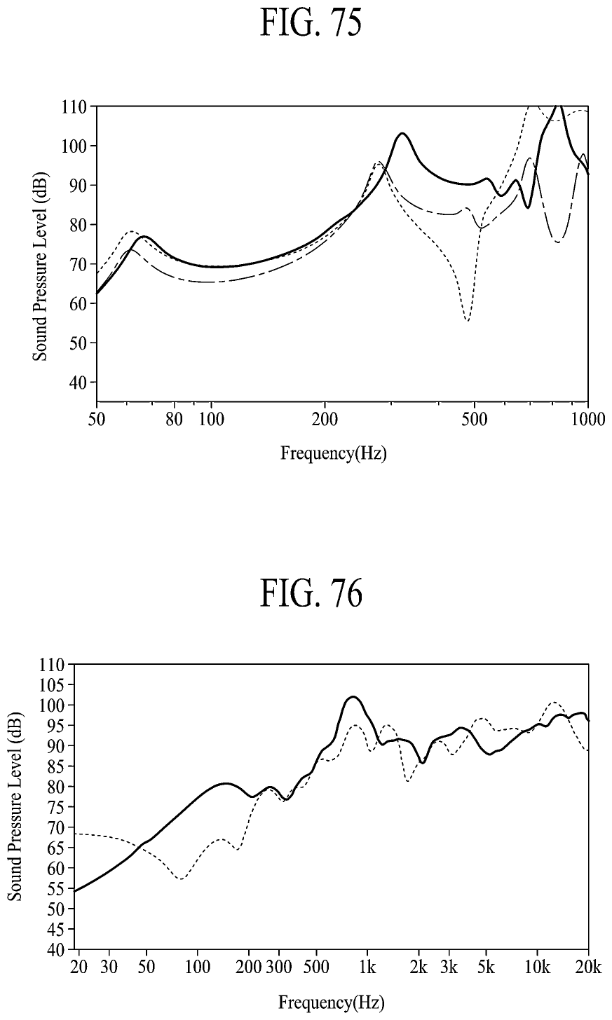

FIG. 75 illustrates a sound output characteristic of an apparatus according to an experiment example and an embodiment of the present disclosure. In FIG. 75, the abscissa axis represents a frequency (Hz), and the ordinate axis represents a sound pressure level (SPL) (decibel (dB)).

In FIG. 75, a thick dotted line represents a sound output characteristic of a configuration where a size of a vibration part is set to 6 cm×12 cm in an apparatus according to an embodiment of the present disclosure in which the arrangement of the vibration generating apparatus illustrated in FIG. 20 is applied to a structure of the apparatus 7 illustrated in FIG. 8. A dash-single dotted line represents a sound output characteristic of a case where a size of a vibration part is set to 6 cm×12 cm in a single vibration member. A dotted line represents a sound output characteristic of a case where a size of a vibration part is set to 12 cm×12 cm in a single vibration member. A size of a vibration part does not limit embodiments of the present disclosure.

A sound output characteristic of an apparatus may be measured by a sound analysis apparatus. The sound analysis apparatus may include a sound card which transmits or receives a sound to or from a control personal computer (PC), an amplifier which amplifies a signal generated from the sound card and transfers the amplified signal to a vibration apparatus, and a microphone which collects a sound generated in a rear region of the apparatus on the basis of driving of the vibration apparatus. The sound collected through the microphone may be input to the control PC through the sound card, and a control program may check the input sound to analyze a peak response time of the apparatus.

A sound output characteristic has been measured in a half anechoic room. In measuring, a driving voltage is 10 Vrms, an applied frequency signal has been applied as a sine sweep within a range of 50 Hz to 1,000 Hz, and a separation distance between a rearmost surface of an apparatus and a microphone is 50 cm. A measurement method is not limited thereto.

As seen in FIG. 75, comparing with the dotted line, in the thick solid line, it may be seen that a sound pressure level and dip are improved in a frequency range of 65 Hz to 140 Hz and 190 Hz to 590 Hz. Comparing with a dash-single dotted line, in the thick solid line, it may be seen that a sound pressure level and dip are improved in a frequency range of 60 Hz to 200 Hz and 190 Hz to 650 Hz. Accordingly, in a case where a vibration member is configured in a double structure and a vibration apparatus is provided in each vibration member, it may be seen that a sound characteristic and/or a sound pressure level characteristic of a low-pitched sound band increase(s) and are/is improved, and thus, the flatness of a sound pressure level is improved.

FIG. 76 illustrates a sound output characteristic of an apparatus according to an experiment example and an embodiment of the present disclosure. In FIG. 76, the abscissa axis represents a frequency (Hz), and the ordinate axis represents a sound pressure level (SPL) (decibel (dB)).

In FIG. 76, a thick solid line represents a sound output characteristic of an apparatus according to an embodiment of the present disclosure except a weight member in the apparatus 9 illustrated in FIG. 72. A dotted line represents a sound output characteristic of a case where only a single vibration member is provided.

A method of measuring a sound output characteristic is the same as descriptions given above with reference to FIG. 75, and thus, repeated descriptions thereof are omitted. A sound output characteristic has been measured in a half anechoic room. In measuring, a driving voltage is 8.65 Vrms, an applied frequency signal has been applied as a sine sweep within a range of 20 Hz to 20 kHz, and a separation distance between a rearmost surface of an apparatus and a microphone is 50 cm. A measurement method is not limited thereto.

As seen in FIG. 76, comparing with the dotted line, in the thick solid line, it may be seen that a sound pressure level and dip are improved in a low-pitched sound band of 300 Hz or less (for example, 50 Hz to 250 Hz) and the peak and dip of a sound pressure level are improved in a full frequency range, and thus, the flatness of a sound pressure level is improved. Therefore, in a case where a vibration member is configured in a double structure, a vibration apparatus configured with a plurality of vibration parts are arranged in an asymmetrical structure in a first vibration member, and vibration apparatuses each configured with a plurality of vibration parts are arranged to overlap each other in a second vibration member, it may be seen that a sound characteristic and/or a sound pressure level characteristic of a low-pitched sound band increase(s) and are/is improved and the peak and dip of a sound pressure level are improved in a full frequency range, and thus, the flatness of a sound pressure level is improved.

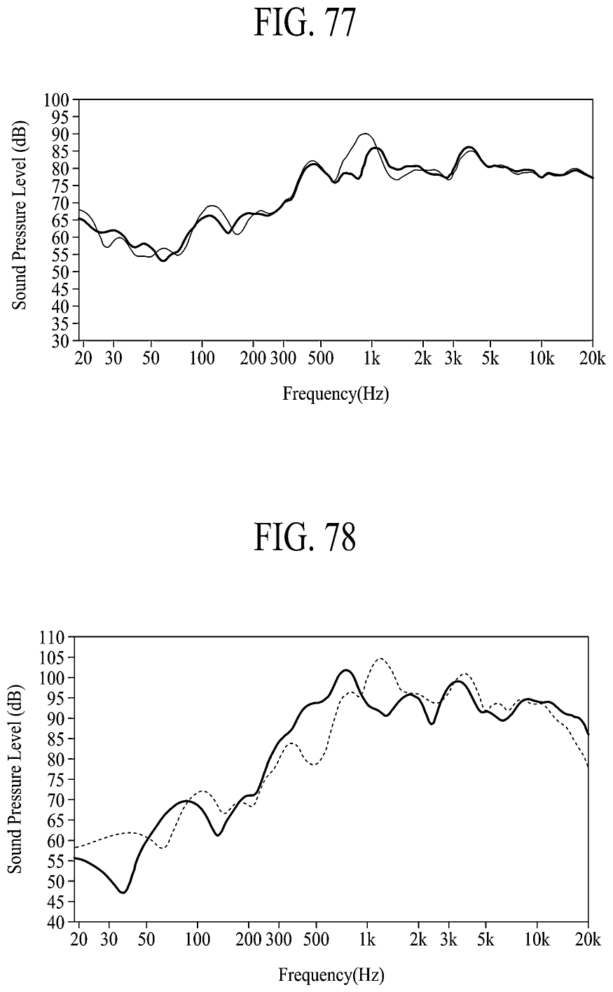

FIG. 77 illustrates a sound output characteristic of an apparatus according to an embodiment of the present disclosure. In FIG. 77, the abscissa axis represents a frequency (Hz), and the ordinate axis represents a sound pressure level (SPL) (decibel (dB)).

In FIG. 77, a thick solid line represents a sound output characteristic of a configuration where an operation of the sound processing circuit described above with reference to FIG. 73 is applied to a configuration where a size of a vibration part is set to 6 cm×12 cm in an apparatus according to an embodiment of the present disclosure in which the arrangement of the vibration generating apparatus illustrated in FIG. 20 is applied to a structure of the apparatus 7 illustrated in FIG. 8. A thin solid line represents a sound output characteristic of a configuration where an operation of a sound processing apparatus is not applied, under the same condition as the thick solid line. A method of measuring a sound output characteristic is the same as descriptions given above with reference to FIG. 76, and thus, repeated descriptions thereof are omitted.

As seen in FIG. 77, comparing with the thin solid line, in the thick solid line, it may be seen that the peak and dip of a sound pressure level are improved in a low-pitched sound band of 300 Hz or less (for example, 100 Hz to 250 Hz) and a high-pitched sound band of 3 kHz or less (for example, 600 Hz to 2 kHz), and thus, the flatness of a sound pressure level is improved in a full frequency range. Therefore, in a case where an operation of a sound processing circuit is applied to an apparatus according to an embodiment of the present disclosure, it may be seen that the peak and dip of a sound pressure level are improved in the low-pitched sound band and the high-pitched sound band, and thus, the flatness of a sound pressure level is improved in a full frequency range.

FIG. 78 illustrates a sound output characteristic of an apparatus according to an experiment example and an embodiment of the present disclosure. In FIG. 78, the abscissa axis represents a frequency (Hz), and the ordinate axis represents a sound pressure level (SPL) (decibel (dB)).

In FIG. 78, a thick solid line represents a sound output characteristic of the apparatus 9 according to an embodiment of the present disclosure illustrated in FIG. 72. A dotted line represents a sound output characteristic of a case where only a vibration apparatus having a bimorph structure is provided in a single vibration member. A method of measuring a sound output characteristic is the same as descriptions given above with reference to FIG. 76, and thus, repeated descriptions thereof are omitted.

As seen in FIG. 78, comparing with the dotted line, in the thick solid line, it may be seen that a sound pressure level and dip are improved in each of a low-pitched sound band of 300 Hz or less (for example, 50 Hz to 90 Hz), and a middle-high-pitched sound band of 3 kHz of less (for example, 200 Hz to 1 kHz), and the peak and dip of a sound pressure level are improved in a full frequency range, and thus, the flatness of a sound pressure level is improved. Therefore, in a case where a vibration member is configured in a double structure, a vibration apparatus configured with a plurality of vibration parts are arranged in an asymmetrical structure in a first vibration member, vibration apparatuses each configured with a plurality of vibration parts are arranged to overlap each other in a second vibration member, and a weight member is additionally provided, it may be seen that a sound characteristic and/or a sound pressure level characteristic of the low-pitched sound band and the middle-high-pitched sound band increase(s) and are/is improved and the peak and dip of a sound pressure level are improved in a full frequency range, and thus, the flatness of a sound pressure level is improved

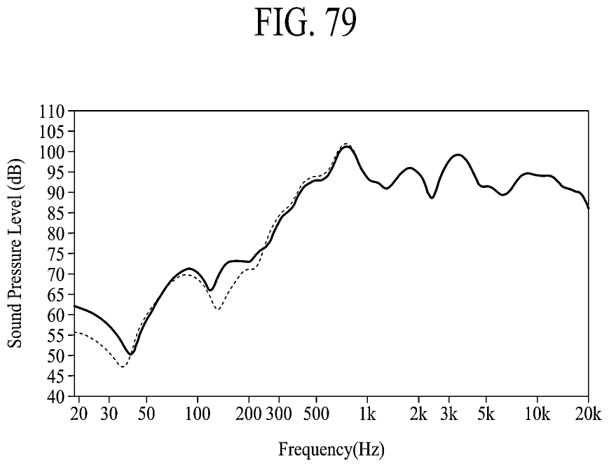

FIG. 79 illustrates a sound output characteristic of an apparatus according to an embodiment of the present disclosure. In FIG. 79, the abscissa axis represents a frequency (Hz), and the ordinate axis represents a sound pressure level (SPL) (decibel (dB)).

In FIG. 79, a thick solid line represents a sound output characteristic of a configuration where an operation of the sound processing circuit described above with reference to FIG. 74 is applied to the apparatus 9 according to an embodiment of the present disclosure illustrated in FIG. 72. A dotted line represents a sound output characteristic of a configuration where an operation of a sound processing apparatus is not applied, under the same condition as the thick solid line. A method of measuring a sound output characteristic is the same as descriptions given above with reference to FIG. 76, and thus, repeated descriptions thereof are omitted.

As seen in FIG. 79, comparing with the dotted line, in the thick solid line, it may be seen that a sound pressure level and dip are improved in a low-pitched sound band of 300 Hz or less (for example, 70 Hz to 250 Hz), and thus, the flatness of a sound pressure level is improved in a full frequency range. Therefore, in a case where an operation of a sound processing circuit is applied to an apparatus according to an embodiment of the present disclosure, it may be seen that a sound pressure level and dip of the low-pitched sound band are improved, and thus, the flatness of a sound pressure level is improved in a full frequency range.

The apparatus according to an embodiment of the present disclosure may be applied to or included in a sound apparatus provided in the apparatus. The apparatus according to an embodiment of the present disclosure may be applied to mobile apparatuses, video phones, smart watches, watch phones, wearable apparatuses, foldable apparatuses, rollable apparatuses, bendable apparatuses, flexible apparatuses, curved apparatuses, portable multimedia players (PMPs), personal digital assistants (PDAs), electronic organizers, desktop personal computers (PCs), laptop PCs, netbook computers, workstations, navigation apparatus, automotive navigation apparatuses, automotive display apparatuses, televisions (TVs), wall paper display apparatuses, signage apparatuses, game machines, notebook computers, monitors, cameras, camcorders, home appliances, etc. Also, the sound apparatus according to the present disclosure may be applied to organic light emitting lighting apparatuses or inorganic light emitting lighting apparatuses. In a case where the sound apparatus is applied to a lighting device, the lighting device may act as lighting and a speaker. Also, in a case where the sound apparatus according to the present disclosure is applied to or included in a mobile apparatus, the sound apparatus may be one or more of a speaker, a receiver, and a haptic, but embodiments of the present disclosure are not limited thereto.

An apparatus according to various embodiments of the present disclosure will be described below.

An apparatus according to various embodiments of the present disclosure may include a first vibration member, a second vibration member at a rear surface of the first vibration member, a vibration apparatus including a first vibration generating apparatus connected with the first vibration member and a second vibration generating apparatus connected with the second vibration member, and a space between the first vibration member and the second vibration member.

According to various embodiments of the present disclosure, at least a portion of the first vibration generating apparatus may overlap the second vibration generating apparatus.

According to various embodiments of the present disclosure, the first vibration generating apparatus and the second vibration generating apparatus may vibrate in a same direction.

According to various embodiments of the present disclosure, a size of the first vibration member may be different from a size of the second vibration member, or may be greater than or equal to a size of the second vibration member.

According to various embodiments of the present disclosure, a thickness of the first vibration member may be different from a thickness of the second vibration member, or may be greater than or equal to a thickness of the second vibration member.

According to various embodiments of the present disclosure, may further include a connection member between the first vibration member and the second vibration member.

According to various embodiments of the present disclosure, the connection member may surround the space.

According to various embodiments of the present disclosure, a first surface of the connection member may be connected with the rear surface of the first vibration member, and a second surface different from the first surface of the connection member may be connected with an upper surface of the second vibration member.

According to various embodiments of the present disclosure, may further include an enclosure at a rear surface of the second vibration member.

According to various embodiments of the present disclosure, the apparatus may further include a first connection member connected with the first vibration member to surround the space, and a second connection member between the second vibration member and the enclosure.

According to various embodiments of the present disclosure, a thickness of the first connection member may be different from a thickness of the second connection member, or may be greater than or equal to a thickness of the second connection member.

According to various embodiments of the present disclosure, at least a portion of the first connection member may overlap the second vibration member.

According to various embodiments of the present disclosure, a first surface of the first connection member may be connected with the rear surface of the first vibration member, and a second surface different from the first surface of the first connection member may be connected with an upper surface of the second vibration member.

According to various embodiments of the present disclosure, a width of the first connection member may be different from a width of the second connection member, or may be less than or equal to a width of the second connection member.

According to various embodiments of the present disclosure, the first connection member may not overlap the second vibration member.

According to various embodiments of the present disclosure, a first surface of the first connection member may be connected with the rear surface of the first vibration member, and a second surface different from the first surface of the first connection member may be connected with the enclosure.

According to various embodiments of the present disclosure, the enclosure may include a bottom portion, and a lateral portion connected with an edge of the bottom portion and at least one of the first vibration member and the second vibration member.

According to various embodiments of the present disclosure, the first connection member may overlap at least a portion of the lateral portion. A width of the first connection member may be different from a width of the lateral portion, or may be less than or equal to a width of the lateral portion. The second connection member may overlap the lateral portion, have a width which is greater than or equal to a width of the first connection member, or may be less than or equal to a width of the lateral portion.

According to various embodiments of the present disclosure, the lateral portion may include a first lateral portion connected with the first vibration member by the first connection member, and a second lateral portion provided at an inner side of the first lateral portion and connected with the second vibration member by the second connection member.

According to various embodiments of the present disclosure, the first connection member and the lateral portion may surround the space.

According to various embodiments of the present disclosure, the bottom portion of the enclosure may include at least one hole provided to connect a space between the second vibration member and the enclosure with the outside.

According to various embodiments of the present disclosure, at least a portion of the at least one hole may be provided to overlap the second vibration generating apparatus.

According to various embodiments of the present disclosure, each of the first vibration generating apparatus and the second vibration generating apparatus may include at least one vibration part, a first electrode layer at a first surface of the at least one vibration part, and a second electrode layer at a second surface different from the first surface of the at least one vibration portion.

According to various embodiments of the present disclosure, the at least one vibration part may include an inorganic material portion having a piezoelectric characteristic.

According to various embodiments of the present disclosure, the at least one vibration part may include a plurality of inorganic material portions having a piezoelectric characteristic, and an organic material portion between the plurality of inorganic material portions.

According to various embodiments of the present disclosure, each of the first vibration generating apparatus and the second vibration generating apparatus may include a first cover member at the first electrode layer, and a second cover member at the second electrode layer.

According to various embodiments of the present disclosure, the first vibration generating apparatus may be disposed at at least one of a first surface of the first vibration member and a second surface different from the first surface of the first vibration member. The second vibration generating apparatus may be disposed at at least one of a first surface of the second vibration member and a second surface different from the first surface of the second vibration member.

According to various embodiments of the present disclosure, a vibration driving signal applied to the first vibration generating apparatus may have a phase which is a same as or opposite to a phase of a vibration driving signal applied to the second vibration generating apparatus.

According to various embodiments of the present disclosure, at least one of the first vibration generating apparatus and the second vibration generating apparatus may include a plurality of vibration generators.

According to various embodiments of the present disclosure, vibration driving signals respectively applied to the plurality of vibration generators may have a same phase or opposite phases.

According to various embodiments of the present disclosure, the first vibration generating apparatus may include a first vibration generator at the first surface of the first vibration member, and a second vibration generator at the second surface of the first vibration member.

According to various embodiments of the present disclosure, at least a portion of the first vibration generator may overlap the second vibration generator.

According to various embodiments of the present disclosure, a vibration driving signal applied to the first vibration generator may have a phase opposite to a phase of a vibration driving signal applied to the second vibration generator.

According to various embodiments of the present disclosure, the second vibration generating apparatus may be disposed at at least one of the first surface and the second surface of the second vibration member. At least a portion of the second vibration generating apparatus may overlap at least one of the first vibration generator and the second vibration generator.

According to various embodiments of the present disclosure, a vibration driving signal applied to the second vibration generating apparatus may have a phase, which is the same as a phase of a vibration driving signal applied to one of the first vibration generator and the second vibration generator, and may have a phase opposite to a phase of a vibration driving signal applied to the other of the first vibration generator and the second vibration generator.

According to various embodiments of the present disclosure, the second vibration generating apparatus may include a third vibration generator at the first surface of the second vibration member, and a fourth vibration generator at the second surface of the second vibration member.

According to various embodiments of the present disclosure, at least a portion of the third vibration generator may overlap the fourth vibration generator.

According to various embodiments of the present disclosure, a vibration driving signal applied to the third vibration generator may have a phase opposite to a phase of a vibration driving signal applied to the fourth vibration generator.

According to various embodiments of the present disclosure, the first vibration generating apparatus may be disposed at at least one of the first surface and the second surface of the first vibration member. At least a portion of the first vibration generating apparatus may overlap at least one of the third vibration generator and the fourth vibration generator.

According to various embodiments of the present disclosure, a vibration driving signal applied to the first vibration generating apparatus may have a phase, which is the same as a phase of a vibration driving signal applied to one of the third vibration generator and the fourth vibration generator, and may have a phase opposite to a phase of a vibration driving signal applied to the other of the third vibration generator and the fourth vibration generator.

According to various embodiments of the present disclosure, at least one of the first vibration generating apparatus and the second vibration generating apparatus may include a first vibration part and a second vibration part spaced apart from each other in parallel.

According to various embodiments of the present disclosure, vibration driving signals respectively applied to the first vibration part and the second vibration part may have the same phase, or have a phase difference therebetween.

According to various embodiments of the present disclosure, each of the first vibration generating apparatus and the second vibration generating apparatus may include a first vibration part and a second vibration part.

According to various embodiments of the present disclosure, one of the first vibration part and the second vibration part of the first vibration generating apparatus may overlap at least one of the first vibration part and the second vibration part of the second vibration generating apparatus, or may not overlap the first vibration part and the second vibration part of the second vibration generating apparatus.

According to various embodiments of the present disclosure, at least one of the first vibration generating apparatus and the second vibration generating apparatus may include a plurality of vibration generators.

According to various embodiments of the present disclosure, the first vibration generating apparatus may include a first vibration generator at the first surface of the first vibration member, the first vibration generator including the first vibration part and the second vibration part, and a second vibration generator at the second surface of the first vibration member, the second vibration generator including the first vibration part and the second vibration part. One of the first vibration part and the second vibration part of the first vibration generator may overlap at least one of the first vibration part and the second vibration part of the second vibration generator, or may not overlap the first vibration part and the second vibration part of the second vibration generator.

According to various embodiments of the present disclosure, the second vibration generating apparatus may include a third vibration generator at the first surface of the second vibration member, the third vibration generator including the first vibration part and the second vibration part, and a fourth vibration generator at the second surface of the second vibration member, the fourth vibration generator including the first vibration part and the second vibration part. One of the first vibration part and the second vibration part of the third vibration generator may overlap at least one of the first vibration part and the second vibration part of the fourth vibration generator, or may not overlap the first vibration part and the second vibration part of the fourth vibration generator.

According to various embodiments of the present disclosure, the apparatus may further include at least one weight member provided in at least one of the first vibration generating apparatus and the second vibration generating apparatus.

According to various embodiments of the present disclosure, the at least one weight member may overlap one or more of a center portion of and an edge portion of at least one of the first vibration generating apparatus and the second vibration generating apparatus.

According to various embodiments of the present disclosure, the at least one weight member may be disposed in at least one of the first vibration member and the second vibration member.

According to various embodiments of the present disclosure, each of the first vibration member and the second vibration member may include one or more materials of metal, plastic, fiber, leather, wood, cloth, rubber, carbon, glass, and paper.

According to various embodiments of the present disclosure, the first vibration member may include one or more of a display panel including a pixel displaying an image, a screen panel on which an image is to be projected from a display apparatus, a light emitting diode illumination panel, an organic light emitting illumination panel, an inorganic light emitting illumination panel, a signage panel, a vehicular interior material, a vehicular exterior material, a vehicular glass window, an interior material of a vehicular seat, a ceiling material of a building, an interior material of a building, a window of a building, an interior material of an aircraft, and a mirror.

It will be apparent to those skilled in the art that various modifications and variations may be made in the apparatus of the present disclosure without departing from the scope of the disclosure. Thus, it is intended that the present disclosure cover the modifications and variations of this disclosure provided that within the scope of the appended claims and their equivalents.

What is claimed is:

1. An apparatus, comprising:
a first vibration member;
a second vibration member at a rear surface of the first vibration member:
a vibration apparatus including a first vibration generating apparatus connected with the first vibration member and a second vibration generating apparatus connected with the second vibration member; and
a space between the first vibration member and the second vibration member.

2. The apparatus of claim 1, wherein at least a portion of the first vibration generating apparatus overlaps the second vibration generating apparatus.

3. The apparatus of claim 1, wherein the first vibration generating apparatus and the second vibration generating apparatus vibrate in a same direction.

4. The apparatus of claim 1, wherein a size of the first vibration member is different from a size of the second vibration member, or is greater than or equal to a size of the second vibration member.

5. The apparatus of claim 1, wherein a thickness of the first vibration member is different from a thickness of the second vibration member, or is greater than or equal to a thickness of the second vibration member.

6. The apparatus of claim 1, further comprising a connection member between the first vibration member and the second vibration member.

7. The apparatus of claim 6, wherein the connection member surrounds the space.

8. The apparatus of claim 6, wherein a first surface of the connection member is connected with the rear surface of the first vibration member, and
a second surface different from the first surface of the connection member is connected with an upper surface of the second vibration member.

9. The apparatus of claim 1, further comprising an enclosure at a rear surface of the second vibration member.

10. The apparatus of claim 9, further comprising:
a first connection member connected with the first vibration member to surround the space; and
a second connection member between the second vibration member and the enclosure.

11. The apparatus of claim 10, wherein a thickness of the first connection member is different from a thickness of the second connection member, or is greater than or equal to a thickness of the second connection member.

12. The apparatus of claim 10, wherein at least a portion of the first connection member overlaps the second vibration member.

13. The apparatus of claim 12, wherein a first surface of the first connection member is connected with the rear surface of the first vibration member, and
a second surface different from the first surface of the first connection member is connected with an upper surface of the second vibration member.

14. The apparatus of claim 12, wherein a width of the first connection member is different from a width of the second connection member, or is less than or equal to a width of the second connection member.

15. The apparatus of claim 10, wherein the first connection member does not overlap the second vibration member.

16. The apparatus of claim 15, wherein a first surface of the first connection member is connected with the rear surface of the first vibration member, and
a second surface different from the first surface of the first connection member is connected with the enclosure.

17. The apparatus of claim 9, wherein the enclosure comprises:
a bottom portion; and
a lateral portion connected with an edge of the bottom portion and at least one of the first vibration member and the second vibration member.

18. The apparatus of claim 17, wherein the first connection member overlaps at least a portion of the lateral portion,
wherein a width of the first connection member is different from a width of the lateral portion, or is less than or equal to a width of the lateral portion, wherein the second connection member overlaps the lateral portion, and
a width of the second connection member is greater than or equal to a width of the first connection member, or less than or equal to a width of the lateral portion.

19. The apparatus of claim 17, wherein the lateral portion comprises:
a first lateral portion connected with the first vibration member by the first connection member; and
a second lateral portion provided at an inner side of the first lateral portion and connected with the second vibration member by the second connection member.

20. The apparatus of claim 19, wherein the first connection member and the lateral portion surround the space.

21. The apparatus of claim 17, wherein the bottom portion of the enclosure comprises at least one hole provided to connect a space between the second vibration member and the enclosure with the outside.

22. The apparatus of claim 21, wherein at least a portion of the at least one hole is provided to overlap the second vibration generating apparatus.

23. The apparatus of claim 1, wherein each of the first vibration generating apparatus and the second vibration generating apparatus comprises:
at least one vibration part;
a first electrode layer at a first surface of the at least one vibration part; and
a second electrode layer at a second surface different from the first surface of the at least one vibration part.

24. The apparatus of claim 23, wherein the at least one vibration part comprises an inorganic material portion having a piezoelectric characteristic.

25. The apparatus of claim 23, wherein the at least one vibration part comprises:
a plurality of inorganic material portions having a piezoelectric characteristic; and
an organic material portion between the plurality of inorganic material portions.

26. The apparatus of claim 23, wherein each of the first vibration generating apparatus and the second vibration generating apparatus comprises:
a first cover member at the first electrode layer; and
a second cover member at the second electrode layer.

27. The apparatus of claim 23, wherein the first vibration generating apparatus is disposed at at least one of a first surface of the first vibration member and a second surface different from the first surface of the first vibration member, and
wherein the second vibration generating apparatus is disposed at at least one of a first surface of the second vibration member and a second surface different from the first surface of the second vibration member.

28. The apparatus of claim 27, wherein a vibration driving signal applied to the first vibration generating apparatus has a phase which is a same as or opposite to a phase of a vibration driving signal applied to the second vibration generating apparatus.

29. The apparatus of claim 27, wherein at least one of the first vibration generating apparatus and the second vibration generating apparatus comprises a plurality of vibration generators.

30. The apparatus of claim 29, wherein vibration driving signals respectively applied to the plurality of vibration generators have a same phase or opposite phases.

31. The apparatus of claim 29, wherein the first vibration generating apparatus comprises:
a first vibration generator at the first surface of the first vibration member; and
a second vibration generator at the second surface of the first vibration member.

32. The apparatus of claim 31, wherein at least a portion of the first vibration generator overlaps the second vibration generator.

33. The apparatus of claim 31, wherein a vibration driving signal applied to the first vibration generator has a phase opposite to a phase of a vibration driving signal applied to the second vibration generator.

34. The apparatus of claim 31, wherein the second vibration generating apparatus is disposed at at least one of the first surface and the second surface of the second vibration member, and
wherein at least a portion of the second vibration generating apparatus overlaps at least one of the first vibration generator and the second vibration generator.

35. The apparatus of claim 34, wherein a vibration driving signal applied to the second vibration generating apparatus has a phase, which is the same as a phase of a vibration driving signal applied to one of the first vibration generator and the second vibration generator, and has a phase opposite to a phase of a vibration driving signal applied to the other of the first vibration generator and the second vibration generator.

36. The apparatus of claim 29, wherein the second vibration generating apparatus comprises:
a third vibration generator at the first surface of the second vibration member; and
a fourth vibration generator at the second surface of the second vibration member.

37. The apparatus of claim 36, wherein at least a portion of the third vibration generator overlaps the fourth vibration generator.

38. The apparatus of claim 36, wherein a vibration driving signal applied to the third vibration generator has a phase opposite to a phase of a vibration driving signal applied to the fourth vibration generator.

39. The apparatus of claim 36, wherein the first vibration generating apparatus is disposed at at least one of the first surface and the second surface of the first vibration member, and
wherein at least a portion of the first vibration generating apparatus overlaps at least one of the third vibration generator and the fourth vibration generator.

40. The apparatus of claim 39, wherein a vibration driving signal applied to the first vibration generating apparatus has a phase, which is the same as a phase of a vibration driving signal applied to one of the third vibration generator and the fourth vibration generator, and has a phase opposite to a phase of a vibration driving signal applied to the other of the third vibration generator and the fourth vibration generator.

41. The apparatus of claim 23, wherein at least one of the first vibration generating apparatus and the second vibration generating apparatus comprises a first vibration part and a second vibration part spaced apart from each other in parallel.

42. The apparatus of claim 41, wherein vibration driving signals respectively applied to the first vibration part and the second vibration part have the same phase, or have a phase difference therebetween.

43. The apparatus of claim 41, wherein each of the first vibration generating apparatus and the second vibration generating apparatus comprises a first vibration part and a second vibration part.

44. The apparatus of claim 43, wherein one of the first vibration part and the second vibration part of the first vibration generating apparatus overlaps at least one of the first vibration part and the second vibration part of the second vibration generating apparatus, or does not overlap the first vibration part and the second vibration part of the second vibration generating apparatus.

45. The apparatus of claim 43, wherein at least one of the first vibration generating apparatus and the second vibration generating apparatus comprises a plurality of vibration generators.

46. The apparatus of claim 45, wherein the first vibration generating apparatus comprises:
a first vibration generator at the first surface of the first vibration member, the first vibration generator including the first vibration part and the second vibration part; and
a second vibration generator at the second surface of the first vibration member, the second vibration generator including the first vibration part and the second vibration part,
wherein one of the first vibration part and the second vibration part of the first vibration generator overlaps at least one of the first vibration part and the second vibration part of the second vibration generator, or does not overlap the first vibration part and the second vibration part of the second vibration generator.

47. The apparatus of claim 45, wherein the second vibration generating apparatus comprises:
a third vibration generator at the first surface of the second vibration member, the third vibration generator including the first vibration part and the second vibration part; and
a fourth vibration generator at the second surface of the second vibration member, the fourth vibration generator including the first vibration part and the second vibration part,
wherein one of the first vibration part and the second vibration part of the third vibration generator overlaps at least one of the first vibration part and the second vibration part of the fourth vibration generator, or does not overlap the first vibration part and the second vibration part of the fourth vibration generator.

48. The apparatus of claim 1, further comprising at least one weight member provided in at least one of the first vibration generating apparatus and the second vibration generating apparatus.

49. The apparatus of claim 48, wherein the at least one weight member overlaps one or more of a center portion of and an edge portion of at least one of the first vibration generating apparatus and the second vibration generating apparatus.

50. The apparatus of claim 48, wherein the at least one weight member is disposed in at least one of the first vibration member and the second vibration member.

51. The apparatus of claim 1, wherein each of the first vibration member and the second vibration member comprises one or more materials of metal, plastic, fiber, leather, wood, cloth, rubber, carbon, glass, and paper.

52. The apparatus of claim 1, wherein the first vibration member comprises one or more of a display panel including a pixel displaying an image, a screen panel on which an image is to be projected from a display apparatus, a light emitting diode illumination panel, an organic light emitting illumination panel, an inorganic light emitting illumination panel, a signage panel, a vehicular interior material, a vehicular exterior material, a vehicular glass window, an interior material of a vehicular seat, a ceiling material of a building, an interior material of a building, a window of a building, an interior material of an aircraft, and a mirror.
